(19) United States
(12) Patent Application Publication
(10) Pub. No.: US 2006/0265508 A1
(43) Pub. Date: Nov. 23, 2006

(54) System for administering a multiplicity of namespaces containing state information and services

(76) Inventors: Franklin J. Angel, Mount Laurel, NJ (US); John King Burns, Philadelphia, PA (US); Charles J. Northrup, Old Bridge, NJ (US)

Correspondence Address: PATTON BOGGS, 1660 LINCOLN ST, SUITE 2050, DENVER, CO, 80264, US

(21) Appl. No.: 11/120,076

(22) Filed: May 2, 2005

(51) Int. Cl. G06F 15/16

(52) U.S. Cl. 709/230

(57) ABSTRACT

The Namespace Management System comprises a run-time configurable state information management system that evaluates a request within a semantic domain defined by the state information at a given moment in time. The Namespace Management System comprises a Namespace Management application, executing on a computer system that is connected to the Internet or other Autonomous System. The Namespace Management System is programmatically and dynamically configurable to take part in and administer a multiplicity of namespaces, each of which contains listings, data, and services or other state information required to satisfy a request and/or interact with callable services. A multiplicity of Namespace Management Systems can register services, provide services, discover services, communicate with services, and participate in one or more dynamic network namespaces, with each Namespace Management System having at least one associated dynamic network namespace listing. At run-time, a Namespace Management System can register a subscriber's present point of presence to associate with its dynamic network namespace listing. The Namespace Management System provides dynamic point of presence registration for namespace listings and through a scheme handler service to resolve a namespace listing reference, which is given as a Uniform Resource Identifier, to the present point of presence for the namespace listing. This process enables the Namespace Management System to provide web services independent of the physical location of the subscriber.

### FIELD OF THE NAMESPACE MANAGEMENT SYSTEM

This Namespace Management System provides a system to administer one or more service directories as namespaces on a multiplicity of edge computing devices, at least one of which is independent of DNS and physical access method, where the namespace administers a multiplicity of namespace listings with associated services and state information to facilitate communications through the namespace.

### PROBLEM

It is a problem in the Internet and the World Wide Web to efficiently administer network addresses, since these systems have grown tremendously in size and complexity since inception. A common Internet activity is for a user to request and graphically render a Hypertext Markup Language (HTML) document on their computer system, using a Uniform Resource Identifier (URI) to uniquely identify the document to the graphic rendering process. The Uniform Resource Identifier contains a domain name that can be resolved to an Internet network address through the Domain Name System of the Internet, or a network address. The computer system is then connected to the identified Internet network address to retrieve and then render the requested Hypertext Markup Language document.

An Autonomous System, such as the Internet, is a collection of gateways (routers) with separate administrative entity. These routers cooperate using a common Interior Gateway Protocol (IGP) and common metrics to route data packets within the Internet and they use an exterior gateway protocol to route data packets to servers and/or other Autonomous Systems that are connected to the Internet. Routers pertaining to different autonomous systems must agree on a common exterior gateway protocol in order to communicate with each other effectively. It is common for a single Autonomous System to use several interior gateway protocols and sometimes several sets of metrics within an Autonomous System. The use of the term Autonomous System here stresses the fact that, even when multiple Interior Gateway Protocols and metrics are used, the administration of an Autonomous System appears to other Autonomous Systems to have a single coherent interior routing plan and presents a consistent picture of which destinations are reachable through it.

As an example, the autonomous systems can use the Border Gateway Protocol Version 4 (BGP-4) as their exterior routing protocol. The Border Gateway Protocol (BGP) uses TCP as its transport protocol and, on the start of the connection process, Border Gateway Protocol peers exchange complete copies of their routing tables, which can be quite large. However, after the initial exchange only changes (deltas) are exchanged, which makes long running Border Gateway Protocol sessions more efficient than shorter ones. The Border Gateway Protocol performs routing between multiple autonomous systems or domains and this protocol exchanges routing and reachability information with other Border Gateway Protocol systems. Border Gateway Protocol's basic unit of routing information is the BGP path, a route to a certain set of Classless Inter-Domain Routing prefixes. Paths are tagged with various path attributes.

The Domain Name System (DNS) is used to resolve a domain name and find a corresponding Internet Address to which a data packet should be sent. The physical delivery of a data packet is facilitated through autonomous systems using the Border Gateway Protocol as the exterior routing protocol for sending the data packets. The Domain Name System provides names for network resources at a more abstract level than a network IP address. The Domain Name System was originally designed to support queries of a statically configured database. While the data was expected to change, the frequency of those changes was expected to be fairly low, and all updates were made as external edits to a zone's Master File.

A Domain Name System host name can only be resolved to an IP address on the Internet, not to a person or to a service. Several issues make the resolution of a Domain Name System host name to a unique person or service impossible. For one, in the normal course of activities, a person may move about from one location to another and utilize different physical network connections to the Internet. Even if they use the same portable computer or other computing device from each location their presence as viewed from the rest of the Internet changes, because the physical network connection is different, i.e., their physical point of presence, the IP address, changes. It is highly likely that the person's Internet Service Provider (ISP) that connects their computing device to the Internet at each of the locations will be different—and since each ISP is allocated unique blocks of IP address space, each Internet connection that the person uses is assigned a different, unique IP address. One, therefore, cannot use an IP address as the sole means for authenticating a user.

Domain Name System host names are even more problematic, as it is common practice for businesses and Internet Service Providers to maintain DNS A or CNAME records only for critical hosts that are commonly reached by name, such as servers. Other computers on the network rarely have Domain Name System records, due somewhat to the desire to reduce administrative burden and also somewhat to the lack of need.

Another problem arises due to the constraints caused by the limited number of domain names and IP addresses available on the Internet. Directly addressable public IP addresses are in short supply due to the limitations inherent in Internet Protocol, version 4. It is, therefore, common for enterprises to implement methods to expand their IP space by the use of such techniques as Network Address Translation (NAT). Home users also employ Network Address Translation to provide Internet access to their small home networks, which in many cases have only one public IP supplied by their ISP. When using Network Address Translation, a large number of computers located behind the Network Address Translation device are assigned non-public IP addresses and share a relatively small number of public IP addresses. The Domain Name System becomes largely useless in this case, as it can only provide names for the limited number of public IP addresses by employing such methods as one-to-one IP address mapping. Even if mapping is employed, the number of hosts inside the Network Address Translation device that can be addressed by a public IP address is limited to the number of public IP addresses that are available. For example, a firm may employ Network Address Translation in their gateway device, which allows them to provide an almost unlimited number of computers on their private network with Internet access over the T1; however, only a subset of the public IP addresses are available for directly mapping external requests to their hosts.

In addition, the need to secure computers from direct access from the Internet introduces yet another problem for host discovery and resolution. Firewalls shield networks from outside access by implementing rules on what protocols and ports may be used for inbound traffic. It is often necessary to hide a computer due to operating system vulnerabilities. Since the network administrator is unsure of what ports on a given computer are open or contain such security issues, it is far simpler to place the computer behind the firewall and prevent all access to that computer from outside the firewall. Thus, a person's computer is not always directly addressable from a computer outside the firewall.

The Dynamic Host Configuration Protocol provides a framework for passing configuration information to hosts on a TCP/IP network. Dynamic Host Configuration Protocol consists of two components: a protocol for delivering host-specific configuration parameters from a Dynamic Host Configuration Protocol server to a host, and a mechanism for allocation of network addresses to hosts. This automated process reduces the administrative effort for enterprises with many network devices. Internet Service Providers take advantage of Dynamic Host Configuration Protocol to lease a relatively small number of IP addresses to a much larger subscriber base on a temporary basis, ensuring that all subscribers can be serviced. For example, although an ISP may have a large number of dial-up subscribers, there is only a subset of those subscribers who are accessing the Internet through the ISP's network at any given time. Dynamic Host Configuration Protocol provides a lease of an IP address for the duration of the subscriber's connection, and the IP address is released to a pool to be used again when the subscriber disconnects. Networks employing Dynamic Host Configuration Protocol effectively render Domain Name System useless as a means of locating hosts that use Dynamic Host Configuration Protocol, as IP addresses for computers on the network change as leases expire.

Corporations often administer their own Name Server (DNS Resolver). Computers participating in the Internet that are controlled by the Corporation may be resolved through the Corporation's domain name Name Server. This is to prevent a computer from having access to sensitive corporate information or appearing to be sanctioned by the Corporation when in fact the Corporation would have no idea what the computer is being used for.

In general, the state of the industry is such that hostnames of a given domain name are resolved to IP Addresses of specific computers under the control of the domain name owner, often representing the domain name owner assets accessible directly through Internet Protocol communications. The complexity and size of the Internet render the operation of existing network address management systems inefficient and limiting in the services that are provided.

### SOLUTION

The above-described problems are solved and a technical advance achieved by the present Namespace Management System, which comprises a run-time configurable state information management system that evaluates a request within a semantic domain defined by the state information at a given moment in time.

The preferred implementation of the Namespace Management System comprises a Namespace Management application, executing on a computer system that is connected to the Internet or other Autonomous System. The Namespace Management System is programmatically and dynamically configurable to take part in and administer a multiplicity of namespaces, each of which contain listings, data, and services or other state information required to satisfy a request and/or interact with callable services. A multiplicity of Namespace Management Systems can register services, provide services, discover-,services, communicate with services, and participate in one or more Dynamic Network Namespaces (DNN), with each Namespace Management System having at least one associated dynamic network namespace listing. At run-time, a Namespace Management System can register a subscriber's present point-of-presence to associate with its dynamic network namespace listing. The Namespace Management System provides dynamic point-of-presence registration for namespace listings and through a scheme handler service to resolve a namespace listing reference, which is given as a Uniform Resource Identifier, to the present point-of-presence for the namespace listing. This process enables the Namespace Management System to provide Web Services independent of the physical location of the subscriber. The Namespace Management System also provides a Uniform Resource Request, which provides backward compatibility for existing Uniform Resource Identifiers. The Extensible Markup Language (XML) namespaces are defined as a collection of names, identified by a Uniform Resource Identifier reference, which are used in Extensible Markup Language documents as element types and attribute names. Extensible Markup Language namespaces differ from the “namespaces” conventionally used in computing disciplines in that the Extensible Markup Language version has internal structure and is not, mathematically speaking, a set.

With the Namespace Management System, a requesting service communicates with a service provider service using inter-process or intra-process interfaces according to a protocol, such as an Internet Protocol. The requesting process is typically a user process and the Internet Protocol is normally part of the protocol stack within the kernel. Other protocols can be used to communicate between services. System protocols are typically accessible through an application programming interface (API). A service may be compiled with a call using an application programming interface providing access to the system protocol. A service can also be registered so that when called by another service, the service can provide access to the system protocol. Application level protocols are made available through the use of services configured to use the operating system communication protocol. Application protocols can also be provided through configuration documents registering services providing the application protocol.

The Namespace Management System includes a bootstrap service for initialization, a parser service for parsing and evaluating the content of a configuration document, a service for registering built-in services provided through dynamically loadable modules that were not compiled into the static representation of the application program corresponding to the Namespace Management process, a service for calling registered built-in services, one or more dynamically loadable modules, and configuration documents describing the services provided by the Namespace Management System.

The Namespace Management System allows services to be dynamically registered in service directories during compilation, initialization, and during run-time. The registration includes the name of the service, connectivity, and zero or more input and/or output types as named representations of data. The Namespace Management System enables additional services to be made available to extend the functionality of the system during run-time without requiring the Namespace Management application program to be recompiled.

The Namespace Management System overcomes the limitations of existing Peer-to-Peer file sharing software. Corporations and even individuals relying on the benefits of computing technology often are the victims of viruses and spyware being installed on their computers. With the Namespace Management System, an overlay network environment is instantiated as a named namespace by a Dynamic Network Namespace service provider service. To obtain a listing in the namespace, a user subscribes to the namespace by satisfying the subscription criteria specified by the namespace service provider, and receives a subscription configuration document and access to a Namespace Management System. The subscription configuration document may optionally include information representative of a service level agreement.

Existing Dynamic Hostname Services can be classified in two forms. First, a subscriber can register a hostname which is subordinate to a Domain Name System domain name that is managed by the Dynamic Hostname Services service provider. The subscriber can then register a present point of presence to associate with the qualified domain name using a controller client application installed on the subscriber computer. In this manner, subsequent references to the qualified name are resolved to that present point of presence. Alternatively, a subscriber can register a fully qualified domain name with a primary Domain Name System server managed by the Dynamic Hostname Services provider. The subscriber can then register the present point of presence to associate with the fully qualified domain name using a controller client application installed on the subscriber computer. The fully qualified domain name may be resolved to an alias hostname and the subscriber registers the present point of presence to associate with their fully qualified domain name as the present point of presence for the aliased hostname.

The Dynamic Hostname Services attempt to solve the problem of Domain Name System hostname mobility and Domain Name System resolution to a current DHCP Internet Address. A Domain Name System hostname, however, is resolved to an IP address on the Internet, not to a subscriber or to a service and thus has the same limitations previously mentioned. A multiplicity of computers located behind a Network Address Translation device are assigned non-public IP addresses and share a relatively small number of public IP addresses. The Domain Name System becomes largely useless in this case, as it can only provide names for the limited number of public IP addresses by employing such methods as one-to-one IP address mapping. If, for example, there are two computers behind a Network Address Translation device, each with a non-public IP address, and the Network Address Translation device has a single external public IP address, then only one of the two computers can be responsive to requests received directed to a particular port of the public IP address. Port forwarding may be enabled through the Network Address Translation device to direct port specific communications to a particular non-public address. For example, a communication directed to a first port (or range of ports) can be forwarded to a first computer, and a communication directed to a second port (or range of ports) can be forwarded to a second computer. However, this would require client applications to know the specific non-standard ports in order to establish connections to server type services available on each of the particular computers behind the Network Address Translation device.

The Namespace Management System overcomes the limitations of dynamic hostname services by enabling a configured Namespace Management System to be installed on a multiplicity of computers behind a Network Address Translation device, with each of the multiplicity of computers having a non-public IP address, and the Network Address Translation device is responsive to a single public IP address. Each Namespace Management System can register a unique namespace listing and through routing services, each Namespace Management System can receive requests communicated by applications external to the Network Address Translation device. Furthermore, with a Dynamic Network Namespace a namespace service provider can provision their namespace and allow for static and dynamic namespace listings. A subscriber can provision their namespace listing and allow for static and dynamic listings relative to the subscriber listing.

### BRIEF DESCRIPTION OF THE DRAWINGS

FIG. 1 illustrates an example of a configuration document registering get.xml.news;

FIG. 2 illustrates an example of a HTML with embedded configuration document calling get.xml service;

FIGS. 3A and 3B illustrate an example of a zipcode to longitude/latitude service;

FIG. 4 illustrates an example of a pdcx request for epop registration service;

FIG. 5 illustrates an example of a pdcx:request;

FIG. 6 illustrates an example of a WS-Addressing Using SOAP;

FIG. 7 illustrates an example of a listing syntax;

FIG. 8 illustrates an example of an optional request;

FIG. 9 illustrates an example of a configuration document;

FIG. 10 illustrates an example of a script using namespace services;

FIG. 11 illustrates an example of an Object Based Language using namespace services;

FIG. 12 illustrates an example of a Functional entity type definition and use;

FIG. 13 illustrates an example of an event-based service using namespace services;

FIG. 14 illustrates an example of a Client application sending request through DNN to server application;

FIG. 15 illustrates an example of a Registering the “Point” service object;

FIG. 16 illustrates an example of a Registering an instance of the Point service object;

FIGS. 17A-17C illustrate an example of a Registering the “Rectangle” service object;

FIG. 18 illustrates an example of a Configuration Document fragment describing service object interaction;

FIG. 19 illustrates an example of a Configuration Document fragment declaring an interface;

FIGS. 20A and 20B illustrate an example of a service information via RSS;

FIG. 21 illustrates an example of an encoded content within a configuration document;

FIG. 22 illustrates an example of a Configuration Document using satisfaction claim to renew epop registration;

FIG. 23 illustrates an example of a request for discovery;

FIGS. 24A and 24B illustrate an example of a Service Advertisement;

FIGS. 25A and 25B illustrate an example of a Configuration Document registering a local service registration service;

FIG. 26 illustrates an example of a service to send the compoints as name value pairs;

FIG. 27 illustrates a service to register response: entity information included in a response communication;

FIG. 28 illustrates an example of a Registering a service described in a separate configuration document;

FIG. 29 illustrates a configuration document describing a request to register a service;

FIG. 30 illustrates an example of an epop.set request;

FIG. 31 illustrates an example of an epop.unset request;

FIG. 32 illustrates an example of an epop.set request for a specified listing;

FIG. 33 illustrates an example of a service to notify registered services of an epop.set;

FIG. 34 illustrates an example of an Access Rights Configuration Document;

FIG. 35 illustrates an example of a configuration document fragment registering http HEADER information;

FIG. 36 illustrates an example of a HTTP communication primitives;

FIG. 37 illustrates an example of a HTTP built-in services;

FIGS. 38A and 38B illustrate an example of a service:main service;

FIGS. 39A and 39B illustrate an example of a bootstrap pdcx.xml, configuration document;

FIG. 40 illustrates an example request including calls for encrypting content;

FIG. 41 illustrates an example of horseracing information that can be imported into the namespace management system;

FIGS. SSDL-1A and SSDL-1B illustrate SSDL Content;

FIG. SSDL-2 illustrates SSDL Prerequisites Content;

FIG. SSDL-3 illustrates SSDL Example Types Content;

FIG. SSDL-4 illustrates SSDL Interface Content;

FIGS. SSDL-5A and SSDL-5B illustrate SSDL Binding Content;

FIG. SSDL-6 illustrates SSDL Binding Content Example;

FIG. SSDL-7 illustrates SSDL Service Content;

FIG. SSDL-8 illustrates SSDL Workflow Content;

FIG. SSDL-9 illustrates SSDL Namespace Content;

FIG. SSDL-10 illustrates SSDL Resource Content;

FIG. RSS-1 illustrates the notation of RSS v2.0 Content; and

FIG. RSS-2 illustrates an example RSS v2.0 Service Syndication.

### DETAILED DESCRIPTION

Peer-to-Peer Network

Peer-to-peer systems, sometimes referred to as overlay networks, are distributed systems without centralized control or hierarchical organization. The software running at each peer is equivalent in functionality; An overlay network operates on top of a routing infrastructure based on a peer's logical identifier, which is mapped to a corresponding IP address in a routing table. The mapping may include a port reference. Peers typically connect to a multiplicity of other peers as determined by the implementation, and propagate queries through these connections. The use of overlay networks can be broadly categorized as either application specific, or frameworks providing generic overlay service networks in the Internet that can be used for a variety of applications.

Endpoints in an overlay network do not have a global view of the namespace topology defining the overlay. The overlay network generally has self-organizing characteristics in that it is established and maintained by the peer-to-peer software without any human intervention. Within an overlay network, a flat namespace is typically used to represent each node participating in the overlay. A two-level hierarchical naming system for peer-to-peer requires a peer to first send an intra-group query message to a super peer in its group, which can then forward the query message to another group. Hierarchical peer-to-peer look-up service also uses a two level hierarchical organization of peers where for each group, there are a set of special peers, called super peers, which are the only peers that are able to execute inter-group look-ups. The rest of the peers of the group, called “normal” peers, are able to perform look-ups in other groups through any super peer of the group. Every peer can become a super peer at every moment. The super peers are intended to be the peers of the group with better characteristics and are chosen according to a “merit” metric.

Peer-to-peer file-sharing software is well known in the industry. In a routine Internet transaction, a user connects via the Internet with a website to obtain information or transact business. In computer terms, the personal computer used by the consumer is considered the “client” and the computer that hosts the web page is the “server.” The client is obtaining information from a centralized source, namely the server. In a peer-to-peer distribution network, the information available for access does not reside on a central server. No one computer contains all of the information that is available to all of the users. Rather, each computer makes information available to every other computer in the peer-to-peer network. In other words, in a peer-to-peer network, each computer is both a server and a client. Because the information is decentralized in a peer-to-peer network, the software must provide some method of cataloguing the available information so that users may access it. The software operates by connecting, via the Internet, to other users of the same or similar software. At any given moment, the network consists of other users of similar or the same software online at that time. Thus, an index of files available for sharing is a critical component of peer-to-peer file-sharing networks.

At present, there are three different methods of indexing: (1) a centralized indexing system, maintaining a list of available files on one or more centralized servers; (2) a completely decentralized indexing system, in which each computer maintains a list of files available on that computer only; and (3) a “supernode” system, in which a select number of computers act as indexing servers.

The first indexing system uses a collective index of available files maintained on servers it owned and operated. Under a decentralized index peer-to-peer file-sharing model, each user maintains an index of only those files that the user wishes to make available to other network users. Under this model, the software broadcasts a search request to all the computers on the network and a search of the individual index files is conducted, with the collective results routed back to the requesting computer. The third type of peer-to-peer file-sharing network at present is the “supernode” model, in which a number of select computers on the network are designated as indexing servers. The user initiating a file search connects with the most easily accessible supernode, which conducts the search of its index and supplies the user with the results. Any computer on the network could function as a supernode if it met the technical requirements, such as processing speed.

Peer-to-Peer file sharing software, as the name implies, is used to share files such as digital audio, video, picture, and text files. The disadvantage of a centralized server is that it requires an index of content and providers managed by a single server. The disadvantage of a completely decentralized index is that there is no structure and no means of authenticating the provider, nor the requester. The disadvantage of the supernode architecture is that there is no authentication of either the user or the provider, and the architecture is limited to sharing files. The aforementioned Peer-to-Peer file sharing software is not dynamically configurable, does not have means for authentication in a global Internet environment, is limited to file sharing service, and is distributed as a binary executable application program.

Dynamic Internet Addresses

An Internet Service Provider typically provides a dynamic Internet Address for the subscriber as part of the basic subscription plan. A subscriber to an Internet Service Provider (ISP) may obtain a static Internet Address, but frequently must pay an extra service charge for that static Internet Address. Separately, the subscriber must pay for and obtain a domain name to associate with that static Internet Address. If the subscriber does not have a domain name with an associated static Internet Address available through the Domain Name System, then that subscriber cannot easily offer a service to another Internet user process that connects to the service via the Internet.

The problem is compounded further when a user has a laptop computer with a wireless Internet connection. As the user moves geographically, the particular dynamic Internet Address may change, thus compounding the problems of associating a domain name with the present Internet Address. Given that Uniform Resource Locators are a common form of Uniform Resource Identifiers, and that the W3C discourages the use of an Internet Address within a URL, a first user may be precluded from providing a Web Service to another Internet user process when the first user's computer does not have a domain name. It is noted that in Web Service, resources have identifiers (in fact they have Uniform Resource Identifiers).

In this context, a web service is understood to provide a standard means of interoperating between different software applications, running on a variety of platforms and/or frameworks. It is noted that the aforementioned Web Service Architecture does not attempt to specify how web services are implemented, and imposes no restriction on how web services might be combined. The Web Service Architecture describes both the minimal characteristics that are common to all web services, and a number of characteristics that are needed by many, but not all, web services.

Programmability of a dynamic system often requires the use of plug-ins for functionality that was not compiled into an application process of the dynamic system. An application program is compiled from source code and linked with various libraries to create an executable application program. When the application program begins execution as a process, it can locate one or more plug-ins installed on the computing device, and register the plug-ins as available services. The plug-in availability is determined during the application process startup. Each implementation has a binary application-programming-interface for how the application communicates with the plug-in. These implementations rely on marshalling parameters between the calling process and the plug-in module. Additionally, these plug-in architectures are limited in that plug-ins (the complete set of extended services) can only be installed during startup thus limiting the extendable feature set to what was known only during the startup.

Request

A request is a stream of data representative of one or more statements expressed in a syntactic notation, which can be interpreted by a parsing service, wherein the parsing service evaluates each of these statements within the semantic domain defined by the current state information. The current state information can be representative of a framework through the use of callable service-object services. In this context, a framework consists of a set of cooperating service-object classes that make up a reusable design for a specific class of software. A framework dictates the architecture of the application. It defines the overall structure, the partitioning of the application into classes and objects, the key responsibilities thereof, how the classes and objects collaborate, and the thread of control. The current state information can be representative of a service-oriented architecture system consisting of one or more service provider services, one or more service consumer services, a service registry, service contract, proxy, and service lease. A Service Oriented Architecture (SOA) combines the ability to invoke remote objects and functions (called “services”) with tools for dynamic service discovery, placing an emphasis on interoperability. The current state information can be representative of nodes available in a specific peer-to-peer application service, such as nodes with semantically equivalent content. The current state information can be representative of an Internet resource that can be expressed as a Uniform Resource Identifier. In the Namespace Management System, current state information is represented as namespace entity information. A reference to an entity is referred to as a listing, and the listing is a fully qualified listing if the reference includes the name of a namespace. Unqualified listings can be qualified using binding method rules.

Domain Name System

The Domain Name System (DNS) helps users to find their way around the Internet. Every computer on the Internet has a unique address—just like a telephone number—which is a rather complicated string of numbers. It is called its “IP address” (IP stands for “Internet Protocol”). It is difficult to remember the IP addresses' strings of numbers. The Domain Name System makes it easier by allowing a familiar string of letters (the “domain name”) to be used instead of the arcane IP address. The domain name is a “mnemonic” device that makes addresses easier to remember. Translating the name into the IP address is called “resolving the domain name.” The goal of the Domain Name System is for any Internet user any place in the world to reach a specific website IP address by entering its domain name. Domain names are also used for reaching e-mail addresses and for other Internet applications.

Universal resolvability ensures that each IP address is unique. The Domain Name System ensures that e-mail intended for one subscriber does not go to someone else with the same number or domain name. Without uniqueness, both systems would be unpredictable and therefore unreliable. Ensuring predictable results from any place on the Internet is called “universal resolvability.” It is a critical design feature of the Domain Name System, one that makes the Internet the helpful, global resource that it is today. Without it, the same domain name might map to different Internet locations under different circumstances, which would only cause confusion.

In an Internet address, the .org part is known as a Top Level Domain, or TLD. So-called “TLD registry” organizations house online databases that contain information about the domain names in that Top Level Domain. The .org registry database contains the Internet whereabouts—or IP address—of users. In trying to find the Internet address of a user, a computer must first find the .org registry database. At the heart of the Domain Name System are root servers. All root servers contain the same vital information—this is to spread the workload and back each other up. The root servers contain the IP addresses of all the Top Level Domain registries—both the global registries such as .com, .org, etc., and the 244 country-specific registries such as .fr (France), .cn (China), etc. This is critical information. If the information is not 100% correct or if it is ambiguous, it might not be possible to locate a key registry on the Internet; the information must be unique and authentic.

Scattered across the Internet are thousands of computers—called “Domain Name Resolvers” or just plain “resolvers”—that routinely cache the information they receive from queries to the root servers. These resolvers are located strategically with Internet Service Providers (ISPs) or institutional networks. They are used to respond to a user's request to resolve a domain name—that is, to find the corresponding IP address. The request is forwarded to a local resolver. The resolver splits the request into its component parts. It knows where to find the .org registry—remember, it had copied that information from a root server beforehand—so it forwards the request over to the .org registry to find the IP address of the user. This answer is forwarded back to the user's computer. The Domain Name System is a hierarchical system. First, the resolver finds the IP address for the .org registry, queries that registry to find the IP address for icann.org, then queries a local computer at that address to find the final IP address for the user.

Anyone can create a root system similar to the unique authoritative root. Some of these are purely private (inside a single corporation, for example) and are insulated from having any effect on the Domain Name System. Some, however, overlap the authoritative global Domain Name System root by incorporating the unique, authoritative root information, and then adding new pseudo-Top Level Domains that have not resulted from the consensus-driven process by which official new Top Level Domains are created through ICANN. The alternate root operators persuade some users to have their resolvers “point” to their alternate root instead of the authoritative root. Others also create browser plug-ins and other software workarounds to accomplish similar effects. The one uniform fact about all these efforts is that these pseudo-Top Level Domains are not included in the authoritative root managed by ICANN and, thus, are not resolvable by the vast majority of Internet users.

There are many potential problems caused by these unofficial, alternate root efforts to exploit the stability and reach of the authoritative root. These efforts are often promoted by those unwilling to abide by the consensus policies established by the Internet community, policies designed to ensure the continued stability and utility of the Domain Name System.

Uniform Resource Request

The Uniform Resource Request (URR) consists of both a grammar and a description of basic functionality for Uniform Resource Request. The Uniform Resource Request (URR) provides an extensible framework for satisfying a resource request by extending and ensuring interoperability with the W3C Uniform Resource Identifier specification. A Uniform Resource Identifier (URI) is an object that can act as a reference to a resource, where a resource is anything that has identity. A resource is not necessarily network retrievable, but the resource has identity. A Uniform Resource Identifier can be classified as a locator, a name, or both.

The term “Uniform Resource Locator” (URL) refers to the subset of Uniform Resource Identifiers that identify resources via a representation of their primary access mechanism (e.g., their network “location”), rather than identifying the resource by name or by some other attribute(s) of that resource. The Uniform Resource Locator is a standard for referencing web documents, and the predominant scheme is http. Other URL schemes include file, ftp, gopher, https, Idap, smtp, and telnet. Uniform Resource Locators are transient, and lack metadata to more accurately identify an intended resource (such as author, creation date, etc.). Various Uniform Resource Locator schemes have been proposed over the years describing alternative transport protocols. The Service Location Protocol defines network access information for network services using a formal notation. In the Service Location Protocol, a User Agent can broadcast a request for available services to Service Agents, and can receive advertisements of available services broadcast by Service Agents. The User Agent uses this information to resolve a request for a particular type of service to the network address of the service. The service: Uniform Resource Locator is intended to allow arbitrary client/server and peer-to-peer systems to make use of a standardized dynamic service access point discovery mechanism.

Uniform Resource Request (URR) provides a simple and extensible framework for evaluating a resource request. This specification of Uniform Resource Request syntax and semantics is derived from concepts introduced by the World Wide Web global information initiative. The term Uniform Resource Request identifies a request for a resource via a representation of a namespace listing, rather than identifying the resource by name or by some other attribute(s) of that resource, such as a network location.

A namespace is a representation of a reference to a service directory comprised of zero or more listings satisfying membership criteria at a given moment in time. The namespace has an associated service that administers the namespace. A listing is a representation of a reference to an entity in the namespace where an entity has a name and an optional value, and may include composite members with each composite member being an entity.

A Uniform Resource Request scheme is bound to a namespace. A designated service for the namespace, which may be distinct from the scheme handler, is called to resolve a reference to a listing within the namespace (if provided). When a listing can be bound to a built-in service, then the optional normalized named representation(s) of data describing the request are registered in a request namespace prior to calling the service, and upon completion of the call, the response (if any) is registered in a response namespace. When the listing can be bound to state information, then that information is registered in a response namespace. A response service, which may be distinct from the scheme handler, can provide the content of the response namespace (if any) as the response to the resource request.

General Uniform Resource Request Syntax

In evaluating a resource request, a system may perform a variety of operations to satisfy the request, as might be characterized by such words as: access, call, connect, disconnect, email, evaluate, export, exec, fax, find,- fork, forward, get, import, locate, post, print, put, query, receive, register, remove, rename, replace, search, send, talk, trigger, update, verify, and so forth.

Uniform Resource Request conforms to the generalized syntax of a Uniform Resource Identifier, given as:

<scheme>:<scheme-specific-part>

The Uniform Resource Request scheme is bound to a namespace. Following the namespace is a colon (“:”) delimiter. An optional listing precedes the scheme-specific-part. Thus, the syntax can be read as:

<namespace>:<listing><scheme-specific-part >

The optional listing is a representation of a reference to an entity in the namespace where an entity has a name and an optional value, and may include composite members with each composite member being an entity.

The Uniform Resource Request extends the subset of Uniform Resource Identifiers that share a common syntax for representing hierarchical relationships within a namespace through a “generic URI” syntax, by introducing an optional listing following the <scheme>: portion, given as:

<scheme>:<listing>//< scheme-specific-part >

Uniform Resource Requests consist of a restricted set of characters, primarily chosen to aid transcribability and usability both in computer systems and in non-computer communications and adhere to the Character and Escape Sequences defined in Uniform Resource Identifiers (URI): Generic Syntax.

A namespace is comprised of a restricted set of characters, primarily chosen to aid transcribability and usability both in computer systems and in non-computer communications, and adhere to the Character and Escape Sequences defined in Uniform Resource Identifiers (URI): Generic Syntax.

The optional listing is a reference to an entity in the namespace, and a delimiter can be used to reference a composite of an entity within the namespace. Additional schemes and services can be added. A Uniform Resource Request can be communicated using various Uniform Resource Identifier schemes, such as the http Uniform Resource Locator. The Uniform Resource Locator shown below, for example, is a Uniform Resource Identifier where the scheme-specific portion is a Uniform Resource Request. The named representation of data, given by listing, is a representation of a reference to a second Uniform Resource Request.

### EXAMPLE

http://localhost/pdcx:request
service=”talk” listing=”brenet:staff.member.pete”

Communication Primitive

A communication primitive provides a service for facilitating communications. A communication primitive typically includes connect, send, receive, and disconnect services through one or more system protocols, such as a TCP/IP system protocol. A communication primitive can use other communication primitives to facilitate the communication. Additional primitives can be added through configuration documents. In a general sense, a communication primitive is a protocol, where a hierarchy of protocols can be used. An application level protocol can be added and used by the Namespace Management System through a configuration document without requiring additional binary software to be installed. This simplifies software development and provides service extensibility through text-based configuration documents obtained from the Internet and installed (saved) to the local computing device without the need for additional binary software to be installed. Communication primitives can be registered in a namespace, such as pdcx:socket.receive (a service to receive data on a socket connection). Higher level services can be called, such as pdcx:receive, which determines the type of connection and calls the corresponding primitive service to satisfy the request. A communication primitive can be registered in a namespace where the name of the namespace is representative of the underlying protocol used by the communication primitive, such as socket:, http:, https:, fifo:, stdfile:, or stdio:.

Binding

The binding service binds named representations of data to an entity. A binding service can use one or more binding methods where each method attempts to bind the named representation of data to an entity understood by the binding method. When a named representation of data is provided, the binding service applies the binding methods until a binding method can satisfy the request or all applicable binding methods have been tried. The order of the binding methods can be changed and the same named representation of data may bind to a different entity based on the order of the binding methods.

A binding method is a service. The service can include a name transformation service to transform a named representation of data to a second named representation of data. The service can include a locate service to locate an entity representative of the named representation of data. The service can include a status service to provide information about the entity that the named representation of data represents. The service can include a query service to register information about the entity that the named representation of data represents. A binding service, when called, can bind the data and register the bound representation.

A binding service method can call another service to satisfy the request. A binding method may call a before- and/or an after-discipline service. The “html” binding method, for example, can call the pdcx:html.source service when an entity can be bound to an HTML document, and the document is located such that the pdcx:html.source service will call the pdcx:html.get service to retrieve the content, decompose the html content, and register one or more entities with values representative of the content.

Built-in Service

A “built-in service” has a corresponding namespace listing that, when called, resolves to the starting address of a service that is dynamically loadable. Built-in services can be registered during bootstrap. Additional built-in services can be registered during run-time. Binding of the starting address can be deferred using lazy evaluation, or immediate, as determined by the registration of the built-in service. A built-in service can be registered, removed from registration, or updated by a second version of the built-in service during run-time. A dynamically loaded built-in service can be temporarily replaced by a second version of the built-in service through a context set and context restore operation. A built-in service can have service.before and/or service.after registered discipline services. The service.before service, if registered, is called with a reference to the request: namespace prior to calling the built-in service. The service.after service, if registered, is called after the built-in service returns but before returning control to the service that called the built-in service. As with any registered service, the registration can include the input types understood by the service. In this context, the input type can be described as a named representation of data that can be bound to an entity in a namespace.

Semantic Domain

The semantic domain of the Namespace Management System is defined by the registered built-in services at a given moment in time. The semantic domain can be dynamically configured, extended, reconfigured, or contracted during run-time, assuming appropriate permission (i.e., a registered built-in service marked as non-delete cannot be removed or replaced). In a preferred implementation, logically related built-in services are registered in the pdcx: namespace.

Compoint

A compoint is a point of communication. The compoint has associated connectivity. The connectivity can be specified as a communication primitive and path, or specified as a named representation of data representative of a namespace listing. A binding service can be used to bind the named representation of data to a communication primitive. Namespace listings can have an associated compoint and the Namespace Management System can connect, send, receive, and disconnect from that compoint. Similarly, the Namespace Management System can listen for an inbound connection on a compoint the Namespace Management System is monitoring. A Namespace Management System registers its current point of presence as its namespace compoint. Depending on the subscription, it may also have a registered point of presence for a secure compoint that uses encrypted communications, such as secure socket layer (SSL).

Configuration Document

A configuration document describes a request, where a request is a stream of data representative of one or more statements expressed in a syntactic notation, which is a possibly infinite set of legal elements that can be interpreted by a parsing service, wherein the parsing service evaluates each representative statement within the semantic domain defined by the current state information.

The import service, where applicable, can peek on-the stream to determine the syntactic notation and select an appropriate parser service that can parse the particular syntax. Thus, the content of configuration document can adhere to one of a multiplicity of languages, each with a well-defined syntactic notation that can be parsed by a corresponding parsing service. The import service can call a service to decrypt encrypted stream data to generate a second configuration document that can then be imported. Similarly, binary data can be decoded by an appropriate service to generate a second configuration document that can then be imported. Alternatively, a parser service for parsing binary data can be called, such as the pdcx:parser.wap service. Additional parsing services can be developed and registered with the Namespace Management System for various syntactic notations.

The stream of data can be obtained from an opened file, operating system interface, device driver interface, through intraprocess or interprocess communications, through a representation of a reference to a namespace listing, and/or generated by a Namespace Management System service. The evaluation of a first stream can dynamically generate a second configuration document. The evaluation can further set the context such that the second configuration document is evaluated as if it were part of the first configuration document. A service can use one or more operating system interfaces to ensure the persistence of a configuration document.

For example, the stream of data is in XML format and the Namespace Management System includes an XML parsing service. An element tag contains the name of the desired built-in service, such as <pdcx:call> and the optional attributes specify one or more input types understood by the built-in service, such as <pdcx:call listing=“brenet:staff.member.pete”/>. Certain requests may include composites as would be understood by the built-in service. The <pdcx:entity.setvalue entity=“request:some.data”> specification, for example, may include one or more composite elements specified in XML format to complete the request. Unlike existing XML Scripting Languages, such as XEPR with a limited runtime semantic domain, the Namespace Management System semantic domain is dynamically determined based on the current state information including available services.

A configuration document describes a request, where a request is a stream of data representative of one or more statements expressed in a syntactic notation, which is a possibly infinite set of legal elements interpreted by a parsing service parsing the stream, wherein a parsing service evaluates each representative statement within the semantic domain defined by the current state information administered in one or more service directories.

There are three basic types of configuration documents, given as: pdcx:boot (a request to bootstrap the Namespace Management System), pdcx:request (a request for the Namespace Management System to provide service), and pdcx:config (a request to use one or more registered Namespace Management System services.

The pdcx:boot Configuration Document

The pdcx:boot is provided with the Namespace Management System, typically as the pdcx.xml configuration document as a request to bootstrap the Namespace Management System. The pdcx:boot configuration document is only used during bootstrap. The body of the request includes one or more calls to registered built-in services.

The pdcx:request Configuration Document

In normal processing, a configured Namespace Management System is limited to receiving pdcx:request configuration documents on its communication points (i.e., namespace, local, and admin compoints). This is necessary for security concerns. For example, it would be inappropriate for an anonymous requesting process to be able to reconfigure a Namespace Management System, install new software, or have the ability to remove files on a user's computer without the user's explicit authorization. The pdcx:request provides a well-defined interface, and it is limited to a request for a service. The pdcx:request configuration document is a request to the Namespace Management System, which dynamically selects an appropriate service to satisfy the request.

The pdcx:config Configuration Document

The pdcx:config configuration document is a request to use one or more registered services. For example, a pdcx:config configuration document can be used to describe a service that is to be registered, the content of a service set, a rule, a workflow, a service that is to be called, or other configuration information necessary for use by the Namespace Management System. For security considerations, an implementation of a configured Namespace Management System may not accept a pdcx:config type configuration document from a communication point (i.e., its namespace, local, or admin compoint). Instead, the pdcx:config configuration document is imported using the pdcx:import service.

The pdcx:config can contain one or more composite members representative of one or more statements expressed in a syntactic notation, which is a possibly infinite set of legal elements interpreted by a parsing service parsing the stream, wherein a parsing service evaluates each representative statement within the semantic domain defined by the current state information administered in one or more service directories. The pdcx:config can request any registered service including pdcx:builtin services. Thus, importing a pdcx:config type configuration document is similar, in some respects, to running an executable.

Certifying a pdcx:config Type Configuration Document

A publisher can certify a configuration document relative to the publisher's listing. That is to say, a configured Namespace Management System importing the configuration document can send a pdcx:request to the publisher for service=“config:doc.certify” and provide information representative of the configuration document, such as its listing, key information (described below), and a hash value of the document content.

The response from the publisher will indicate if the pdcx:config document can be certified by the publisher. If the document cannot be certified, it will not be imported. Once certified, the configuration document can be reused without the need to re-certify the content.

Softswitch Service Description Language (SSDL)

SSDL is the Softswitch Service Description Language and is used to express a service offering. It overcomes the limitations of the W3C WSDL (Web Service Description Language) specification to permit the use of URR as a superset of the current URI standard.

A W3C conforming web service can be described by a WSDL document - - adhering to the Web Service Description Language, specification 2.0. The WSDL document is typically viewed by a programmer (or analyst) to understand the interface for the web service. The invention uses SSDL to describe a service offering. The service offering can be a namespace, a registered service such as a listing in a namespace, a workflow, or a resource. In one aspect, SSDL describes the availability and in another aspect it can describe a desired use.

In WSDL, the term “operation” describes a sequence of input and output messages. The term “interface” describes a set of operations. The term “service” describes the endpoints supporting an interface. The term “binding” describes a message format and transmission protocol. The term “endpoint” describes a specific endpoint at which a service is available.

In SSDL, the term “interface” describes a request-response sequence. The term “service” describes a service supporting an interface. The term “binding” describes a message format and transmission protocol. The term “listing” describes an entity in a namespace providing the service.

A local W3C conforming web service can use the Namespace Management System to route a WSDL document to a second W3C conforming web service (or local application) accessible through a second Namespace Management System. In that context, the content of the pdcx:request body is the WSDL document.

A configuration document can contain content representative of a service offering expressed using the Softswitch Service Description Language. The offering describes an accessible type of service such as a namespace, listing, service, workflow, or resource. A namespace is provided by a namespace provider service and is registered with an Active Namespace Root Service. A listing is qualified by the namespace it is registered in. A listing can provide a service in response to receiving a request for the service (the content of the request can be empty for broadcast type services). A workflow is a sequence of rules governing service calls. A resource can be requested and can be identified by its Uniform Resource Request (URR). A W3C conforming web service is described by its Uniform Resource Identifier, which is a subset of the URR.

The SSDL configuration document is bound by its publisher's URR. The publisher URR, when requested, SHOULD return the same configuration document.

A translation service may be applied to convert the publisher's URR relative to the local Namespace Management System's advertisement: namespace. For example, the publisher URR of flightnet:usair//advertisement:flight.ticket.purchase could be translated by the receiving Namespace Management System and registered as advertisement:flightnet.usair.flight.ticket.purchase.

The publisher is not always the provider of the advertised type of service. The SSDL configuration document can, for example, describe a service available from a multiplicity of Namespace Management System listings, such as members of a set of commonly configured Namespace Management Systems. The namespace provider of the common set can publish the SSDL configuration document, and it could describe a service available from members in the set.

In an implementation, the content of the configuration document describing the service is enclosed with the <ssdl> and </ssdl> XML element tags. A description of the SSDL content is shown in FIGS. SSDL-1A and SSDL-1B.

The prerequisite component describes prerequisites for the evaluation of the SSDL content. A prerequisite can be specified for usage and/or for syndication. The usage describes zero or more prerequisites for using the type of service offering. The distribution describes zero or more prerequisites that a configured Namespace Management System should satisfy before syndicating the service offering. A description of the prerequisite component is shown in FIG. SSDL-2.

The usage can include zero or more satisfactionClaims, and zero or more configuration documents required in using the type of service offering. The configuration prerequisite component asserts zero or more configuration documents that must be (or have been) imported by the current Namespace Management System to use the type of service offering. Each member is a reference to a URR. A Namespace Management System that does not satisfy the usage prerequisites MAY be denied the type, or receive an undefined response if an attempt is made to use the type of service offering. A Namespace Management System can optionally distribute the service offering availability to other Namespace Management Systems satisfying the distribute.satisfactionClaims.

Each satisfactionClaims must begin with “is.” or “isnot.” A satisfaction claim cannot be namespace qualified. A satisfaction claim is typically bound, during assertion, to a pdcx:builtin satisfaction service. The claim is not “namespace qualified” to eliminate the dependency on evaluation of inline pdcx:service calls.

Each configuration prerequisite is requested, if not currently configured. A service offering without a distribute prerequisite SHOULD be interpreted as being able to be distributed (syndicated) without restriction. To indicate the service offering should not be distributed, a prerequisite satisfaction claim that cannot be satisfied should be used.

An entity type definition can be expressed in the types component as an entity:typedef or an xs:schema. See FIG. SSDL-3 for examples. The entity:typedef provides a streamlined implementation of schema definitions and may be sufficient for most type definitions. However, for compatibility with existing W3C-conforming web services that are being advertised to the Namespace Management System, the type definition can include xs:schema definitions as well.

The entity:typedef requires a schema attribute whose value is a URR that uniquely identifies the entity type definition. The entity:typedef schema is bound in the entity: namespace of an Active Namespace listing. If there are no child elements of the type definition present, then the identified schema is imported from the corresponding active namespace listing.

An interface is identified by its URR name, which is required. When the interface has an empty body (i.e., no composite members), then the URR is requested to obtain the interface definition. See FIG. SSDL-4 for detailed definition of the interface content.

The composite members of the interface describe a request and/or a response. Although a single request is typically defined, multiple response types are possible. A response can indicate a status of satisfied, unsatisfied, or failed, and this can be used in binding the response:content as well as used in workflow evaluations.

A request has a corresponding schema URR that can be requested to obtain the type definition (the schema ) describing the request. If an interface includes only a request, then the response from the service using the interface, if any, is ignored.

A response has a corresponding schema URR that can be requested to obtain the type definition (the schema ) describing the response. If an interface includes only a response, then the content of the request: namespace is not used in calling the service according to the interface. The schema URR can indicate the response as an entity:pdcx.rawdata type, and the response content will be registered as response:pdcx.rawdata. A discipline service can then be called to further evaluate the response. This enables legacy applications to provide content that can then be evaluated into a usable format.

A binding component identifies zero or more binding methods describing the format and communication protocol used in making a request and receiving a response. See FIGS. SSDL-5A and SSDL-5B for detailed content description, and FIG. SSDL-6 for an example embodiment.

A service component describes a service offered by a namespace listing. A service typically has one interface, although multiple interfaces are supported depending on the criteria in using the service.

A service can have one or more bindings. In WSDL, a binding is a required attribute of the endpoint (hence, only one binding is permitted), and a service is {REQUIRED} to have an endpoint. In the invention, the endpoint address is dynamically determined and hence there is no endpoint member. Thus, a Namespace Management System service cannot be described in a WSDL document.

See FIG. SSDL-7 for detailed content description of the service component of the SSDL configuration document content.

A workflow component describes a workflow offered by a namespace listing. A workflow typically has one starting interface, although multiple interfaces are supported depending on the criteria in using the workfiow. The workflow is identified by its URR qualified in the workflow namespace of an active namespace listing. See FIG. SSDL-8 for workflow component content.

A namespace component describes a namespace offered by a namespace provider listing. See FIG. SSDL-9 for SSDL namespace component content.

A resource component describes a resource offered by a service, which may be provided by a namespace listing. See FIG. SSDL-10 for SSDL resource component content.

A configured Namespace Management System sends a pdcx:request for a service to a second configured Namespace Management System, and in response to receiving a response that the service is not installed, can send a pdcx:request for service=“service:advertise” to the second Namespace Management System with the body of the request including SSDL content representative of a service offering. In response thereto, the second Namespace Management System can use the pdcx:import service to import the configuration document to register the service with the second Namespace Management System. The first Namespace Management System can send a second pdcx:request for the service to a second configured Namespace Management System.

A first configured Namespace Management System can provide a service feed describing accessible services. A second configured Namespace Management System can use this information to provide a syndicated service offering. A third configured Namespace Management System can request a service advertisement from the first configured Namespace Management System and in response thereto the first configured Namespace Management System can provide the third configured Namespace Management System a pdcx:response containing a service offering expressed in the Softswitch Service Description Language. In the preferred embodiment, the response is a pdcx:response with a service attribute value of service:advertisement, with composite members describing the service offering in the SSDL format.

Publisher Authorization

A publisher of a pdcx:config type configuration document is either explicitly authorized, explicitly denied, or unknown. When authorized, the import proceeds normally. When denied, the document is not imported. If a publisher is neither authorized nor denied, then the publisher is unknown, and a service is called to determine the disposition of the import request.

The pdcx:config.publisher service is used to set the authorization level. The configured Namespace Management System uses the config:active.publisher listing to manage the list of publishers. The config:active.publisher.authorized is the list of authorized publishers, config:active.publisher.denied is the list of denied publishers, and config:active.publisher.unknown is the list of unknown publishers. When a pdcx:config type configuration document is being imported, the pdcx:import service uses the config:active.publisher listing information to determine the disposition of the request. If a publisher is not in the authorized or denied list, then it is added to the unknown list and the pdcx:config.publisher.unknown service is called to determine the disposition. If service:active.publisher.unknown is a registered service, then that service is called to determine the disposition. Otherwise, the publisher is retained in the list of unknown publishers and the pdcx:import will return with status unsatisfied.

As an example, syndicated service offerings are provided through one or more service feeds, and in response to evaluating the service feed, the configured Namespace Management System may request a SSDL description of the service offering. In evaluating the SSDL description of the service offering, a pdcx:config type configuration document can be imported using pdcx:import.

Rating Services

A publisher can submit a configuration document to a rating service for consideration, and upon review, the rating service can indicate if the configuration document meets the requirements set forth by the rating service for a rating. A user (or corporation) could subscribe to the rating service and set customized requirements such as the configuration document cannot include pdcx:system calls, or that the configuration document includes calls only to specified namespace listings, or that the configuration document does not include or request binary data, or that the configuration document communicates using a particular security scheme such as an encryption method. One skilled in the art can add requirements based on the content of a configuration document or how the document will be evaluated.

When importing a pdcx:config type configuration document, a rating service can be specified to indicate the rating service that can provide rating information associated with the configuration document. Alternatively, or in conjunction therewith, a configured Namespace Management System can call a separate registered rating service to obtain rating information.

A rating service can provide a configuration document representative of the service offering in SSDL format, which describes the interfaces. A configured Namespace Management System can register its own requirements for rating information and the registered requirements will be used in the response from the rating service to determine if the configuration document satisfies the rating requirements.

A rating service is explicitly authorized, explicitly denied, or unknown. When authorized, the rating service is called to determine a rating for the configuration document. When denied, the document is not imported. If a rating service is neither authorized nor denied, then the rating service is unknown, and a service is called to determine the disposition of the request for rating information. The pdcx:config.ratingService service is used to set the authorization level. The configured Namespace Management System uses the config:active.ratingService listing to manage the list of rating services. The config:active.ratingService.authorized is the list of authorized rating services. The config:active.ratingService.denied is the list of denied rating services. The config:active.ratingService.unknown is the list of unknown rating services.

When a rating service is called by the pdcx:import to determine the rating associated with the pdcx:config type configuration document, the service uses the config:active.ratingService listing information to determine the disposition of the request. If a rating service is not in the authorized or denied list, then it is added to the unknown list and the pdcx:ratingService.unknown is called to determine the disposition. If service:ratingService.unknown is a registered service, then that service is called to determine the disposition. Otherwise, the rating service is retained in the list of unknown rating services and the pdcx:import will return with status unsatisfied.

Connectivity

Connectivity is specified as a named representation of data through name-value pairs, where the value specifies an optional communication primitive (a scheme as one would understand in the context of URls), and a scheme-specific-part (a path) that can be interpreted by the scheme. A binding service is used to bind the value so that when a path is specified without a scheme, then a candidate scheme can be determined through the binding service. For example, connectivity=“/bin/who” includes a path component but not a scheme. The binding service can apply the file binding method and attempt to bind the named representation of data to an accessible file. If the file is found, then connectivity=“stdio:/bin/who” would be the bound value of the named representation of data if the file is executable, or connectivity=“stdfile:/bin/who” (or simply file:/bin/who) if the file is not executable. Similarly, connectivity=“pdcx.com/default.html” could be bound using the http binding method and the bound value would be connectivity=“http://www.pdcx.com/default.html”. The communication primitives are provided through built-in services. Additional schemes (communication primitives) can be deployed, installed, registered, and used in configuration documents imported by the Namespace Management System.

An active namespace listing with registered connectivity to a configured Namespace Management System participating in a Dynamic Network Namespace is resolved to the registered connectivity. Thus, a reference to a resource relative to an active namespace listing, such as brenet:staff.member.john/cf/config.pdcx, is a reference to the resource given as cf/config.pdcx available from the configured Namespace Management System accepting connections at the registered connectivity corresponding to brenet:staff.member.john. This conforms to a URR where the scheme is the namespace, the host is the listing, and the path is the resource.

Edge Device

An edge device is a physical device that can send a communication through a communication connection. A device with an IP address such as a recording device, a camera device, a GPS device, a computer, and a monitoring device are examples of edge devices. An Edge Computing Device is a physical instrument that has a CPU, an operating system, and interfaces for using a communication device accessible to the operating system. An Edge Computing Device can operate as a stand alone and/or as a networked computing device to which it is connected by some means to a data and/or communications network. An edge device can be an Edge Computing Device. An Edge Computing Device executing a configured Namespace Management System can have an associated dynamic network namespace listing. The Namespace Management System is used to enable Mobile Ad-Hoc Network (MANET) devices as DNN listing addressable end points.

Point of Presence

A listing in a DNN can have a point of presence associated with the listing. The point of presence may be static, or dynamically registered. A point of presence can be de-registered (cleared), and subsequently re-registered. When a request is to be delivered to a listing, and the listing does not have a current point of presence, then a store-and-forward service can be called to record the request and subsequently deliver the request when the listing has a current point of presence. Each time the point of presence is registered, the store-and-forward service can be called to send any pending request to the point of presence. A multiplicity of communication points can be registered, such as a namespace compoint, and a secure compoint wherein the secure compoint uses an encrypted communication mechanism such as secure socket layers.

Subscribe

To subscribe to a DNN, the subscription criteria specified by the DNN service provider must be satisfied in response to a subscription request. In a preferred implementation, an end-user uses a web browser to send a request for subscription requirements (the criteria to be satisfied) using the industry standard HyperText Transfer Protocol (HTTP), and receives a response that is rendered by the web browser. After providing the required subscription information, the subscriber submits the subscription information as a subscription request, and this is communicated using the HTTP POST command to a DNN service provider service which validates the request, and upon success registers the user as a subscriber and assigns a DNN listing to the subscriber.

In a second implementation, a DNN service provider registers an entity type definition describing the criteria for subscribing to the DNN, and in response to receiving a subscription requirements request uses the pdcx:entity.typeset.expand service to register the requirements, and communicates the entity type definition to send a response, typically formatted in HTML unless the request species a desired format such as XML or ksh.

A subscriber can provide one or more services and in this context is considered a service provider. Similarly, a subscriber can consume one or more services. A service provider service can be a consumer of another service while providing a service. The Namespace Management System employs a service-oriented architecture with support for peer-to-peer and client-server communications.

Namespace

A namespace is a named service directory. A service directory is comprised of zero or more entities. An entity is a named representation of data, which may have an empty value. Each entity has a name and an optional value, and zero or more composite members which themselves are entities. An entity value may represent a link (a named representation of data) that can be representative of an entity in a namespace. In a preferred implementation, entities in a service directory are arranged hierarchically with a dot separator to delimit names. A reference to an entity in a namespace is referred to as a listing. The listing is qualified if the listing includes the name of the namespace followed by a colon. Unqualified listing references are bound to a namespace by the binding service. An implementation can reference brenet:staff.john, for example, as a qualified listing within staff.john within the brenet: namespace. An implementation may use an alternative directory structure such as the Light Weight Directory Access Protocol with a reference such as uid=john, ou=staff, dc=brenet, and may define the directory structure using ITU-T Object Identifiers.

Each namespace has a set of zero or more discipline services for administering entity information in the namespace. The discipline services are representative of communication services for connecting, sending, receiving, disconnecting, calling, evaluating, requesting, responding and binding, and entity discipline services for get, set, unset, and update.

The pdcx: namespace represents the current state information of the Namespace Management System executing on the local computer. The http: namespace represents URI resources available through the http protocol. The file: namespace represents URI-resources available via the file: scheme. Thus, a getvalue of file:/usr/tmp/local.html is the content of the local.html file from the /usr/tmp directory. The stdio: namespace represents the set of services executable by the operating system. Communication with the services can use standard I/O. The stdfile: namespace represents the set of files accessible through operating system standard I/O interfaces. The dns: namespace represents the set of services that the operating system can communicate with using Internet protocols. The entity: namespace represents the set of registered entity type definitions (also referred to as schemas). A type definition describes an entity in a namespace. The request: namespace represents the entity information available to a service that is being called. The response: namespace represents the entity information provided as the response to a called service. The service: namespace represents a set of registered services. An entity in the service: namespace can include a connectivity member representative of a URR that is to be bound within a namespace. When the service is called, the connectivity is evaluated using the namespace's discipline services. The service can include an action representative of a configuration document that can be evaluated by a parsing service. The service can include a reference to a representation of an entity namespace listing describing the entity information of the request: namespace that can be understood by the service. Each service can include a reference to a representation of an entity namespace listing describing the entity information of the response: namespace.

The local: namespace represents the entity information registered by a called service that persists only through the duration of the call. The workflow: namespace represents registered workflows. A workflow is described by a configuration document that can include one or more rules evaluated within the semantic domain of registered state information in the “pdcx:” namespace. The rule: namespace represents the set of registered rules that may be evaluated within the semantic domain of registered state information in the “pdcx:” namespace. A rule includes zero or more prerequisites that must be satisfied prior to evaluating the action of the rule. The compoint: namespace represents the set of registered communication points. A communication point includes a connectivity member representative of a URR that is to be bound within a namespace. The comprim: namespace represents the set of registered namespace listings that can be evaluated using the pdcx:connect service. The service uses the namespace connect discipline service to establish a connection.

The advertisement: namespace represents the set of registered advertisements. An advertisement describes a service. For example, brenet:staff.member.john//service:im is an advertisement of the service:im listing available through the brenet:staff.member.john listing. The user: namespace contains information representative of the end user subscriber. The config: namespace represents references to configuration information.

Uniform Resource Request (URR)

A URR identifies a request for a resource via a representation of a namespace listing, rather than identifying the resource by name or by some other attribute(s) of that resource, such as a network location. As an example, brenet:staff.member.john//service:im?m=“hi” is a request for the “im” service from namespace listing brenet:staff.member.john. When the request is made, the request:m entity listing will have the value “hi”.

The Protocol and Services Namespace Management System

The Protocol And Services Namespace Management System (Namespace Management System), which in local uses (local meaning resident on one computing device) or in a distributed environment (resident on or available to many computing devices) provides a service-oriented system to discover and communicate with services. The system provides state management and other coordination and control services that support computational and informational exchange activities involving the advertising of, discovery of, exchange of, communication with, and the use of callable services.

A multiplicity of Namespace Management Systems can participate in an ad-hoc network (that can be overlayed on existing networking infrastructure and/or the internet network) wherein:

1. The ad-hoc overlay network is identified by a uniquely named Active Namespace also referred to as a Dynamic Network Namespace (DNN);

2. A DNN configuration document is obtained from a Network Namespace Root Service (NNRS), and the NRRS can provide authentication services to authenticate a credential assigned during the point of presence registration for the DNN;

3. A first Namespace Management System evaluates the DNN configuration document to register the current point of presence to associate with the DNN;

4. The first Namespace Management System can statically provision listings within the DNN;

5. The first Namespace Management System can dynamically provision a listing within the DNN to satisfy a subscription request;

6. The first Namespace Management System can delegate a subscriber as a group listing and that subscriber has authority for DNN listings relative to its DNN listing; and

7. Each Namespace Management System with authority for provisioning relative listings also provides credential authentication for said listings.

A DNN is obtained from a Network Namespace Root Service (NNRS), and the NNRS can provide authentication services to authenticate the DNN. The NNRS may administer a multiplicity of DNNs, with each DNN administering its own listings. A public NNRS administers the public registry. A private NNRS can administer one or more DNNs in a private logical network.

The system includes a Namespace Management System application program and a computing device enabled for communications as provided by operating system communication primitives (system protocol services). Operating system providers, such as Microsoft Corporation, IBM, Sun Microsystems, RedHat, and others may provide the Namespace Management System as an integral component of their operating system distribution, which can be installed on a computing device. The Namespace Management System can be instrumented as a Java application installed in a cell phone with a Java Virtual Machine.

At initialization, the Namespace Management System is configured with a bootstrap service, a parser service, a service registration service, a service to call a registered service, and a default internal namespace. One skilled in the state of the art could add or replace the parser service with a parser for parsing and interpreting a different syntax or semantic language such as natural query language. In the preferred embodiment, the parser service is an XML parser.

The bootstrap service calls the parser service to interpret a bootstrap configuration document. In a preferred implementation, this is the pdcx.xml configuration document. This configuration document contains service registration statements to register built-in services available to the Namespace Management System. The built-in services are provided by dynamically loadable modules (on Unix-based systems, this can be a module within a shared library, and on Windows-based systems this can be a module within a DLL). Each module contains an initialization service that provides information to the Namespace Management System indicating the name (or names) of available service(s) and the input types that the service understands. The Namespace Management System registers this information in an internal namespace. The registration may optionally include output types that the service may respond with. The types are specified by name with an optional data type to indicate the representation of the value, and this information is registered in the internal pdcx: namespace.

The registration of additional built-in services enables the Namespace Management System to provide additional functionality that was not originally compiled into the static representation of the application program corresponding to the Namespace Management System process. As an example, the built-in services are registered into the pdcx: namespace and are callable from the evaluation of a configuration document. One skilled in the art can use the bootstrap service to allocate a namespace and provide that namespace to the initialization service for the registration of available service information.

One skilled in the art can use a Microsoft Windows DLL (or equivalent) where the DLL contains a DIlMain function (or equivalent) that is executed when the DLL is loaded, and when the DLL is detached, to connect to and provide the equivalent functionality as the initialization service without the need for the Namespace Management System to initiate the call to that initialization service. In such an implementation, the DIIMain function could use Microsoft 's COM, DCOM, or other equivalent inter/intra process communication.

Namespace

In the computing disciplines, the term “namespace” conventionally refers to a set of names, i.e., a collection containing no duplicates. The Namespace Management System provides a multiplicity of uniquely named active namespaces, each consisting of zero or more named entries satisfying membership criteria at a given moment in time. A multiplicity of services can cooperate to provide a dynamic network of active namespaces (DNN) where each service administers that portion of the active namespace relative to its own listing in the active namespace. A built-in service can set the context of an active namespace prior to calling a service, and subsequently restore the context after the call completes. Similarly, a built-in service can set the context of an active namespace spanning a multiplicity of service calls, and subsequently restore the context after the calls are complete.

An entity in a namespace can be representative of state information, a constant, an object class, an instance of an object, a method, a service, a workflow, a rule, a communication point, a communication primitive, request information, response information, a device, a user, a subscriber, a service provider, subscription information, a point of presence, an active namespace, an active namespace listing, an entity type definition, or other information registered by a built-in service. The value associated with a given entry in an active namespace can be automatically encrypted when set and decrypted when referenced (assuming appropriate authorization).

An active namespace is distinct from namespaces used in C#. In C#, a default namespace is created, and sometimes called the global namespace. Any identifier in the global namespace is available for use in a C# named namespace. C# namespaces implicitly have public access and this is not modifiable. A C# namespace persists throughout the execution of a C# application program. Each instance of an executing C# application has its own global namespace, and any namespace declared within that execution is limited in scope (i.e., can only be accessed) to that particular application. C# namespaces are not shared between disjoint application programs. The use of a C# namespace is fixed and constrained by the C# application adhering to the C# Language Specification. Other object-oriented languages such as Java employ similar semantics for a namespace.

An active namespace is distinct from an XML namespace. An XML namespace is a collection of names, identified by a URI reference, which are used in XML documents as element types and attribute names. XML namespaces differ from the “namespaces” conventionally used in computing disciplines in that the XML version has internal structure and is not, mathematically speaking, a set. The primary use of a namespace in XML documents is to enable identification of logical structures in documents by software modules such as query processors, stylesheet-driven rendering engines, and schema-driven validators. In XML namespaces, a namespace is identified solely by a URI reference.

The Namespace Management System overcomes these limitations by providing a multiplicity of uniquely addressable named active namespaces for administering entity information wherein entity information can be registered for private or public access. Additionally, a multiplicity of cooperating services can each have authority for administering that portion of a named active namespace relative to their own listing in the active namespace. Throughout this document, an unqualified reference to the term “namespace” can be interpreted as an active namespace.

An entry in the namespace is an entity where the entity has a name and an optional value. An entity may include composite members where each composite member is an entity. The entity year, for example, may include composite members January, February, March, and so on. An entity may include indices such as year.month[January], year.month[February], year.month[March], and so on, where each index is an entity. An entity can represent a namespace listing where a namespace listing is a callable point within the namespace.

A namespace listing is an entity, and an entity can be representative of a DNN listing, state information, data, a reference to a service, or a named representation of data. The value of an entity can be representative of a configuration document. A binding service can be used to bind a named representation of data to an entity known to the namespace service administering the namespace.

Built-in services can reference binary data associated with an entity. The binary data typically is used for retention of common data structure values referenced in the memory address space of the Namespace Management System process.

An entity can have registered discipline services, and the registered discipline service can be updated or removed as appropriate. A discipline service can have one or more before, discipline, and after services. The “get” discipline service is called when retrieving an entity from the namespace. The “get.before” discipline service is called with requested input types, which can include selection criteria for getting one or more entries from the namespace. The “get.disc” discipline service is called to retrieve the entity (such as a database SELECT statement). The “get.after” discipline service is called with the results from the “get.disc” service and the response from the get.after service is then provided as the response to the request to retrieve entity information from the namespace. Other discipline services can be added as appropriate such as a “set” discipline for inserting an entry, an “update” discipline for updating an entry, and an “unset” discipline for deleting an entry. A “commit” discipline service for committing changes can also be used. Discipline services can use the built-in pdcx:odbc service, the pdcx:jdbc service, or communicate with an external application providing data management services, such as ODBC or JDBC.

When registering an entity in the namespace, the set.before discipline service for the entity can be called to apply various constraints, such as converting between formats, changing characters to upper or lower case, condensing extraneous white space, eliminating unprintable or control characters, providing default values for missing composite entities, and the like. For example, an entity type definition describing a book as containing composite members author, title, ISBN, and publisher, can have a set.before discipline service to fill-in the ISBN number using the title and author, if the ISBN number was not present.

The set.disc discipline service can be called to insert a record into a database, or add a new record to a data management system. The set.after discipline service is called after the set.disc, and generally is used for formatting and presentation services.

When retrieving an entity from the namespace, the get.before discipline service can be called to apply various constraints to the criteria, such as converting between formats, changing characters to upper or lower case, condensing extraneous white space, eliminating unprintable or control characters, providing default values for missing information components, and the like. The get.disc discipline service can be called to select a record from a database, or request a record from a data management system. The get.after discipline service is called after the get.disc, and generally is used for formatting and cleansing of the result set. For example, a request to retrieve information about clients may be permissible within the confines of a corporate network, but not permitted when the request originates from outside of the corporate network. In such cases, the get.after service can be used to remove one or more entities within the response namespace.

An entry in a namespace can be functional. A reference to the entry can result in a service being called where the result from the service is provided as the response to the reference. A reference to pdcx:current.time, for example, calls a service to retrieve the current time of day and provides that response as the response to the namespace listing reference. Thus, the following statement will set local:current.time to the value of the current time:

<pdcx:setvalue entity=”local:current.time” value=”{pdcx:current.time}”/>

A discipline, or functional service, can set (insert), get (query), update, or unset (delete) entries within a namespace. Said service can discover a service, connect to a service, communicate with a service, and disconnect from a service. The discipline or functional service can call a service, or evaluate a service registered with the Namespace Management System. Discipline services can be used to administer a viewpath of listings that are logically mounted on top of each other. Lower level entities have copy-on write semantics to the top of the view. Entity information in the lower level is read-only. If a lower level entity is modified, it is copied to the top view before the modification. Viewpaths can be chained. A reference to an entity in the view is resolved to the first entity satisfying the reference.

An entity in a namespace can be public or private. The value of a public entity can be included in the response to a query, whereas a private entity value is not included. An authorized query request can include private entity values in the response. The authorization is determined by the service called to satisfy the request.

An entity in a namespace can have permissions associated with the entry. A permission can include one or more of read, write, and execute. An owner of an entity in the namespace can be recorded and permissions set for the owner. Similarly, a group of listings can be used and permissions for the group access can be set. Similarly, public access can be defined and permissions for everybody can be set. Additional constraints and permission sets can be added by the implementation such as whether or not the request included a credential, a key, its namespace listing, its access method, and other constraints specific to an installation or deployment.

A namespace can be internal (administered by a single Namespace Management System), or a Dynamic Network Namespace administered by a multiplicity of Namespace Management Systems.

A directory service administers the service directory and the directory service can be internal to the Namespace Management System, Similarly, the service directory is a namespace, and the namespace entries may be administered within the memory of the system. Entries within the namespace can persist. Entries may reside in a database. Entries may be managed by a data management service. The data management service may be internal (compiled into the executable code associated with the Namespace Management System) or an external service that is callable.

When calling a listing in a namespace, a registered communication primitive for the namespace can be used. A namespace can have registered discipline services, and the services can be used when querying, registering, deleting, or updating listings within that namespace. A namespace can have registered satisfaction claims that can be called when asserting a satisfaction claim on a listing in that namespace, such as with pdcx:condition, pdcx:is, pdcx:isnot, and other built-in services.

Internal Namespaces

The Namespace Management System includes an internal namespace with the name “.default”. Additional internal namespaces are allocated and registered as namespaces within the default namespace. The registration records the name and provides a link to the allocated namespace. The Namespace Management System can resolve a reference to a namespace by querying the default namespace.

Each internal namespace is identified by a name and represents a hierarchically arranged namespace. The reference pdcx:service.register, for example, is a reference to service.register entry in the namespace named “pdcx:”. The reference is resolved by locating the pdcx entry in the “.default” namespace to determine the location of the “pdcx:” namespace. A set of commonly used namespaces include pdcx:, request:, response:, local:, service:, compoint:, comprim:, workflow:, workarea:, and rules:. Additional internal namespaces can be added through PDCX protocol statements.

In a preferred implementation, the “request:” namespace contains entries representing a request, and the “response:” namespace contains one or more entries representing the response to the request. The “pdcx:” namespace contains entries administered by services of the Namespace Management System. The “service:” namespace contains entries representative of services available to the Namespace Management System. The said services may be called. In another implementation, the service can be evaluated. In another implementation, the service can be connected to, wherein a pdcx:send, a pdcx:receive, and pdcx:disconnect service can be specified for communication connections requiring more than a request-response type of interaction. The “compoint:” namespace contains entries representative of communication points. The “comprim:” namespace contains entries representative of communication primitive services. A listing within the comprim: namespace can be representative of a reference to another namespace with discipline services. The “workflow:” namespace contains entries representative of workflows. The “rule:” namespace contains entries representative of rules used in a workflow. The “workarea:” namespace contains entries representative of one or more name values used by services. The “local:” namespace contains entries representative of one or more named values defined within a context where a new context can be created, and an old context restored. The “local:” nammespace is typically-used when a service is called -to provide a namespace area for that service. When the service completes, the old context of the “local:” namespace is then restored. One skilled in the state of the art can add or delete internal namespaces as appropriate for their use of the Namespace Management System, and can organize entries within the namespace as appropriate for use by a service.

Dynamic Network Namespace (DNN) Names and Listing Names

A multiplicity of Namespace Management Systems in a distributed environment can participate in, and interact with, services listed within a namespace. A first Namespace Management System can provide a Network Namespace Root Service and is responsible for administering one or more leased namespaces. A namespace provider subscribes to the Network Namespace Root Service and leases a namespace from the Network Namespace Root Service. The Network Namespace Root Service creates an internal namespace corresponding to the leased namespace, and registers the leased namespace in the “.default” namespace. The namespace provider uses a Namespace Management System to provide a namespace provider service responsible for administering the leased namespace. The Namespace Management System creates a namespace with the name of the leased namespace, and registers that namespace in its .default namespace.

An end user subscribes to the namespace provider service to obtain a listing within the leased namespace. This namespace listing represents an edge listing in the namespace and does not permit subscriptions relative to its namespace listing. The namespace provider service adds an entity to the namespace representing the listing.

The namespace provider can provision the leased namespace to include one or more groups. A group listing can be administered by the namespace provider service, or as a Namespace Management System that has subscribed to the namespace provider service as a namespace group service. A namespace group service administers that portion of the namespace relative to its group listing. An end user may subscribe to the namespace and obtain a group listing, if permitted by the namespace provider service, or an edge listing. A group listing may include one or more groups. A group listing may include one or more edge listings. A single distribution of a Namespace Management System with its built-in services is used. Configuration documents control the behavior and functionality of the Namespace Management System process executing in the computing device.

In a heterogeneous computing environment, a deployment of a Namespace Management System for each type of computing device (and possibly for each operating system) is used, and the configuration documents control the functionality of each Namespace Management System. In a second implementation, the run-time Namespace Management System can obtain, load, and register built-in services from a designated service using a compoint to facilitate communication. One skilled in the state of the art will understand that, in such an implementation, the built-in services will not need to be distributed with a Namespace Management System and may be obtained though communication with another service.

Local Configuration Documents

The Namespace Management System will evaluate local configuration documents matching the regular expression pdcx/config/rs.d/*.pdcx.

The local configuration documents can register services in the service:, workflow:, and rules: namespaces. Additional PDCX protocol statements can register (set) entries in a namespace. The Namespace Management System can obtain local configuration documents from a compoint through a pdcx:request to that compoint.

After evaluating the configuration documents, the Namespace Management System calls the service:main service, if registered, or the workflow:main service if registered. The Namespace Management System then terminates processing.

Namespace Management System Compoints

The Namespace Management System accepts connections on a compoint. In a preferred implementation, the Namespace Management System uses a “namespace” compoint, a “local” compoint, and an “administrative” compoint. The compoints can be specified in a configuration document. Additional compoints and services to call when a connection is initiated can be specified in the compoint map configuration document that is evaluated by the compoint mapper service.

The standard compoints are registered as compoint:pdcx.connectivity[n_a_m_e] where n_a_m_e is one of namespace, local, or admin. Each registration includes connectivity.

In a preferred implementation, the service:main service accepts a connection on the compoint:pdcx.connectivity and registers the associated compoint as the pdcx:active.compoint.name. In accepting a connection on the namespace compoint, for example, the active.compoint.name will be set to “namespace”. The Namespace Management System will attempt to determine the physical connection of the requesting side, and will register that information as the pdcx:active.consumer.connectivity entity.

The Namespace Management System will evaluate the registered service associated with the active compoint, or a default service if available. If a service cannot be determined, then the service:unknown service is called if available. When complete, the accepted connection is terminated and the Namespace Management System continues with the service:main service.

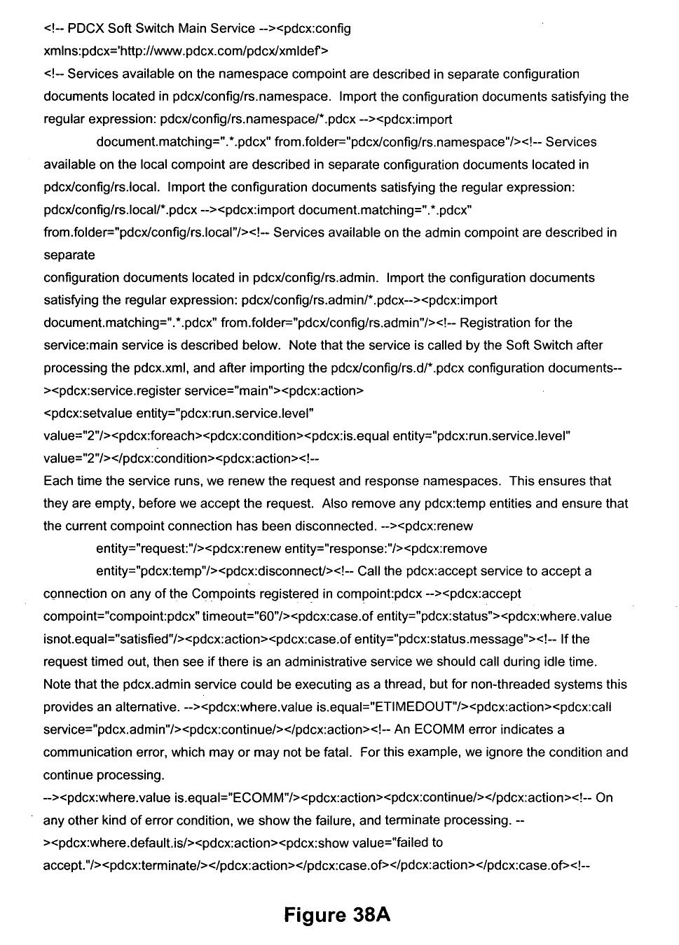

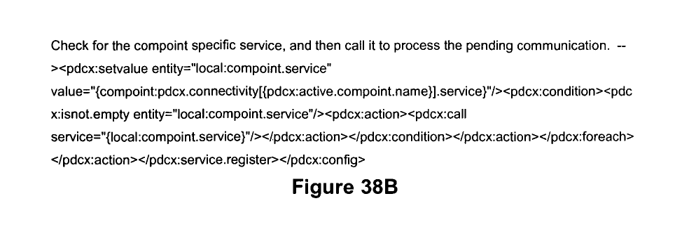

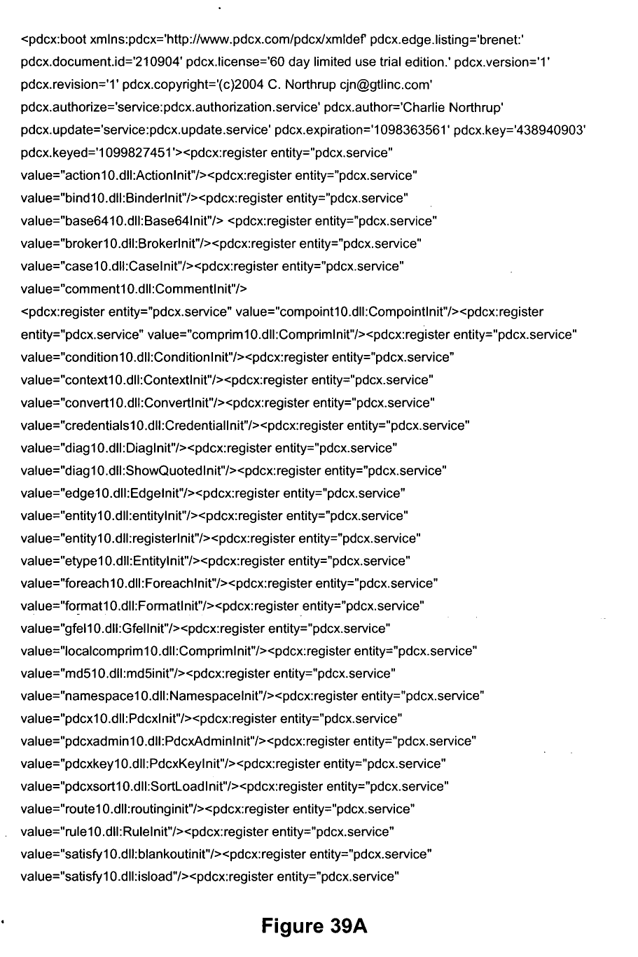

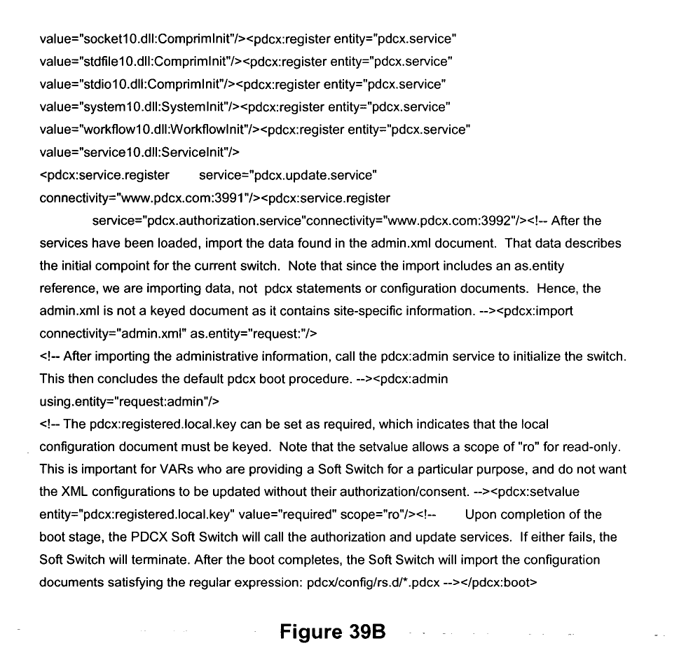

The service:main service is provided by a configuration document with PDCX protocol statements describing the service. An embodiment is shown in FIGS. 38A and 38B. One skilled in the state of the art can create alternative service:main service configuration documents to change the preferred implementation of the Namespace Management System service:main service, without recompiling or redeploying the Namespace Management System.

The pdcx:accept built-in service registers the current time as the connect time once a connection is established on a compoint:pdcx communication point. The pdcx:send and pdcx:receive built-in services register the current time as the modification time each time data is sent or received. When the connection is closed, the pdcx:disconnect service registers the current time as the disconnect time. The pdcx:connect, pdcx:accept, pdcx:send, pdcx:receive, pdcx:disconnect, pdcx:seek, and pdcx:peek services register the current time as the access time each time the services are called.

The registration of connect, disconnect, access, and modification time can be associated with each connection (regardless of incoming or outgoing) by registering the pdcx:compoint.stat as enabled.

Namespace Management System Uses

The Namespace Management System can be deployed and used as a self-standing application on a stand-alone computing device. A multiplicity of edge computing devices with Namespace Management Systems can also be used. Each instance of a Namespace Management System can use the built-in services in different sequences to produce a different desired behavior, and such sequences are determined by one or more configuration documents available to the Namespace Management System.

In one sequence, the main service accepts a request, selects a service to satisfy the request, provides the service, and sends a response representative of the response to the request. One skilled in the art can change the sequence through one or more configuration documents describing the desired implementation.

Namespace Management System as a Network Namespace Root Service

A Namespace Management System can be used as a Network Namespace Root Service. A multiplicity of network namespaces can be administered by a Network Namespace Root Service which itself is a Namespace Management System configured for this purpose. In a second implementation, a multiplicity of Network Namespace Root Services can provide and synchronize updates including insert, delete, and update data management services. In a third implementation, the multiplicity of Network Namespace Root Services will incorporate the use SQL statements for data management synchronization.

The administrator of the Network Namespace Root Service registers criteria for naming and leasing a Dynamic Network Namespace. The criteria are provided as a registration request to a requesting process when a user desires to obtain a namespace. The user provides the request registration information, and upon satisfying the registration request, the Network Namespace Root Service registers the namespace in a service directory as a communication point.

Namespace Management System as a Namespace Provider Service

A namespace provider administers a Namespace Management System configured to provide a named network namespace service by obtaining the configured Namespace Management System and a namespace subscription configuration document from a Network Namespace Root Service. The namespace provider can establish and enforce the criteria for obtaining a namespace listing within the named network namespace. A subscriber that satisfies the criteria can obtain a namespace subscription configuration document for a listing within the namespace.

The Network Namespace Root Service is provided by a configured Namespace Management System with registered criteria for obtaining a named network namespace. A namespace provider uses a web browser to request the criteria for obtaining a named network namespace, and the Network Namespace Root Service provides the registration requirements based on the registered criteria as the response. In response thereto, the namespace provider provides the requested registration information to the Network Namespace Root Service which validates that the registration requirements are satisfied, reserves the namespace, and provides a namespace configuration document and access to the configured Namespace Management System software which is then downloaded and installed on the namespace provider computer.

When the installed Namespace Management System is started, it locates the namespace subscription configuration document which contains a pdcx:epop registration request for registering the point of presence for the named network namespace, causing the Namespace Management System to register the current point of presence for the named network namespace with the Network Namespace Root Service. This is referred to as a Dynamic Network Namespace.

Namespace Management System as a Listing in a Network Namespace

A Namespace Management System can have an associated listing within a named Dynamic Network Namespace. By satisfying the subscription criteria, a listing configuration document with a pdcx:epop registration request to register the current point of presence to associate with the listing can be obtained. In evaluating the listing configuration document, the Namespace Management System registers the point of presence to associate with its listing in that Dynamic Network Namespace. The point of presence includes the connectivity required to reach the Namespace Management System.

A listing can be authorized, configured on initialization and/or in run-time, as a group or an edge listing. An edge listing permits the Namespace Management System to participate as an edge within a Dynamic Network namespace. A group listing permits the Namespace Management System to establish criteria for obtaining a listing relative to the group within the Network Namespace. A Namespace Management System with an edge listing cannot provide or administer listings relative to its edge listing. It is not configured to establish children or sub networks of edges. Note that groups can be established and administered by the administrator of each named Network Namespace without requiring a specific Namespace Management System but through configuration of the switches on the edges. Namespace Management Systems with an edge listing using the same core switch software with additional configuration documents can participate, and have points of presence, in more than one group and in more than one DNN. The number depends only on administrative requirements and the deployment of Dynamic Network Namespace switches. A Namespace Management System with an edge listing can be dynamically re-configured to be able to provide group listings.

Namespace Management System as a Group Listing Within a Network Namespace

A Namespace Management System can be used to administer listings within a group listing of a namespace. This permits the Namespace Management System to establish criteria for joining (participating) in the group. A reference to a listing, such as brenet:staff.member.pete, can traverse the Network Namespace through the brenet: namespace provider Namespace Management System service, to the staff.member group Namespace Management System service, to the staff.member.pete edge Namespace Management System service.

Namespace Management System as an Edge Listing Within a Network Namespace

A Namespace Management System can be used to administer an edge within a namespace. The edge is addressable by its listing, and a reference to the listing, such as brenet:staff.member.pete, can traverse the Network Namespace through the brenet: namespace provider Namespace Management System service, to the staff.member group Namespace Management System service, to the staff.member.pete edge Namespace Management System service. End users, such as desktop users in the corporate environment, and home-based users typically use edge listings within a namespace.

Common services typically used by an end user are described in configuration documents. The installation may include one or more HTML documents, and the HTML documents may include one or more embedded configuration documents.

Electronic Mail

A service:email.smtp service is provided, and the user can configure an email program such as Microsoft Outlook to send email through the Namespace Management System using the Simple Mail Transfer Protocol. The email TO field is bound to a namespace listing. A service:email.pop3 service is provided, and the user can configure an email program such as Microsoft Outlook to receive email from a Namespace Management System using the Post Office Protocol Version 3 protocol.

When creating a new email message, the user enters a namespace listing in the To: field, and enters the message content. Outlook connects to the Namespace Management System, and using SMTP protocol, Outlook communicates the email information to the Namespace Management System. The Namespace Management System, using the service:email.smtp service, receives the email message from Outlook. The Namespace Management System creates a configuration document containing a pdcx:request with the to.listing having the value of the namespace listing entered by the user and a service request of certified.email.

The configuration document is then imported and evaluated by the Namespace Management System, and the Namespace Management System sends the request to the specified listing. When a Namespace Management System receives a pdcx:request for the certified.email service, it will first validate the credential provided with the pdcx:request to authenticate the request. Upon authentication, an inbound email message is constructed using information from the pdcx:request. Microsoft Outlook can then connect to the Namespace Management System and by using the POP3 protocol, it can retrieve the inbound email message.

In a preferred implementation, the service:email.smtp service is registered in a local service set and is available only to local application programs. This ensures that all email requests can be properly verified and authenticated. The service:email.smtp service could be registered in the namespace service set and configured to bypass credentialization (authentication of a request), thus enabling SMTP servers without a namespace listing to participate.

The implementation provides for a credentialized email service in that each email is sent as a pdcx:request to a namespace listing, and credentials can be used to authenticate the request. The implementation affords existing email applications, such as Microsoft Outlook, to be used for both unauthenticated email using existing SMTP/IMAP/POP3 protocols and authenticated email through the Namespace Management System. Another advantage is that the use of authenticated email can eliminate phishing, an Internet scam in which unsuspecting users receive official-looking e-mails that attempt to fool them into disclosing online passwords, user names, and other personal information. Victims are usually persuaded to click on a link that directs them to a doctored version of an organization's website.

Document Transfer Services

As an example, a folder (file system directory) is created and the path name to the folder is registered as pdcx:registered.public.folder. The user uses a mouse device to drag and drop, or copy, documents to the registered public folder. Their Namespace Management System receives a pdcx:request for the public.document.list service and calls the service. The service uses the pdcx:system.dirlist built-in service to register the filenames found in the public folder as entities of workarea:documents. The service calls the built-in pdcx:format.html.input service to format the entity information of workarea:documents with a service request of document.get and outputs the HTML content. When the user (using their browser or equivalent HTML rendering service) selects a named document, their service sends a pdcx:request for the document.get service for the selected document. The Namespace Management System, upon receiving the request, calls the service:document.get service. The service:document.get service sends an HTML response with the Content-Type set to the corresponding document type and sends the document.

Communication Services

The user Namespace Management System includes configuration documents describing common communication services such as email, chat, instant messaging, document transfer, fax, printing, voip service, and standard Hyper Text Transfer Protocol services including http.get, and http.post. An address book service is provided to administer an addressbook: namespace and provides services to register, query, update, and delete information registered in the address book.

Each entry in the address book represents a namespace listing. Short names, such as Brooke, can be used as keywords for locating an entry in the address book. The pdcx:format.html.sellist service can be called to create a drop down select list for selecting an entry in the address book as part of an HTML rendered page. The pdcx:format.html.sellist call shown below, for example, will list each listing in the address book as an HTML select option.

<pdcx:format.html.sellist entity=”addressbook:listing”/>

Communication services can be registered as pdcx:registered.communication.services and the pdcx:format.html.sellist can be used to create a selection list.

The user can therefore maintain a single address book, and through a selection service select a current listing, and using a second selection list, select a communication service. As an example, this is facilitated through an HTML page with a form, providing a single user interface for selecting a namespace listing and a communication service.

An application program can call the Namespace Management System with one or more pdcx:requests to format the requested entity information in a format suitable for the application program. For example, the pdcx:request can include response.format=“ksh”, and the response is formatted as a ksh command and scripting language compound variable. The response can be formatted in XML by specifying response.format=“xml” or as new-line terminated records by specifying response.format=“nl”. Using response.format=“nl” with delimiter=“|” will format the values as new-line terminated records where each field in the record is separated by a vertical bar delimiter.

Additional formatting services can be added through built-in services registered with the Namespace Management System. Note that if the value of the response.format can be bound to a service, then that service is called to format the response.

Routing Service

A Namespace Management System service executing on a computing device with a private network address behind a firewall is not directly addressable by a Namespace Management System service executing on a computing device with an Internet address outside of the firewall. The network namespace provider service can use a Namespace Management System configured to provide routing services to facilitate the connection.

When the first Namespace Management System service is started, it registers its current point of presence (the connectivity) to reach the first Namespace Management System with the network namespace provider service. If the network namespace provider service cannot determine an appropriate connection that can be used to call the first Namespace Management System service, then the network namespace provider service can suggest a routing service that the first Namespace Management System service can use to receive inbound requests.

The network namespace provider service can send a request to a routing service to reserve a route for the first Namespace Management System, and the routing service responds with a route reservation, which is then added to the response to the first Namespace Management System.

The first Namespace Management System can determine if it desires to use the routing service, and if so, it can then call that routing service and provide the route reservation information. The routing service validates the reservation and calls the network namespace provider service to register the current point of presence (the connectivity) to the first Namespace Management System as being provided by the routing service. The connection from the first Namespace Management System to the routing service remains open. Upon success, the routing service sends a response indicating that the route is now available.

The first Namespace Management System registers compoint:pdcx.connectivity[route] as the open connection to the routing service, and continues processing the service:main service.

When a second Namespace Management System desires to send a request to the first Namespace Management System, the second Namespace Management System contacts the network namespace provider service to query for the current connectivity associated with the first Namespace Management System's listing. The response indicates a connection to the routing service. The second Namespace Management System connects to the specified connectivity and sends the request.

The routing service receives the request from the second Namespace Management System and uses a credential service to verify the request if a credential is supplied. The routing service registers the connection and the request and assigns a unique id to the entry. The routing service dynamically creates a callback compoint and sends the unique id and compoint information on the open connection to the Namespace Management System.

Upon receiving the unique id and the compoint information, the first Namespace Management System connects to the specified connectivity and provides the unique id. The routing service sends the request (that it received from the second compoint) on the callback compoint. Upon receiving a response (or a disconnect), the routing service forwards the response (if any) to the second Namespace Management System and terminates the callback connection. The first Namespace Management System terminates the callback connection.

Namespace Management System Switching Service

A Namespace Management System can provide a switching service as a special instance of a communication point to accept a communication from one communication point and redirect the communication to the appropriate destination. A group of Namespace Management Systems behind a common firewall can use a common Namespace Management System Switching Service to send and receive requests for services from exterior services.

The Bootstrap Service

The bootstrap service uses the parser service to evaluate a first configuration document that typically contains built-in service registration requests. As an example, the bootstrap service allocates and initializes the memory for the internal namespaces and registers a pdcx:register service with a start service address and an end service address, corresponding to the executable code in memory for these services. The bootstrap service calls the parser service to evaluate the configuration document.

The configuration document may include a reference to an authorization service, and the Namespace Management System calls the authorization service to determine if the Namespace Management System is authorized to continue processing. If not authorized, the Namespace Management System will not continue evaluating the configuration document. The configuration document may include a reference to an update service. The Namespace Management System calls the update service and receives a configuration document containing PDCX protocol statements to be evaluated by the Namespace Management System.

The bootstrap service looks for a subscription.xml configuration document (subscription document) indicating the type of functionality that the Namespace Management System is to provide. This can include a namespace provider service, a group service, a routing service, or an edge service. The subscription document includes a registration request, and the request is sent to a specified service to validate the request and register a point of presence (connectivity) to associate with the listing corresponding to the subscription. Depending on the subscription level, a secure communication point connectivity can be registered in addition to the namespace communication point connectivity (with the former using a secure socket layer communications.

The bootstrap service receives a response configuration document and evaluates that configuration document using a parser service. If the registration has failed, then the Namespace Management System terminates processing. If the response document includes a reference to a routing service, then the Namespace Management System may subscribe to the routing service. The response document may include a dynamic credential, and the Namespace Management System will register that credential in its “pdcx:” namespace. The bootstrap service registers additional information into the internal “pdcx:” namespace including the registered.edge.listing and the registered.edge.credential if available. The bootstrap service will import local configuration documents satisfying the regular expression pdcx/config/rs.d/*.pdcx. A local configuration document can describe an available service that the Namespace Management System can communicate with to obtain additional configuration documents.

After the local configuration documents have been imported, the Namespace Management System calls the service:main service (if registered) or the workflow:main workflow (if registered). The Namespace Management System then terminates processing. A configuration document can describe one or more services to call just before the Namespace Management System terminates its processing.

A configuration document can describe one or more services to call in response to receiving a signal. A configuration document can describe one or more services to call in response to receiving a notification that an event has occurred. A service can communicate the notifications to the Namespace Management System as a pdcx:request for an event.notification service and indicating the event that has occurred. The configuration document can describe an interest in a notification of an event wherein the Namespace Management System will send a request to a service that it is to be notified when the event has occurred. Similarly, a Namespace Management System can send a request to a service that, when notified of an event or particular event, the service should provide a requested service.

The pdcx.xml configuration document includes a multiplicity of pdcx:register calls indicating an entity and a value. A call such as <pdcx:register entity=“pdcx.service” value=“action10.dll:ActionInit”/> indicates that the Namespace Management System parser service is to call the pdcx:register service with entity=“pdcx.service” and value=“action10.dll:ActionInit”. The pdcx:register service interprets the request as a built-in service registration request and calls the Actioninit service (initialization service) within the action10.dll. Each pdcx:register call optionally includes one or more service detail specifications where a specification includes a service name, synopsis, description, example, and/or related topic. An implementation is shown in FIGS. 38A and 38B.

The pdcx:register call can include an md5sum name-value attribute. If present, the bootstrap service will use an internal service to generate an MD5 value for the library to verify the authenticity of the library. One skilled in the art can use other authenticity verification services.

In a second implementation, the pdcx.xml configuration document includes a multiplicity of pdcx:register calls indicating the entity type and a value. A call such as <pdcx:register type=“built-in” library=“action10.dll” initialization.service=“ActionInit”/> indicates to call the pdcx:register service with type=“built-in” library=“action10.dll” initialization.service=“ActionInit”. The pdcx:register service interprets the request as a built-in service registration request and calls the ActionInit service (initialization service) within the action10.dll. One skilled in the state of the art could standardize on the name for the initialization service, such as the DLL name followed by “Init” (as in ActionInit) to avoid requiring the initialization.service to be part of the pdcx:register statement. The DIlMain function can also be used to initialize data, such as data structures, check for prerequisites such as license information, or perform other administrative tasks associated with startup or shutdown, depending on the DLL being attached or detached. For systems not supporting Windows DIlMain functionality, a standardized name such as _nit could be encoded into each dynamic library and called by the implementation when the library is attached and subsequently detached.

When the library cannot be located, the pdcx:register service will call the pdcx:binding service (if available) to resolve the reference to the library. The binding service can send a request to another service to obtain the library for the edge device, install the library locally, and subsequently use that library.

The ActionInit service allocates an internal service directory and registers the name of a callable service as an entity in the allocated service directory where the corresponding entry includes the names of the input types understood by the service, a start service address, and an optional end service address. It returns the address of the allocated internal service directory to the pdcx:register service. The pdcx:register service queries the service directory for entity information and registers each entity in the pdcx: internal service directory along with the names of the parameters (input types) understood by the service. The pdcx:register service then releases the memory of the allocated internal service directory.

Additional functionality can be embedded into the library such as a standardized service that, when called, provides a configuration document on standard output, which can subsequently be imported into the Namespace Management System. The advantage is that a separate configuration document would not need to be distributed with the library. Instead, the library could be distributed and a Namespace Management System service provided to call the standard service to generate a configuration document that can then be saved to disk and subsequently imported, or imported each time the library is first referenced.

In another implementation, the Namespace Management System calls the ActionInit service with a reference to an internal namespace, and the ActionInit service registers the name of a callable service as an entity in the allocated service directory including the names of the input types understood by the service, a start service address, and an optional end service address. A multiplicity of entities can be registered representing built-in services.

The parser service parses a configuration document, and when an opening XML element with a name corresponding to a built-in service is located, the parser service will call the start service registered for that named built-in service. When the closing XML element corresponding to the opening XML element is found, the parser service will call the end service registered for the named built-in service. XML attributes appearing in the element specification are provided as parameters to the built-in service. The parser service allocates an internal namespace, registers the attribute name-value pairs into that internal namespace, and calls the start service at the registered address in memory with a reference to the allocated internal namespace containing the parameters. When a start service has a corresponding end service, then the start service may register additional entity information into the namespace specific to the functionality of the service. The parser service registers composites of the opening XML element into the allocated namespace. The end service is also called with a reference to the allocated namespace and uses the entity information in the allocated namespace to ensure all data required for the service is present, provide the service, and then return to the calling service (the parser service), which then de-allocates the allocated internal namespace.

When parsing the initial pdcx.xml configuration document, the parser service can initially call the only registered service, which is the pdcx:register service. As additional services are registered, the parser service can call those additional services in response to locating an opening XML element with a name corresponding to a registered built-in service. Similarly, a registered end service will also be called.

Various built-in services can evaluate entity information stored in the various internal namespaces. When a registered service is called (or evaluated), and the entity reference for the service contains a pdcx:action composite member, then the Namespace Management System will call the built-in pdcx:action service with a reference to its entity information (as a namespace reference). For each composite member found in the referenced entity information that represents a built-in service, the pdcx:action service will call an internal Namespace Management System service to evaluate the composite reference. The internal Namespace Management System service allocates an internal namespace, registers the parameter name-value pairs, and calls the registered start service corresponding to the built-service with a reference to the allocated namespace. The end service corresponding to the built-service, if registered, is also called with a reference to the allocated namespace. The internal Namespace Management System service then de-allocates the allocated namespace.

In this manner, a service can be registered with a composite member named “pdcx:action”, and the pdcx:action member can have one or more composites that are PDCX Protocol statements to be evaluated. Thus, a configuration document can be written, updated, or replaced to register, remove, or replace registered services available through the Namespace Management System.

Services

A service is provided by the evaluation (execution of computer instructions) of a component of software. A service can be a consumer of another service. A service can be a consumer of one or more services while providing a service. A service can execute as a daemon process accepting communication connections on a compoint from a requesting process. A service can be loaded and executed on demand. A service may execute as a separate thread of control. A service can be provided by a dynamically loadable module such as a module with a shared library or a module within a Microsoft Windows DLL, or a Mac OS X dylib, or any other dynamic library method supported by the underlying operating system. A service can be provided by a script that is interpreted by an interpreter, such as a shell, perl, or javascript script interpreter (which may be a service provided by a browser). A service can be provided by the evaluation (or interpretation) of a document, such as a WSDL document or SOAP document. A java program can provide a service. A service may be compiled using a just in time compiler or assembled from component parts.

A service can communicate with another service. The communication may be required to satisfy a request. A service can perform housekeeping type services, debugging service, billing service, administrative service, integrity service, quality of service services, and the like. A service can call a service which may be a service corresponding to a listing within a namespace. By way of example, brenet:staff.member.pete can call brenet:staff.member.frank. When calling a service, the interaction is facilitated through a protocol, which may include a hierarchy of protocol services. The hierarchy of protocol services can include one or more application level protocols and one or more system protocols. By way of example, the Hyper Text Transfer Protocol is an application level protocol which may use system level services providing Internet Protocol services. In a second implementation, a first service communicates a request using HTTP, and the second service interprets the request as a PDCX protocol request, provides the service to satisfy the request, and provides a PDCX protocol response using HTTP. The request may be a Uniform Resource Request.

Application level services are provided by an application process. The application process executes in user space and at times use system level services.

The service may have an associated action block consisting of one or more statements. When the service is called (evaluated), the action block is evaluated by the Namespace Management System. The evaluation can result in one or more services being called to satisfy the request. The content of the action block can be representative of a configuration document and a parser service selected to parse the stream.

A local application service can be registered as a service. When called, the Namespace Management System will connect to the local application service using the default stdio communication primitive. In this implementation, the registered service has a specified connectivity, and if the connectivity does not include a communication primitive, then the stdio primitive is used. A local application service can call the Namespace Management System and request to be registered as a service. This enables a user of the system to select an application and, when executed, the application can register as an available service to the Namespace Management System. In an implementation, an application service that is interactive, such as an application with a graphical user interface, can connect to the Namespace Management System and register as a service. When a request is received by the Namespace Management System, and the request is intended for the said application, the Namespace Management System will forward the request to the application.

In another implementation, the said application can send a request to the Namespace Management System. The request can be intended to be evaluated by the Namespace Management System. The request can be intended to be sent to a service such as a listing or a service registered with the intended listing, and the Namespace Management System will send the request to the compoint with which it can associate the listing.

In another implementation, a Namespace Management System can call a local application service in response to receiving a first request for a service. The call will send a second request to the local application service and will send the response from the local application service (if any) as the response to the first request.

In another implementation, a multiplicity of services is used by the Namespace Management System to broker communication content between a first type and a second type. A broker service may use a protocol to send a request that is different from the protocol used to receive the request. A broker service may select one or more named representations of data to be included in a request. A broker service may rename one or more of the named representations of data.

An application program that can be started by the edge device operating system can be registered as a callable service. The service registration includes the connectivity required to start the execution of the application. When the service is called, the connectivity information is used to register a compoint for the service, and this compoint can persist through the duration of the service. Alternatively, the application connectivity can be referenced in a call to the pdcx:call (or pdcx:connect) service without the application having an entity pre-registered with this information.

In one implementation, the application will be called on a per-request basis. That is to say, the Namespace Management System will start an instance of the application, send a request, receive a response, disconnect, and ensure the proper termination of the application process.

In another implementation, the application can be started through user interaction with the edge device, such as using a mouse device to click on an icon wherein the operating system starts the application (such as with a Microsoft Windows operating system). This application process can send a request to the Namespace Management System to be registered as a callable service (connectivity information can be a default connection such as http://localhost:80 or discovered through initialization files, system registry entries, command line parameters, or through environment variables). Once registered, the Namespace Management System can direct a request intended for the service provided by the application to the appropriate compoint on which the application process can receive such a request. In one implementation, the application process includes connectivity in its registration request, while a second implementation receives connectivity information from the Namespace Management System as part of the registration request response.

In another implementation, the application can be started by the Namespace Management System through a coshell. A coshell service executes concurrently with the Namespace Management System, and the connection to the coshell can include communication using a protocol. A multiplicity of coshells can be used by the implementation, and a round-robin or other dispatcher (scheduler) can select the coshell to which a request should be forwarded. In a preferred implementation, the coshell is a shell process (such as a KornShell, bash, csh, or Windows Shell).

A built-in service can connect to a communication point using an operating system service or through the use of built-in PDCX Protocol services. A configuration document can describe how to connect to a communication point. A configuration document can request the Namespace Management System to send a communication according to an application level protocol. For example, <pdcx:http.posturl=“http://hegel.research.att.com/tts/cgi-bin/nph-talk” txt=“Convert to audio” pdcx.response.method=“pdcx:mime”/> instructs the Namespace Management System to use the http.post built-in service to send an HTTP POST request for the http://hegel.research.att.com/tts/cgi-bin/nph-talk URL and to evaluate the pdcx:response using the pdcx:mime service. The service, available from AT&T Research as of the date of this patent filing, converts the text message “Convert to audio” to audio and responds with a WAV file containing the results.

The content of the WAV file can be saved for subsequent playback. The location of the saved WAV file can be registered as the value of a namespace entity.

The pdcx:mime service, which provides MIME services, can be used to playback the WAV file and will invoke the MIME handler service corresponding to the .wav file suffix to playback the audio. Note that the pdcx:base64 service provides base64.encode and base64.decode services that can be called by the pdcx:mime service when necessary.

A service can be registered with one or more prerequisites that must be satisfied in order to use the service. In a preferred implementation, the registration includes a pdcx:condition statement describing the condition or conditions that must be satisfied prior to using the service.

A service can be registered with a request entity type that defines the input types understood by the service. The entity type is defined using the pdcx:entity.typedef service, and the corresponding type can be registered as the request.type for the service. When the service is called, only those name-value pairs satisfying the request.type will be provided to the service. A service registered in the service: namespace can have a registered before discipline service, and this service will be called before calling the service itself. The .before discipline is called in the current context of the namespaces. A new local namespace is allocated, registered as “local:”, and the service is called. Upon return from the service, the prior “local:” namespace is restored and the .after discipline service (if registered) is then called.

A service registered in the service: namespace can have a registered on.error discipline service, and this service will be called when an error condition is returned during the evaluation of the service call. A service registered in the service: namespace can have a registered on.unsatisfied discipline service, and this service will be called when an unsatisfied condition is returned during the evaluation of the service call. A service registered in the service: namespace can have a registered on.satisfied discipline service, and this service will be called when a satisfied condition is returned during the evaluation of the service call. A service registered in the service: namespace can have a registered on.timeout discipline service, and this service will be called when a timeout condition is returned during the evaluation of a service call. A service registered in the service: namespace can have a registered on.unauthorized discipline service, and this service will be called when an unauthorized condition is returned during the evaluation of the service call. A service registered in the service: namespace can have a registered on.unknown discipline service, and this service will be called when an unknown service is requested.

A service registered in the service: namespace can have a registered request-response type to define the context in which to call the service. If the type is set to “rr”, then a new context is created for the request and response namespaces, and entity information that is to be provided to the service is registered in the new request: namespace. When the service completes, the content of the response: namespace becomes the result from the service, and the request and response namespace context is then restored.

Built-In Service

A built-in service is a service that is dynamically loaded into the Namespace Management System on demand through a PDCX service registration request. The service is provided by a module within a shared library (on Unix-based systems, this would be a shared library, and on Microsoft Windows-based operating systems, this would be a DLL). Another implementation may use components of software with a just in time compiler to assemble the service as required for use by the Namespace Management System. Built-in services are deployed as stand alone units of software and are not precompiled into the Namespace Management System application program. Instead, they are dynamically loaded into the address space of the Namespace Management System on demand. An implementation can create an execution thread when calling the built-in service, or the built-in service can create an execution thread if needed. Various synchronization services can be applied to determine when the thread has completed.

The library includes a callable initialization service. The pdcx.xml configuration document contains a multiplicity of pdcx:register service calls where each call includes an entity of pdcx.service and a value identifying the DLL and initialization service given as:

<pdcx:register entity=“pdcx.service” value=“action10.dll:ActionInit”/>

The parser service evaluates the configuration document and calls the pdcx:register service with the name-value pairs for the entity and the value. The pdcx:register service uses the value statement to identify the DLL and the initialization service. The pdcx:register service uses a first operating system interface to dynamically load the DLL, a second operating system interface to determine the address of the initialization service, and then calls that initialization service.

The initialization service allocates a memory region and registers into the memory region the name of the built-in service and the names of the input types that the built-in service understands. The initialization service responds by providing the address of the allocated memory region to the pdcx:register built-in service, which then registers that information into the pdcx: internal namespace. The initialization service may identify one or more such callable services and the input types understood by each service.

Typically, the services (or service) provided by a module are logically grouped. The initialization service in the entity.dll, for example, identifies the available services as pdcx:entity.typeset, pdcx:entity.typedef, pdcx:entity.getvalue and pdcx:entity.setvalue.

In a second implementation, a single shared library can contain one or more callable initialization services used by the Namespace Management System to identify and register the multiplicity of services.

When a service is called or evaluated, the Namespace Management System's parser examines the request to map optional name-value pairs supplied with the request to the name-value pairs registered for a built-in service. Only registered name-value pairs will be provided to the built-in service. A built-in service can convert the value from a first data type to a second data type as required by the implementation of the built-in service.

The Namespace Management System provides for namespace reference indirection by specifying a value within curly braces. For example, the reference name=“{request:user}” will include the value of request:user as the value for name when calling a service. The reference name=“{request:user[{request:counter}]}” will include the value of the index of request:user where the index is the value of request:counter.

In a preferred implementation, built-in services are registered in the pdcx: namespace. Throughout this specification various references are made to the pdcx: namespace, such as pdcx:service.register and pdcx:private. One skilled in the art can use a different namespace and/or different service names relative to the namespace reference as appropriate in the implementation.

Interactive Service

The Namespace Management System can start a service that is interactive (user interactive) such as a web browser. Alternatively, an interactive service can register with a Namespace Management System as a callable service. The Namespace Management System can redirect received communications intended for the interactive service, as well as receive a request communication from the interactive service intended for either the Namespace Management System or another service. A URR can be used to represent the request.

In one implementation, the Namespace Management System receives a request and selects an Instant Messenger service to satisfy the request. If the Instant Messenger is not currently a registered compoint, then the Namespace Management System starts the Instant Messenger service and directs the request to the service. In one implementation, the Instant Messenger service is registered as a callable service with a standard I/O communication primitive. In a second implementation, the Instant Messenger is registered as a callable service with command line parameters for specifying a compoint that the Instant Messenger service can use to communicate with the Namespace Management System. In a third implementation, Instant Messenger service will determine the Namespace Management System compoint through an operating system registry. In a fourth implementation, the Instant Messenger will determine the Namespace Management System compoint through an initialization file, such as im.ini on a Windows operating system. In a fifth implementation, a generic front-end loader service can be used to establish a first compoint to send a communication to the Namespace Management System and a second compoint to receive a communication from the Namespace Management System. One skilled in the state of the art may employ a multiplicity of the implementations for initializing the one or more communication points for communication from the Namespace Management System to a service and from the service to the Namespace Management System.

In another implementation, the registered compoint for an interactive service will be used for communications, while in another implementation each request intended for the interactive service will start a new instance of the interactive service with its own compoint or compoints. One skilled in the state of the art can create a configuration document with a service to apply one or more constraints in determining when to start a new instance of an interactive service and when a service with a current compoint can process the request.

Non-Interactive Service

A non-interactive service can be called in response to a request. Similarly, a non-interactive service that is started by other means, such as a scheduler or system startup service, can connect to the Namespace Management System and register as an available service.

When a request is received and a registered service selected, the Namespace Management System will evaluate the service registration to call the service. In one implementation, the service can be provided by the PDCX protocol statements registered for the service. In another implementation, the service is loaded and executed. In another implementation, the service is called. As an example, the Namespace Management System pdcx:call built-in service will determine the appropriate action for using the registered service to satisfy the request.

A configuration document can call a non-interactive service. For example:

<pdcx:call connectivity=“mplayer http://micorsops.com:80/stream.asf”/>

Command line parameters may be provided as references to an entity in the namespace and the value expanded prior to calling the service. For example:

<pdcx:setvalue entity=”local:mplayer.url”
value=”http://micorsops.com:80/stream.asf”/>
<pdcx:call connectivity=”mplayer {local:mplayer.url}”/>

The pdcx:call service binds mplayer to determine the path and will use stdio connectivity as the default comprim. The Namespace Management System will fork a new process and execute the mplayer program in that address space with the command line parameter http://micorsops.com:80/stream.asf.

Coshell Service

A coshell service executes in conjunction with a Namespace Management System, and the Namespace Management System communicates a request to the coshell. The coshell processes the request and provides a response, which is then considered the response to the request. In one implementation, the coshell is a KornShell shell service, and requests are command strings that are evaluated by the coshell. Background commands can be sent, as well as foreground commands. The Namespace Management System. may use a multiplicity of coshell services and select from the set of coshell services currently available. The Namespace Management System may manage the pool of services allowing for a minimum and maximum number of concurrent service executions. A coshell service may be executing on the Namespace Management System computing device or started as a remote shell wherein the Namespace Management System service can communicate with the remote shell.

System Service

An operating system typically includes a binary application-programming interface (binary API) that is callable by a compiled application program when running as a process. The Namespace Management System built-in services, as compiled code, can call one or more binary APIs. The built-in services registered in the pdcx:system group provide PDCX Protocol Services for common operating system services. These include file services (such as create, open, read, write, close, seek, copy, move, link, and unlink), time services (such as (date, time, cpu time), file system reference services (such as path services, file system directory services), process management services (such as create (or fork) a process, wait for a process, execute a program, process termination services, signal services), and user management services, among others.

Application Service

The Namespace Management System can use a built-in service to start a service installed on the computing device. In one implementation, the standard I/O communication primitive is used to communicate with the service. For example, the /bin/who_command (service) can be registered as a callable service. Other services, such as interactive services including Microsoft Word, can be started by the Namespace Management System but may not be able to register a compoint without the use of a plug-in specific to that application.

When the service is configured with system level communication primitives, then the Namespace Management System can use corresponding primitives to communicate with the service. The Microsoft Word service, for example, can open a URL and a user can specify the URL as including the Namespace Management System compoint. A scheme handler can be registered to allow the URL to be interpreted as a URR. Similarly, the Namespace Management System could receive a request, save content to a file, and start the service with a parameter specifying the file (which may be a temporary file). One skilled in the state of the art can use one or more communication primitives to communicate content with the service.

Communicating with a Service

The Namespace Management System services can include one or more protocol services, communication primitive services, formatting services, broker services, and inter and intra process communication services. The services provide a multiplicity of communication, control, and monetization options. A series of built-in services are provided through the comprim.dll that, when registered, provide a common calling interface for connect, send, receive, and disconnect. This enables the pdcx:call service to be called to establish connectivity through a single service call, where the service will call the communication primitive service to the primitive specific service. For example, calling pdcx:call to a communication point with connectivity=“/bin/who” will bind the connectivity to stdio:/bin/who, and then call the stdio.connect to establish the connection. When necessary, a configuration document could reference a call to the communication primitive service.

Receiving a Request

In a preferred implementation, a Namespace Management System will accept a connection on one of a multiplicity of communication points and receive a request. A process that can send a request intended for a communication point registered as an index of the compoint:pdcx.connectivity may or may not be a Namespace Management System service. A process that can use system level communication primitives to communicate a request to the compoint can interact with the Namespace Management System.

Certain services that connect to the Namespace Management System may require an announcement. This is often the case of legacy services such as a pop3 client or an SMTP client. The client service expects the server service to provide an announcement according to the respective application level protocol. In such cases, additional communication points and corresponding services can be registered with the Namespace Management System such that when a connection is accepted on the communication point, the corresponding service will be called by the Namespace Management System. An SMTP communication point, for example, can be registered with the Namespace Management System and a service:SMTP.service registered as the corresponding service. When the SMTP client connects on the smtp communication point, the Namespace Management System will call the service:SMTP.service to satisfy the request. The service:SMTP.service can provide the announcement according to the simple mail transfer protocol, and the client will begin sending requests according to the protocol.

The Namespace Management System can use a service level service to peek on a connection to determine the nature of the request. A multiplicity of protocols can be supported through configuration documents, and when the request can be satisfied by a corresponding protocol service, the Namespace Management System will know what service to call. The service:main service, for example, will peek on the active communication point to determine if the request is a pdcx:request formatted in XML, an HTTP request, or a SOAP request.

When the request is representative of an HTTP request, the service:main service will call the service:http.request service to satisfy the request. When the request is representative of a SOAP request, the service:main service will call the service:soap.request service to satisfy the request. When the request is representative of an XML formatted pdcx:request, the service:main service will call the service:pdcx.request service to satisfy the request.

A binding service can be used to bind the request to a service, and the corresponding bound service can then be called. This permits a multiplicity of binding methods to be used, each provided through configuration documents that can be evaluated in run-time.

One skilled in the state of the art will understand that a request received by a Namespace Management System may or may not include credential information identifying where the request originated. It is desirable to support both cases, as there are some services that the end user may wish to provide where credentialization is not required and other services where credentialization is required. Consider a web site, for example, providing information to the public. In many cases, it is desirable to provide this information to the public. In other cases it is desirable to require credentialization when a request is being made for sensitive data or services that are monetized. Through the selection service, prerequisites can be registered by the Namespace Management System owner configuration documents describing when to provide certain services. The prerequisites can be specified as conditions that must be satisfied, and the conditions can include a requirement for credentialization, as well as identifying the requester namespace listing, and even the point of presence of the process sending the request. Thus, a service can be denied if any rule is not met; for example, if a request originated outside of a particular firewall, if a requestor's listing does not satisfy a pattern, if the request did not include credentials, if the requestor's listing is not a subscriber, if a secure communication is not being used (such as https or openssl), and various other criteria registered in a namespace.

The PDCX Request

A Namespace Management System communicates (sends) a request intended for a listing. In a preferred implementation, the request is an XML formatted request with the outer tag being a pdcx:request. One or more attributes of the pdcx:request element are used to provide information representative of the Namespace Management System issuing the request. Attributes are provided as name-value pairs. The to.listing attribute identifies the Namespace Management System that the request is intended for. The key attribute is a hash key of the body of the request. The keyed attribute is a hash key of the attributes. The service attribute describes the requested service. The from.listing attribute describes the listing that originated the request. A reply.to attribute describes a listing to which the response should be communicated. The credential attribute describes the dynamic credential assigned to the listing's compoint by the namespace provider service providing the listing. When the request must be redirected, the Namespace Management System that redirects the request can apply one or more services and alter one or more attributes. In such cases, the redirection service verifies the credential of the requesting Namespace Management System, and inserts the public information associated with the requesting Namespace Management System that it obtained from the Namespace Management System's namespace provider service in response to the request to verify the credential. The redirection service can add its own dynamic-credential to the request prior to forwarding the request to the intended Namespace Management System. A multiplicity of redirection services can be used to ensure the request is forwarded to the intended Namespace Management System.

The pdcx:request service registers the from.listing as the pdcx:active.consumer.listing, the from.credential as the pdcx:active.consumer.credential, and the client connection information as pdcx:active.consumer.connectivity.

Service Sets

In an implementation, an entry in the namespace is representative of a service or a group of services referred to as a service set with one or more members. A configuration document can register a service as belonging to one or more service sets. Each compoint of compoint:pdcx.connectivity can have an associated service set. When a connection is accepted on one of said compoints, the Namespace Management System can select a service from the associated service set to satisfy the request. In this manner, the set of registered services for the “local” compoint service set can include one or more services that may be different from the set of registered services for the “namespace” compoint. Similarly, the “admin” compoint service set can include one or more services that may be only available on the administrative communication point.

Registering a Service in a Service Set

In one implementation, a configuration document can request a service to be registered in a particular service set by specifying the service set during the registration request. A configuration document can describe a service to be registered in a multiplicity of service sets. The service sets can be administered through file system semantics, permitting configuration documents to have different path names wherein the path name is used to identify the service set. When an entry in the namespace representing the service set is functional, then a request for a service within the service set can be determined by the functional service associated with the namespace entry. The entry in the namespace can have one or more discipline services, and a request for a service within the service set can be determined by the discipline service associated with the namespace entry.

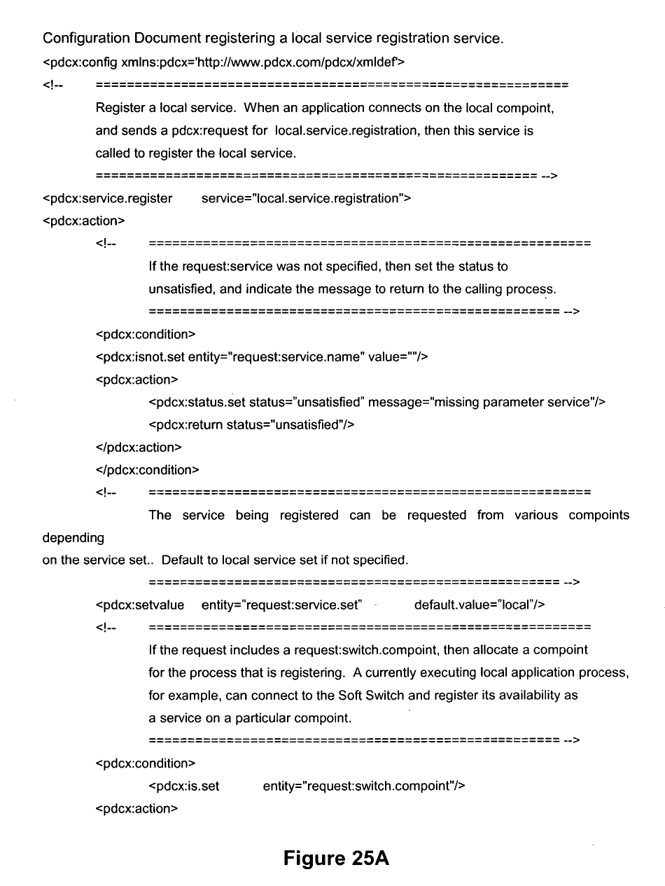

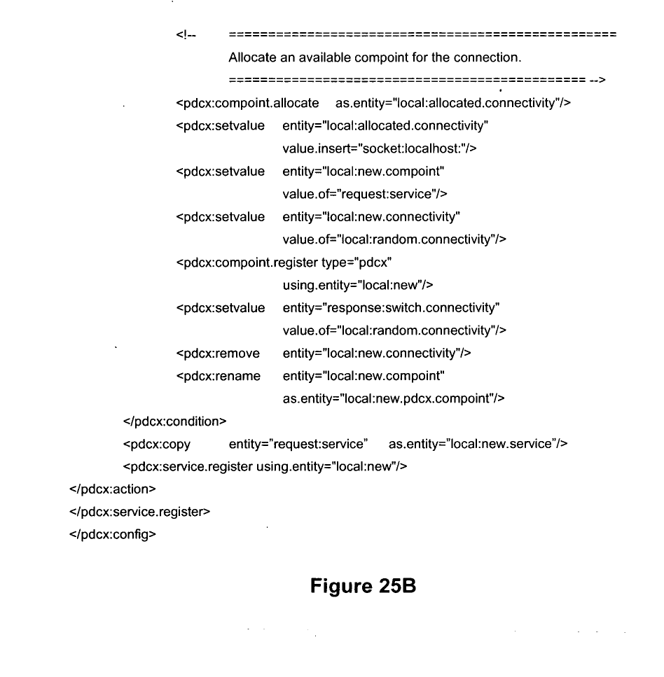

In FIGS. 25A and 25B, a configuration document describing a service registration service is disclosed for a local process (meaning executing on the same edge computing device as the Namespace Management System) to register its availability with the Namespace Management System.

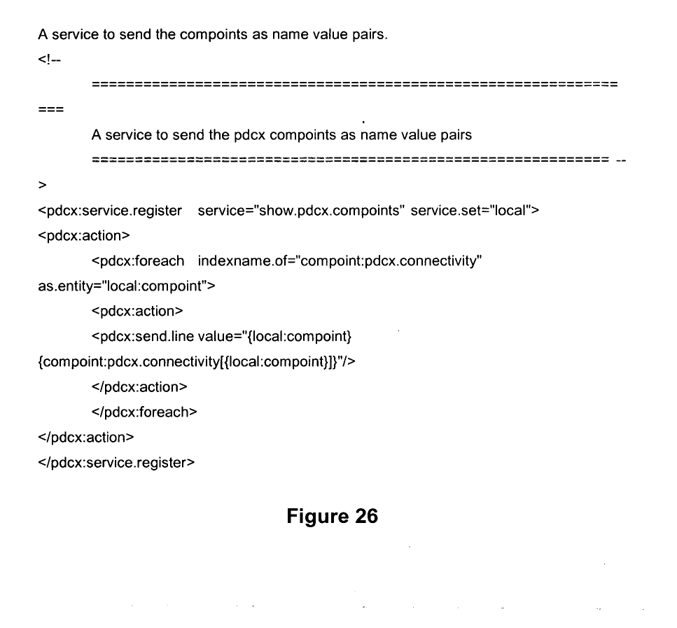

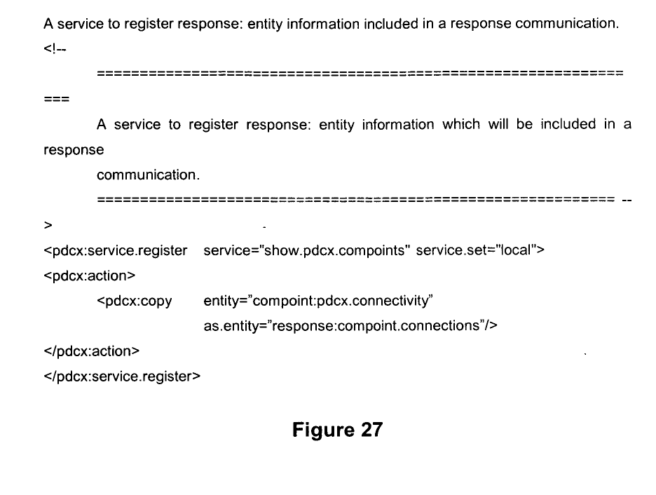

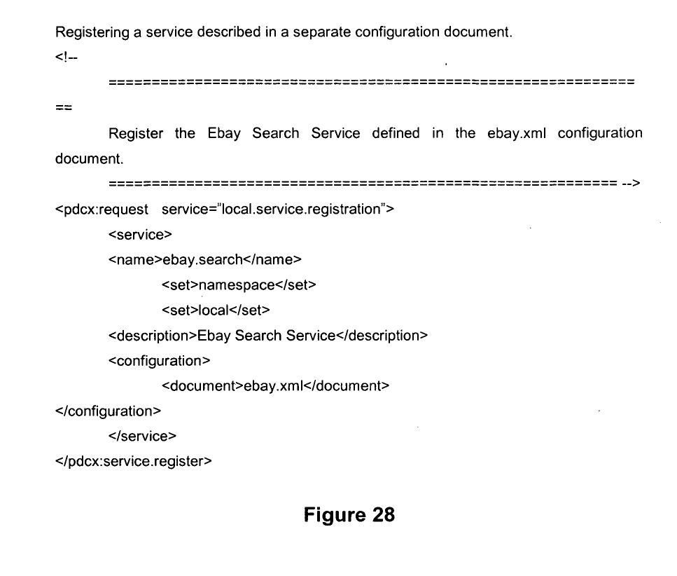

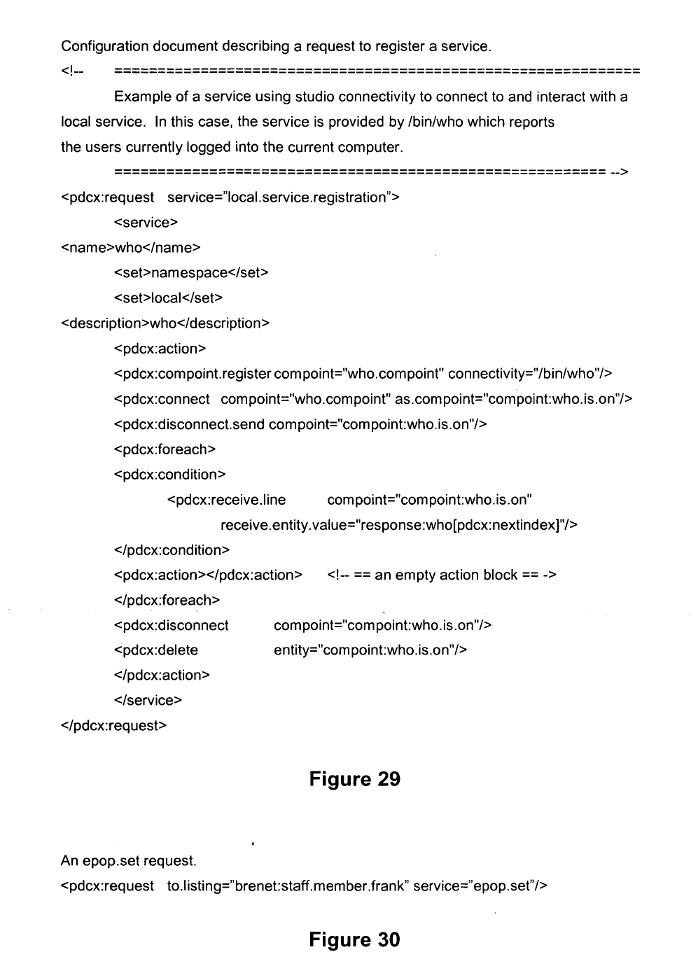

In FIG. 26, a configuration document describing a service to register is disclosed. The service communicates current state information as its response. In FIG. 27, a configuration document describing a service is disclosed. The service registers entity information in the response: namespace as the response from the service. An application process connecting to the local compoint of the Namespace Management System sends the configuration document shown in FIG. 28 describing a request for the local service registration service to register an Ebay search service described in an ebay.xml configuration document. In FIG. 29, a request to register a service that uses stdio connectivity is shown. Once registered, a service can call the “who” service and the response is registered in the response: namespace.

Selecting a Selection Service

In one implementation, a selection service is provided as a built-in service. When a request is received on a compoint, the Namespace Management System will use the built-in service to select a service to satisfy the request from a service set. In a second implementation, a configuration document registers a “selection” service, and the selection service is called to select the service to satisfy the request. In a third implementation, a configuration document registers a “service set” selection service, and the service set selection service is called to identify one or more service sets to be considered. In a fourth implementation, a binding service is used to select one or more selection or “service set” selection services.

The default “service set” is given below where the active compoint name is the name of the compoint that the request was received on, such as admin, local, or namespace.

pdcx:registered.service.{pdcx:active.compoint.name}

A configuration document can register an “unknown service request” service. When a request is received and a service to satisfy the request cannot be determined through the selection services, the Namespace Management System can call the “unknown service request” service.

In another implementation, a configuration document can register a “denied” service such that when a selection service denies a request, a registered “denied” service can be called to satisfy the request. This enables a multiplicity of selection services to be used and a common denied service to be called when one of the selection services indicates that the request is to be denied. The denied service may simply log information about the request.

Selecting the Service Set

When a pdcx:request is received on a compoint, the Namespace Management System pdcx:request built-in service will search for a “service set” to use in resolving the request. A “service set” is a set of registered services available for the specified compoint. The default “service set” is given below where the active compoint name is the name of the compoint that the request was received on, such as admin, local, or namespace.

pdcx:registered.service.{pdcx:active.compoint.name}

Service Set Bindings

The pdcx:serviceset.bind service is called to attempt to bind the requested service in the specified service set. The order of the binding methods used is determined by the value of the pdcx:registered.service.set.binding.methods list, which defaults to a list containing namespace, fs, and sc. If the requested service cannot be bound, then the first registered service satisfying one of the following will be bound and called:

pdcx:registered.service.{pdcx:active.compoint.name}.unknown

pdcx:registered.service.unknown

Namespace Binding Method

The namespace binding method attempts to locate the requested service in the specified service set. If the service is registered in the set, then the request is considered bound. Otherwise, the request remains unbound.

Fs Binding Method

If the service is not registered in the “service set”, then the referenced service is translated as a relative pathname to a configuration document given as:

pdcx/compoint/{pdcx:active.compoint.name}/{requested_service}

If the relative pathname can be bound to a configuration document, then that configuration document is imported. If the service is registered in the set after evaluating the configuration document, then the request is considered bound. Otherwise, the request remains unbound.

Sr Binding Method

If the service is not registered in the “service set”, then the first registered service satisfying one of the following will be bound and called:

pdcx:registered.compoint.{pdcx:active.compoint.name}.service.definition

pdcx:registered.service.definition

Other binding methods can be registered and an ordered list of one or more methods adjusted to the implementation. The sr binding method, for example, can be registered as the only method to use. The default sr binding method is a service that resolves service requests to a registered service. The implementation can describe its own sr binding method and register that method.

Calling the Service

When a service has been bound, the pdcx:request service will register the bound service reference as the value of pdcx:active.consumer.service and will call the service using the pdcx:call built-in service. If the called service has a “before” discipline service, then that service is called just before the bound service is called. Similarly, if the service has an “after” discipline service, then the after service is called after the bound service has completed. This allows a service, such as a service responsive to an HTTP request, to register a root directory based on information in the namespace, such as the pdcx:active.consumer entity. For example, if a request is received and the request originated from the listing brenet:staff.member.john, then root directory can be set to one location, while a request originating from church:project.cd can set the root directory to a second location. Similarly, when a request for a file is received from a first listing, a first root directory can be registered, while a second request from a second listing can have a second root directory. In a second implementation, a root directory is registered in the namespace as a functional entity whose value is the result of a service call wherein the called service uses the pdcx:active.consumer information to determine a root directory value.

One skilled in the art could use the pdcx:active.consumer entity information (one or more composite members thereof) to register the value of a second namespace entity referenced by a called service. When the request does not include a from.listing, or is missing a credential, a default value can be registered. This is particularly useful for providing one or more services based upon the value, or pattern, of the pdcx:active.consumer entity information.

Sending a pdcx:request

The built-in pdcx:call service can be used to call a listing and may include an optional desired service. The pdcx:call service calls the pdcx:format.pdcx.request service to convert the request into a formatted request that can be understood by the intended listing. In a preferred implementation, this is in XML format with the outer element being <pdcx:request>. The format service adds name-value pair attributes to provide additional information, including the registered listing associated with the Namespace Management System, and the intended listing. When sending a request to a listing, the format service can add a key describing the generated content of the request and a seal key describing the pdcx:request element. Otherwise, a pdcx:request can be formatted without the key information and will be considered a public request.

Queuing Requests

The service:main service calls the administrative service pdcx:registered.admin.service, during inactive periods, to provide for administrative services. The administrative service calls the pdcx:queue.pop service to retrieve a configuration document previously pushed on the queue with a pdcx:queue.push service and evaluates said configuration document. As an example, the administrative service calls the pdcx:import service to import said popped configuration document with a prerequisite that the configuration document must be a pdcx:request.

### Example Services

Logging Service

A configuration document can register a logging service, and other services may call the logging service with a request to log information. The logging service can query the namespace for a log level and, depending on the log level, determine if the information should be logged. This enables logging of errors, warnings, detailed information, and other levels to be controlled through one or more namespace entries. A logging service can also query the namespace for a compoint to which the logging request should be directed. This enables a Namespace Management System to offer a common log service and the common log service to redirect the request to a compoint. In another implementation, the log request may be appended to a data file. In another implementation, the namespace may use functional or discipline services to enable a log request to be satisfied by a registered service.

A dynamically loadable service called with a reference to a service directory containing entity information representative of the input types understood by the service can call the pdcx:admin.log.start service with a reference to the service name and service directory parameter. The pdcx:admin.log.start service looks for a registered logging service and, if found, calls the logging service with the reference to the service name and service directory parameter enabling the logging service to record the service name and entity information from the service directory. Upon completion of the dynamically loadable service, the service can call the pdcx:admin.log.end service with a reference to the service name and status to return. The pdcx:admin.log.end service looks for a registered logging service and, if found, calls the logging service with the reference to the service name and returned status. This detailed transactional information is captured and logged, showing the services that were called, the order in which they were called, the parameters provided, and the return code. A playback service interprets the detailed transactional information to dynamically create a configuration document that can be imported by the Namespace Management System to provide playback of the particular transaction for auditing purposes.

Compoint Mapper Service

The compoint mapping service evaluates a compointmap.xml configuration document containing compoint names and default services to associate with the compoint. The compoint mapping service registers the specified compoint name and service. The compointmap.xml configuration document contains one or more maps. Within each map is specified a compoint name, a service, and connectivity. The compoint mapper service registers the compoint name as an index of compoint:pdcx.connectivity and specifies the value as the connectivity given within the map. It also registers the default service to associate with the compoint. When the pdcx:accept service is called, the default action is to accept a connection on any one of the compoint:pdcx.connectivity compoints and call the default service associated with the compoint on which the connection was received.

XML News

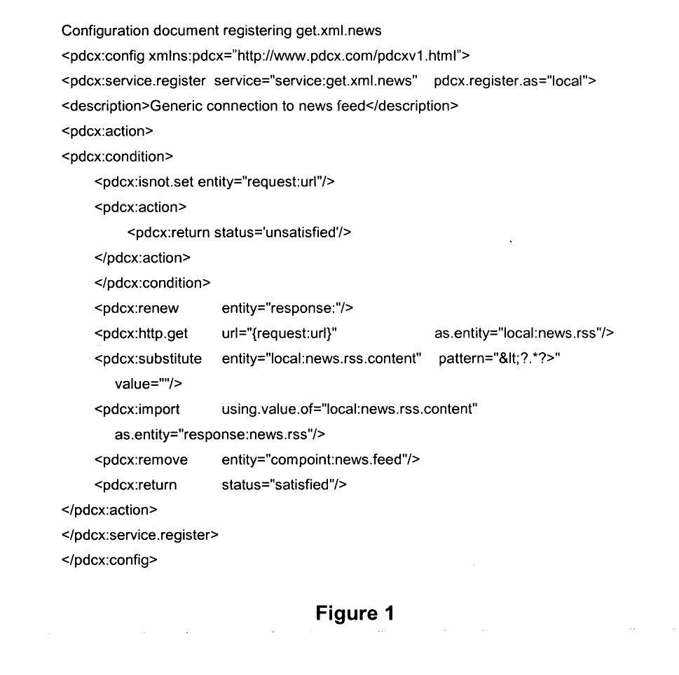

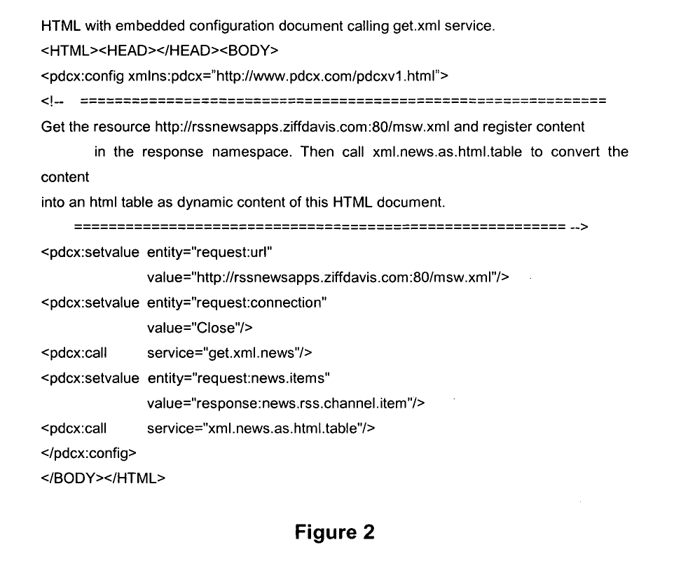

A configuration document registering a get.xml.news service is shown in FIG. 1. The service is registered as a local service indicating that it can be called as a pdcx:request on the local compoint. Other services can call this service. A configuration document can describe a request to call this service, as shown in FIG. 2. The request:url describes the resource to be retrieved. The results are registered in the response namespace.

A Namespace Management System configuration document describing a RSS/Atom News Reader service that an end user can interact with through an HTML rendering enabled application, such as a web browser, can be obtained, or the end user can write their own to provide equivalent functionality. Similarly, a Namespace Management System configuration document describing a news aggregation service for online searching, subscription, creating and sharing of news feeds, blogs, and rich web content can be obtained, or the end user can write their own to provide equivalent functionality.

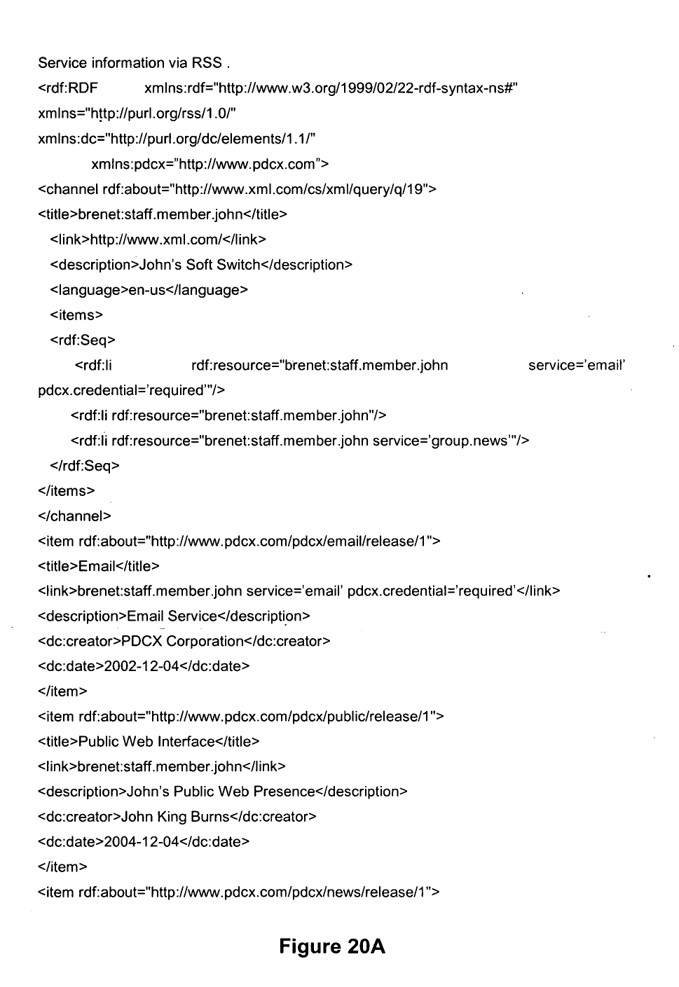

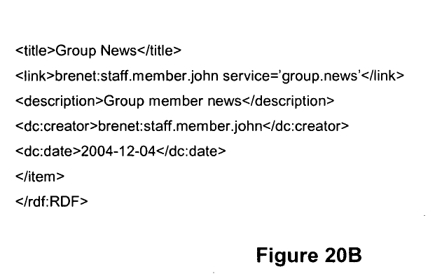

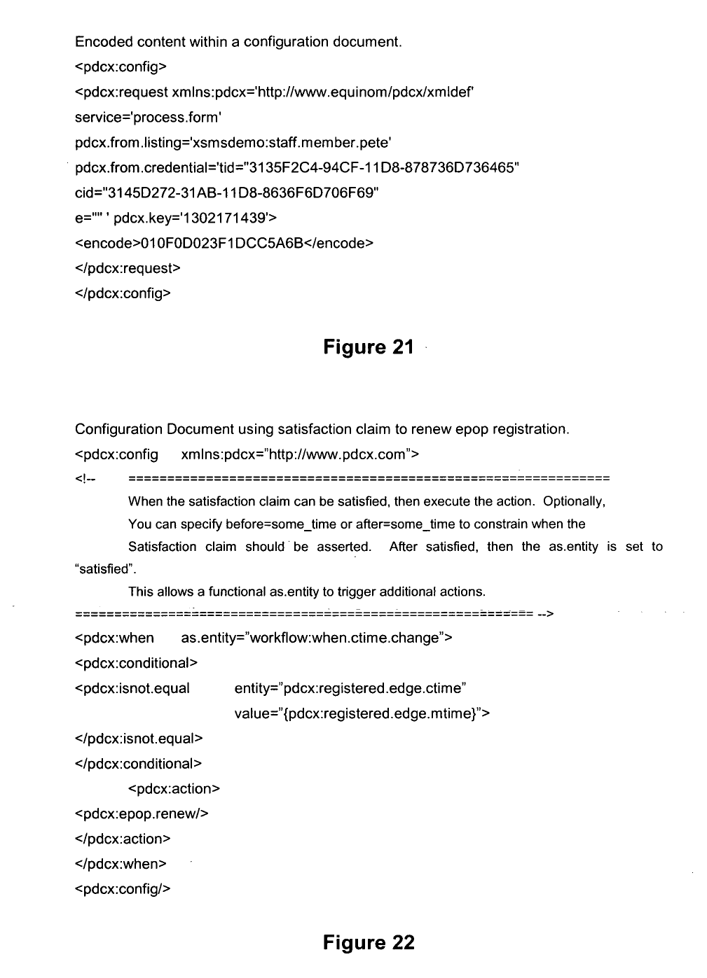

RSS is a format for syndicating news and the content of news-like sites. FIGS. 20A and 20B provide an example RSS conforming content that can be received by a configured Namespace Management System, and in response thereto, one or more services can be called to process the content.

Zip Code to Longitude and Latitude Service

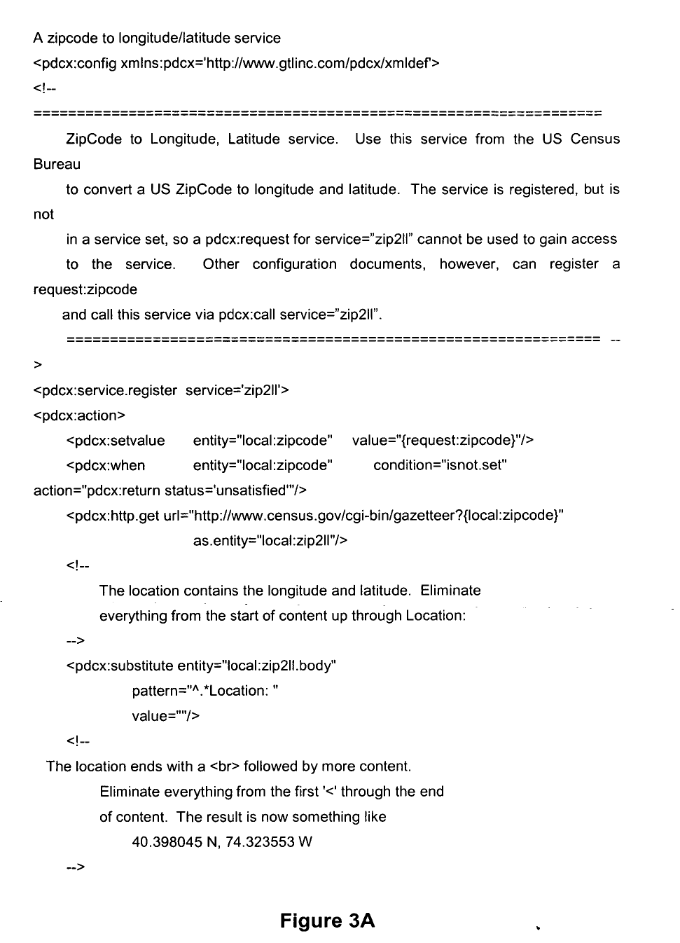

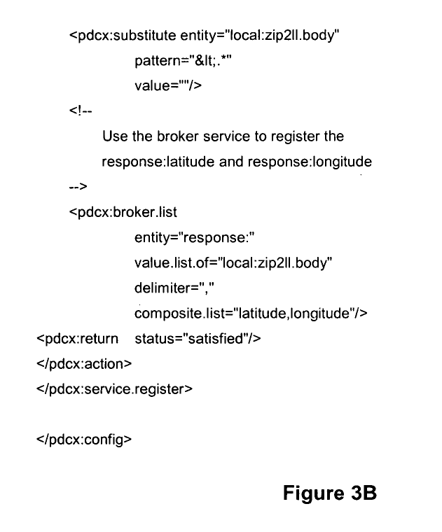

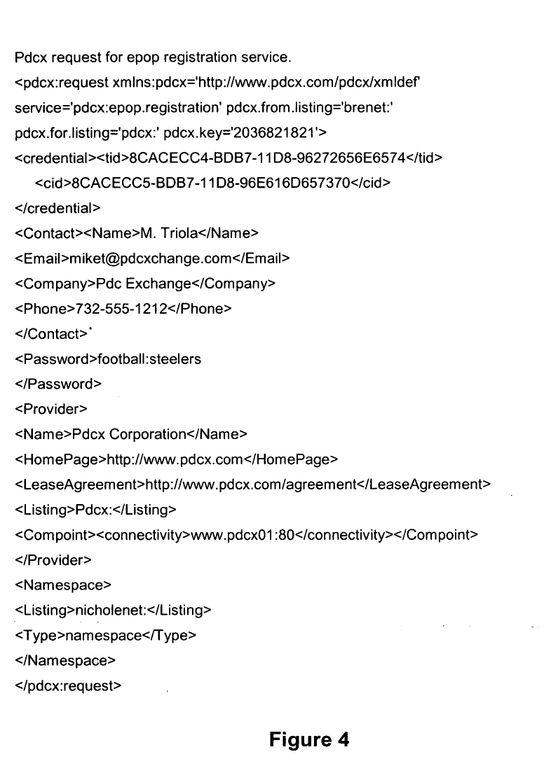

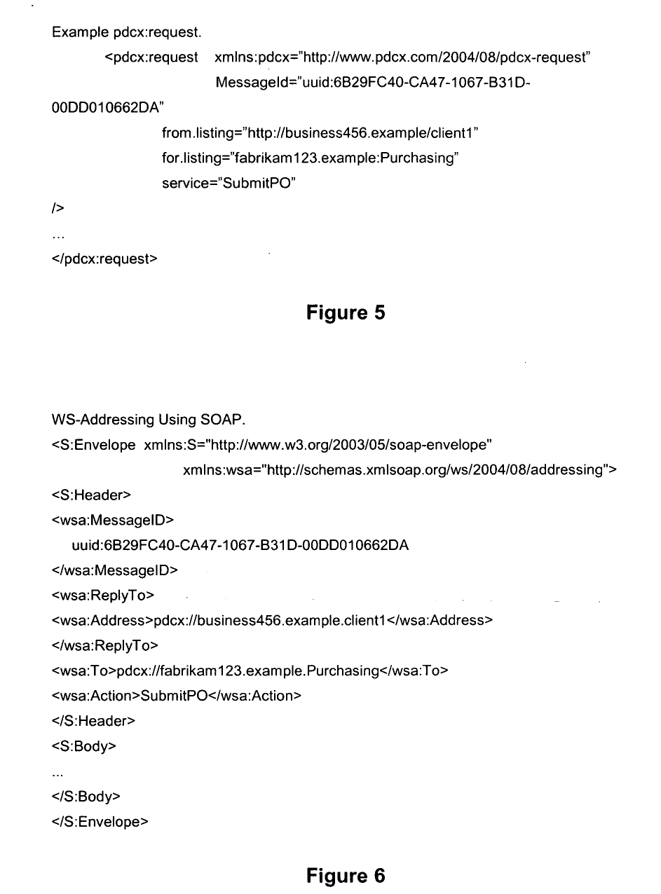

A configuration document registering a zip code to longitude/latitude service is shown in FIGS. 3A and 3B. The service is called with request:zipcode set to the desired zipcode. The response from the service registers the corresponding response:longitude and response:latitude. A user using a web browser can enter a URR such as pdcx:call//service:zip2ll?zipcode=08857 which uses the pdcx scheme handler to call the local compoint of the Namespace Management Service with a pdcx:request for the specified service, where zipcode is registered in the request: namespace with a value of 08857. Additional information, such as county name, FIPS code, time zone, area code, street map graphic, current weather, weather forecast including text and/or graphic, aerial photographic imagery, satellite imagery, and/or aerial photography can be added.

Drag and Drop Service

An application service, such as a file transfer service installed on a Microsoft Windows operating system, can have a corresponding desktop icon with a Target corresponding to the path of the installed application service. The Target includes a %1 macro enabling the user to identify an object such as a file via a drag and drop operation onto the icon. The application service creates a dialogue with the end user, typically through a dialogue (or HTML form), allowing the end user to identify an intended namespace listing. When the intended service is not yet known to the application service, the dialogue will enable the user to identify an intended service, such as file transfer, print, archive, or other appropriate intended service. In response thereto, the application service connects to a Namespace Management Service communication point and sends a request for the intended service to the intended namespace listing. A file transfer service, for example, enables the user to identify the intended object (file or directory of files) and the intended namespace listing.

Embedded Configuration Documents

When the built-in pdcx:send service is called with a mode setting of pdcx, it will scan the data to be sent for embedded <pdcx:config> . . . </pdcx:config> statements. This is referred to as an embedded configuration document. In a preferred implementation, HTML content may contain one or more embedded configuration documents, and each configuration document is evaluated when the HTML content is sent using the pdcx:send built-in service. In a second implementation, the pdcx:send service will call an appropriate comprim send service depending on the communication primitive in use, and the corresponding comprim send service will evaluate the embedded configuration document. One skilled in the state of the art can use the pdcx:send service to evaluate embedded configuration documents in other content.

In another implementation, the content being sent can include one or more embedded pdcx:request statements, and the Namespace Management System can evaluate the request. In another implementation, the content being sent can include one or more embedded PDCX Protocol Services Calls, and the Namespace Management System can evaluate the call. In another implementation, a lexical analyzer service can be used to translate the data to be sent into an embedded configuration document or a PDCX protocol service call that can be evaluated by the Namespace Management System. In another implementation, a parser service can be used in conjunction with a lexical analyzer to decompose a sentence into component parts containing PDCX Protocol service calls that can be evaluated by the Namespace Management System.

One skilled in the state of the art can create and register a natural language parser (Human Computer Interface [HCl] parser) or register a third party natural language parser service to decompose a sentence into component parts that can be evaluated within the semantic domain of the Namespace Management System.

Reserved Network Namespace

In the Namespace Management System, certain namespaces are reserved and have particular meaning to the Namespace Management System. The “request:” namespace, for example, is used to register information about the current request. The “response:” namespace, for example, is used to register information representing the response to the current request. The semantics and syntax are determined by the Namespace Management System built-in services. To ensure common services, certain namespaces are reserved. In particular, protocols and published specifications have reserved namespaces such as those shown in Table 1.

TABLE 1
Reserved Namespaces

| | |
|---|---|
| Define: | namespace is reserved for dictionary style definitions. |
| File: | namespace is reserved for entries representing files on the |
| | computing device |
| Ftp: | namespace is reserved for entries representing the File Transfer |
| | Protocol |
| Geo: | namespace is reserved for entries representing a Geo-spatial |
| | namespace |
| http: | namespace is reserved for entries representative of resources that |
| | can be requested using the Hyper Text Transfer Protocol |
| https: | namespace is reserved for entries representative of resources that |
| | can be requested using secure socket layer and Hyper |
| | Text Transfer Protocol |
| Ldap: | namespace is reserved for entries representing the light weight |
| | directory access protocol |
| Soap: | namespace is reserved for entries representing the SOAP |
| | protocol |
| Uddi: | namespace is reserved for entries relating to the current UDDI |
| | standard |
| Uri: | namespace is reserved for entries representing URIs |
| Url: | namespace is reserved for entries representing URLs |
| Wsdl: | namespace is reserved for information specific to the Web |
| | Service Description Language |
| Xmlrpc: | namespace is reserved for entries representing the XMLRPC |
| | protocol |

In one implementation, a listing given as uddi: references a UDDI namespace. In a second implementation, a listing given as pdcx:uddi references a UDDI namespace. In a third implementation, a listing given as pdcx:microsoft.uddi references a UDDI in the pdcx:microsoft namespace. In a fifth implementation, a listing given as pdcx:microsoft:uddi references a UDDI namespace administered by the pdcx:microsoft: namespace service. In a sixth implementation, a listing given as pdcx:microsoft:uddi:ibm:uddi references a UDDI namespace available through the service associated with the pdcx:microsoft:uddi:ibm listing. In one implementation, the pdcx:microsoft:uddi:ibm listing represents the pdcx:microsoft namespace service which resolves uddi:ibm, while in another implementation the listing represents an IBM listing in the uddi namespace available through the pdcx:microsoft namespace.

When providing a namespace listing for a specification API, the listing should include the current version number of the specification.

Public Registry Namespace

Listings in the public registry namespace represent namespaces, groups, and edges participating in a global network. In this context, the listing belongs to the public registry akin to the public telephone system network. Subscribers can be grouped by geographic area, by name, by physical address, by an email address, telephone number, social security number, federal tax-id number, or other criteria as imposed by the implementation.

In a preferred implementation, each listing includes one or more communication identifiers to uniquely qualify a listing. The communication identifier may be part of the namespace listing, such as public:arthur.r.brownlee or may be a composite member of the listing such as public:arthur.r.brownlee.job=yeoman. In a second implementation, a subscriber can add a name-value pair to their listing to uniquely qualify their listing. The listing public:arthur.r.brownlee may be uniquely qualified by job=yeoman when compared to other arthur.r.brownlee listings in, the public namespace.

To locate a listing in the public registry, a user of a computing device uses an interactive service to send a query to a namespace compoint whose service uses one or more built-in services to satisfy the request and communicates the response to the user interactive service. In response thereto, the interactive service displays the response to the user. In one implementation, the response may include a single listing; and in a second implementation, the response may include a multiplicity of listings from which the user can select. The response may be limited to a predetermined maximum number of, or the user may indicate a maximum number of, responses to return.

In a preferred implementation, a user would enter the criteria for selecting a listing, and also select a desired service, such as call, or connect to. When the response from the namespace compoint service query request represents a single listing, then the desired service is evaluated. When the response from the namespace compoint service represents a multiplicity of listings, the desired service is not automatically applied; instead, the user is provided with the listing information so that the user can select an appropriate listing or discover additional information about a listing presented to determine if the listing is appropriate.

As an example, a user can query for a listing and save the response in an address book namespace available to their Namespace Management System (i.e., a buddy list). The user can use the Namespace Management System to add entries, display entries, select an entry, and select a desired service to apply to the listing. With an HTML interface, for example, this may be displayed through a first drop-down list of names and a second drop-down list of services. The user selects the name and the service and submits the request to the Namespace Management System. This provides-a single interface for -a- multiplicity-of- services around a single address book namespace. One implementation, for example, can include a call, connect, email, send document, send fax, talk, and message services as available services.

Private Network Namespace

The Namespace Management System can be used to administer service calls in a private networked namespace. In such an implementation, each participant obtains a listing from a namespace provider and all listings can be resolved within that namespace. Group services and edge services can be used and may reside on different computing devices that are able to communicate directly or indirectly. A private namespace can be used by a corporation, for example, as middleware for administering communication interconnections between various services.

Credentials

The Namespace Management System uses dynamic credential services for authentication. The Namespace Management System issuing the dynamic credential determines the content, which can be registered as an entity in a namespace.

In one implementation, a dynamic credential is composed of a communication point ID (cid), a transaction ID (tid), and an optional expiration time (eid). The tid is a transaction id, and its value is a GUID value. The cid is a compoint id, and its value is a multipart hash value. The eid is an expiration id, and its value is a time_t type as defined by the operating system. The dynamic credential is created with the pdcx:credential.create built-in service. When called with the pdcx:call built-in service, then an unqualified “credential.create” will be bound to “service:credential.create”, if registered, or the default “pdcx:credential.create”. Other binding methods may bind the reference to other namespace services. Similarly, a pdcx:call to a non-namespace qualified credential.authenticate call will be bound as “service:credential.authenticate”, if registered, or the default “pdcx:credential.authenticate”. Other binding methods may bind the reference to other namespace services. Thus, a configuration document can register an alternative service to create a credential. A configuration document can register an alternative service to authenticate a credential.

In the preferred implementation, the credential includes a Public Key Infrastructure (PKI) certificate that binds a public key with a distinguished name representative of an active namespace listing, such as flightnet: or brenet:staff.member. The namespace provider service provisioning the listing is the issuer, and the issuer digitally signs the certificate with its private key with a distinguished name representative of the issuer's active namespace listing. By signing a certificate with the issuer's private key, anybody that has the issuer's public key can verify the certificate's authenticity.

An Active Namespace is administered by a pdcx:root service provided through a configured Namespace Management System designated as a DNN Root Service. The pdcx:root is the authority and issuer for the Active Namespace. A multiplicity of pdcx:root services provided through a multiplicity of configured Namespace Management Systems can exchange and update state information for persistence and fail-over recovery.

In provisioning an active namespace, the authority issues a namespace credential corresponding to the namespace and the credential includes a namespace certificate with the subject representative of the namespace and the issuer representative of the pdcx:root. The pdcx:root uses its private key to sign the namespace certificate.

An active namespace, or authorized namespace listing, is the authority and issuer for subordinate listings (listings relative to the active namespace or authorized namespace listing). In provisioning a subordinate listing, the authority issues a namespace credential, including a namespace certificate corresponding to the listing. The subject is representative of the provisioned listing, and the issuer is representative of the active namespace or authorized namespace listing that provisioned the listing. The issuer uses its private key to sign the namespace certificate.

The issuer of a namespace certificate can authenticate the certificate. A given Namespace Management System that has obtained the necessary certificates required in establishing a chain of custody for a namespace certificate can validate the certificate.

A subscriber subscribes to the pdcx:root to obtain a namespace, and in provisioning the namespace, the pdcx:root delegates authority for the Active Namespace to the subscriber (the namespace service provider).

A namespace service provider can delegate authority for a portion of its namespace by provisioning a listing within the Active Namespace. The listing is then the authority for that portion of the Active Namespace relative to its listing.

A reference to a namespace (or listing within a namespace) is resolved using the pdcx:ans services. The set of services provided for Active Namespace resolution include the pdcx:ans.resolver service which is used to set, unset, and get active namespace resolution service information; the pdcx:ans.bind service which is used to bind a listing to resolve connectivity by calling one or more registered namespace resolution services; the pdcx:ans.unbind service to unbind a previously bound listing; and the pdcx:ans.query service to query for information about a bound listing.

The pdcx:ans.resolver service is used to set, unset, and get active namespace resolution service information.

The method for resolving a namespace listing to its current point of presence is determined by a resolution service level agreement (RSLA). The RSLA defines the resolution, and can be one of: public, indicating non-authenticated requests can be resolved; authenticated, to indicate only authenticated requests can be resolved; private, to indicate that the namespace listing resolves references for listings that it has authority for; or unpublished, to indicate that connectivity information is not provided in resolution request.

For a top-level namespace, the RSLA may also describe one of: namespace, to indicate the pdcx:root should provide resolution service to the namespace only for authenticated requests from top-level namespaces; or managed to indicate the pdcx:root should provide resolution service to the namespace only for authenticated request, by sending the request to the namespace provider, and providing the response from that request as the response to the authenticated initial request.

A resolution service level agreement can also indicate if the issuer can advertise the listing. An advertisement can be initiated by the authority or provided in response to a request.

There are various classifications for certificates used within the Namespace Management System. The registration certificate is used during point-of-presence registration. The namespace certificate is used for authentication of content. The subscriber certificate is used when authenticating with subscription-based services. The session certificate is used by the Namespace Management System for its [secure] compoint. The pdcx, route, and proxy certificates are used for administration of message routing within the Active Namespaces. An implementation may use a single certificate.

In current practice, a Public Key Infrastructure certificate's subject (the owner) is determined by an OID, such as InetOrgPerson, comprised of Country, State, Locale, Organization, OrganizationalUnit, and CommonName fields wherein only the CommonName is required. The other fields may be empty or have a default value. The issuer (signer) of the certificate also has a subject comprised of the similar field names. A typical subject is given as:

Subject=/C=US/ST=PA/O=PDCX Corporation/OU=sales/CN=John Burns.

Namespace Management System certificates are unique in that the subscriber's namespace listing is used for the subject CN field value, and the namespace provider's listing is used for the issuer's CN field value. For example, the fully qualified namespace listing flightnet:usair.newark.agent would have: Subject=/CN=flightnet:usair.newark.agent and Issuer=/CN=flightnet:usair.newark.

The CN field may be replaced by a new OID with Listing as the field name, thus yielding Subject=/Listing=flightnet:usair.newark.agent and Issuer=/Listing=flightnet:usair.newark.

Each certificate also has a unique serial number assigned by the Issuer and an SHA-1 fingerprint. The maximum length of the common name (CN) field is 64 bytes. An implementation can use the issuerAltName and subjectAltName to extend the maximum length of a listing.

The registration credential is used during the point-of-presence (POP) registration. A typical subscription is completed by using a web browser to connect to a namespace provider service, selecting a “subscribe to” option, and completing the subscription form. Typically, this is provided through an HTTPS connection. The subscription form will ask for the desired fully qualified namespace listing, and typically allows the user to set a pass phrase which will then be used during the point-of-presence registration. Upon completing the form, the user submits the request for approval. The namespace provider service that receives the request ensures the availability of the desired namespace listing and generates a subscription configuration document containing a pdcx:request for the epop.registration service.

The subscription configuration document is imported by the subscriber's Namespace Management System during bootstrap, and the Namespace Management System calls the built-in pdcx:request service. The request is for a point-of-presence registration service.

After the user supplies the appropriate pass phrase, the content of the cipher block can be decrypted and made available to the user's Namespace Management System. The Namespace Management System extracts the issuer's listing and the subscriber's listing to determine the subscriber's fully qualified active namespace listing.

The pdcx:epop.registration service will call the root namespace service to determine the connectivity to the issuer, if necessary. In a private namespace, for example, the subscription configuration document includes this information.

The response may indicate a redirect (a second connectivity), and that response may indicate a third redirect, and so on. The maximum number of redirects is determined by the value of redirects within the subscription configuration document. Each call includes the issuer's namespace listing.

After the point-of-presence registration has completed, the subscriber will request a namespace credential if its namespace provider has not already issued one. A namespace provider issues a subscriber a namespace credential. The purpose of this credential is to enable persistence for encryption and authentication within a pdcx:request after point-of-presence registration.

The namespace credential includes the subscriber's active namespace listing (as the subject common name) and the namespace provider's active namespace listing (as the issuer's common name). The subscriber can generate the private key, create a certificate request, and send the certificate request to the namespace provider service to request a namespace credential that includes a namespace certificate.

Only the namespace provider can issue a subscriber's namespace credential. The namespace credential is registered in the credential: namespace as the default credential. The subscriber maintains the private key associated with the credential. The namespace provider service registers the public portion. If the subscriber permits, then the namespace service provider will provide the public portion of the namespace credential in response to a query. Otherwise, the credential is unpublished and not available through the namespace provider service.

The issuer can revoke the namespace credential, and once revoked, the subscriber is notified. Similarly, the subscriber can request its namespace credential be revoked, and the issuer will revoke the credential and notify the subscriber that it has been revoked.

The subscriber can request the namespace credential be renewed. If the issuer renews, it will notify the subscriber that the credential has been renewed. Otherwise, the subscriber can request a new namespace credential.

A Namespace Management System that has established its point of presence can use the pdcx:subscribe built-in service to send a subscription request to a second namespace listing offering a subscriber-based service. The response from the request includes a subscriber credential, including a subscriber certificate.

The subscriber credential is registered in the credential: namespace with a listing representative of the active namespace listing to which it has subscribed. As an example, if brenet:staff.member.john subscribes to flightnet:usair, he receives a subscriber credential. Thus, john's subscriber credential may include:

Subject=/CN=flightnet:usair.cust.jkb and Issuer=/CN=flightnet:usair.

The credential is registered as credential:flightnet.usair. When john makes a subsequent pdcx:request to flightnet:usair, then the subscriber credential will be used in place of the namespace credential. The content of the subscriber content credential is determined by the implementation. It may include public information registered about the subscriber. It includes a certificate-that has been signed by the namespace provider providing the subscription-based service.

The PDCX credential is used to verify an inbound pdcx:request from a Namespace Management System. This enables a receiving Namespace Management System to verify the sender without the need to decrypt the content of the pdcx:request. The PDCX credential is primarily used for multi-hop Namespace Management System messaging. In certain configurations, the PDCX credential replaces the need for a proxy credential. The PDCX credential can include a PDCX certificate.

A route credential is used when receiving inbound requests from a routing service. The route credential includes a route certificate that is dynamically generated and subsequently revoked when the connection between the Namespace Management System and the routing service is terminated.

A proxy credential is used when a first Namespace Management System is using a proxy Namespace Management System for sending a pdcx:request to another namespace listing. When the proxy Namespace Management System also provides inbound requests, then a single proxy credential can be used and this would eliminate the requirement for the route credential. A proxy credential may persist, but typically is reissued each time a subscriber Namespace Management System using the proxy is rebooted. The proxy credential includes a proxy certificate that is dynamically issued as needed.

A session credential is necessary when a Namespace Management System desires to provide a [secure] compoint type connection. This is essentially an SSL3/TLS1 type connection. The session credential includes the current Internet Address of the Namespace Management System as the common name. This is necessary only for the case where the user is using a browser to connect to the Namespace Management System via hftps: scheme. Without this type of certificate, the browser may generate a warning, such as the domain name does not match the common name of the server certificate. To circumvent such warnings, a subscriber Namespace Management System can request a session credential and use that certificate for the current invocation. When the Namespace Management System is rebooted, a new session credential will be required if the Namespace Management System changesthe IP Address.

An authentication service may use an industry standard protocol, such as the Online Certificate Status Protocol, the Simple Certificate Validation Protocol (SCVP), and/or Certificate Revocation Lists. Alternatively, or in conjunction therewith, one or more authentication services can be added through configuration documents. Non-repudiation is enabled by signing each message before encrypting it.

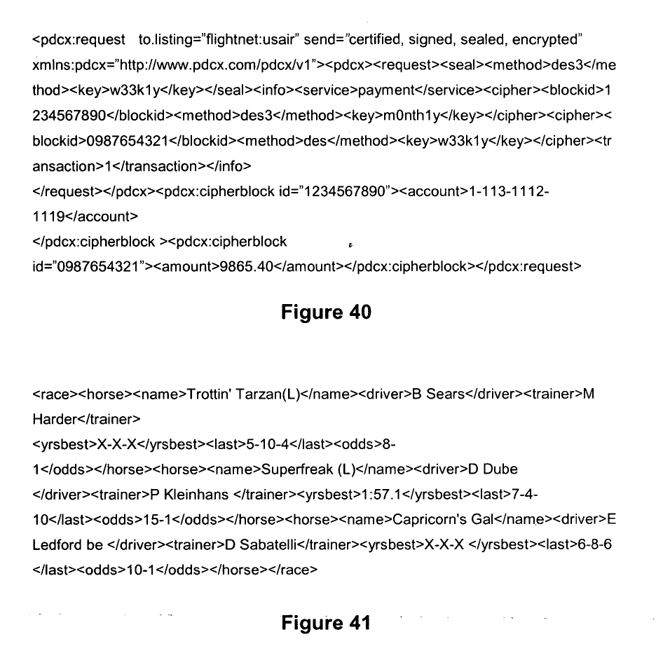

In an implementation, the pdcx:request can include a request.info composite member comprising one or more pdcx:cipher calls. The request.info.cipher identifies a cipher method, a block id, and a key. An illustration is provided in FIG. 40. When a local application sends the request to the Namespace Management System, the pdcx:request.info (and its composite members) are encrypted using the pdcx:request.seal.method and the pdcx:request.seal.key. The pdcx:request.seal is then encrypted using the public key corresponding to the active namespace listing given as the value of the to.listing as part of the pdcx:request. The pdcx:cipherblock calls containing a blocked name-value pair are encrypted using the specified cipher method and key corresponding to the cipher block definition provided within the request.info. This enables the pdcx:request to be communicated through the active namespace(s) wherein the to.listing is not encrypted but content within the request can be encrypted. The Namespace Management System corresponding to the to.listing active namespace listing uses its private key to decrypt the pdcx:request.info content. A transaction identifier can be included in the pdcx:request.info and validated to prevent replay attacks. Non-repudiation is enabled by signing the pdcx:request.info before encrypting it.

Authentication

The first Namespace Management System uses a built-in service to send a request to a third Namespace Management System. The request includes the namespace listing and session credential. In response thereto, the third Namespace Management System sends a credential verification request to the second Namespace Management System including the namespace listing, the credential, and the connectivity used by the first Namespace Management System.

In response thereto, the second Namespace Management System uses the registered credential information associated with the first Namespace Management System and the registered connectivity used by the first Namespace Management System in a call to a service to determine if the credential can be authenticated. The second Namespace Management System sends a response indicating if the credential is authenticated. For an authenticated credential, the response can include public information registered during the first Namespace Management System subscription with the second Namespace Management System.

When a Namespace Management System registers the current point of presence to associate with its listing, the namespace provider service receives the subscription credential, validates the credential, and assigns a session credential. The session credential is provided as the credential entity to the point-of-presence registration request. The session credential is registered as the current credential for the listing. The session credential can be dynamically constructed.

In one implementation, a dynamic credential is composed of a communication point ID (cid), a transaction ID (tid), and an optional expiration time (eid). The tid is a transaction id and its value is a GUID value. The cid is a compoint id and its value is a multipart hash value. The eid is an expiration id and its value is a time_t type as defined by the operating system.

An application process sends a subscription request to a Namespace Management System, and in response thereto, the Namespace Management System validates the request, calls the credential service to obtain a credential, creates the subscriber listing, and sends a response including the credential. As shown in FIG. 2, the response is an XML-formatted configuration document containing a pdcx:request for the epop.registration service.

In another implementation, upon validating the subscription request, the Namespace Management System calls the pdcx:entity.setvalue service to set a listing, and one or more discipline services are called to register the subscription with a data management service providing persistence for the registration. The discipline service calls a credential assignment service, and the response from the credential assignment service becomes the dynamic credential assigned to the registration of the subscription request.

When evaluating a point of presence (POP) registration request, a configured Namespace Management System calls the pdcx:entity.getvalue service using named information from the request to verify the request. The Namespace Management System calls the pdcx:entity.setvalue service to set the POP registration, and one or more discipline services are called to register the POP with a data management service providing persistence for the registration. The discipline service calls a credential assignment service, and the response from the credential assignment service becomes the dynamic credential assigned to the point-of-presence registration.

Alternatively, or in conjunction therewith, other authentication methods can be provided through services defined by the configuration. The DNN Service Provider, for example, can provide subscription configuration documents with encoded content that can be decoded or decrypted using a symmetric cipher service callable by the subscriber Namespace Management System (SSP1). The pdcx:dialogue service can be called to prompt the user to enter a pass phrase and the returned pass phrase can be used to decrypt the subscription configuration document.

The response from the point-of-presence registration of SSP1 with DNN Service Provider service (DNN-SP1) can include a dynamic credential assigned by DNN-SP1. SSP1 registers its dynamic credential.

When SSP1 wants to call SSP2, it can use a broker service to convert the dynamic credential into a second format that SSP2 can understand. Alternatively, or in conjunction therewith, SSP1 can use a binding service to bind the dynamic credential into a value that SSP2 can understand. Alternatively, or in conjunction therewith, SSP1 can call DNN-SP1 for a service to format SSP1's dynamic credential into a form that SSP2 can understand. When SSP1 sends its request to SSP2, then SSP2 can interpret the dynamic credential using the registered services available to SSP2. SSP2 can use a binding service to bind the credential to SSP1's listing. Alternatively, or in conjunction therewith, SSP2 can use a broker service to convert the credential into a format that SSP2 can evaluate. Alternatively, or in conjunction therewith, SSP2 can call DNN-SP1 for a service to validate the credential and then call that service.

Adding Services to a Namespace Management System

Services can be registered with a Namespace Management System through configuration documents. The import service, for example, can be called to import a configuration document, and the configuration document can include a pdcx:service.register service call to register an available service.

A user of a Namespace Management System can use the Namespace Management System to request a configuration document, from a second Namespace Management System. In a second implementation, a configuration document is selected and downloaded to the computing device using a web browser. In a third implementation, a user enters a URL and the web browser renders a page including a graphic icon with an anchor tag reference. The user selects the icon (i.e., depresses and holds the left mouse button over the icon) and drags the icon into an input field of a second interface wherein the anchor tag is displayed as input for the input field. The process providing the second interface uses the input for the input field in a request to obtain the configuration document associated with the input. The process providing the second interface can be a web browser with a rendered HTML document containing a form. The action associated with the input field is to send a pdcx:request to the local compoint the Namespace Management System is listening on, wherein the Namespace Management System sends a request and receives a response that is saved as a configuration document, which can subsequently be imported by Namespace Management System. The service satisfying the request may optionally import the configuration document without saving the configuration document to disk.

A validation service is used to validate a configuration document. Information from the configuration document, such as its key, seal key, from.listing, document id, license information, and copyright information can be sent to a validation service. Configuration document providers can register their configuration documents with the validation service. When a configuration document is validated, then the document can be imported. Otherwise, the import service can notify the user that the document cannot be authenticated and the document can be discarded or manually accepted by user interaction. In a preferred implementation, a pdcx:config XML element is used with composite elements containing pdcx:service.register calls. The name-value pair attributes of the pdcx:config element are communicated to the validation service, which provides a response in XML format indicating the status of the request. One skilled in the state of the art can provide an alternative service to validate each pdcx:service.register call with a validation service.

In another implementation, a Namespace Management System may be preconfigured with pre-determined services, and the user will not be able to import configuration documents containing service registrations to the Namespace Management System if the configuration documents were not distributed with the Namespace Management System. In this implementation, the Namespace Management System may ignore the request and notify the user or silently ignore the request.

In another implementation, access to a built-in service can be temporarily disabled by registering a security setting with the Namespace Management System. This enables the user to set a high security setting for a configuration document, which prevents access to one or more built-in system services. This prevents a configuration document that is being imported from executing system services, such as delete, add, modify, call, connect, send, receive, or disconnect while registering the service. The security setting can be set for the duration of a service, such as for the duration of the import, and reset when complete. This can be automated by a service.

Compiling Configuration Document Services

The parsing service evaluates each representative statement of a configuration document within the semantic domain defined by the current state information. A statement can be represented internally as an abstract syntax tree record with the structure of the input insensitive to the grammar that produced it, thus making it easier to manipulate during translation. Given that each service is registered, and that the input types understood by the service are provided as named representations of data, the abstract syntax tree can be represented in an intermediate language format (ILF). The ILF can be encoded and persistent through operating system interfaces such as writing the ILF to a file. An ILF parsing service can then be used to import the ILF formatted configuration document. The ILF formatted version can be-reproduced if the modification time associated with the ILF version is older than the modification time of the non-ILF version.

The parser service validates the configuration document syntax and evaluates each statement within the semantic domain defined by the current state information, and this can result in one or more calls to registered built-in services having corresponding object code that was dynamically loaded. Using call by reference, a service can generate source code corresponding to the object code interfaces which can then be compiled and linked with the object code to create a stand alone executable.

Alternatively, the ILF format can be used to generate source code that can then be compiled into object code and subsequently dynamically loaded in the Namespace Management System.

Integrating with Existing Standards and Services

The Namespace Management System architecture enables interoperability with existing services and standards. A service that can communicate using standard I/O, for example, can communicate with the Namespace Management System. A service that can communicate using an Internet Protocol can communicate with the Namespace Management System.

In a preferred implementation, the Namespace Management System's service:main service can communicate using the Hyper Text Transfer Protocol. When the Namespace Management System accepts a connection on the SMTP compoint, it communicates using the simple mail transfer protocol. When the Namespace Management System accepts a connection on the pop3 compoint, it communicates using the post office protocol (version 3).

Namespaces can be administered with one or more Namespace Management System services configured to provide transformation services as part of, or in addition to, the built-in services to support one or more vocabularies expressed in XML. XML Schemas express shared vocabularies and allow machines to carry out rules made by people. They provide a means for defining the structure, content, and semantics of XML documents.

WS-Addressing

An endpoint reference consists of abstract properties including an address, where the address is a URI that identifies the endpoint as a network address or a logical address. WS-Addressing provides transport-neutral mechanisms to address web services and messages. The specification enables messaging systems to support message transmission through networks that include processing nodes such as endpoint managers, firewalls, and gateways in a transport-neutral manner.

The pdcx:request shown in FIGS. 3A and 3B can be sent using services adhering to the published W3C specifications, such as shown in FIG. 6. A Namespace Management System configuration document can register a wsa: internal namespace with services as defined in the WS-Addressing specification. The wsa:MessageID service, for example, can register the MessageID in the pdcx:current.request. The wsa:ReplyTo service, for example, can register the wsa:Address within the pdcx:current.request or other appropriate namespace listing. The wsa:To service can process or direct the request to the appropriate service.

In a preferred implementation, the SOAP Envelope is evaluated as a current pdcx:request where wsa:MessageID value is the messageID, the wsa:ReplyTo is the from.listing for synchronous request ir, the replyTo.listing for asynchronous request, and the wsa:Action is the service. A wsa:Address is evaluated as a listing. The evaluation is provided by a parser service calling services in the wsa: namespace to convert the request into a pdcx:request, which is then evaluated using the pdcx:request service. A pdcx:response can be communicated as a SOAP response. The parser service, or one of the wsa: namespace services, can register a response protocol for request, and the Namespace Management System can call the appropriate response service to format the results in the response: namespace as the response to the request.

In a second implementation, the parser service calls built-in soap services registered in an internal soap: namespace to convert a SOAP request into a pdcx:request that can be evaluated by the pdcx:request service. The parser service, or one of the wsa: namespace services, can register a response protocol for request, and upon satisfying the request, the Namespace Management System can call the appropriate response service to format the results in the response: namespace as the response to the request.

URIs

A Uniform Resource Identifier (URI) is an object that can act as a reference to a resource, where a resource is anything that has identity. A resource is not necessarily network retrievable, but the resource has identity. A Uniform Resource Identifier can be classified as a locator, a name, or both.

The term “Uniform Resource Locator” (URL) refers to the subset of a URI that identifies resources via a representation of their primary access mechanism (e.g., their network “location”) rather than identifying the resource by name or by some other attribute(s) of that resource. The URL is a standard for referencing web documents, and the predominant scheme is http. Other URL schemes include file, ftp, gopher, hftps, Idap, smtp, and telnet. URLs are transient and lack metadata to more accurately -identify an intended resource (such as author, creation date, etc.).

Various URL schemes have been proposed over the years describing alternative transport protocols. The Service Location Protocol defines network access information for network services using a formal notation. In the Service Location Protocol, a User Agent can broadcast a request for available services to Service Agents and can receive advertisements of available services broadcast by Service Agents. The User Agent uses this information to resolve a request for a particular type of service to the network address of the service. The service: URL is intended to allow arbitrary client/server and peer-to-peer systems to make use of a standardized dynamic service access point discovery mechanism.

The term “Uniform Resource Name” (URN) refers to the subset of a URI that is required to remain globally unique and persistent even when the resource ceases to exist or becomes unavailable.

The URI syntax is dependent upon the scheme. In general, absolute URI are written as follows:

<scheme>:<scheme-specific-part>

A URI can be assigned to anything that has an identity. The scheme portion of a URI is typically evaluated by a scheme handler that processes the scheme-specific-part of the URI to satisfy the request for a representation of the resource. Example schemes include:

a) file: scheme where the scheme-specific part is interpreted as a request for a representation of a file that is accessible either on the current computer or available through a file network protocol. If the reference is a full pathname to an executable on the local computer, such as file:///c:/winnt/system32/notepad.exe, then Microsoft Internet Explorer will automatically start that application, whereas the Mozilla Firefox browser will prompt the user that it is opening a file that is an application and allow the user to save the file to disk, but not automatically start that application.

b) http: scheme including an Internet domain name representing a server with a process accepting requests on the specified port (or default port 80), that interprets the path portion as a request for a representation of a resource.

c) clsid: scheme is used to reference a representation of a Component Object Model (COM) class.

d) ftp: scheme with a domain name representing a computer with a process providing file transfer protocol services.

A URI can be used with the Namespace Management System. A URI reference can be entered as:

http://pdcx.com/brenet:staff.member.brooke

The pdcx.com is a reference to a domain, and the service on port 80 at the Internet Address corresponding to the domain processes the request and sends a response. An HTTP server could respond with an HTML stream including a meta tag refresh to an accessible communication point, or the HTTP server could administer the communication and respond with the result. Such a server service can be provided by a Namespace Management System. Given that the Namespace Management System is composed of built-in services, one skilled in the art can add such services to an Apache HTTP Server (or equivalent).

Consider, for example, the interaction of a standard web browser. A user of a computer uses a Microsoft Internet Explorer browser and enters a URL (a URL is a subset of a URI) to request a representation of a resource. If the user-entered string does not contain a colon, then current browsers typically interpret the request as one or more keywords to send to a search engine service such as Google, Microsoft MSN, or Netscape's Search Engine. Otherwise, the browser attempts to apply a scheme handler to process the scheme-specific-part. Certain browsers will apply a registered default string as a prefix for the user-entered string, thus eliminating the need for the user to type http://, for example. A user may enter a reference to a local file using the file: protocol and the browser will open the file without the need for use of the Internet Protocol.

The Namespace Management System uses a scheme handler to interpret the scheme-specific-part as a uniform resource request (URR). As an example, the scheme name is “pdcx” and the request is given as pdcx:scheme-specific-part. In one implementation, pdcx: is a registered scheme handler. A URR is entered in a browser as: pdcx:call brenet:staff.member.brooke for MS stock quote, and the browser calls the scheme handler which directs an http: request to the local compoint of the Namespace Management System as an http request.

The Namespace Management System receives the request on its local communication point and interprets the request as:

<pdcx:request to.listing=”brenet:staff.member.brooke” service=”MS stock
quote”/>

The Namespace Management System then sends the request to brenet:staff.member.brooke namespace listing registered communication point, receives a pdcx:response, registers the response in the response: namespace, uses a pdcx:format.html built-in service to format the response as an HTML response to the browser, and sends the response to the browser.

In another implementation, pdcx: is a registered scheme handler. A URR is entered in a browser as:

pdcx:google.lucky cookies

and the browser calls the scheme handler which directs an http: request to the Namespace Management System local compoint as:

http://localhost:9915/pdcx:request urr=“pdcx:google.lucky cookies”

and the Namespace Management System uses a built-in service to receive the request on its local communication point. The service:main service splits the request into a service call and zero or more tokens. The service:main service attempts to bind the service call and determines that pdcx:google.lucky is not a registered service. It then translates the request to google.lucky and the request is interpreted as shown below, and the pdcx:request built-in service will use the binding service to bind the requested service.

<pdcx:request service=”google.lucky”
request:pdcx.parameter=”cookies”/>

In the aforementioned pdcx:request, tokens that are not in the format of name=“value” pairs are added as the value of request:pdcx.parameter, as shown above. Otherwise, name-value pairs are added to the request in the order specified.

In another implementation, the reference can be entered as a reference to a namespace listing, such as brenet:staff.member.brooke. The brenet: portion of the request is interpreted as a scheme, and the corresponding scheme handler service can administer the communications to satisfy the request. The scheme handler service can direct a request to the user's Namespace Management System, or to a Namespace Management System that the scheme handler service can communicate with, receive a response, and provide that response as the response to the URI request.

The scheme handler service can be registered by the Namespace Management System when importing a subscription response configuration document with a call to register the current point of presence for the Namespace Management System. For example, a configuration document containing <pdcx:epop.register listing=“brenet:staff.member.brooke”> indicates a request to register the current point of presence for the brenet:staff.member.brooke namespace listing. The pdcx:epop.register service can add the scheme handler for brenet: as an http request to the communication point for the Namespace Management System. For example, it could register the scheme handler to use “http://localhost:9921/pdcx:call %1” where the %1 is replaced by the URI reference that the user entered.

In a preferred implementation, pdcx: is registered as a scheme (protocol) handler that directs the request to the local communication point of a Namespace Management System, and in response thereto, the Namespace Management System receives the request, selects an appropriate service to satisfy the request, calls the service, and provides the response.

A Uniform Resource Request (URR) can be used with the Namespace Management System. The URR provides a simple and extensible framework for evaluating a resource request. The term “Uniform Resource Request (URR)” identifies a request for a resource via a representation of a namespace listing, rather than identifying the resource by name or by some other attribute(s) of that resource, such as a network location. A namespace is a representation of a reference to a service directory comprised of zero or more listings.

A listing is a representation of a reference to an entity in the namespace where an entity has a name and an optional value and may include composite members with each composite member being an entity.

A URR scheme is bound to a namespace. A designated service for the namespace, which may be distinct from the scheme handler, is called to resolve a reference to a listing within the namespace (if provided). When a listing can be bound to a built-in service, then the optional normalized named representation(s) of data describing the request are registered in a request namespace prior to calling the service, and upon completion of the call, the response (if any) is registered in a response namespace. When the listing can be bound to state information, that information is registered in a response namespace. A response service, which may be distinct from the scheme handler, can provide the content of the response namespace (if any) as the response to the resource request.

In evaluating a resource request, a system may perform a variety of operations to satisfy the request, as might be characterized by such words as: access, call, connect, disconnect, email, evaluate, export, exec, fax, find, fork, forward, get, import, locate, post, print, put, query, receive, register, remove, rename, replace, search, send, talk, trigger, update, verify, and so forth.

URR conforms to the generalized syntax of a URI, given as:

<scheme>:<scheme-specific-part>

The URR scheme is bound to a namespace. Following the namespace is a colon (“:”) delimiter. An optional listing precedes the scheme-specific-part. Thus, the syntax can be read as:

<namespace>:<listing><scheme-specific-part >

The optional listing is a representation of a reference to an entity in the namespace where an entity has a name and an optional value and may include composite members with each composite member being an entity.

The URR extends the subset of URI that share a common syntax for representing hierarchical relationships within a namespace through a “generic URI” syntax by introducing an optional listing following the <scheme>: portion, given as:

<scheme>:<listing>//<authority><path>?<query>

The optional listing is a reference to an entity in the namespace, and a delimiter can be used to reference a composite of an entity within the namespace. The optional request is comprised of one or more character sequences. A URR can be communicated using various URI schemes, such as the http URL. The URL, shown below, for example, is a URI where the path portion is a URR. The named representation of data, given by listing, is a representation of a reference to a second URR.

### EXAMPLE

http://localhost/pdcx:request service=“talk”

listing=“brenet: staff. member. pete”

The pdcx scheme is a representation of a Protocol for Discovery and Communication Exchange request. The general syntax is given as:

pdcx:<listing><request><?<search>>

The pdcx namespace is composed of entity information describing state information and available services for administering one or more URR schemes.

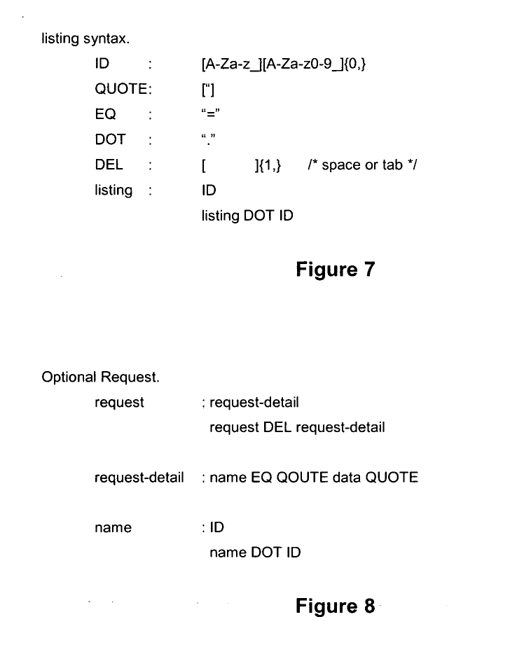

The listing is a reference to an entity relative to the namespace. An implementation can follow the syntax shown in FIG. 7.

The syntax of the optional request is dependent on the implementation but normalized as zero or more named representations of data. An implementation can follow the syntax shown in FIG. 8.

The syntax of the optional search adheres to that as defined in the http scheme in Uniform Resource Locators (URL) and is given as:

search= *[ uchar | “;” | “:” | “@” | “&” | “=” ]

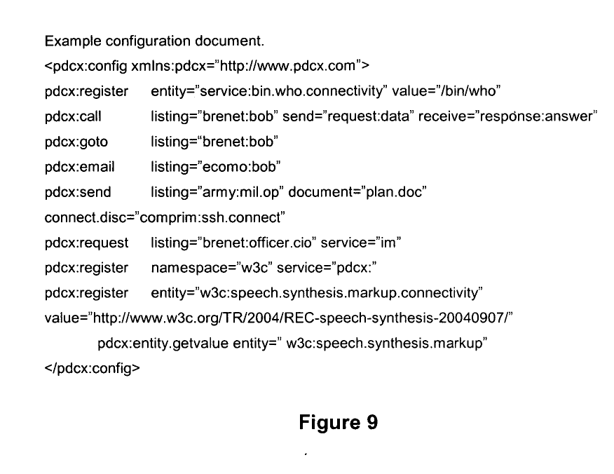

Initially, the pdcx scheme includes a service.register service listing in the pdcx namespace. This service is called to register additional service listings in the pdcx namespace, referred to as built-in services. Prior to evaluating the built-in service, the normalized named representations of data are registered in a request namespace, and upon evaluating the built-in service, a response namespace contains the response to the service request. The pdcx scheme does not in itself pose a security threat. Users should be aware that there is no general guarantee that a pdcx request, which at one time can be satisfied, continues to do so, and does not even at some later time yield a different result. An implementation is shown in FIG. 9.

The scheme-specific-part of the URR can be representative of a URR. For example, pdcx:call//brenet:staff.member.john. In this context, pdcx: is a scheme and call is a listing within pdcx, and the scheme-specific part is a reference to staff.member.john within the brenet: namespace.

Similarly, brenet:staff.member.john//service:im?m=hello can be interpreted as a request for the im service to be sent to the staff.member.john listing within the brenet: namespace.

Browser Search Strings

As a high level overview, Google, Inc. uses a googlebot web crawler to index HTML content corresponding to URLs, indexes the content, and provides a search engine service for users looking for web pages that satisfy their search request. The user typically uses a web browser, enters the URL http://www.google.com, enters their search request into the input text box shown in the web browser, selects the search button, and their browser communicates the request to the Google search engine, which responds, and the browser displays the results of the search request. Different search engines provide different results for the same search terms, and this is what differentiates the services that they provide.

A user of the browser enters a URL and the browser sends an HTTP GET command to the service corresponding to the Internet address and (default) port given. When the URL entered by the user does not include a colon (“:”), however, the browser treats the user-entered information as a search request, sending the user-entered information to a search engine service, and displaying the results for the user. Certain browser configurations and/or search engine services enable the first matching URL to be used as the result. Others, such as Avant Find, Microsoft MSN, and Netscape Search, provide html content containing a multiplicity of hyperlinks to URLs that can satisfy the search request.

Depending on the browser, the search engine service used, and browser configuration options either enabling or disabling searching, different results may be achieved. As shown in Table 2, the user entered URL as baby, and the browsers did not all display the same result.

TABLE 2

| | Operating | URL | Search Engine | |
|---|---|---|---|---|
| Browser | System | Word | Service | Resolves To |
| Avant | Windows XP | baby | Avant Search | Avant Find html content |
| FireFox v0.9.3 | Windows XP | baby | Google IFLS | http://www.babycenter.com |
| FireFox v0.9.3 | Apple | baby | Google IFLS | http://www.babycenter.com |
| | MacOS/x | | | |
| Mozilla v1.6 | Windows XP | baby | Ask Jeeves | http://www.baby.com |
| MSIEv6.0.2800 | Windows XP | baby | MSN Search | MSN html content |
| MSIEv5.2 | Apple | baby | MSN Search | http://www.baby.com |
| | MacOS/x | | | |
| Netscape v7.2 | Windows XP | baby | Netscape | Netscape Search html content |
| | | | Search | |
| Opera v7.54 | Windows XP | baby | | http://www.baby.com |

It is noted that the Avant browser allows a multiplicity of search engines to be used, but in no case does it automatically redirect to a URL listed in the search results. For example, entering “g baby” as the search request will cause the Avant browser to send a search request as an HTTP URL reference to the Google search engine, and the result of the Google search is then displayed by the Avant browser (this should have the same effect as entering http://www.google.com and then entering “baby” as the search term).

The disadvantage of tying a user-entered string to a search request and a particular service engine service is that the user has no control over the search results (other than providing the search string). That is to say, each search engine provides a response that it deems as the most appropriate from the search string (query string) entered by the user. Search engine sites such as Microsoft MSN, for example, allow for paid advertisements to appear at the top of their results based on the word(s) appearing in the user-entered search string.

Another disadvantage is that the user has no control over the URL rankings (sometimes referred to as page rankings). Google, for example, ranks babycenter.com higher than baby.com even though the search request was indeed “baby”. Another disadvantage is that the search engine service must first index (also known as web crawling or spidering) the URL content and rank the content. Given that the W3C standard organization does not promote the use of Internet addresses within URLs, and the problems of using DNS in dynamic environments, search engine sites typically do not include content from sites that do not have a domain name.

The Namespace Management System overcomes these limitations by providing a configurable service to evaluate the user-entered string as a request to be satisfied by the Namespace Management System.

In one implementation, a Windows XP operating system is used with a Namespace Management System configured to receive a request on the local communication point given as localhost port 80. The user, using a Mozilla FireFox browser on the Windows XP operating system, enters the URL as about:config. The browser displays a configuration page. The user selects the keyword.url and changes the default value from:

http://www.google.com/search?btnl=l%27m+Feeling+Lucky&ie=UTF-
8&oe=UTF-8&sourceid=firefox&q=

to:

http://localhostlpdcx:request service=uri. request&request=

When a user of the browser enters a string where the string does not include a colon, the request is directed to the specified address. Through a configuration document, the user can specify the Namespace Management System local communication point to correspond to localhost port 80. This enables the browser to send the request to the Namespace Management System, and the service:main service to use the http services to parse the request into a request that can be evaluated by the Namespace Management System, thus enabling a multiplicity of services to be available instead of a single search request to be interpreted by a single search engine.

When the user desires to use a standard search engine, the user could enter “search:for wireless phones” or “search for wireless phones” or use “s for wireless phones” and the request can be interpreted by the Namespace Management System as a request for a standard search through a search engine such as Google.

When the user enters “call pete”, the request can be interpreted as a pdcx:request for the call service to the unqualified namespace listing given as pete. The service could look up the unqualified listing to qualify it in a namespace (such as by using an address book service), or use a service such as the binding service to qualify the reference to a namespace listing. The service can then send a pdcx:request for default service to the corresponding namespace listing.

When the user enters “im pete”, the request can be interpreted as a request to use an instant messaging service to instant message pete. When the user enters “talk to pete”, the request could be interpreted as a request to initiate a VOIP session to pete. When the user enters “email pete”, the request could be interpreted as a request to initiate an email service to send pete an electronic mail message. When the user enters “sendto pete”, the request could be interpreted as a request to electronically send a document (or file, such as a photograph) to pete. When the user enters “auction search casio keyboard”, the request could be interpreted as a request to search an online auction for “casio keyboard”. For example, pdcx:request service=“auction.search” keyword=“casio keyboard”. When the user enters “new address”, the request could be interpreted as a request to add a new address to an address book.

When the user enters “flightnet usair.agent reservation”, the request could be interpreted as the URR flightnet:usair.agent//service:reservation.

One skilled in the art can register various services to interpret the user request, select a service to satisfy the request, call the appropriate service, monitor the service, and monetize and/or audit the service and its provisioning and consumption.

The browser source code can be modified to call the Namespace Management System with the user request. Alternatively, the browser source code could be changed to enable a multiplicity of services to be called until at least one of the services satisfies the request. Current browser technology does not appropriately distinguish a space character appearing after the first word and before a colon. For example, the FireFox browser interprets the user-entered string “call brenet:staff.member.pete” as a candidate URL since the string includes a colon. However, the embedded white space after the word “call” should indicate to the browser that the request is a user request that the browser should send to a service to satisfy the request.

The Namespace Management System service that receives the user request can use a natural language parser service to parse the request to determine how to satisfy the request. For example, if a first word can satisfy a built-in request (such as “call” satisfying pdcx:call), then the second word could be interpreted as an input type for that service. In the example of “please call pete”, the word “call” could be interpreted as a pdcx:call and “pete” interpreted as a reference to a namespace listing (which in this example would need to be bound to a fully qualified namespace listing).

A Namespace Management System service for interpreting a user request may generate a multiplicity of service requests in order to satisfy the user request. Each service request may be called until a service has satisfied the request. Alternatively, each service request may be called and the responses registered in the response: namespace of the Namespace Management System, and formatted by a formatting service to provide the response to the requesting process (the web browser). Services may be called asynchronously as appropriate.

The various communications between the Namespace Management System and the services may use a multiplicity of formats according to specifications, such as the W3C published specifications for web services. A service could interpret a communication adhering to a W3C published specification into PDCX Protocol statements that could be evaluated by the Namespace Management System.

The pdcx:call built-in service can be used to call a URR, which may be given as a URI. For example, pdcx:call urr=“http://www.pdcx.com/index.html” is interpreted as a call for a resource identified as index.html under the pdcx.com domain name. Similarly, pdcx:call urr=“brenet:staff.member.john/index.html” is interpreted as a call for a resource identified as index.html available from the Active Namespace listing given as brenet:staff.member.john.

Virtual Network Computing

There are several commercial VNC product offerings, as well as open source offerings for Virtual Network Computing, including TightVNC. TightVNC is a free remote control software package derived from the popular VNC software. With TightVNC, you can see the desktop of a remote machine and control it with your local mouse and keyboard, just like you would do it sitting in the front of that computer. TightVNC has a server process (server service) and a viewer process (viewer service). The viewer service connects to the server service to interact with the desktop for the computer that the server service is executing on. A user can use a browser to connect to the server service. A Java version of the viewer can be downloaded automatically.

The TightVNC server service can be registered with a Namespace Management System as a callable service. A user using a browser can enter a URR to connect to the TightVNC server service by namespace listing. For example, the user could enter the URR as:

pdcx:call listing=‘brenet:staff.member.charlie’ service=‘tightvnc’

When the Namespace Management System receives the request, it determines that the TightVNC server service is a registered service with a registered compoint (the Internet Address and Port that the server service is listening on). The Namespace Management System connects to that compoint and redirects communications between the server service and the communication connection on which it received the request.

To establish the connection, a multiplicity of Namespace Management Systems and their corresponding services can be used. In this manner, a service such as a web browser with access to the public Internet can connect to a VNC service provided through a Namespace Management System through one or more routing services by referencing the corresponding namespace listing.

The TightVNC server process can be configured to accept a VNC connection on a localhost socket, such as 127.0.0.1:3993, and the Namespace Management System receiving the request for VNC services can connect to that VNC connection. The Namespace Management System reads data from the VNC connection and writes the data to the compoint evaluating the request for the VNC service. The implementation is applicable to other server type services such as Virtual Private Networking, FTP, secure shell, and many others.

Using the Namespace Management System from the Microsoft Network Neighborhood

A listing can be added to the Microsoft Network Neighborhood so that, from Microsoft Word, a user can select File SaveAs and enter a listing as the file name. Similarly, the user can use the Print option to print the document to a listing.

When sending a request to print a document to a listing, portions of the content can be encrypted. A generic printer setting can be used and the content formatted and sent to the listing's Namespace Management System as a pdcx:request. The Namespace Management System receives the listing and sends the content to a printer device available to the Namespace Management System.

When sending a request to fax a document to a listing, portions of the content can be encrypted and decrypted as necessary through built-in services. Upon receiving the request, the Namespace Management System will retain the content until the printer device is available and will send the content to the printer device. Decryption of content can be deferred until the printer device is available. In this manner, the content can remain encrypted until sent to the printer device. The content can be removed from the Namespace Management System after the print has completed. An acknowledgement message can be sent to the requesting listing's Namespace Management System as a pdcx:request to indicate that the document has printed.

Namespace Listings and Participation

The namespace listing is used to identify a request. That is to say, a Namespace Management System sends a request and the request includes the leased namespace listing associated with the Namespace Management System as the value of the pdcx.from.listing in the pdcx:request. In a private leased namespace with configuration documents that preclude the use of the Namespace Management System with other leased namespaces, the user will be limited to subscribing and obtaining a listing within the private leased namespace. Otherwise, a user may subscribe and obtain a listing from a multiplicity of namespace provider services.

When a user has obtained a namespace listing within a first namespace from a namespace provider service, and desires to send a request to a service within a second namespace, the second namespace service can authenticate the request by sending a pdcx:request for authentication to the first namespace provider service. However, the second namespace service can administer an allow list and a deny list wherein when the first namespace provider listing is registered in the deny list; the request then will be denied without the authentication service being called. Similarly, if the first namespace provider listing is registered in the allow list, the request will be allowed if the authentication service can authenticate the namespace listing. The default action can be to allow, or to deny, as determined by the pdcx:registered.authentication.action.

When using the Namespace Management System in a private leased namespace, the Namespace Management System will typically be configured to preclude the user from obtaining and importing configuration documents that are provided by third parties. For example, the user will typically be precluded from importing a configuration document from http://www.hackers.com.

A user of the Namespace Management System typically subscribes to a namespace provider service to obtain a namespace listing. When the user's Namespace Management System is started, it registers its current point of presence based on the response to the earlier subscription request. The user may subscribe and obtain another listing in a second namespace where the second namespace listing includes a reference to the user's first namespace listing. In this manner, the user can participate in a multiplicity of namespaces where the listings resolve to the user's first namespace listing. When a service in the second namespace is sending a request intended for the user's Namespace Management System, the request can be directed to the second namespace listing, which uses the pdcx:redirect service to direct the request to the user's first namespace listing, which resolves to the user's current point of presence.

In a second implementation, the user subscribes to a multiplicity of namespace listings with each having a corresponding configuration document to register the user's current point of presence to associate with the listing. Each namespace that the user participates in is registered as an index of the pdcx:registered.edge.listing. When sending a request to a second namespace service in which the user has subscribed to the namespace, the corresponding namespace listing is used as the pdcx.from.listing value in the pdcx:request. Otherwise, the first listing registered in pdcx:registered.edge.listing is used. In this implementation, each namespace listing subscription has a corresponding pdcx:epop.registration service request in a configuration document (a single configuration document with a multiplicity of service calls for point-of-presence registration or a multiplicity of configuration documents can be used).

Note that in a private namespace, an end-user may be limited to a single DNN to which it can subscribe. Using the same Namespace Management System with a different set of configuration documents, however, the end-user may be able to participate in a multiplicity of DNNs.

Entity Resolution and Context Management

The service:, workflow:, and rule: namespaces have entity registration information describing the namespace entries. When a Namespace Management System is configured to permit configuration documents to be obtained and imported, there can be a conflict for names. For example, a first service:purchase can be registered by a first configuration document, and a second service:purchase (with different functionality) can be registered by a second configuration document as callable services.

In one implementation, the user and/or service providers will standardize the registration process to preclude such conflicts, such as by registering services relative to unique ids. In a second implementation, configuration documents that are imported from a service provider containing pdcx:service.register calls will always register the services relative to the service provider namespace listing.

In a third implementation, the service registration within the configuration document can prompt the user for a unique name for the service, similar to prompting for file name with the File—SaveAs option of Microsoft Word. The reference service=“{pdcx:prompt message=‘Enter the name for the service:’}” will cause a dialogue box to appear and allow the user to enter a name for the service.

When a service provider service is called, the service can call the pdcx:service.name.context service to set the context for subsequent references to services in the service: namespace. This context will be reset when the service provider service completes. In this manner, a first configuration document can be provided that permits the user to set a service name, and subsequent service references will be relative to the registered service name context, which may be a unique name specified in the service: namespace. For example, a first configuration document includes a service that the user names service:address.book. When the service:address.book service is called, the service obtains additional configuration documents that register additional services relative to service:pdcx.corp., and calls to services within the service:address.book service, such as service:phone.book, will be resolved as service:pdcx.corp.phone.book.

The preferred implementation is for service providers to always use namespace listings relative to their subscribed listing, even for configuration documents downloadable from a web site, and to use one service registration that the user selects the name for, which then sets the context for subsequent references.

DNN listing resolution is provided through a series of built-in services. The pdcx:call built-in service, for example understands the listing input type to be representative of a listing in a DNN (an Active Namespace) with an associated communication point. There are several implementations of the pdcx:call built-in service.

The first implementation sends a pdcx:lookup service request to the namespace provider to which the first Namespace Management System has subscribed. The response is then recorded as the communication point to which the pdcx:call should connect. The second implementation sends the call to the namespace provider to which the first Namespace Management System has subscribed, and the namespace provider service facilitates the call and sends the response. The third implementation uses a traversal service to traverse an internal namespace corresponding to the DNN listing. That is to say, a first Namespace Management System has a namespace listing of brenet:staff.member.pete, and is attempting to pdcx:call a listing of brenet:staff.member.frank. The first Namespace Management System starts at the parent listing of brenet:staff.member.frank and searches for a communication point that it can call (brenet:staff.member). If no communication point is found, it continues searching upwards in the namespace (brenet:staff and then brenet:). When a communication point is found, the Namespace Management System sends a pdcx:lookup service request to the communication point and receives a response indicating the communication point (if available). The first Namespace Management System registers the communication point in an internal namespace representative of the namespace to which the Namespace Management System is a member. The call is then placed to the communication point. When a Namespace Management System receives a lookup request, it determines if it can satisfy the request (if it has the registered communication point for the listing). When it does not, the Namespace Management System will call downward through the namespace until it can determine the appropriate communication point, or the possible searches have been exhausted.

In a fourth implementation, a binding method is registered for DNN listing lookups such that a built-in service can associate a communication point (if available) with a listing by calling the built-in binding service. The binding service can use the appropriate binding method to bind the listing to a compoint and register the compoint in a namespace. In a fifth implementation, the pdcx:registered.dnn.lookup is registered as a reference to a service, and that service is called with the DNN listing to be resolved. The response includes a communication point (if available) to be used for the connection. In a sixth implementation, a Namespace Management System calls a Root Resolution Service (similar to a DNS lookup) to locate the Namespace Management System administering the DNN namespace service. Existing DNS domain names can be used for the name of the DNN and, in that regard, the entire system interoperates with the existing DNS. An application program compiled to use only DNS, however, may not be able to discover the communication point of a namespace listing.

A user of a Namespace Management System registers with a first namespace provider and obtains a first namespace listing. To use a second namespace listing as a first namespace listing, the user will start a second instance of the Namespace Management System with the second namespace listing registered as the first pdcx:registered.edge.listing. The- second Namespace Management System will use compoints that are unique to the second Namespace Management System.

Logging

The service used by the Namespace Management System to administer a call to a built-in service creates a namespace and registers the entity information that is to be provided to the service into the allocated namespace. A logging service can be registered with the Namespace Management System, and that service will be called with the allocated namespace, its content, and the name of the built-in service that the Namespace Management System is going to call. The Namespace Management System calls the built-in service, and upon return, it deallocates the allocated namespace. The Namespace Management System will call the logging service with the returned status from the call to the built-in service. The logging service can log the name of the built-in service, the content that was provided in the allocated namespace, and subsequently log the returned status from the call. By logging the calls in the order received, and logging them as PDCX protocol statements, a document of the entire service interaction is then made.

One skilled in the state of the art can use the logging feature to provide a namespace, accounting, control, audit, and/or monetization service. One skilled in the art can add a playback service by providing the document containing the logging information as a configuration document to the Namespace Management System.

With the name of the built-in service, and the name of any parameter and value provided, and knowing that the built-in services are provided by a dynamically loadable module, a service can be constructed to parse the document containing the logging information and create a source code in a format and syntax specific to a particular language such that the source code can then be compiled to create an executable.

Proprietary and Open Source

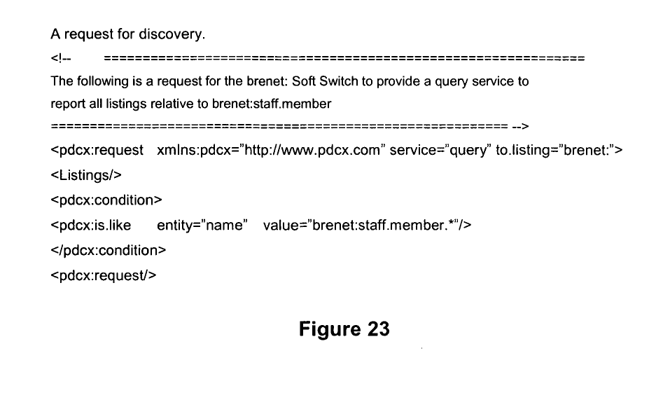

The use of plain text configuration documents ensures the user (or one skilled in the state of the art) can review the configuration document and the request that it includes. There are, however, foreseeable instances in which a configuration document may contain encoded information to prevent disclosure. The configuration document may include a section with encoded statements that can be decoded by a corresponding service. An encoded section of a configuration document can be registered as the value of an entity and subsequently made available to a service in its encoded form. A Namespace Management System receiving the request in FIG. 23, for example, would register request:encode with the value 010F0D023F1DCC5A6B and would call the service corresponding to the process.form service request with this information.

Namespaces and Services

Various namespaces have been implemented and contemplated. A first namespace and its service can be combined with one or more namespace services to extended the functionality of the services available to the first namespace.

Information in the namespace can be publicly available and thus does not require a Namespace Management System or sending of credentials or namespace listing to obtain that information. A web browser, for example, can be used to obtain and view information available from a namespace service. In another implementation, information in the namespace requires the requesting process to provide the DNN listing of the subscriber originating the request. In other implementations, the dynamic credential assigned during registration may also be required. In another implementation, portions of the communication are encrypted using built-in PDCX protocol statements or through a service that is callable by the Namespace Management System.

One skilled in the state of the art can combine the services of a multiplicity of namespace services into a single namespace service set to best satisfy the needs of the implementation.

Although a name for the namespace is provided, one skilled in the state of the art could apply a different name for the namespace as appropriate. Communications between namespace services can be encrypted with a built-in encryption service or a callable service. The service receiving the communication can decrypt with an appropriate service. When communicating a request, one or more portions of the communication can be encrypted and decrypted in traversing the request to an intended service.

In one implementation, a single namespace service can be used to administer the listings within the namespace. In a second implementation, a multiplicity of namespace services can be used to administer the listings within the namespace.

When the address is known or the domain name is known for a particular Namespace Management System, a browser may be used to connect to the Namespace Management System (with the built-in services and configuration documents). If, for example, there is a Namespace Management System executing on the google.com server, and the Namespace Management System can accept a connection on port 80, then the following URL can be used:

http://www.google.com/pdcx:request service=“search” content=“PH P”

The advantage to using the Namespace Management System architecture is that a request does not necessarily convey the idea of a hierarchical file system reference. Instead, it is a request to be interpreted by the Namespace Management System.

Consider, for example, the millions of web sites that require the user to browse first to their home page and then navigate from there. For example, when a user wants to lookup information at Google, the user uses the web browser and enters http://www.google.com. The web browser sends an HTTP GET command to the Google server and receives an HTML document that is then rendered by the browser (the Google Home Page). The home page includes a text input area through which the user can enter the search terms, such as “what is RFC1738”. When the server is running a Namespace Management System, the service:main service can determine the disposition of the request, which in this example is: “what is RFC1738”. Using the Google I'm Feeling Lucky Service, the search can be satisfied and a response sent to the user. In this case, the I'm Feeling Lucky Service response includes a meta tag refresh to redirect the user browser to an appropriate URL to satisfy the request.

Geospatial Namespace

Listings within the geo: namespace represent an extended set of geographic coordinates given as latitude, longitude, altitude, and time where time includes time of day and date with day/month/year and/or any other system of coordinates that can be abstracted from this extended set of geographic coordinates and used to create other systems and/or grids to define a unique location or locational vector or grid in, on, or around the planet Earth at a certain time or over time. (Intergalactic Namespaces can be created to contain any other planet or spatial body and the entire system of universes including celestial objects in the celestial sphere). In a preferred implementation, all four of the geographic coordinates are used, although the implementation may apply default values for one or more coordinates. The altitude or elevation may default to mean low sea-level as its datum plane or be the distance above or below another described datum plane. The time may default to the current date and time, which may be a standard such as GMT.

The listing geo:40d1 mN.105d17 mW would represent latitude 40 degrees 1 minute north, longitude 105 degrees 17 minutes west.

The listing geo:40d1 mN.105d17 mW.lft.23:12:12 would represent latitude 40 degrees 1 minute north, longitude 105 degrees 17 minutes west, altitude 1 foot above sea level, at time 23:12:12 on day Aug. 7, 2005.

When referencing a listing, a service may apply one or more services to convert the named values into a representation representative of the namespace listings used. The referenced longitude[105d17 mW], for example, may be interpreted as longitude[105.17].

One skilled in the state of the art can employ various representations of a listing to represent a unique location in space. Various representations of a listing may be used to represent different states of conditions at a unique location in space by combining location information with other listings.

A multiplicity of namespace services can be used to administer the geo: namespace. Listings within the namespace, for example, may be administered on computing devices distributed and operating in government facilities of the country in which the coordinate is geographically bounded. A multiplicity of listings in the geo: namespace may have an associated compoint administering that listing (and its associated groups, if any).

Although the geo: namespace is designed for real world coordinate mappings, it can be used to organize and support basic and advanced applications of RFID technology, where RFID tokens organized within the Geospatial Namespace can be used to track the location of people, animals, vehicles, goods, and equipment in any state of action, employ, use, design, manufacture, shipment, storage, display, and/or delivery. A military operation may use the geo: namespace for missile trajectory, or battlefield conditions, which may be real-time or simulated real-time. A fire department can access a geo: namespace and visualize blue prints of a building.

The geo: namespace may include one or more views, where a view is a service providing a view of the geo: namespace at a particular level of granularity. A zoom service can zoom the view in or out, providing finer detail on the content. The zoom service may provide a multiplicity of zoom levels.

The geo: namespace can be used for simulation environments, such as gaming, flight simulators, battlefields, or other such simulated environments.

Alternatively, or in conjunction, an edge computing device configured with an electronic device configured to communicate GPS information can be used to obtain GPS information that can be registered as entity information in a namespace. The GPS information can be used with other namespace services, such as for generating street maps, displaying aerial and/or satellite imagery, postal code translation services, and for services bounded within a geographic location such as lodging, entertainment, food, recreational, military, civil, or transportation services.

Visualization Namespace

The visualization: namespace can be used in association with the Geospatial Namespace for visualizing and modeling the state, location, and movement of objects that have associated locale information in two, three, or n dimensions. The listings represent an object within a bounded grid, which may be a two-dimensional grid, a three-dimensional grid, or an n-dimensional grid such as a geo: namespace.

The visualization: namespace uses a perspective service to change the visualization perspective of the object within the visualization: namespace. The service can provide intervals and specific time of observation while collecting and persisting the perspective, time series, and other information that can be used to instruct an observation. That is to say, the perspective (the view) is determined at a point of time from a point of origin in the grid looking at the object (a line of sight). Changing the perspective listing changes the visualization of the object.

One skilled in the state of the art can use a point of reference within the object as registered in the grid to construct the object for visual display when the dimensions of the object are known to the service providing the visual display.

A service may apply a force in time to an object registered in the visualization: namespace, and using a service to calculate velocity and direction, the object can move through the namespace by having its coordinates (its grid coordinate listings) change according to the service providing the calculations.

The changes to the visualization: namespace listings can be recorded and subsequently played back in sequence to provide a dynamic visualization of the object moving through the namespace. This visualization can represent a historical record of the state and movement of a tagged object over time and/or create a forward-looking projection of predicted state and movement.

World Nations Namespace

The nations: namespace contains listings representing countries and can include in association with the geospatial namespace their natural and political boundaries and sublistings of the internal political subdivisions and districts and their boundaries. A country will have an associated listing in another namespace, such as the geo: namespace. Each country: namespace listing may operate as a country namespace service with listings representing provinces and/or states. Similarly, each state listing may operate as a namespace service with listings representing districts, counties, townships, boroughs, cities, towns, and villages. A district: namespace listing may operate as a namespace service with listings representing highways, streets, transportation, and utility services. A street: namespace may operate as a namespace service with listings representing buildings and lots on the street. A building: namespace listing may operate as a namespace service with listings representing the structure, its contents, and its occupants. Any World namespace listing may have a listing in a geo: namespace.

Commercial Real Estate Namespace

The commercial realestate: namespace contains listings representing buildings managed by a representative agent, such as a landlord, building owner, or a real estate agency or agent. Each building listing may operate as a namespace service with listings representing floors. Each floor service may operate as a namespace service with listings representing rooms. Each room listing may have a namespace service with listings representing objects associated with the room, such as occupancy, occupants, one or more devices with namespace listings, and RDIF or appropriately tagged fixtures, furniture, and equipment.

A message received by a realestate: namespace service can forward the message to an intended occupant by referencing or searching for the occupant. The message can then be forwarded to a device in the occupant's room based on the namespace listing.

A maid/janitor can clean a hallway or a room and use a portable device to send a message including the real geographic coordinates for the hallway or room to indicate the area has been cleaned. Using the geo: namespace in conjunction with the realestate namespace, the listing associated with the area can be updated to indicate the maintenance state of the area.

Listings in the realestate: namespace can represent rental equipment equipped with GPS tracking devices. In one implementation, a listing can represent a boat. When the boat is leased, the boat's current location can be tracked through the geo: namespace listings corresponding to the boat listing.

The realestate: namespace can include services for financing, building inspections, and municipality certificate validations such as a certificate of occupancy service. These services can be provided through communications with one or more namespace services.

### Exemplary Implementation

Suburban Homes Realtor leases the suburban: namespace as a real estate namespace, and obtains configuration documents, the Namespace Management System, and their subscription configuration document. After installing the Namespace Management System, they configure their namespace communication point as www.shrealtor.com port 80.

A type definition for listings_t is registered using the pdcx:entity.typedef built-in service where the type is autoindexed and contains a street, city, price, and description. The suburban:listings is registered as a listings_t type of entity.

Jane, a realtor on staff, uses the Microsoft Internet Explorer on her Intel-based computer running the Windows XP operating system and enters the URL

http://www.shrealtor.com/newlisting.html

The newlisting.html describes a page that can be rendered by a browser. The page includes a multiplicity of input text boxes and Jane fills in the information describing a new listing to be added. Jane submits (selects the submit button) and the browser sends a pdcx:request for the add.listing service to the Suburban Homes Realtor's Namespace Management System.

The Namespace Management System receives the request and registers the provided information in the request: namespace including request:street, request:city, request:state, request:price, and request:description. For example, the request: namespace may contain city=“Matawan” and street=“2699 Rt 516” and price=“$460,000” and description=“2BR Ranch.”

The service:add.listing service uses the built-in pdcx:entity.setvalue service to register a new representation of the suburban:listings entity by calling:

<pdcx:entity.setvalue entity=”suburban:listings”
using.candidate=”request:”/>

Joe, a prospective buyer, uses his browser on his home computer and enters the URL http:www.shrealtor.com/ which is sent to the Suburban Homes Realtor's Namespace Management System as a GET/HTTP/1.1 HTTP command. The Namespace Management System recognizes that the path is “/” and uses the pdcx:format.html.response built-in service to format the registered listings for his review. The call is:

<pdcx:format.html.response entity=”suburban:listings”/>

Household Namespace

Each household may organize itself under a Namespace and provide listings to incorporate family members, other properties, boats, vehicles, collections, appliances, computational devices, antiquities, jewelry, software programs, and valued possessions of all types.

Listings in the household: namespace can represent all the family's members' cars with their associated geo locations (the vehicles in this case are wired with GPS systems and wireless connections). Another listing can represent the entire family's music collection across all of their storage and playing devices. When part of the family is traveling to its lake home, the rest of the family can track the traveler's location through the location of their car and, at the same time, the traveling members can access the family music collection on the city home system and then play the music locally.

Define Namespace

Listings in the define: namespace represent words, phrases, technical terms, medical terms, political terms, judicial terms, and technology terms. A reference to a listing returns the definition associated with the listing. A language preference may be specified and the definition provided in the desired language. A locale may be specified, such as when used in conjunction with the geo: namespace, to give precedence to a definition based on the locale in which the request was generated.

A NYSE or Listed Exchange Namespace

Stock and other tradable financial instrument listings in the Listed Financial Exchange namespace would be representative of each of the stocks and/or instruments traded on the New York Stock Exchange and/or other exchanges. For example, PDCX:NYSE.IBM.Common would be the listing for IBM's common in a NYSE namespace, a private transactional namespace where an exchange like the NYSE would list all the traded instruments listed on the exchange. The namespace can be deployed as part of a strategy to fully virtualize the specialist's function, moving the specialist to the role of market maker and namespace listing operator. In the case of an exchange like the NYSE and other auction markets using the specialist structure, listing a stock/instrument in the exchange namespace will allow the specialist to continue to manage and extend the business of trading the listed stock/instrument through the namespace.

The IBM listing in a NYSE namespace allows the exchanges, the specialists, market makers, and brokers on the floor and upstairs to have fully auditable control over the participants in the IBM market who are off the floor and who have access to the floor or transactional opportunities off the floor through the namespace. Specialists can each organize and coordinate their own books providing full disclosure of order information to the market place. Each participant can participate anonymously in transactions with the floor and exchange information that relates to transactions taking place on an exchange floor, as well as create markets off the floor that can be brought to the floor for execution. Parties off the floor can participate directly with the floor. The physical and/or virtual specialists on the exchange and traders can conduct business and communicate directly through the Namespace to participants who want to trade IBM, those participant systems, and their devices. Individual stock-related information can be exchanged among market participants who have expressed interest in a certain type of transaction around an individual stock or instrument or a portfolio of instruments. Transactions can be structured and auction markets created with the namespace. This information can be distributed over existing network infrastructure and can be made available using serverless web page publishing through the Namespace to bring all interested parties to the market at the point when a transaction with certain volume and price constraints can be completed. Transactions can be conducted directly through a namespace using the exchange's existing networks and order management systems and/or the participants existing networks and systems when all are connected through the system of Namespace Management Systems.

One skilled in the state of the art can create and administer namespaces for any securities and/or futures exchange and/or any auction market. This includes such organizations as the Chicago Mercantile Exchange, the Chicago Board of Trade, the CBOE, the AMEX, and other foreign and domestic securities and commodities, and insurance exchanges.

Auction houses and market places such as Christies and Sotheby can also use namespaces. High-stakes gambling and wagering exchanges can also be organized using a multiplicity of software switches and namespace listings.

Academia Namespace

The academia: namespace contains listings representative of objects, people, services, and facilities related to academia. This may include grades, courses, staff, textbooks, fees, students, equipment, and academic requirements, among others. Within the namespace, a grade may represent a year of schooling, such as first, or sophomore. Within a grade may be a homeroom with an associated instructor and student enrollment. A student may have his or her own listing in the academia namespace.

The namespace and its services can be used to determine course requirements, fees, available instructors, location, work assignments, schedules, and other similar activities. Course work may be submitted by a student to the instructor through the system. A student may operate a Namespace Management System to obtain and participate in current activities related to the year, course, instructor, or activity. A student may send electronic mail intended for a listing representing a student, and the second student can accept or reject (deny) the request.

Physician Pharmaceutical Service Namespace

The pharmacist: namespace contains listings representative of pharmacist. A pharmacist with a Namespace Management System can register in the namespace.

A doctor using a Namespace Management System can participate in the pharmacist: namespace by obtain a listing, or being authorized to communicate with services in the pharmacist: namespace.

A patient is registered and assigned a unique identifier (a listing). In one implementation, the patient is registered in the pharmacist namespace. In a second implementation, the doctor registers the patient with a namespace service. In a third implementation, the patient subscribes to the pharmacist: namespace to obtain a listing. In a fourth implementation, the patient's insurance carrier registers the patient with a namespace service. The patient visits the doctor and the doctor prescribes a medication for the patient. The doctor uses a Namespace Management System to send the prescription as a request to a pharmacist in the pharmacist namespace. The request includes the prescription information, and unique identifier for the patient, which may be a namespace listing, credential, or other information to uniquely qualify the patient.

Upon receiving the request, the pharmacist Namespace Management System provides the request to the pharmacist, and the pharmacist can optionally identify a pickup time and a price. The patient may use a Namespace Management System to determine when the prescription will be ready and the cost. The patient visits the pharmacist and supplies their unique identifier to the pharmacist. The pharmacist uses the Namespace Management System to identify the correct prescription and provides the same to the patient.

Doctor Namespace (Professional Namespace)

The doctor: namespace contains listings representative of doctors. A doctor's practice may have a namespace service with an associated listing. The practice may have additional listings representing patients. The practice may register specialties, accepted insurance programs, current availability, location, and other information of interest to patients. A practitioner may register their vita, seminars attended, presentations, medical journal entries, and the like.

A prospective patient can use the doctor: namespace services to locate a doctor that accepts the patient's insurance provider. Criteria for selecting the doctor may include availability, location, specialty, and other criterion specified by the patient. A prospective patient can subscribe to the doctor: namespace service to obtain a listing, schedule an appointment, review account information, check payment information, make payments, register preferred pharmacists, obtain medical records, request referrals, and obtain referrals.

Loan Namespace

The loan: namespace contains listings representative of commercial lenders, consumers, commercial entities, government agencies, such as a municipality or a department within the municipality, and loan applications.

A consumer uses the namespace service to submit a request for a loan to one or more commercial lenders. The commercial lender service receives the request and registers the application. Various lenders can apply different criteria for determining if they wish to accept the application. Similarly, lenders can apply different services for determining if and when to deny an application. Through a creditcheck: namespace service, the lender may obtain credit information about the applicant and use that information in the decision-making process.

Through a namespace service, the lender can obtain information from a municipality about a property for which the loan application is being considered, to determine if there are problems with the property, such as no certificate of occupancy, delinquent taxes owed, hazardous waste, or flooding problems.

When a construction loan is being requested, the lender can obtain information on the general contractor to determine reliability, claims that have been filed against the contractor, claims that have been paid, and other information to be used in the decision-making process. When a car loan is being requested, the lender can obtain the service history of the car, recall information, repossession information, and other information to be used in the decision-making process.

Classified Namespace

A namespace can be used to expand any publication's number of classified, personal, and commercial advertisement placements. Customer satisfaction can be improved through results that are geographically bounded within a region specified by the customer. The namespace allows the publisher to define a new relationship with, and increase revenues from, subscribers and classified advertisers, as well as from commercial, professional, and personal advertisers in the publication.

The use of a namespace will allow a publication to use its existing infrastructure to provide trusted, classified advertising listing and auction services with complete transactional services. A publication will be able to create new, open, and dynamic communications to conduct more valuable transactions with its entire subscriber and advertising base. A publication will be able to communicate with each subscriber in a manner where those subscribers can discover and advertise services directly through the namespace. If a publication provides NSP and/or cable services, a user can use those offerings across existing Internet Protocol-based networks by deploying those services through the namespace.

Publications can use a namespace to aggregate and distribute classifieds and also expand the use of classifieds services by creating a hierarchy of private classified service listings under the publications: namespace. Publications can organize classified ads and advertisers, as well as organize the readers and subscribers to both the paper and digital versions of the publication under different listings in a namespace, each with different service levels. Publications can organize these listings under local, national, and global service communities made up of their known subscribers. Subscribers will be able to create ad-hoc trusted communities within any publications: namespace, and all subscribers so authorized will be able to communicate with other subscribers through the namespace.

A namespace allows a publication to expand the number of services that a publisher can offer readers, subscribers, and advertisers in their community. Publishers can also make a new business of offering household namespaces and small business subscriptions. Households and small businesses can organize their members and communications under their individual household: namespace. With namespace publishing, an organization can provide a new dynamic classified advertising service where the publisher can provide services that allow for anonymity and for the completion transactions between their communities of subscribers. The publication can earn fees from the additional transactional services. Publications will also be able to provide their own branded local auction services. Publications will be able to compete directly with E-bay by providing the auction: namespace services to subscribers placing classified advertisements. Publications can offer these services on top of their existing network infrastructure with no need to develop extensive expertise, software, and/or hardware assets. Publications configure their private network namespace services using XML documents. Publications can also use a namespace to provide expanded clipping services at lower cost and offer to monitor, capture, decompose, disintermediate, and then re-aggregate or enrich specific relevant information about any item in any digital editions.

Classified Advertisement Service

The Internet provides various venues for classified advertisements. Some venues provide means of advertising items for sale by a specific category, such as autotrader.com, which lists classified advertisements for automobiles, and boattraderonline.com, which lists boats for sale. These venues operate on the same model as traditional newspaper classified ads by charging an insertion fee for listing for a specific time period. If the item listed does not sell within the specified time period, the seller has the option to pay for another insertion to re-run the advertisement.

Users of existing Internet classified services are constrained by the limitations of the format of the web sites run by each individual service and have very little control over the content. Often, the services offer varying levels of advertisements with each level providing more features, such as photographs and more detailed descriptions, with the cost of insertion increasing with each level of features. The Namespace Management System can be used to implement a classified advertisement service that overcomes the limitations of current practice. The Namespace Management System provides subscribers listings in the public registry namespace. Each listing includes one or more communication identifiers to uniquely qualify a listing, and listings can be further qualified with the use of name-value pairs.

Other subscribers locate listings in the public registry through the use of a computing device that uses an interactive service to send a query to a namespace communication point whose service uses one or more built-in services to satisfy the request and communicates the response to the user interactive service. In response thereto, the interactive service displays the response to the user. In one implementation, the response may include a single listing, and in a second implementation, the response may include a multiplicity of listings from which the user can select.

### Exemplary Implementation

The following provides an exemplary implementation. The implementation is implemented with the public namespace registry, a multiplicity of Namespace Management Systems, and configuration documents.

Harry J. Vadorche subscribes to the public namespace registry as public:harry.j.vadorche. When subscribing to the public namespace registry, and upon satisfying the subscription criteria, he is provided a Namespace Management System, configuration documents, and a subscription configuration document that he installs on his computer as a second Namespace Management System.

When Harry decides to sell his sport utility vehicle, he elects to advertise the vehicle for sale by using the public namespace registry and a classified advertisement listing service. He does so by modifying his public namespace registry listing to indicate that he has a vehicle for sale. He consults a web site that contains public services and searches for one that provides a classified advertisement listing service for an automobile.

He selects a service and downloads the associated configuration documents to his computer. He then uses the built-in pdcx import service to register the downloaded classified advertisement listing service via the pdcx:service.register service. The pdcx:service.register service registers a type definition for vehiclead_t using the pdcx:entity.typedef built-in service where the type is autoindexed and contains a vehicle type, make, model, year, mileage, exterior color, engine type and size, transmission type, number of doors, location, asking price, and description.

Once the classified advertisement listing service is registered with Harry's Namespace Management System, he then opens his web browser and connects to the Namespace Management System via the local communications point, and the browser displays a page with a multiplicity of registered pdcx services and a multiplicity of hyperlinks to invoke each service. The hyperlinks include a ‘servicename.html’ corresponding to the HTML file that is associated with the pdcx service, and a ‘Service Name’ corresponding to the description of the pdcx service as shown below:

<A HREF=”servicename.html”>Service Name</A>

By way of example, the following HTML statement represents the hyperlink for the automobile classified advertisement service:

<A HREF=“html/classad.html”>Automobile Classified Advertisement</A>

Using the mouse pointing device, he selects the automobile classified advertisement listing service from the multiplicity of registered services by using the left mouse button to click on the associated hyperlink, causing the browser to load and render the HTML file associated with the hyperlink. In the case of the automobile classified advertisement listing service, the browser displays a page with a multiplicity of classified advertisement listing maintenance functions and a multiplicity of hyperlinks to invoke each function. The hyperlinks include a functionname.html corresponding to the HTML file that is associated with the service function and a FunctionName as the name of the service. The format is given as:

<A HREF=”functionname.html”>Function Name</A>

By way of example, the following HTML statement represents a hyperlink for the automobile classified advertisement service functions:

<A HREF=”html/classad_add.html”>Add a new classified ad</A>

Similarly, the following also represents a hyperlink for the automobile classified advertisement service function:

<A HREF=” html/classad_revise.html”>Revise an existing
classified ad</A>

Similarly, the following also represents a hyperlink for the automobile classified advertisement service function:

<A HREF=” html/classad_remove.html”>Remove an existing classified
ad</A>

Harry then uses the mouse pointing device to select the automobile classified advertisement service function named “Add a new classified ad” by using the left mouse button to click on the associated. hyperlink, causing the browser to load and render the HTML file associated with the hyperlink. The browser displays the new classified advertisement listing page, which includes HTML statements and pdcx statements. The HTML statements define a form that includes input fields for providing data for the classified advertisement. The HTML statements also contain a “submit” action that includes an HTML POST statement in the following format where servicename corresponds to the “add new classified ad” service:

<FORM method=”POST” action=”/pdcx:request service=’servicename’”>

He uses the mouse pointing device and keyboard device to navigate through the input fields on the form and either select from pre-defined lists or types in information. In one implementation, he selects “Sport Utility Vehicle” from the item category type field which contains a multiplicity of vehicle types; in another implementation he types “SUV” in the item category type field. Continuing to fill in the form, he either selects from lists or types in other information about the vehicle to be sold, including the make, model, year, mileage, exterior color, engine type and size, transmission type, number of doors, location, asking price, and description. When done, he uses the mouse pointing device to click on the “submit” action. The browser retrieves the data from the form fields and sends the pdcx request to the local compoint that the Namespace Management System is listening on. The Namespace Management System receives the request and registers the provided information in the request: namespace including request:vehicle-type, request:make, request:model, request:year, request:mileage, request:exterior_color, request:engine_type, request:engine_size, requestjtransmission_type, request:number_doors, request:location, request:asking_price, and request:description. For example, the request: namespace may contain vehicle_type=“SUV”, make=“Jeep”, model=“Grand Cherokee”, year=“1999”, mileage=“52,400”, exterior_color=“Black”, engine_type=“V8”, engine_size=“4.0L”, transmission_type=“automatic”, number_doors=“4”, location=“Philadelphia”, asking_price=“15,000” description=“Second vehicle, only driven by an old lady to church on Sundays.”

The service:add.listing service uses the built-in pdcx:entity.setvalue service to register a new representation of the public:vehiclead entity by calling:

<pdcx:entity.setvalue entity=“public:vehiclead” using.candidate=“request:”/>

Joe, who is looking to buy a used sport utility vehicle, uses his browser on his Windows XP home computer to search for public automobile classified advertisements in his geographic area. He opens his web browser and connects to the Namespace Management System via the local communications point, and the browser displays a page with a multiplicity of registered pdcx services and a multiplicity of hyperlinks to invoke each service. The hyperlinks are of the following format where ‘servicename.html’ corresponds to the HTML file that is associated with the pdcx service, and ‘Service Name’ corresponds to the description of the pdcx service:

<A HREF=”servicename.html”>Service Name</A>

By way of example, the following HTML statement represents the hyperlink for the automobile classified advertisement search service:

<A HREF=”html/classad.html”>Automobile Classified Advertisement
Search</A>

Using the mouse pointing device, he selects the automobile classified advertisement search service from the multiplicity of registered services by using the left mouse button to click on the associated hyperlink, causing the browser to load and render the HTML file associated with the hyperlink. In the case of the automobile classified advertisement search service, the browser displays a page which includes HTML statements and pdcx statements.

The HTML statements define a form that includes input fields for providing data for the classified advertisement search. The HTML statements also contain a “submit” action that includes an HTML POST statement in the following format where ‘servicename’ corresponds to the “classified advertisement search” service:

<FORM method=”POST” action=”/pdcx:request service=’servicename’”>

He uses the mouse pointing device and keyboard device to navigate through the input fields on the form and either select from pre-defined lists or type in information. In one implementation, he selects “Sport Utility Vehicle” from the item category type field which contains a multiplicity of vehicle types; in another implementation he types “SUV” in the item category type field. Continuing to fill in the form, he either selects from lists or types in other information about the vehicle to be searched, including the make, model, year and location. When done, he uses the mouse pointing device to click on the “submit” action. The browser retrieves the data from the form fields, and sends the pdcx request to the local compoint that the Namespace Management System is listening on. The Namespace Management System receives the request and registers the provided information in the request: namespace including request:vehicle_type, request:make, request:model, request:year, and request:location. For example, the request: namespace may contain vehicle_type=“SUV”, make=“Jeep”, model=“Grand Cherokee”, year=“1999” and location=“Philadelphia”. The Namespace Management System recognizes that the path is “/” and uses the pdcx:format.html.response built-in service to format the registered listings for his review.

News Namespace

The news: namespace permits for the dynamic presentation of targeted information and news gathered through the dynamic aggregation and collection of specific information and news from sites Where the search of those sites for information is conducted automatically and where those site's pages are continuously monitored for structural and content change. The news: namespace can make the metadata about that specific targeted and aggregated information available and/or present for both the metadata and the targeted information for review.

News: namespaces provide users a focused selection function that allows them to use the namespace to look at many sources of news and to capture only news they are most interested in, in real-time. A user could look at every article about global warming in today's Financial Times without having to visit the Financial Times website.

News: namespaces can also be used to provide decentralized news discovery services where networks of independent writers would use services that are accessible to web search engines to distribute their stories and reach the public more efficiently than traditional media.

News: namespaces can be organized for independent writers and reporters. These namespaces would allow a loose linking among professional writers and reporters where topics and region would be distributed to the authors by auction, where writers would be paid from subscription proceeds to the News: namespace, and by the number of readers that they attracted, where no corporate publishing entity would exist. The accredited freelancers organized in namespaces could provide more spontaneous, exciting, and complete coverage than a traditional media company. All search engines would automatically promote namespace articles.

Calendar Namespace

The calendar: namespace provides services for determining days and dates for the purpose of recording past events and calculating days and dates for future events where days and dates are based on the modern calendar system involving 12 months in a year, and 365 days, 5 hrs., 45 min., and 46 sec., in a year, with three years of 365 days and a forth of 366. Other calendar systems can be used as well. The calendar: namespace time stamp can synchronize and calibrate time and dates across all namespaces using a time code format similar to the one used by Automated Computer time Service (ACTS) as shown below:

JJJJJ YR-MO-DA HH:MM:SS TT L H ms ADV UTC (NIST) OTM

Theater Namespace

The theater: namespace includes listings representative of theater objects, such as plays, movies, and concerts. A user can select an object and, through the Namespace Management System, obtain on-demand viewing and/or playback of the object. The service providing the streaming content can add identification information unique to the current stream, and this information can then be used for tracking purposes. The service provider may provide the streaming content only to authenticated namespace users. This may require a user to obtain a listing with the service provider's namespace, or be authenticated with a namespace listing that the service provider can verify.

Restaurant Namespace

The restaurant: namespace contains listings representative of objects typically used and provided for in the restaurant industry. Additional listings of available restaurants, bounded by geographic region, can be obtained. Each restaurant may have a listing and a namespace service through which they provide information about their restaurant services. Menus, kids' menus, pricing, seating capacity, reservation requirements, reviews, chefs, delivery services, supplies bendable straws, hours of operation, directions, and other information can be registered and provided through namespace services. A user can set criteria for selection and browse the restaurant namespace viewing those listings that satisfy the request. Through the namespace services, a user can view a restaurant.

Subscribers to the restaurant: namespace may be provided additional benefits, such as reservations, reservation by table number, or location, discounts, account information, co-branded services, and special menu options. Namespace Management System users can be authenticated through the Namespace Management System, and a restaurant can use this information to provide specific services only to authenticated users.

Bookstore Namespace

The bookstore: namespace contains listings representative of objects typically available at a local book store, such as books, magazines, audio books, and compact discs. The namespace can include listings for bookstore providers such as Barnes and Noble or Amazon. The user is presented a menu choice and selects a listing to obtain additional information. When the user determines to make a purchase, the user selects the item or items of interest and sends their user listing information to the provider. The provider verifies the request and sends a request for payment information to the user's Namespace Management System. The user's Namespace Management System receives the payment request and prompts the user for their payment information. If, however, the user had already registered their payment information with the Namespace Management System and registered auto.pay enabled, then the payment information would be sent without prompting the user. Otherwise, the user is prompted for their payment information, which is then sent to the service provider. Upon receiving the payment information, the service provider generates billing (preferably through a billing service such as paypal) and sends a confirmation message to the user.

The current web sites for book providers such as Amazon, Barnes and Noble, and Borders Bookstore do not provide inventory information for particular stores. Of the three, only Borders allows a user to request a book and a particular store that they want to pick it up from. The user must key in location information such as city, state, zipcode, and driving distance. When the user selects a particular book for pickup, they do not know if the book is in stock or not. Instead, they can receive a message stating: “The title you have selected must be special ordered from the publisher or label” and that special orders usually arrive at the store within one to six weeks. In the several titles tested, all reported the same response. Alternatively, a message stating: “Please wait until you receive an email confirmation before going to the store to pick up your merchandise, as inventory information does not reflect recent store sales” is received.

The challenge for most retail chain outlets is one of managing inventory. If a single web site is used, such as www.barnesandnoble.com, then control of inventory is usually managed by databases accessible to the web interface. With namespace listings, however, each store can have a Namespace Management System with listings representing their current inventory. This will enable a user to browse through the inventory to see if a particular item is in stock. The user could request a reservation on an item that is in stock, request to be notified when an item is re-stocked, or purchase an item through the Namespace Management System and arrange delivery, which can be a pick-up.

The bookstore: namespace listings can be organized as appropriate for the implementation. In one implementation, a first Namespace Management System uses bookstore:BarnesAndNobel and bookstore:Borders. A second Namespace Management System uses bookstore:provider.BarnesAndNobel and bookstore:provider.Borders, and a binding method that binds first level references that cannot be found to listings relative to bookstore:provider. The binding method is registered through a configuration document with a pdcx:service.register service call.

The bookstore: namespace includes services related to bookstores. These include a search service to locate works by an author, isbn, title, publication date, edition, and related works. Contact information (including listings) for the provider, the author, shipping, and customer service is provided where available. Pricing information and promotional advertisements can also be registered, such as free shipping with orders over $50. Information about a nearest location can be provided so that the end user can select a book and send a request for the nearest bookstore with the book in stock. Using a mapping service such as that provided by www.mapsonus.com, driving instructions can be provided. A user can set criteria such as a maximum price, maximum driving distance, or shipping cost that the user is willing to pay, and such criteria can be used in querying the namespace to determine the best answer to satisfy the user's request.

Vmall Namespace

The vmall: namespace and associated services relate to a virtual mall with listings representing objects within the mall. The namespace provider (vmall operator) can use a vmdesigner service to construct the vmall using objects such as main hallways, atriums, entrances, exits, exhibits, displays, retail storefronts, information desk, entertainment facilities, and rest areas. The vmdesigner service provisions the vmall: namespace, and one or more services can be registered for the respective listings. The vmall and its associated services can work in conjunction with a geospatial namespace and its services.

Once constructed, the vmall operator can rent virtual retail shops to merchants. The owner/operator will presumably charge more for larger space and for spaces strategically located near main entrances. A vmall can have more than one entrance/exit. When a user wants to shop at the vmall, a service can randomly choose an entrance for the user to enter. In this context, the operator may charge a premium for shops located at an entrance. After the basic layout has been completed, the vmall operator can add objects to the vmall. Window displays, main hallways, entrances, exits, exhibits, displays, retail stores, and entertainment facilities can be added by the operator.

The operator can lease a namespace listing representative of an object a user can enter, such as a retail store, a theater, gaming area, kiosk, or rest area. The leased area can be provided by a Namespace Management System service administering listings of objects within the leased area. This can include merchandise, displays, advertisements, and other objects that can be described through the namespace.

A user computing device can use a visualization service to navigate through the vmall. When a user traverses through the namespace, they are connected to an appropriate listing based on the coordinates of the user within the vmall. Through the interface, the user can select one or more goods, examine the goods, view pricing information, product descriptions, and gain additional information as may be provided through the service. The service can also include a checkout service so that a user may pay for goods and/or services, and ensure proper shipping instructions. Payment can be provided through a payment service, or by the vendor sending a pdcx:request for payment to the user's Namespace Management System, which can display the information and allow the user to select an appropriate payment method. The user completes the request and submits the response back to the vendor who facilitates the payment transaction.

When entering a vmall theater, a user may select a movie to view, optionally make a payment through a payment service, and view the movie through their Namespace Management System. The selection of the movie may require a media player service available on the user's computing device, such as the Microsoft Media Player. The selection of the movie can connect to an appropriate listing providing the movie as a stream of data that is sent to the user's media player service.

Additional services can be added to the vmall: namespace. A mini map viewing service, for example, can be added to render a first location within a scaled down view of a second location, such as user location within a vmall. A directory service can provide information for a visualization service describing the content of the geographic area, such as graphic icons representative of the stores within a vmall that, upon the user selecting the icon, the user enters the corresponding location. An assistant service can be added to provide automated responses to user questions, or live operator assistance through an instant messaging service.

Medical Transcription Namespace

Current practice in the health care industry includes a significant amount of outsourcing of medical transcription by providers to transcription service firms. Instead of maintaining a staff of transcriptionists on the payroll, health care providers have found that using a transcription service is more cost effective. These transcription services have taken advantage of the ease of file transfer that the Internet provides, and commonly operate by receiving digital voice files from providers, transcribing the dictation, and returning a transcribed document to the provider in a common word processing file format.

Current implementations that employ password protected access, such as HTTPS, FTP, etc., fall short of this requirement as it is possible for unauthorized access to be gained by using techniques that use brute force to decode passwords or other password detection methods. Likewise, section 164.312 Technical safeguards (e)(1) Standard: Transmission security requires that entities “Implement technical security measures to guard against unauthorized access to electronic protected health information that is being transmitted over an electronic communications network.” Current implementations that use HTTPS, FTP, etc., fall short of this requirement as they do not guarantee that only desired points of presence on the Internet are able to gain access.

The Namespace Management System can be used to overcome these limitations. A Medical Transcription Service employs a Dynamic Network Namespace that is comprised of members including the transcription service provider, who administers the namespace, and many health care providers. The transcription service provider subscribes to a Network Namespace Root Service and leases a namespace from the Network Namespace Root Service. The namespace provider uses a Namespace Management System to provide a namespace provider service to the transcription service provider, who is responsible for administering the leased namespace.

An end user, the health care provider, subscribes to the namespace provider service to obtain a listing within the leased namespace. This namespace listing represents an edge listing in the namespace and does not permit subscriptions relative to its namespace listing. The namespace provider service adds an entity to the namespace representing the listing and provides a subscription configuration document to the health care provider.

To provide for multiple health care providers, the namespace provider can provision the leased namespace to include one or more groups. A group listing can be administered by the namespace provider service or as a Namespace Management System that has subscribed to the namespace provider service as a namespace group service. A namespace group service administers that portion of the namespace relative to its group listing. An end user may subscribe to the namespace group and obtain a group listing, if permitted by the namespace provider service, or an edge listing. A group listing may include one or more groups. A group listing may include one or more edge listings.

Using the Namespace Management System authentication service, the namespace provider service will only accept requests that include a credential and can be authenticated as members of the namespace and of the group. Used in this manner, the Namespace Management System satisfies all of the requirements of federal law, including verification that a person or entity seeking access to electronic protected health information is the one claimed, and has also implemented a method with technical security measures to guard against unauthorized access to electronic protected health information that is being transmitted over an electronic communications network.

### Exemplary Implementation

The following provides an exemplary implementation. Fast Fingers Medical Transcription Service uses a Namespace Management System to administer the ffmtshipaa: namespace with a first Namespace Management System.

JD Medical Group is a health care provider who uses the Fast Fingers Medical Transcription Service to outsource the transcription of patient records. JD Medical Group subscribes to the namespace as ffmtshipaa:jdmed with a second Namespace Management System. JD Medical Group registers a group namespace listing as ffmtshipaa:jdmed.staff.member, and this group is administered by the second Namespace Management System. JD Medical Group registers the criteria for subscribing to the ffmtshipaa:jdmed.staff.member group.

Dr. Johnson of JD Medical Group subscribes to the second Namespace Management System as the namespace listing ffmtshipaa:jdmed.staff.member.johnson and installs a third Namespace Management System on her computer. Medical Assistant Williams of JD Medical Group subscribes to the second Namespace Management System as the namespace listing ffmtshipaa:jdmed.staff.member.williams, and installs a fourth Namespace Management System on his computer.

After performing a physical examination of patient Smith, Dr. Johnson updates the patient record using her Patient Management Software (PMS), dictates the findings of the examination into her Olympus DS-3000 digital recorder, and downloads the digital voice file to her computer, associating the downloaded file with the patient record in the PMS system. At the end of day, Medical Assistant Williams reviews the patient activity for the day and exports portions of the patient records, including portions of the record of patient Smith, in XML format from the PMS system to a data file on his computer, including the reference to the digital voice files to be transcribed. He uses a web browser to connect to the local communication point of his Namespace Management System, and the browser displays a page with instructions for sending the exported patient data and digital voice files to the transcription service. The page includes a form with an action and a multiplicity of input text boxes. The form includes a submit action to send page content to his Namespace Management System as a pdcx:request for service:request.transcription. He selects from the multiplicity of file icons associated with the XML exported patient data and digital voice files and, with the mouse device, he drags and drops the file icons into a multiplicity of input text boxes in the browser to identify the files that are to be transcribed. He uses the mouse device to select the submit button on the web page, and the browser sends the request to his Namespace Management System.

For each set of identified files submitted, his Namespace Management System uses services described in configuration documents to interpret the pdcx:request for service:request.transcription. The identified files are registered as request:patient.record with composite members identifying the set of one or more patient information files to be included in a request for transcription services. The service:request.transcription service verifies the identified files exist and generates a pdcx:request for the ffmtshipaa: listing for a service:transcription.request. The content of the pdcx:request includes the content of the identified files in base64 encoding.

Medical Assistant Williams' Namespace Management System sends the request to Fast Fingers Medical Transcription Service's Namespace Management System and, after credentials are exchanged and authentication is completed, the content of the pdcx:request is evaluated by the service:transcription.request registered in Fast Fingers Medical Transcription Service's Namespace Management System. That service registers the request as a composite entity of ffmtshipaa:work.available.

Fast Fingers administers a namespace group listing named ffmtshipaa:scribe for all subcontracting medical transcriptionists.

Jane Jackson is a professional medical transcriptionist who works from home on a subcontract basis with Fast Fingers Medical Transcription Service. Jane Jackson subscribes to the Namespace Management System as the namespace listing ffmtshipaa:scribe.jjackson and installs a Namespace Management System on her computer with configuration documents describing available services for transcriptionist. Jane begins her work day by using a web browser to connect to the local compoint of her Namespace Management System, and the default page includes an embedded configuration document to call ffmtshipaa: to query for available work. The ffmtshipaa: Namespace Management System receives the request and responds with information from the ffmtshipaa:work.available namespace entry, and her browser displays a page with the list of available work. She selects an icon associated with at least one available work item, and the browser sends a request to her Namespace Management System to request that work item. Her Namespace Management System sends the request to ffmtshipaa: whose Namespace Management System selects the available work item, registers the work as in progress, and sends a pdcx:response with content representing the patient data and digital voice files to be transcribed.

Jane creates a new document in Microsoft Word based upon a document template that is appropriate for JD Medical and uses the mouse device to drag and drop the file icon representing one of the received XML documents onto the new Word document. The patient data from the XML file is interpreted by a Word macro, which populates the template data fields with patient name and other data. She then opens the digital voice file and transcribes the patient record into a word processing document in a format that is designated by JD Medical. When complete, Jane again uses a web browser to connect to the local compoint of her Namespace Management System, and the browser displays a page with a list of completed work. She uses the mouse device to select the completed word processing document, and the browser sends the request to her Namespace Management System.

Jane's Namespace Management System sends a pdcx:request to the Namespace Management System located at Fast Fingers Medical Transcription Service after credentials are exchanged and authentication is completed with content representing the word processing file from her computer. Fast Fingers Medical Transcription Service's Namespace Management System, upon satisfying the request, records the file content to their computing device and registers the work item as completed.

At the start of the following day, Medical Assistant Williams uses a browser to connect to his Namespace Management System and sends a request for the list of completed transcriptions for JD Medical. He reviews the list of completed transcriptions. He uses a web browser to connect to the local compoint- of his Namespace Management System, and the browser displays a page with instructions for retrieving the transcribed word processing documents from the transcription service. He selects the documents to be transferred with the mouse device, and the browser sends the request to his Namespace Management System.

Medical Assistant Williams' Namespace Management System initiates a file transfer with the Namespace Management System located at Fast Fingers Medical Transcription Service after credentials are exchanged and authentication is completed. The transcribed patient records in word processing format are sent from Fast Fingers to JD Medical where they are printed and filed with the patient chart.

Medical Imaging Service

Advanced technologies have made medical imaging a common source of diagnostic information for patient care. In addition to traditional radiographs, ultrasound, CT scan, MRI scan, PET scan, and other forms of imaging are all readily available to health care providers. Because of the high cost of obtaining and maintaining the equipment needed to produce the imaging, and the extensive specialty training involved in their interpretation, companies that specialize in providing medical imaging services to providers are becoming widespread. Modern imaging equipment is capable of producing images in digital format. Coupled with the migration of patient records to digital format, the need to establish reliable, secure communications of digital medical images is growing.

In current practice, it is common for a health care provider to refer a patient to an imaging center to obtain ultrasound, CT scan, MRI, etc. After the patient is serviced by the imaging center, images are produced on film or other media and sent to the referring provider, along with an analysis of the imaging performed by doctors of radiology who are on staff with the imaging center. Because the images and analyses are physically delivered to the provider, there is a delay before the patient can resume treatment. In addition to the delay, the same concerns for the confidentiality of patient information and conformance with HIPAA regulations as mentioned in previous examples applies here.

The Namespace Management System can be used to overcome the limitations of current practice. A medical imaging center employs a Dynamic Network Namespace that is comprised of members including the medical imaging center staff, which administers the namespace, and many health care providers. The medical imaging center subscribes to a Network Namespace Root Service and leases a namespace from the Network Namespace Root Service. The namespace provider uses a Namespace Management System to provide a namespace provider service to the medical imaging center, which is responsible for administering the leased namespace.

An end user, the health care provider, subscribes to the medical imaging center's namespace provider service to obtain a listing within the leased namespace. This namespace listing represents an edge listing in the namespace and does not permit subscriptions relative to its namespace listing. The namespace provider service adds an entity to the namespace representing the listing and provides a subscription configuration document to the health care provider.

To provide for multiple health care providers, the namespace provider can provision the leased namespace to include one or more groups. A group listing can be administered by the namespace provider service, or as a Namespace Management System that has subscribed to the namespace provider service as a namespace group service. A namespace group service administers that portion of the namespace relative to its group listing. An end user may subscribe to the namespace group and obtain a group listing, if permitted by the namespace provider service, or an edge listing. A group listing may include one or more groups. A group listing may include one or more edge listings.

As an example, JD Medical Group can use a Namespace Management System on a computing device within their practice, and subscribe to the A+ Medical Imaging Service (the namespace provider) to obtain a namespace group listing. Members of the practice can subscribe to the JD Medical Group to obtain listings within the group. Members of the JD Medical Group can communicate directly to each other through the group Namespace Management System. When the group Namespace Management System sends a communication to the namespace provider service, portions of that-communication can be encrypted and subsequently decrypted by the namespace provider service. Using the Namespace Management System authentication service, the namespace provider service will only accept requests that include a credential and can be authenticated as members of the namespace and of the group. Used in this manner, the Namespace Management System satisfies all of the requirements of federal law, including verification that a person or entity seeking access to electronic protected health information is the one claimed, and has also implemented a method with technical security measures to guard against unauthorized access to electronic protected health information that is being transmitted over an electronic communications network.

### Exemplary Implementation

The following provides an exemplary implementation. A+ Medical Imaging sells medical imaging services to health care providers. The service includes a multiplicity of Namespace Management Systems and a Dynamic Network Namespace with a multiplicity of groups to allow health care providers to receive digital medical images and their analysis over the Internet. Each health care provider is provided a group listing in the namespace that can be subscribed to by individual health care providers who will use the service.

A+ Medical Imaging uses a Namespace Management System to administer the aplushipaa: namespace with a first Namespace Management System. A+ Medical Imaging registers the criteria for subscribing to the namespace as a group listing. A+ Medical Imaging subscribes to the namespace as aplushipaa:aplus. A+ Medical Imaging also registers a group namespace listing as aplushippa:aplus.staff.member, and this group is administered by the Namespace Management System. A+ Medical Imaging registers the criteria for subscribing to the aplushippa:aplus.staff.member group. A+ Medical Imaging has a staff of doctors of radiology who analyze medical images and provide written analysis reports to referring doctors. Dr. Dover of A+ Medical Imaging subscribes to the third Namespace Management System as the namespace listing aplushippa:aplus.staff.member.dover, and upon satisfying the subscription criteria, he is provided the Namespace Management System, configuration documents, and a subscription configuration document that he installs on his computer-as a second Namespace Management System.

JD Medical Group is a health care provider who uses the A+ Medical Imaging Service. JD Medical Group subscribes to the namespace as aplushipaa:aplus:jdmed with a third Namespace Management System. JD Medical Group registers a group namespace listing as aplushippa:aplus:jdmed.staff.member, and this group is administered by the third Namespace Management System. JD Medical Group registers the criteria for subscribing to the aplushippa:aplus:jdmed.staff.member group. Medical assistant Williams of JD Medical Group subscribes to the third Namespace Management System as the namespace listing aplushippa:aplus:jdmed.staff.member.williams, and upon satisfying the subscription criteria, he is provided the Namespace Management System, configuration documents, and a subscription configuration document that he installs on his computer as a fourth Namespace Management System.

Patient Chen is a new patient of the JD Medical Group, having been referred by his primary health care provider to seek the treatment of a specialist. After an initial examination, Chen is advised that an MRI scan of his abdomen is indicated. JD Medical Group refers Chen to A+ Medical Imaging for the MRI scan. To do so, Medical Assistant Williams accesses Chen's patient record in the practice computer system and exports portions of Chen's patient record in XML format from the patient records system to a data file on his computer. He then uses a web browser to connect to the local communication point of his Namespace Management System, and the browser displays a page with instructions for sending the exported patient data to the A+ Medical Imaging service. The page includes a form with a multiplicity of actions and a multiplicity of input text boxes. The form includes a submit action to send page content to his Namespace Management System as a pdcx:request for service:request.mriscan. The form also includes a browse action to select from the multiplicity of files associated with the XML exported patient data files and, with the mouse device, he locates Chen's exported patient file in the list of exported patient files and double-clicks on the file within the list in the browser to identify the files that are to be sent. He uses the mouse device to select the submit button on the web page, and the browser sends the request to his Namespace Management System.

For the identified file submitted, his Namespace Management System uses services described in configuration documents to interpret the pdcx:request for service:request.mriscanappt. The identified file is registered as request:patient.record with composite members identifying the set of one or more patient information files to be included in a request for an MRI scan appointment. The service:request.mriscanappt service verifies the identified file exists and generates a pdcx:request for the aplushipaa: listing for a service:mriscan.request. The content of the pdcx:request includes the content of the identified files in base64 encoding. His Namespace Management System sends the request to A+ Medical Imaging's Namespace Management System, and after credentials are exchanged and authentication is completed, the content of the pdcx:request is evaluated by the service:mriscan.request registered in A+ Medical Imaging's Namespace Management System. That service registers the request as a composite entity of aplushipaa:schedule.request.

The service uses the pdcx:call service to call the aplushippa:aplus:jdmed listing, specifying the request.entity as workarea:request, the response.entity as workarea:response, and the service as request.appointment such as:

<pdcx:call listing=”aplushipaa:aplus:jdmed”
request.entity=”workarea:request”
response.entity=”workarea:response” service=”request.appointment”/>

The pdcx:call service uses the built-in pdcx:format.request service to create a pdcx:request in XML format with attribute members to.listing equal to the listing being called, and from.listing equal to the current namespace listing, and from.credentials equal to the dynamic session credential. The pdcx:format.request service adds composite elements and attributes from the request.entity (workarea:request) as content to the pdcx:request.

The aplushippa:aplus Namespace Management System receives the request, and after credentials are exchanged and authentication is completed, the content of the pdcx:request is registered in the request: namespace, and the request.appointment service is called. The service calls an appointment scheduling service registered with connectivity as /user/home/rp, and this causes the Namespace Management System to allocate communication pipes, and fork a child process, causing a scheduling program to be started. The child process sets the first pipe as its standard input, and the second pipe as its standard output and standard error. The child process then executes the rp program as a separate process. The service uses the pdcx:format.xml.schema service with a reference to an XML schema and a reference to the request: namespace, and the pdcx:format.xml.schema service formats the content of the request: namespace according to the schema and sends the formatted information on the pipe to the rp child process.

The scheduling program uses the supplied patient data to scan the patient schedule for available dates and times for the MRI scan. When complete, the scheduling program sends the response to the Namespace Management System request.appointment service, including the dates and times of the available appointments and a unique identifier associated with each, and the Namespace Management System sends the response to Medical Assistant Williams' Namespace Management System, which then displays the response on his computing device along with an action for reserving an appointment. Medical Assistant Williams reviews the list of available appointment dates and times with patient Chen and selects the appointment that is preferred by Chen from the multiplicity of appointments in the list with his mouse device. He uses the mouse device to select the reserve button on the web page, and the browser sends the request to his Namespace Management System.

For the identified appointment reservation, his Namespace Management System uses services described in configuration documents to interpret the pdcx:request for service:request.mriscanres. The identified appointment is registered as request:patient.record with composite members identifying the set of one or more patient information files to be included in a request for an MRI scan appointment reservation. The service:request.mriscanres service verifies the identified file exists and generates a pdcx:request for the aplushipaa: listing for a service:mriscan.request. The content of the pdcx:request includes the content of the identified files in base64 encoding, along with the unique identifier of the appointment being reserved. His Namespace Management System sends the request to A+ Medical Imaging's Namespace Management System, and after credentials are exchanged and authentication is completed, the content of the pdcx:request is evaluated by the service:mriscan.request registered in A+ Medical Imaging's Namespace Management System. That service registers the request as a composite entity of aplushipaa:schedule.request.

The service uses the pdcx:call service to call the aplushippa:aplus:jdmed listing, specifying the request.entity as workarea:request, the response.entity as workarea:response, and the service as request.reservation such as:

<pdcx:call listing=”aplushipaa:aplus:jdmed”
request.entity=”workarea:request”
response.entity=”workarea:response” service=”request.reservation”/>

The pdcx:call service uses the built-in pdcx:format.request service to create a pdcx:request in XML format with attribute members.listing equal to the listing being called, from.listing equal to the current namespace listing, and from.credentials equal to the dynamic session credential. The pdcx:format.request service adds composite elements and attributes from the request.entity (workarea:request) as content to the pdcx:request. The aplushippa:aplus Namespace Management System receives the request, and after credentials are exchanged and authentication is completed, the content of the pdcx:request is registered in the request: namespace, and the request.reservation service is called. The service calls an appointment reservation service registered with connectivity as /user/home/rp, and this causes the Namespace Management System to allocate communication pipes, and fork a child process, causing an appointment reservation program to be started. The child process sets the first pipe as its standard input, and the second pipe as its standard output and standard error. The child process then executes the rp program as a separate process. The service uses the pdcx:format.xml.schema service with a reference to an XML schema and a reference to the request: namespace, the pdcx:format.xml.schema service formats the content of the request: namespace according to the schema, and sends the formatted information on the pipe to the rp child process. The appointment reservation program uses the supplied patient data and the unique appointment identifier to record an appointment for patient Chen for the MRI scan on the date and time designated. When complete, the program sends the response to the Namespace Management System request.reservation service, including the date and time of the appointment, and the Namespace Management System sends the response to Medical Assistant Williams' Namespace Management System, which then displays the response on his computing device. Medical Assistant Williams prints the appointment reservation confirmation and files it in the patient chart. He also prints an appointment card for patient Chen.

After patient Chen's MRI scan has been performed at A+ Medical Imaging, Dr. Dover reviews the digital images of the MRI scan and performs his professional analysis, recording the results of his analysis by typing a report into the A+ Medical Imaging medical records software program, and associating both the report and the digital MRI image files with patient Chen's patient record. When done, he uses the mouse device to select the report button in the medical records software program, and the program sends the request to his Namespace Management System. For the identified medical record, his Namespace Management System uses services described in configuration documents to interpret the pdcx:request for service:request.mriscanrep. The identified MRI scan report is registered as request:patient.report with composite members identifying the set of one or more patient information files, digital image files, and scan analysis report files to be included in a request for an MRI scan report. The service:request.mriscanrep service verifies the identified files exist and generates a pdcx:request for the aplushipaa: listing for a service:mriscan.request. The content of the pdcx:request includes the content of the identified files in base64 encoding, along with the unique identifier of the appointment associated with the MRI scan. His Namespace Management System sends the request to A+ Medical Imaging's Namespace Management System, and after credentials are exchanged and authentication is completed, the content of the pdcx:request is evaluated by the service:mriscan.request registered in A+ Medical Imaging's Namespace Management System. That service registers the request as a composite entity of aplushipaa:report.request.

The service uses the pdcx:call service to call the aplushippa:aplus listing, specifying the request.entity as workarea:request, the response.entity as workarea:response, and the service as request.report as shown below:

<pdcx:call listing=”aplushipaa:aplus” request.entity=”workarea:request”
response.entity=”workarea:response” service=”request.report”/>

The pdcx:call service uses the built-in pdcx:format.request service to create a pdcx:request in XML format with attribute members.listing equal to the listing being called, from.listing equal to the current namespace listing, and from.credentials equal to the dynamic session credential. The pdcx:format.request service adds composite elements and attributes from the request.entity (workarea:request) as content to the pdcx:request.

The aplushippa:aplus:jdmed Namespace Management System receives the request, and after credentials are exchanged and authentication is completed, the content of the pdcx:request is registered in the request: namespace, and the request.report service is called.

The service calls an MRI scan report service registered with connectivity as /user/home/rp, and this causes the Namespace Management System to allocate communication pipes, and fork a child process, causing an appointment report. program to be started. The child process sets the first pipe as its standard input, and the second pipe as its standard output and standard error. The child process then executes the rp program as a separate process. The service uses the pdcx:format.xml.schema service with a reference to an XML schema and a reference to the request: namespace, the pdcx:format.xml.schema service formats the content of the request: namespace according to the schema, and sends the formatted information on the pipe to the rp child process.

The MRI scan report program uses the supplied patient data and the unique appointment identifier to record the results of the MRI scan for patient Chen in the JD Medical patient records system, and associates the MRI scan digital image files and radiologist's report file with that record. It also sends an alert via the pdcx:service:smtp.service to Chen's attending doctor, Dr. Johnson, to inform her that the requested MRI scan has been completed and the analysis report is on file.

Medical Insurance Referral

It is quite common for health care providers to refer a patient to a specialist when a preliminary examination dictates the need. Most health insurance plans require that the subsequent visit to the specialist be pre-approved. It is common practice in the industry for the specialist health care provider to submit a request for verification of coverage to the patient's insurance company via electronic means. There are several predominant means of submission today, ranging from dedicated electronic devices that use a telephone line to submit the query to the insurance company, and then receive the response, to World Wide Web based sites that the provider can access. Either method requires the health care provider to submit the patient's policy number and plan identification and answer basic questions regarding the referral.

In particular, Section 164.312 Technical Safeguards, (d) Standard: Person or Entity Authentication, requires that entities “Implement procedures to verify that a person or entity seeking access to electronic protected health information is the one claimed.” Current implementations that employ password protected access, such as HTTPS, FTP, etc., fall short of this requirement, as it is possible for unauthorized access to be gained by using techniques that use brute force to decode passwords or other password detection methods. Likewise, Section 164.312 Technical Safeguards (e)(1) Standard: Transmission Security, requires that entities “Implement technical security measures to guard against unauthorized access to electronic protected health information that is being transmitted over an electronic communications network.” Current implementations that use HTTPS, FTP, etc., fall short of this requirement, as they do not guarantee that only desired points of presence on the Internet are able to gain access.

The Namespace Management System can be used to overcome these limitations. An insurer can lease a namespace and install a Namespace Management System with configuration documents to provide a medical insurance referral service for health care providers authorized to participate in the insurance plan. A health care provider obtains a Namespace Management System with the configuration documents and subscribes to the namespace to obtain their health care provider namespace listing. The namespace listing can be an edge listing or a group listing, depending on the criteria provided and the subscription level. For example, the insurer may provide for group listings only, edge listings only, or group listings for particular health care providers satisfying specified criteria such as the number of practitioners in the health care provider practice. A health care provider with a namespace group listing can use their Namespace Management System to administer that portion of the namespace relative to their group listing. The health care provider establishes the criteria for subscribing to their group listing. This enables one or more practitioners within the health care provider service to subscribe to the health care provider group listing and obtain an edge listing relative to the group listing.

A multiplicity of insurers can lease and administer their own namespace to provide a medical insurance referral service for health care providers specific to their insurance plan. Alternatively, a single namespace can be used and the insurers can subscribe to that namespace.

Using the Namespace Management System authentication service, the namespace provider service will only accept requests that include a credential and can be authenticated as members of the namespace and of the group. Used in this manner, the Namespace Management System satisfies all of the requirements of federal law, including verification that a person or entity seeking access to electronic protected health information is the one claimed, and has also implemented a method with technical security measures to guard against unauthorized access to electronic protected health information that is being transmitted over an electronic communications network.

### Exemplary Implementation

The following provides an exemplary implementation. MicroMed Medical Software Company sells an insurance referral processing service to medical insurance companies. The service includes a license for the FastReferral software programs, a multiplicity of Namespace Management Systems, and a Dynamic Network Namespace with a multiplicity of groups to allow health care providers to process insurance referrals over the Internet. Each insurer is provided a group listing in the namespace that can be subscribed to by individual health care providers who wish to process referrals for that individual insurer and a license to redistribute the health care provider version of the FastReferral software program. MicroMed uses a Namespace Management System to administer the mmhipaa: namespace with a first Namespace Management System. MicroMed registers the criteria for subscribing to the namespace as a group listing.

Acme Insurance Company is a medical insurance company that has the need to process insurance referral requests from a multiplicity of health care providers who may be presented with a request for care from one of their insureds and uses the MicroMed referral processing service to accomplish this task. Acme subscribes to the namespace as mmhippa:acmeins with a second Namespace Management System. Acme registers the criteria for subscribing to the mmhippa:acmeins group and criteria for subscribing to the namespace as an edge listing. Acme also installs and configures the insurer version of the FastReferral software program.

JD Medical Group is a health care provider who has patients referred by primary health care providers and who are covered by a health insurance plan administered by the Acme Insurance Company. JD Medical Group subscribes to the namespace as mmhippa:acmeins:jdmed with a third Namespace Management System and installs the health care provider version of the FastReferral software program provided by Acme. JD Medical Group registers a group namespace listing as mmhippa:acmeins:jdmed.staff.member, and this group is administered by the third Namespace Management System. JD Medical Group registers the criteria for subscribing to the mmhippa:acmeins:jdmed.staff.member group. Medical Assistant Williams of JD Medical Group subscribes to the third Namespace Management System as the namespace listing mmhippa:acmeins:jdmed.staff.member.williams, and upon satisfying the subscription criteria, he is provided the Namespace Management System, configuration documents, a subscription configuration document that he installs on his computer as a fourth Namespace Management System, and a copy of the health care provider version of the FastReferral software program.

Patient Chen is a new patient of the JD Medical Group, having been referred by his primary health care provider to seek the treatment of a specialist. Chen is insured by Acme Insurance Company, which requires pre-approval prior to treatment by a health care provider out of their network. In order to satisfy the requirements of Acme Insurance Company prior to providing service, Medical Assistant Williams processes a pre-approval. To do so, he opens the FastReferral program and swipes the insurance identification card that patient Chen provides using a magnetic stripe reader. Pertinent patient and insurance plan data that is stored on the magnetic stripe of the insurance identification card is read into the FastReferral program on Williams' computer and is displayed on the computer's display device.

Using the mouse pointing device on his computer, Medical Assistant Williams then specifies additional details about the patient, including whether the patient is the insured or a dependent of the insured, by clicking on a multiplicity of window controls to indicate selection or de-selection. He uses the mouse pointing device to specify the date of birth of the patient by selecting from list controls for the month, day, and year. He then uses the mouse pointing device to click on the Send button in the FastReferral program to process the request. The FastReferral program sends this information, along with the pre-configured provider identification number, as an XML formatted pdcx:request for the request.referral service to his Namespace Management System. His Namespace Management System receives the request and registers the parameter names and values in the request: namespace, and evaluates the service:request.referral. The service:request.referral service validates the XML request and, if valid, calls the pdcx:base64.encode service to encode the content as workarea:request.patient.info.

The service uses the pdcx:call service to call the mmhippa:acmeins:jdmed listing, specifying the request.entity as workarea:request, the response.entity as workarea:response, and the service as request.approval given as:

<pdcx:call listing=”mmhipaa:acmeins:jdmed”
request.entity=”workarea:request”
response.entity=”workarea:response” service=”request.approval”/>

The pdcx:call service uses the built-in pdcx:format.request service to create a pdcx:request in XML format with attribute members.listing equal to the listing being called, from.listing equal to the current namespace listing, and from.credentials equal to the dynamic session credential. The pdcx:format.request service adds composite elements and attributes from the request.entity (workarea:request) as content to the pdcx:request.

The mmhippa:acmeins Namespace Management System receives the request, and after credentials are exchanged and authentication is completed, the content of the pdcx:request is registered in the request: namespace and the request.approval service is called.

The service calls a referral processing service registered with connectivity as /user/home/rp, and this causes the Namespace Management System to allocate communication pipes, and fork a child process, causing the insurer version of the FastReferral program to be started. The child process sets the first pipe as its standard input and the second pipe as its standard output and standard error. The child process then executes the rp program as a separate process. The service uses the pdcx:format.xml.schema service with a reference to an XML schema and a reference to the request: namespace, and the pdcx:format.xml.schema service formats the content of the request: namespace according to the schema and sends the formatted information on the pipe to the rp child process.

The insurer version of the FastReferral program uses the supplied patient data, insurance plan data, and health care provider data to perform an analysis on whether the treatment by the querying health care provider is granted or rejected. When complete, the insurer version of the FastReferral program sends the response to the Namespace Management System request.approval service, and the Namespace Management System sends the response to Medical Assistant Williams' Namespace Management System, which then displays the response on his computing device. Medical Assistant Williams prints the response of the referral and files it in the patient chart.

Programmatic Integration and Support

The Namespace Management System can be instrumented in existing scripting, object, and event-based programming languages. For example, the KornShell command and scripting language source code is available from AT&T Research. KornShell supports function declarations and definitions through shell scripts. In addition, KornShell allows for built-in functions to be provided through dynamically loadable libraries. However, KornShell, in its current format, does not support ‘:’ as a valid variable name character, and since function names follow variable name syntax, a function name cannot include a ‘:’. KornShell provides a single namespace, although local variables may be declared within a function and are local in context to that function only.

KornShell can be modified to support multiple namespaces and variable names with ‘:’, such that a shell script can include pdcx:call listing=“brenet:staff.member.pete”, the function reference will search the pdcx: namespace for the service listing “call”, and will call that function with the parameter listing=“brenet:staff.member.pete”. Alternatively, KornShell can be modified so that de-referencing of the function call can determine the associated namespace is an active namespace, locate the service within that active namespace, and add the parameters to a request: namespace service directory. Thus, within the function, a standard shell command or utility can reference the parameter relative to the request: namespace, such as: print—${request:listing}.

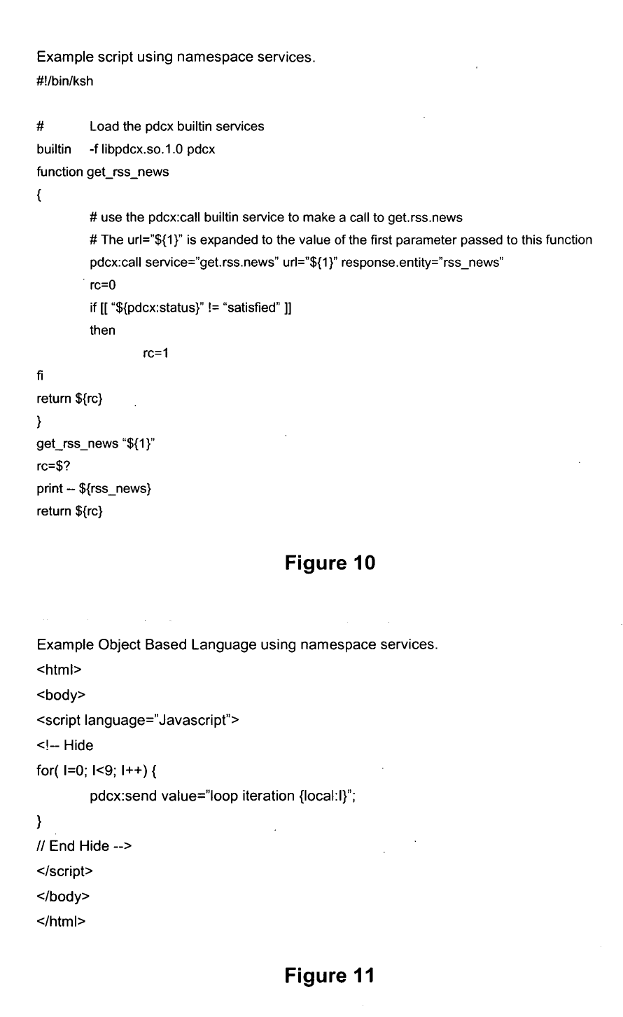

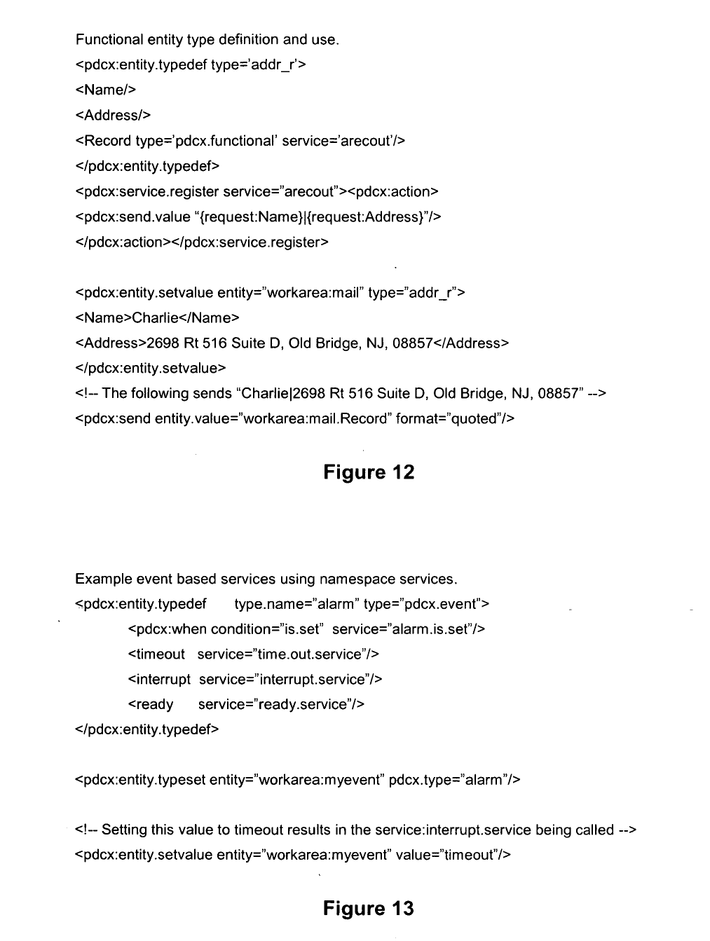

Although the above syntax conflicts with the standard KornShell command and programming language parameter substring expansion, that portion of the shell source code can be modified to determine if characters to the right of the colon are numeric, or a reference to a listing within a namespace, and perform the appropriate action. An example script using namespace services is shown in FIG. 10.

Object-Based Languages and PDCX Protocol Bindings

Object-based languages, such as ECMAScript, can be extended through the Namespace Management System. A conforming implementation of ECMAScript is permitted to provide additional types, values, objects, properties, and functions beyond those described in the ECMAScript specification. In particular, a conforming implementation of ECMAScript is permitted to provide properties not described in this specification, and values for those properties, for objects that are described in this specification. Adding support for a colon “:” within an ECMAScript identifier would allow a function definition to be bound to a listing within a namespace. As shown in FIG. 11, for example, an ECMA Script conforming browser with the ability to support dynamically loadable services expressed in configuration documents (requires a plug-in conforming to the browser standard) can interpret HTML with embedded scripts including references to services within the pdcx namespace. The Namespace Management System, by itself, has no notion of objects in the sense of object-oriented programming methodologies. However, using the built-in pdcx:entity.typedef service, a configuration document can describe an entity with functional composite entities, as shown in FIG. 10.

Event-Based Modeling

The event-based communication model represents an emerging paradigm for asynchronously interconnecting the components that comprise an application in a potentially distributed and heterogeneous environment and has recently become widely used in application areas such as large-scale Internet services and mobile programming environments, which are central to the vision of ubiquitous computing.

An event is a message sent by an object to signal the occurrence of an action. An event is published as a message adhering to some well-defined syntax described by the publisher. On the publisher side, there is executable code for raising the event and executable code for sending (publishing) the event notification message to one or more subscribers. An event can be published by an operating system service, such as a mouse event, keyboard event, window resize event, or an alarm, and an application process executing on said operating system can use an operating system interface to receive the event notification message. Thus, the availability of the event notification message published by the operating system is limited to one or more processes executing within said operating system.

An application event is an event published by a first application process to a second application process (subscriber), typically in a distributed environment. In CORBA, for example, a supplier (publisher) can send an event to an event channel as a CORBA ‘any’ type, and the channel will then broadcast the event to all of the consumers (subscribers) that have subscribed to the channel.

Higher level abstractions are also applicable, such as a web site monitoring service wherein when a web site cannot be accessed, the service publishes an event notification to a subscriber, which may be published (sent) to a communication device such as a pager. Such an announcement associates a specific event type with certain proximity and implicitly bounds event propagation. Consumers receive events only if they reside inside a proximity in which events of this type are raised.

Within the current state of the art, the logic associated with the action for raising the event and sending the event notification is fixed and unalterable within the producer application process. The producer defines the semantic meaning of the event, the syntactic definition of the event notification message, and the event notification service used to communicate the message to a subscriber. A subscriber cannot alter the action of the producer (other than to subscribe).

Within the current state of the art, a publisher publishes each event to a subscriber, even if the subscriber is only interested in a subset of all possible events published by the publisher. A subscriber typically would employ some logic for selecting only those events of interest and discarding (or ignoring) others.

The Namespace Management System overcomes the limitations of the prior art through the use of a service event with one or more event services representative of a detect-event service (i.e., a service to detect that an event has occurred), a raise-event service (i.e., a service to register a namespace entity representative that the event has occurred), and an event-processing service (i.e., a service to process a registered event). A service event can include one more composite entities representative of attributes such as a description, the format of the event notification message, the disposition of a registered event, or an interval at which the event can be detected again. A configured Namespace Management System can receive an advertisement configuration document (as a pdcx:request or in response to a request sent by the Namespace Management System) describing a service event that can be published from a communication point and can register information representative of the service event in a namespace administered by the Namespace Management System, thus enabling automatic discovery and registration of publishable service events.

A detect-event service can use an application-programming interface to receive a system event (i.e., an event published by the operating system) and can apply additional processing logic to determine if a service event should be raised. Alternatively, or in conjunction with, a service can use one or more built-in services to determine if a service event should be raised. The raise-event service registers an entity in a namespace representative that the event has occurred.

An event-processing service, such as a notification service to publish the event to one or more subscribers, is called to process the raised event. The use of the service event within a configured Namespace Management System permits a publisher to accept one or more configuration documents from a subscriber and associate the configuration document with the evaluation of an event service. Thus, the logic used by the publisher for processing an event can by dynamically configured and/or reconfigured through the evaluation of a subscriber-provided configuration document. A service event subscriber, for example, can provide a service event publisher a configuration document representative of event-notification constraints (satisfaction claims) that must be satisfied in order for the publisher to send the event notification message to the event subscriber. A configured Namespace Management System that receives an event notification message can use a service event service to register an entity in a namespace representing that the event has occurred and a service event service to process the event.

A service object can be representative of a service event where the event services associated with the service event are service object methods. Service events are a reusable design pattern.

Using the Namespace Management System, a first configured Namespace Management System can subscribe to an event publishing service of a second configured Namespace Management System and can register one or more configuration documents to be evaluated by an event service of the second Namespace Management System. Thus, the first Namespace Management System can request the second Namespace Management System to dynamically (meaning at run-time) reconfigure the logic for processing of the event on behalf of the subscriber. Additionally, through one or more configuration documents evaluated by the first Namespace Management System, the logic for processing a raised event can be dynamically configured and/or reconfigured.

In a preferred implementation, a subscriber can send a configuration document describing one or more satisfaction claims that must be satisfied, and the publisher's event notification service evaluates the configuration document as a before discipline service of the event notification service, and upon satisfaction of the evaluation of the before discipline service, the publisher uses the event notification service to notify the subscriber of the event. The publisher can allow the subscriber to specify state information that is to be registered in a namespace and subsequently available for use within the satisfaction claims of the subscriber's configuration document.

A subscriber can specify a satisfaction claim as a filter to discard the message if the subscriber is not interested in a particular event (i.e., the subscriber only wants to be notified of a subset of possible events in the set of events to which the subscriber has subscribed). A subscriber can specify a multiplicity of conditions within a given satisfaction claim, such as “if event A and event B”. A subscriber can specify a time-related constraint, such as “if not notified within past five minutes of same event, then notify”. A subscriber can specify that when event A is raised and a corresponding event B is not raised within a specified time, then notify the subscriber. A subscriber can specify the connectivity for communicating the event notification message. A satisfaction claim can be used to specify a duration of interest such that when the event notification message cannot be delivered within a specified time, or specified number of attempts, then a subscriber-defined action can be evaluated, such as discarding the event notification message or using a different connectivity such as a URR to notify the subscriber.

As shown in FIG. 13, an entity in the namespace can be defined as an event, with composite members representing possible values for the event and services to be called based on the current value of the entity. One or more conditional statements can be expressed, using pdcx:when to indicate the condition and the service that is to be called when the condition is satisfied.

When an event occurs, it is registered as the value of the event entity. A before event discipline service can be specified, and it will be called just before the event value is registered. The value is then registered, and each pdcx:when condition, if specified, is evaluated. If there is a composite member whose name matches the value being registered, then the service associated with the composite is called. An after event discipline service can be specified, and it will be called after the event value has been registered. The composite member “unknown” (if it has a registered service) is called when an event value is being registered for which there is no event value (composite name) corresponding to the event value. Re-registering the same event value will have no effect unless the event value has a “repeat” attribute such as:

<timeout service=”time.out.service” attribute=”repeat”/>

One skilled in the art can configure a system of Namespace Management Systems to allow the consumer to order rich, contingent interactive notices of events given different scenarios. The consumer can further self-configure the switch to order and enrich the value of the real-time event alert/notice by giving it appropriate context and allowing direct exchange of dynamic information post the receipt of the notice.

Each consumer can determine what notice that consumer wants delivered and, when given, a series of contingent and correlated or non-correlated events that the consumer can exploit a direct synchronous connection with a service that enables the consumer to interact with service providers in a reaction to events.

Workflows

An entity in a namespace can represent a rule. A rule is comprised of zero or more prerequisites and zero or more action statements. In most respects, a rule is a registered service and can be called using the pdcx:call built-in service. A rule can have a registered policy service for determining if a rule's action must be triggered; otherwise, the value of pdcx:registered.workflow.policy (which defaults to pdcx:workflow.policy.time) is used. A rule may have one or more attributes. An entity in a namespace can represent a workflow comprised of one or more references to rules.

The pdcx:workflow.evaluate service evaluates a workflow by evaluating each of the registered rules given by the value of pdcx:registered.workflow.rules, which defaults to pdcxinit, init, main, done, and pdcxdone. For each rule, the service calls the pdcx:workflow.rule.evaluate service with the name of the rule to evaluate. The pdcx:workflow.rule.evaluate service calls the binding service to bind the rule name to an entity. The response from the binding service is registered and used by the pdcx:workflow.rule.evaluate service. When a rule name is bound to a functional entity whose expanded value is interpreted as a multiplicity of rule names, then the current rule name is replaced by the list of rule names and the service calls itself with each of the rule names. A binding service method can update the entity registration. For each prerequisite of the current rule, the pdcx:workflow.rule.evaluate service calls itself with the prerequisite name as the name of the rule to evaluate.

The policy service is called with a reference to the current rule name, and the response indicates if the action must be triggered. When the rule name is bound to a service in the service: namespace, then that service is called using the pdcx:call built-in service. If the rule name is bound to an entity in the rule: namespace, then the pdcx:call service is called with a reference to the rule name to evaluate the rule's action (if any) when necessary. A triggered action causes the pdcx:workflow.rule.evaluate service to call the binding service to bind the rule name a second time. A rule named “error” is called when a rule cannot be successfully evaluated and the rule is not bound to an entity with an ignore attribute. A rule name that is bound to an entity with a force attribute indicates that the action should always be triggered, regardless if the policy service response indicates otherwise. A rule name that is bound to an entity with a repeat attribute indicates that the rule can be evaluated more than one time. A rule with a multiplicity of prerequisites having a joint attribute indicates that the evaluation of any one of the prerequisites satisfies all of the prerequisites. A multiplicity of prerequisites for a given rule may be evaluated in parallel (in the order specified). However, a prerequisite named pdcx.semaphore indicates that all parallel evaluation must be completed prior to continuing the evaluation. After evaluating the last rule, the pdcx:workflow.evaluate service considers the workflow as having completed and returns control back to the calling process.

Electronic Devices

The Namespace Management System can communicate with one or more electronic devices capable of receiving a communication and/or transmitting communications. An electronic device can have an associated listing in at least one namespace administered by a Namespace Management System, and this may include the connectivity required to communicate with the electronic device. A configuration document can reference a built-in service, such as pdcx:connect, to request a connection to an electronic device and subsequently send and/or receive communications from the device.

An application executing in a programmable electronic device can send a communication to a Namespace Management System communication point administered by a Namespace Management System service executing on a second electronic device, such as a computer. A Namespace Management System service can receive data transmitted by an electronic device. A Namespace Management System service can send data to an electronic device configured to receive transmitted data. A Namespace Management System service, for example, can connect to a printing device and send data to be printed. The connectivity to communicate with the electronic device can be registered with the Namespace Management System, and the Namespace Management System can send and/or receive communications from the electronic device using a built-in service. An application on a programmable electronic device can use information to construct a URI and send that URI through the wireless connection.

An edge computing device connected to a router can execute a Namespace Management System process that dynamically configures services and registers the connectivity required to communicate with an electronic device. When the Namespace Management System receives a request on its namespace compoint, it can validate the request and call a service to receive a communication from an electronic device using the registered connectivity to communicate with that device. The received communication can be processed by a Namespace Management System service. A response can then be provided to satisfy the request. Note that the process communicating the request to the Namespace Management System's namespace compoint can send a text-based message to initiate the request and, in response to receiving the request, the Namespace Management System can redirect text-based or binary-based communications to/from the compoint.

A benefit of the Namespace Management System is that, through configuration documents, a Namespace Management System executing on an edge device can be dynamically configured to communicate with a multiplicity of electronic devices where the input and/or output communications are administered using configuration documents. As new devices that use industry standard protocols become available, one or more configuration documents can be used to integrate the use of the electronic device with the Namespace Management System.

Provisioning Namespace Listings for Electronic Devices

A namespace service provider with appropriate authorization can statically provision a namespace with one or more listings. Similarly, one or more namespace listings can be dynamically provisioned. The service provider of the family: namespace, for example, can provision specific listings such as family:nicole.phone.cell, and family:nicole.camera.frontDoor. The listing can be registered with a specified connectivity. Alternatively, the listing can be registered without connectivity, and in the default case, a subscription configuration document will be generated. The family:nicole.camera.frontDoor listing, for example, may be registered with a static Internet Address or host name assigned, and this may include a specific port, or a DHCP Internet Address that a Namespace Management System service can discover and register when needed. The family:nicole.phone.cell listing, for example, can be provisioned without the connectivity specified and a subscription configuration document generated and installed on the cell phone.

An electronic device can be registered as a compoint in the compoint: namespace administered by a Namespace Management System, and a service can connect to that electronic device using the specified connectivity. Alternatively, a configuration document containing calls to built-in services can establish a connection and communicate with the electronic device. Certain electronic devices use a proprietary communication format, and they may require a built-in service that can communicate using the proprietary communication format.

Global Positioning Service

The GPS chip in an electronic device such as a user's cell phone can provide the current location information for the cell phone. Although a user can subscribe to the www.accutracking.com free tracking service, which installs software on the cell phone, the subscriber cannot configure new or extended services beyond the limited accutracking tracking services available from the Accutrack server. The accutracking information is not currently used in conjunction with Google's Short Message Service or Location service, nor can text driving instructions or graphic maps from a service such as www.mapsonus.com be sent back to the cell phone. Topographical image maps from NASA Worldwind cannot be easily integrated. Even if, or when, these services become available, the user will be confronted with a multiplicity of services from a multiplicity of service providers each focused on particular market niches, and will not have the necessary mechanisms to custom configure, integrate, or extend these disjointed service offerings.

The Namespace Management System is used to overcome these limitations by obtaining the GPS coordinates from a GPS-enabled electronic device and communicating this information so that it can be registered as a listing in a namespace administered by a Namespace Management System.

Subscription Configuration Documents

One or more configuration documents, such as a subscription configuration document, can be stored in an electronic device, such as a USB flash drive or other electronic device providing readable storage and communicated to a Namespace Management System service. This enables the electronic device to be used as a wallet for mobile e-commerce, or authentication to an accessible configured Namespace Management System. Certain electronic devices can be connected to an edge computer device USB port, and a process (service) executing on the edge computer device can be used to access the configuration document residing on the electronic device.

In one implementation, a user's cell phone (equipped with Bluetooth) is programmed and a subscription configuration document is uploaded to the cell phone. The configuration document is subsequently communicated to a Namespace Management System service executing on an edge computing device. In response to receiving the subscription configuration document, the Namespace Management System imports the configuration document to register a current point of presence to associate with the user's namespace listing. The Namespace Management System service executing on the edge computing device can be a Namespace Management System kiosk in a public venue where the Namespace Management System is configured to receive a subscription configuration document, register the point of presence to associate with the user's namespace listing, and configured to provide common services. When the user completes their use of the Namespace Management System kiosk, the logout service will cause the Namespace Management System to reboot. The service:main service can use a timeout to automatically reboot the Namespace Management System at a specified time interval of inactivity.

In a second implementation, the electronic device is configured to use wireless communications to communicate the configuration document to a configured Namespace Management System service executing on a computing device. In this implementation, the configured Namespace Management System registers a point of presence to associate with the user's namespace listing. The pdcx:pgp.encrypt service can be used to encrypt a subscription configuration document and make it available as a replacement subscription configuration document or as an encrypted subscription configuration document. The subscription configuration document (or the encrypted subscription configuration document) can be stored on an electronic device such as a cell phone.

The user can start a brew application to post said configuration document with or without the GPS coordinates to a service available over the Internet, such as http://www.pdcx.com/mobile, which registers the information as an entity in a active namespace and responds with a unique communication identifier, such as a listing in that active namespace. The cell phone user can subsequently key-in the unique communication identifier into a configured Namespace Management System that sends this information in a query request to a service to retrieve said configuration document and any available GPS information. The Namespace Management System can use a decrypt service, such as pdcx:pgp.decrypt, to decrypt the configuration document, and the user can be prompted for a pass phrase, if necessary.

Correlating a Namespace Listing with GPS Location Information

Correlating a provisioned namespace listing, such as a subscriber listing, with GPS location information enables location-based services, tracking services, and navigation services to be used. Depending on the GPS location information format, a conversion service may be called to convert Degrees/Minutes/Seconds to/from Decimal Latitude/Longitude. A reverse geocoding service is called to translate the GPS location information into street address information that is registered as a composite entity of the namespace listing.

Having the location information registered in a namespace allows a Namespace Management System associated with the namespace to be dynamically configured, by importing one or more configuration documents, to coordinate service interactions. A first user, for example, imports a configuration document providing a service to communicate GPS location information to obtain flood information from FEMA, while a second user imports a configuration document providing a service to obtain earthquake information from the US Geological Service using the current GPS location, and a third user imports a configuration document providing a service to obtain driving instructions to the nearest gas station. Another user imports a configuration document providing a tracking service. Thus, a multiplicity of configuration documents describing services using location can be provided. A user of a Namespace Management System can import one or more of these configuration documents, thus providing centralized access to only those services of interest.

Enabling an electronic device to communicate a configuration document allows a user to carry one or more configuration documents with them. A physical or virtual Namespace Management System kiosk in a designated public area, such as an airport terminal, can securely obtain the user's configuration document. Similarly, a corporation with virtual desks can deploy common Namespace Management Systems to desk computers, and an employee arriving at the desk can have the Namespace Management System configured according to the employee's needs.

Alternatively, a subscription configuration document could be stored on any type of portable computer readable media, such as a business card CD that can be inserted into a CD reader device accessible to the computer that is running the Namespace Management System. The subscription configuration document can be recorded on any media, such as a magnetic strip that can be read by a magstripe reader accessible to a computer that is running a Namespace Management System.

Security Services

Brittany, an end user with a computer, subscribes to the myname: namespace as the listing myname:brittany.rose and installs a configured Namespace Management System. The computer is connected to a port router, and the router is connected to a Cable Modem with Internet connection. Brittany purchases and installs a Wireless Internet Camera. The cable modem service subscription uses a dynamic WAN IP address, which can change from time to time. Brittany uses a configured Namespace Management System on the computer to remotely access the camera. The Wireless Internet Camera is assigned a local Internet Address such as 192.168.0.20. Brittany's Namespace Management System imports a configuration document which registers the ‘service:access.camera’ service and registers the connectivity to the camer~a as 192.168.0.20:80. Using a web browser on a computer with Internet connectivity external to the router, Brittany enters a URL to send a request to her Namespace Management System for viewing access to the camera, such as:

http://www.pdcx.com/redirect

listing=‘myname:brittany.rose’ service=‘access.camera’

In response to receiving the redirect request, the pdcx.com redirect service locates the registered point of presence for the listing myname:brittany.rose and sends an HTML response with a meta tag redirect to the registered point of presence associated with the myname:brittany.rose listing wherein the URL path is a pdcx:request with the specified name-value pairs.

Briftany's browser receives the meta tag redirect communication, and this redirects the browser to the registered current point of presence associated with the specified namespace listing. In response to receiving the communication, a registered service in her Namespace Management System uses the registered connectivity to open a connection to the camera, and registers the open connection as a compoint in the compoint: namespace administered by her Namespace Management System. A service is then called to redirect communications between said compoint and the -active compoint connection on which the request was received.

Proxy Namespace Management System

A first Namespace Management System can use a second Namespace Management System as a proxy Namespace Management System. This implementation enables a common set of computers inside a firewall to communicate using a first compoint, while communications external to the firewall are routed through the proxy Namespace Management System. When the first Namespace Management System attempts to register its current point of presence, it sends the request to the proxy Namespace Management System that registers the DNN listing and connectivity to the first Namespace Management System, and then forwards the request to the appropriate namespace provider service. The namespace provider service authenticates the request and sends a response back to the proxy Namespace Management System. Thereafter, a query can be sent to the namespace provider service for the DNN listing, and the response indicates the connectivity of the proxy Namespace Management System. A request can then be sent to the specified DNN listing by communicating the request to the proxy Namespace Management System, which forwards the request to the first Namespace Management System. Thus, the first Namespace Management System can use a namespace compoint, which is inside the firewall, and receive externally generated requests through the proxy Namespace Management System. In one implementation, a “corporate” compoint is used for requests generated within the firewall and a “namespace” compoint for externally generated requests. Note that the proxy Namespace Management System may use one or more routes as appropriate.

Programmatic Evaluations

The Namespace Management System includes a minimal API that permits a configuration to dynamically extend the API available through the Namespace Management System. That is to say, when the Namespace Management System evaluates a configuration document, and the document includes a pdcx:register statement identifying a module within a dynamic load library (or shared library on POSIX compliant operating systems), then the Namespace Management System will load and call the module, which can register additional services to extend the application programming interface (API) until de-registered (removed).

One or more services can be registered as part of the callable services to enable programmatic evaluation of a configuration document. Variable declaration and assignment, for example, are provided by the pdcx:register, pdcx:setvalue, and pdcx:entity services. Control flow is provided by the pdcx:call, pdcx:evaluate, pdcx:connect, and other services. Iteration is provided through the pdcx:foreach, and pdcx:dountil services. Conditional evaluation is provided by the pdcx:condition and pdcx:when services. Communication is provided by pdcx:connect, pdcx:send, pdcx:receive, and pdcx:disconnect services. Workflows and rules are provided by pdcx:workflow and pdcx:rule services, respectively. Operating system interfaces are provided by the pdcx:system services. Stored procedures are provided through the pdcx:register, pdcx:call, and pdcx:evaluate services.

Services can be provided through one or more dynamic link libraries containing callable modules and registered with the Namespace Management System when the Namespace Management System evaluates a configuration document containing pdcx:register service calls that identify the library and module to be called. In a preferred implementation, these services are registered in the pdcx: namespace.

Self-Adaptive Architecture

Dynamic software architectures modify their architecture and enact the modifications during the system's execution. A dynamic software architecture is a self-managing system if it implements the initiation and selection of a change, while a user-managed architecture system usually exhibits ad-hoc change in which the initiation and selection occur external to the software.

In the Namespace Management System, the evaluation of a service can result in the dynamic reconfiguration of one or more Namespace Management System services without requiring the Namespace Management System to reboot (restart). The reconfiguration of a Namespace Management System can be predicated on an event, pattern of events, or lack thereof. Similarly, a service detecting the availability of a configuration document can import said configuration document, which may result in a configuration and/or reconfiguration of one or more Namespace Management System services. Thus, the Namespace Management System provides both a self-managing and user-managed architecture. In FIG. 23, for example, a satisfaction claim is registered so that, whenever the claim can be satisfied, the action is triggered (evaluated), and the Namespace Management System renews the current point of presence to associate with its listing.

Client-Server Applications

Client-server applications are common within the industry and are typically defined as:
A network architecture in which each computer or process on the network is either a client or a server. Servers are powerful computers or processes dedicated to managing disk drives (file servers), printers (print servers), or network traffic (network servers). Clients are PCs or workstations on which users run applications. Clients rely on servers for resources, such as files, devices, and even processing power.

A web browser, for example, predominately functions as a client application process that communicates with a web server application process. The file transfer protocol client application communicates with an FTP server application process. A telnet client application communicates with a telnet server application process. In many cases, existing client-server applications can communicate through one or more Namespace Management Systems.

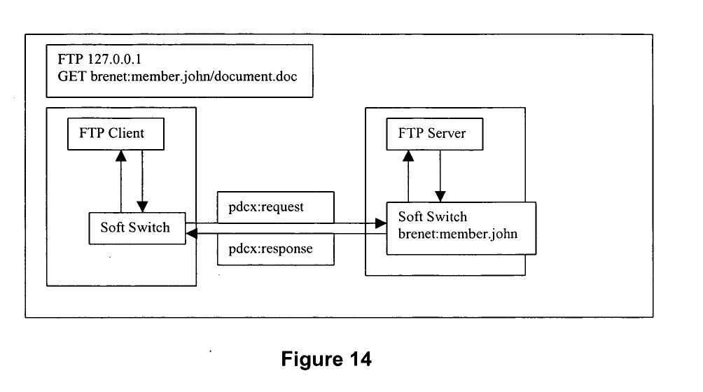

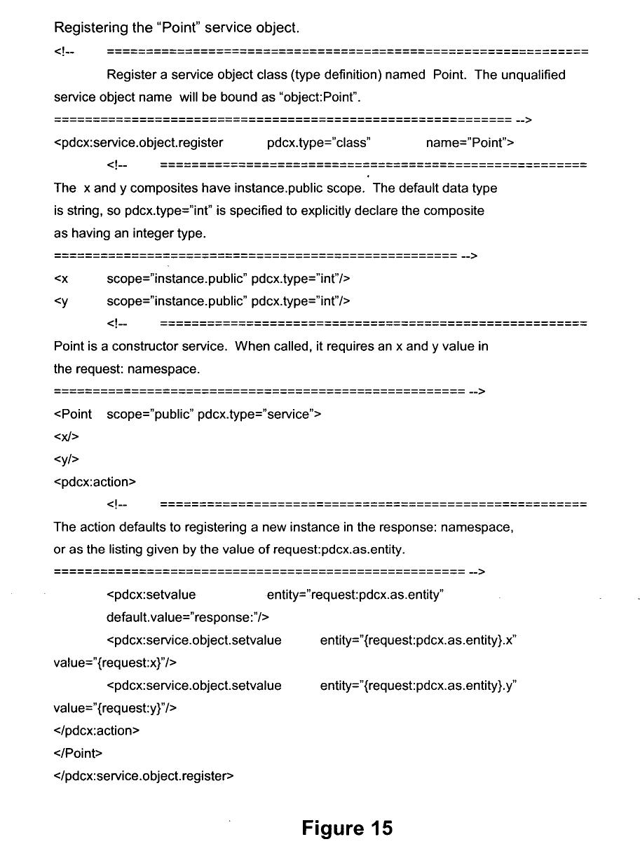

An FTP client application, for example, can connect to a Namespace Management System compoint, such as localhost:21 and use a GET command wherein the filename is specified as a namespace listing with a relative path, such as brenet:staff.john/hisword.doc. In this context, the GET command is received by the Namespace Management System executing on the local computer and is evaluated. The Namespace Management System sends a pdcx:request to the specified listing for service=‘ftp’ and the specified path name, which is path=“hisword.doc”. The response to the request will include the file being transferred (base64 encoded), and the content is decoded and sent to the FTP client. In another implementation, the Namespace Management System receiving the pdcx:request for the FTP service can connect to an FTP server application process executing on the same computer (or addressable computer) and send a GET command for the specified path. The response is received, encoded, and sent as the response to the request (see FIG. 14).

A URL enabled client application can be used to send a request to the Namespace Management System. Similarly, a URR enabled client application can send a request to the Namespace Management System. When a URL enabled client application does not have access to a configured Namespace Management System, it can use a redirection service available from a public Internet Address, such as http:H/www.pdcx.com/redirect, and specify the listing and other parameters such as:

http://www.pdcx.com/redirect listing=”brenet:john”
service=”IM” message=”call frank”

When a URL enabled client application has access to a configured Namespace Management System, it can specify the URL as a pdcx:request with a requested service, listing, and other parameters. In this context, a scheme handler may be called to direct the request to a Namespace Management System communication point.

Similarly, when a URR enabled client application has access to a configured Namespace Management System, it can specify a URR that is evaluated by the configured Namespace Management System. In this context, a scheme handler may be called to direct the request to a Namespace Management System communication point.

Design Patterns

A pattern describes a problem which occurs over and over again in our environment, and then describes the core of the solution to that problem in such a way that one can use this solution a million times over without ever doing it the same way twice. A design pattern names, abstracts, and identifies the key aspects of a common design structure that makes it useful for creating a reusable object-oriented design. A design pattern also includes sample code to illustrate an implementation.

Through the use of the Namespace Management System, the content of a configuration document can be representative of a design pattern description that, when evaluated within the context of the callable services, a design pattern implementation can be dynamically configured (registered) and usable through one or more callable services.

Discovery and Service Advertisements

For web service, the industry has turned to the Universal Description Discovery & Integration (UDDI), which is the definition of a set of services supporting the description and discovery of (1) businesses, organizations, and other web service providers, (2) the web services they make available, and (3) the technical interfaces which may be used to access those services. Based on a common set of industry standards, UDDI provides an interoperable, foundational infrastructure for a web services-based software environment for both publicly available services and services only exposed internally within an organization. Access points in UDDI are limited to attribute-qualified URI, typically a URL, representing the network address of the web service being described. UDDI does not address the specific requirements of overlay networks with respect to dynamism, decentralization, and maintenance. Overlay networks operate on top of a routing infrastructure based on a logical identification of the peers participating in the overlay. For routing, this logical identification is mapped onto an IP address in the routing tables. In the P-grid overlay network, peers generate universally unique identifiers locally, independent of their IP address or any other global information, and store them along with their public key, their current IP address, and a cryptographic signature in the P-Grid P2P lookup system [1, 4] on a certain number of peers (replicas). Instead of IP addresses, the unique IDs are used for querying and routing.

UDDI does not specify any kind of registry to manage models or even schemas or metadata. Thus, relationship information cannot be provided. For putting in a new web service, one has to know the existing tModels (supported by the implementation). Furthermore, the search facility is limited; one can search by keywords but cannot ask for “something similar”, since UDDI does not provide a vocabulary (ontology).

With the Namespace Management System, listings within a DNN are organized hierarchically with one or more Namespace Management Systems having authority for its relative listings within the DNN. The current point of presence for a listing may change over time, but the listing itself remains consistent. This enables a first Namespace Management System to direct a request to a second Namespace Management System by its corresponding DNN listing. Discovery is enabled through query requests that specify one or more satisfaction claims. When a Namespace Management System receives a query request, it calls the corresponding service to satisfy the request and sends an appropriate response. As an example, a Namespace Management System sends a configuration document representative of a request for a query service and specifies one or more satisfaction claims. In FIG. 23, for example, the request is for listings relative to brenet:staff.member.

A Namespace Management System can advertise one or more services by sending a service advertisement to a second Namespace Management System, and in response thereto, the second Namespace Management System's service for satisfying the service advertisement request registers information representative of the advertisement in a namespace. The second Namespace Management System service can direct a service advertisement to one or more additional Namespace Management Systems to propagate the advertised service. A Namespace Management System receiving a query request for service advertisements can satisfy the request using the information registered in a namespace.

A service advertisement describes a service and may include one or more constraints under which the service is to be provided. For example, a service advertisement can advertise a service provider service (i.e., a service that one or more subscribers can subscribe or otherwise request). Similarly, a service advertisement can be representative of a request for a service (i.e., provide me this service if, or when, you can satisfy the request). Similarly, a service advertisement can be representative of a configuration document that can be imported by a Namespace Management System desiring the use of the service. A service advertisement can include one or more satisfaction claim statements related to the advertisement, the availability, and/or conditions related to the service advertisement.

A satisfaction claim can describe an expiration that can be time oriented, event oriented, geographic oriented, or usage oriented. Similarly, a satisfaction claim can describe one or more prerequisites for providing the service.

A configured first Namespace Management System can offer a service to notify a second Namespace Management System via its DNN listing of an accessible service satisfying criteria specified by the second Namespace Management System. When the first Namespace Management System receives a service advertisement satisfying the criteria, it notifies the second Namespace Management System of the advertised service. A configured Namespace Management System (in addition to sending a service advertisement to a particular listing) can send zero or more service advertisements to its namespace service provider service. The namespace service provider service can aggregate advertisements and send corresponding service advertisements to its namespace service provider service as appropriate, and this process repeats for each namespace service provider service in the DNN.

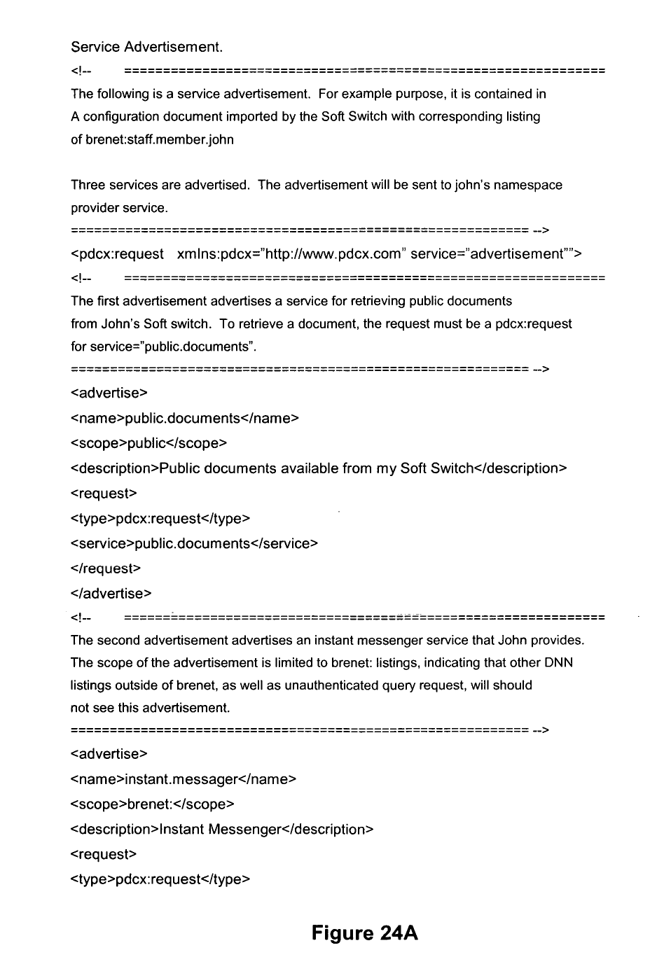

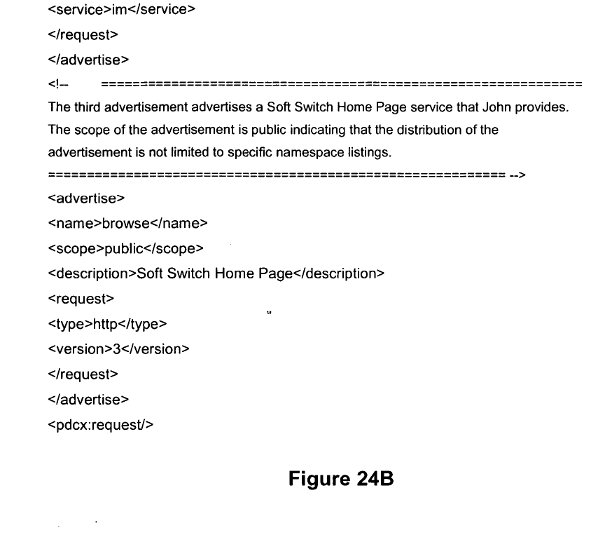

A configured Namespace Management System can import a configuration document describing a service advertisement request such as that shown in FIGS. 24A and 24B. When the request does not include a specific to listing, then the Namespace Management System will send the service advertisement to its namespace provider service. One skilled in the art can create, modify, or otherwise alter the content of a service advertisement and/or the configuration document describing how to evaluate a service advertisement to adhere to an industry specification, such as UDDI.

Syndication is a method of making content available to a range of outlets simultaneously. With web syndication, a portion of a web site is made available to other sites as a web feed. A web feed is an XML-based document in any of several emerging formats, such as RSS or ATOM. The Namespace Management System extends the usefulness of syndication by providing syndicated Namespace Management System service feeds describing one or more services offered by a configured Namespace Management System. A multiplicity of service feeds can be used, each based on criteria provided (or not provided) by a requesting process. Although described in terms of the Really Simple Syndication (RSS) Specification v2.0, other formats could be used such as ATOM v0.3, RSS v1.0, or RDF RSS. One skilled in the art can create a- configuration document with a service to provide the necessary content in the particular format desired.

Using a service feed allows for concise description of available namespaces, listings, services, workflows, and/or resources. It provides an easy method of publishing both interactive and non-interactive services. A configured Namespace Management System receiving the service feed content can filter syndicated services. This lowers bandwidth requirements in comparison to retrieving all SSDL configuration documents describing all services. A news aggregation reader service can be used to review syndicated service offerings, and the user can select the service, mark the service offering as ignored, or otherwise determine the disposition of the service offering.

The RSS Specification v2.0 makes use of an attribute named “url” and in one case clearly states the value must be an http: url. RSS is a dialect of XML. At the top level, a RSS document is a <rss> element, with a mandatory attribute called version that specifies the version of RSS to which the document conforms. If it conforms to this specification, the version attribute must be 2.0. Subordinate to the <rss> element is a single <channel> element, which contains information about the channel (metadata) and its contents. This is shown in FIG. RSS-1. An example service feed using RSS v2.0 is shown in FIG. RSS-2. Note that the item.link is a pdcx:request, and when the RSS document is rendered by a news reading service, the generated hyperlink is a pdcx:request. By installing a pdcx: scheme handler, the user can use a pointing device (a mouse) to select the hyperlink which causes a pdcx:request to be sent to their Namespace Management System's local compoint.

In one embodiment, the request is a request for the corresponding SSDL configuration document describing the service. In response thereto, the Namespace Management System can retrieve the corresponding SSDL configuration document describing the service. Information from the SSDL configuration document can be evaluated. Alternatively, or in conjunction therewith, information from the SSDL configuration document can be provided to the browser for additional user interaction, such as subscribing to a service or authorizing the configuration of the service with the local Namespace Management System.

Service Object

A namespace listing can be representative of a service object, similar to a Java object. The use of service objects is distinct from Java and C#, wherein source code must also be compiled and both require a main function for the program to execute (C# assembly can have DLLMain, WinMain, or Main).

In Microsoft .NET, programs are not compiled into executable files; they are compiled into Microsoft Intermediate Language (MSIL) files. The operating system cannot execute the MSIL generated code. The MSIL is saved to disk. An assembly is the basic unit or reuse and is a collection of files that appear to the programmer to be a single dynamic link library (DLL) or executable (EXE). The assembly is deployed and reused as a unit. A multi-module assembly consists of multiple files (zero or one EXE and zero or more DLL files, though at least one EXE or DLL is required). When one runs the program, it is compiled again using a Just-In-Time Compiler, and the machine's processor executes the resulting machine code. At least one main function must be included as an entry point for the executing application (the resulting machine code). The methods of a C# application defined object can be executed while executing the application, and thus cannot execute once the application terminates.

The Namespace Management System overcomes the limitation of requiring a compiler to produce deployable Java byte code or IL (Intermediate Language) files that must be recompiled by a Just-In Time Compiler and executed within a Common Language Runtime environment. A configuration document describes the service object and its use at run-time within the semantic domain of the Namespace Management System. Importing the content of the configuration document enables a service object to be dynamically registered (declared with zero or more service methods defined) during run-time and subsequently reused. A service object registered with the Namespace Management System can persist even after a registering application terminates. That is to say, an executing application program can send a configuration document to a configured Namespace Management System wherein the configuration document is imported the evaluation registers a service object, and said executing application program terminates.

The pdcx:service object services enable a namespace listing to be representative of a service object and provides for service object class registration, abstract classes, instance registration, state information operations, constants, method services, inheritance, interface registration, interface implementations, public and private scope, and class and instance composite members.

A service object class has a registered namespace listing wherein the corresponding entity includes one or more composite entities for representing state information, constants, and service methods. The service object class can be a subclass of a superclass, where the subclass inherits state information and service methods from the superclass. The subclass can override an inherited service method by providing a different implementation of the service method. The service object class can be registered as an abstract class containing one or more abstract service methods. The abstract class can be extended by providing the abstract service method action. A service method is a service owned by the service class and includes a declaration and a body where the declaration declares the service method and the body includes one or more statements describing the desired service operation. The action of a service method can register a string value associated with the service method, and this value can be retrieved by reference to the service method in a non-pdcx:service.object service.

A composite entity of the service object can have class or instance scope.

A service object class is registered using the pdcx:service.object.register service, and subsequently removed using the pdcx:service.object.delete service. A constructor service method is a composite registered as a service with the same basename (the unqualified service class name) as the service object class. An instance of a service object is registered using the pdcx:service.object.new service, where non-keyword named attribute values and composites (if any) are registered in the request: namespace before calling the appropriate constructor based on the criteria of the request: namespace (i.e., the entity information registered in the request: namespace).

The pdcx:registered.object.class.namespace defines the namespace for registering an otherwise unqualified service object class (i.e., a named service object class without a namespace designation) where the default value is “object:”.

A named composite entity that is not part of the semantic domain is interpreted according to its specified type, which can be a data type (i.e., signed or unsigned int, float, string, double, string) or “service”, with the former representing state information (or constants). The scope of said composite entity is one of “class” or “instance” (with the default being instance) and with a composite of public, private, or constant, with “public” being the default. The “class” scope indicates a single instance shared by all service objects, while “instance” indicates an instance per service object. The “private” portion indicates that only a service within the service object can operate on said composite entity, while “public” indicates that said composite entity is callable.

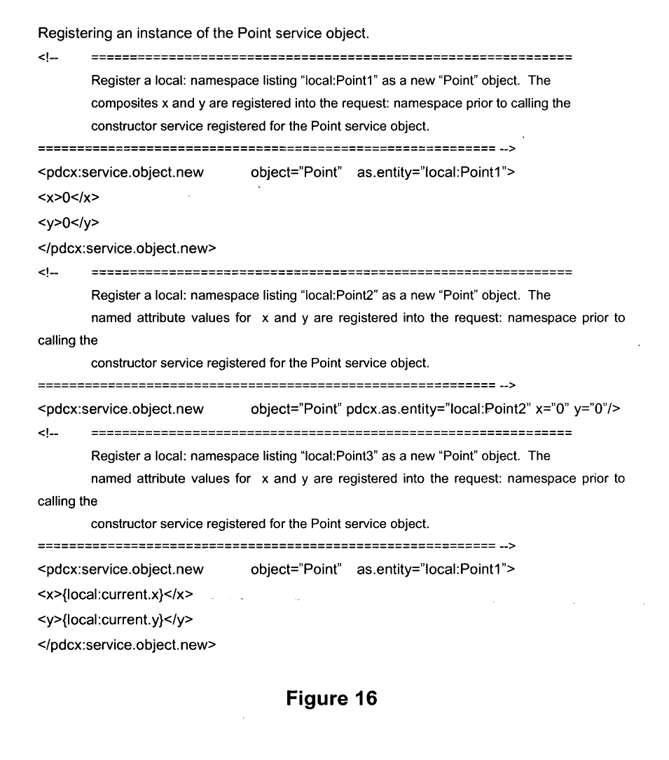

In FIG. 16, an object named “Point” is registered with composites “x” and “y” as named representations of state information. The named object “Point” is not qualified with a namespace, and thus defaults to “object:” and is bound as “object:Point”. The composites “x” and “y” are bound with “instance.public” scope. The composite “Point” is a service method, and since it has the same name as the service object, it is a constructor service method. The composites of “Point” include “x” and “y”, indicating the requirements for calling this construction service. The composite “pdcx:action” describes the constructor service action. When called, the constructor service registers a new instance of the Point service as the value of the listing specified by request:pdcx.as.entity, which defaults to the response: namespace.

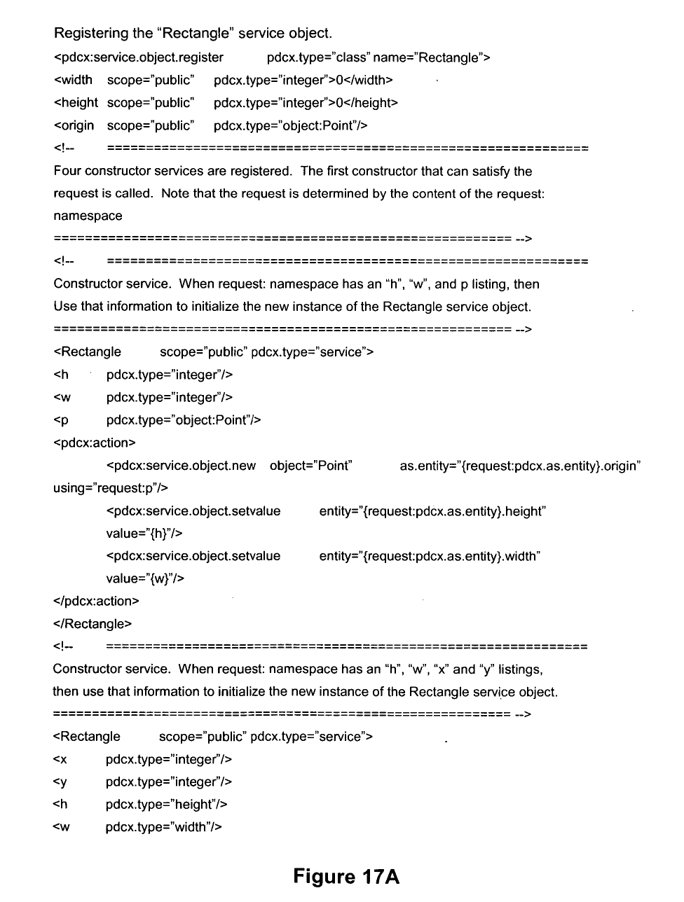

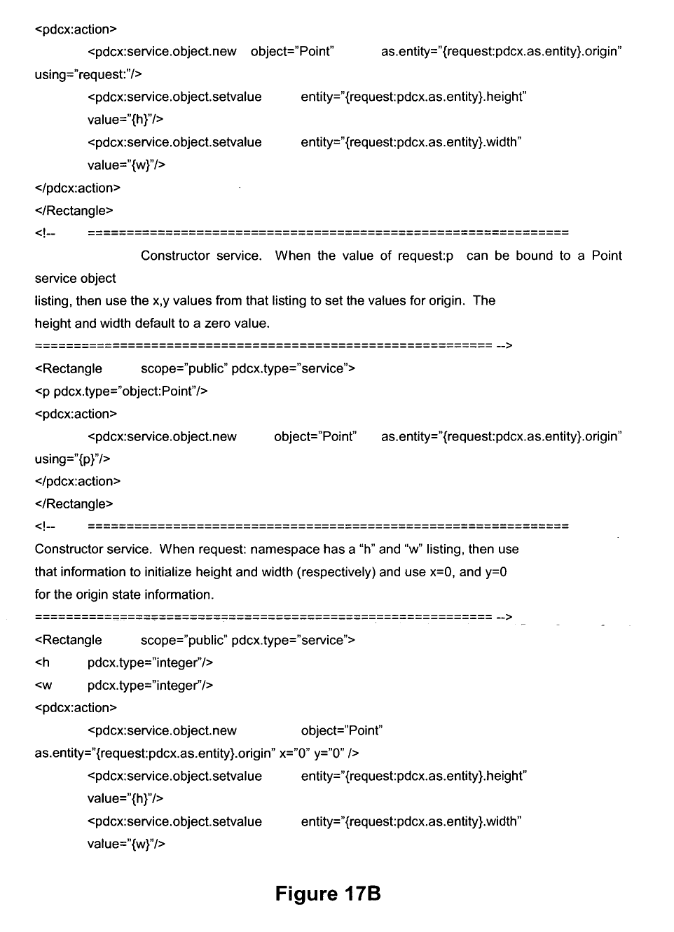

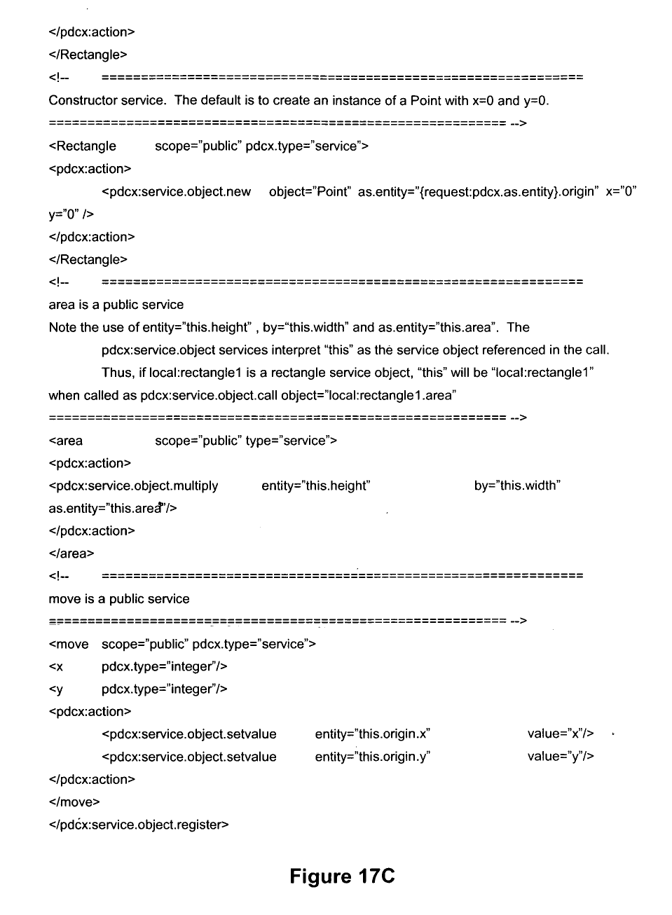

In FIGS. 17A through 17C, a service object named “Rectangle” is registered with composites “width” and “height” as named representations of state information. The named object is not namespace qualified and the pdcx:service.object.register service binds the name as “object:Rectangle”. The width and height are bound with instance.public scope, both representative of an integer. The origin is a Point service object. Four constructor service methods are registered along with an “area” and a “move” service method.

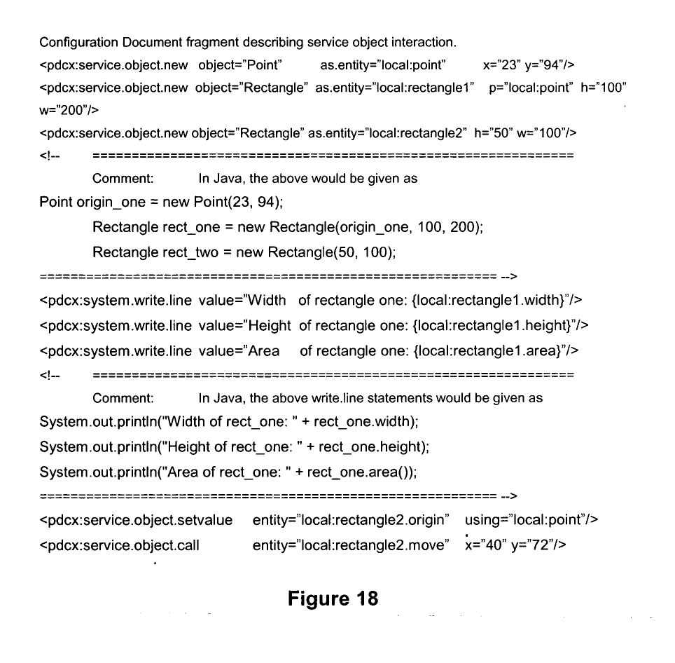

In FIG. 18, a fragment of a configuration document is shown to illustrate the use of the pdcx:service.object.new service along with various references to service object services and state information. The pdcx:service.object.call service is used to call a service method of an service object. The pdcx:service.object.setvalue service is used to set a service object's value.

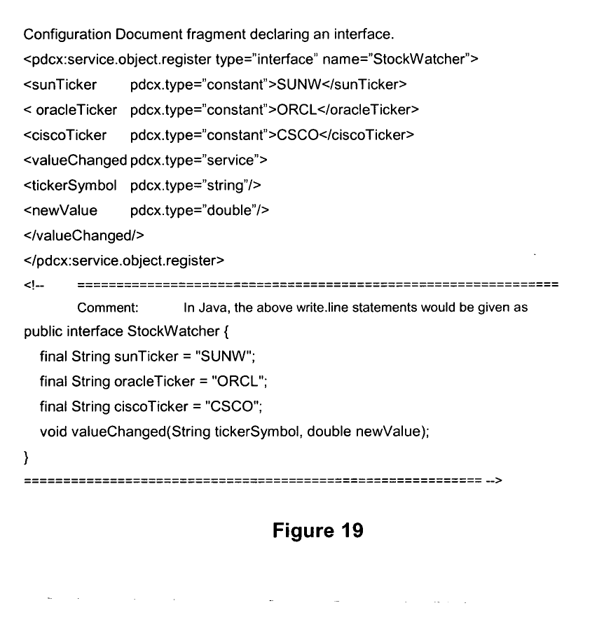

A service object interface is a named collection of service method definitions (without a body) and can register zero or more constants. A service object interface cannot implement any service method. The interface body contains the service declarations for all the service methods included in the service object interface. In FIG. 19, a fragment of a configuration document is shown to illustrate the use of pdcx:service.object.register to register an interface. For each service object interface implemented by the service object class, the registration must include a pdcx:service.object.implements statement identifying the interface, such as:

<pdcx:service.object. implements interface=“StockWatcher”/>

The service object class must implement all the service methods declared in the interface and its superinterfaces, or the class must be declared abstract. One can use service object interface names anywhere one can use pdcx.type within the pdcx:service.object services.

As an example, interface inheritance is provided through pdcx:service.object.implements, and implementation inheritance is provided through the pdcx:service.object.extends service. Implementation inheritance is discouraged, and said service can be removed from the pdcx:service.object services, thus providing only the interface inheritance service.

Reflection

Reflection is the process by which a program can read its own metadata. A program is said to reflect on itself (also referred to as “introspect” upon itself), extracting metadata from its assembly, and using that metadata either to inform the user or to modify its own behavior. The use of reflection is as at the discretion of the application programmer designing and implementing the source code to be used in a particular application. Once compiled and field deployed, the application program is limited to the logic design implemented by the programmer, and the programmer would be required to modify the source code, recompile, and field deploy. This places a burden on the end user desiring additional features, and is further complicated when access to the source code is limited (i.e.., a proprietary application where the source code is not available). While open-source source code provides wider access to the source code, the code must still be modified, compiled, and field deployed.

The limitation on the use of reflection requiring an application programmer to modify, compile, and field deploy the compiled application program is overcome by the Namespace Management System through the use of callable “service reflection” services. A configuration document statement can call the service reflection service without requiring source code changes to the application program. An end user of a Namespace Management System can create, edit, or otherwise obtain a configuration document using a service reflection service, and the state information representative of a dynamically constructed service object can be administered by the Namespace Management System for subsequent use.

Service reflection is the process by which a Namespace Management System is configured with one or more services to read state information representative of a service in a service: namespace administered by the Namespace Management System. This information can be used to inform the user or to configure and/or reconfigure services administered by the Namespace Management System. Service reflection can be used to retrieve entity type information. The pdcx:entity.typedef.info service, for example, can be called to register the type information of a specified type as an entity in a namespace. Similarly, the pdcx:entity.type.info service can be called to register the type information of an entity as an entity in a namespace. The pdcx:service.object.definition service can be called to register the definition of a service object as an entity in a namespace, including service methods and other state information. In general terms, a “service reflection” service can be called to obtain metadata about an entity in a namespace administered by the Namespace Management System.

Point of Presence Detection

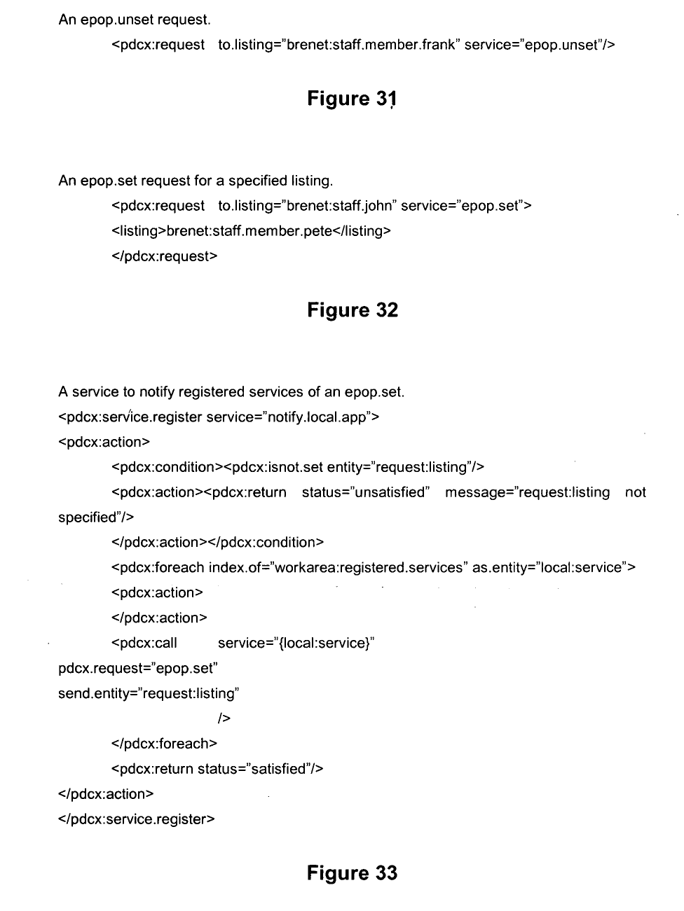

A first Namespace Management System can import a configuration document to send an epop.set request to a second Namespace Management System by specifying the listing of the second Namespace Management System in an epop.set request such as shown in FIG. 30. Similarly, a Namespace Management System can import a configuration document to send an epop.unset request to a listing (see FIG. 31). In response to receiving the request, the second Namespace Management System can evaluate one or more services, such as sending a notification request to a third Namespace Management System as shown in FIG. 32. When an epop.set request is received, the second Namespace Management System can communicate the availability of the listing to a registered service, as shown in FIG. 33. Upon receiving the communication, the registered service can display the availability to the user of the Namespace Management System through a graphical user interface (such as a buddy list).

A user of a configured Namespace Management System can provide their DNN listing when subscribing to services offered by a second Namespace Management System service provider. The service provider's Namespace Management System accepts the DNN listing, authenticates the credential, and may assign a secondary communication identifier, such as a screen name, to associate with the user subscriber. The response from the service provider Namespace Management System can include a pdcx:response for a registration service to register the service provider's listing for notification when the user subscriber Namespace Management System changes its point-of-presence registration.

Service Aggregation

The Namespace Management System enables switching between and among protocols and architectures providing explicit communication controls. This allows both the ultimate providers of content and portal operators to manage the aggregation of services and disintermediation as they choose. Various forms of service aggregation exist in the industry, including the provisioning of content and descriptions of content from a multiplicity of providers, as a service. A web portal, for example, can provide its subscribers content from a multiplicity of ultimate content and/or service providers. Similarly, service-oriented sites such as priceline.com expose certain form-based user interfaces such that, upon completion of the form detail, a user can submit a request that is processed by a CGI program to satisfy the request and generate a response. Portal providers generally attempt to provide uniquely packaged services/content to distinguish their offerings from that of their competitor. Now they have the option of marketing unique content and also merchandising connectivity to their content providers.

To prevent disintermediation of branded service offerings, web site operators generally do not fully disclose from whom or how content is being generated (other than from the top level web portal provider), nor do they have a mechanism to make direct access to that source free and/or easy to access directly where they at the same time control access to that provider. Portal providers rely on receiving certain content (such as news or general stories) via email from an author, and then provide this as re-branded content from their web site. Other content providers use a form of wholesale distribution, relying on proprietary applications and/or interfaces that are not available to the general public. A reporter or his syndicator, for example, may sell or resell (stories, editorials) content to a distributor. The distributor, such as www.sys-con.com, receives the story content and adds the story to their web site as featured content under their brand name and under their editorial supervision.

The Namespace Management System can be used to allow the portal operator to provide direct access to the ultimate content provider as a switchable service, while controlling the access to the content and being able to allow the ultimate provider and the portal to monitor and monetize each use of the content and to extend interest in any one instance of content dynamically into a larger relationship where more content and/or services can be offered by the ultimate content provider.

The Namespace Management System can also be used for ad hoc content services aggregation with or without editorial supervision. In certain instances, the Namespace Management System can also be used to allow for instantaneous direct and symmetric connection with the ultimate content and/or service provider without use of a form-driven CGI program.

The Namespace Management System allows the ultimate content provider to allow for active, controlled, and/or ad hoc disintermediation of any distributors and/or portals branded services offerings where the disintermediation can be a controlled and/or ad hoc service in its own right at the election of the ultimate provider. The ultimate content provider can register his content as a service in a DNN so that any party with an appropriately configured Namespace Management System can access the content, the service, and/or the ultimate provider directly through the corresponding listing and service request.

An advertised service, for example, that does not require a credential can be registered and made available from a Namespace Management System. When the Namespace Management System receives a request for the service, it can call the service, receive the response, and provide a response to the requesting process. When the use of the service requires a credential, the Namespace Management System can provide its credential or that of its subscriber when communicating with the advertised service. The ultimate provider can provide the necessary credential, and/or the ultimate provider can allow the content syndicate and/or distributor, the portal operator, to provide the necessary credential in exchange for a fee and/or some other consideration.

One skilled in the art can enable any portal operator to deploy Namespace Management Systems to its content providers and consumers. This deployment of Namespace Management Systems allows the portal operator to create a system of Namespace Management Systems and change the nature of the dynamic and dimension of its connections with its provider and/or end users.

Once deployed, the system of Namespace Management Systems allows the portal operator and the ultimate providers to collect meta data and other data and measure, count, and monetize any communication between any one or group of the distributed switches.

One skilled in the art can define groups within the system of Namespace Management Systems and define access controls that restrict the services and/or the access to those services and/or the provider of those services. One skilled in the art can allow authors or owners of works, the ultimate content providers, to control the provisioning of their content on any commercial terms through any portal or over the Internet network by first listing their works in a DNN and providing the means for the portal or other distributor to acquire a Namespace Management System configured to provide access to that content and/or service and any related descriptive information. One skilled in the art can use the Namespace Management System to allow content providers or groups of thematically related content providers to publish their content anonymously to consurmiers over the Internet Network without editorial constraint. One skilled in the art can use the Namespace Management System to allow consumers or groups of consumers of certain content to express their need to consume such content and to access that content anonymously.

Access Rights

The httpaccess.xml configuration document describes access control services including user administration service (UAS) and a satisfaction service used when accessing content. The UAS provides a user interface service for administering the satisfaction claims that must be satisfied by the satisfaction service when accessing content.

The UAS enables the user to view folders, create new folders, and remove old folders. Each folder can have access rights described by the satisfaction claims located within the folder as the named document “pdcxaccess.xml”. The UAS enables the user to create, view, edit, and remove pdcxaccess.xml configuration documents.

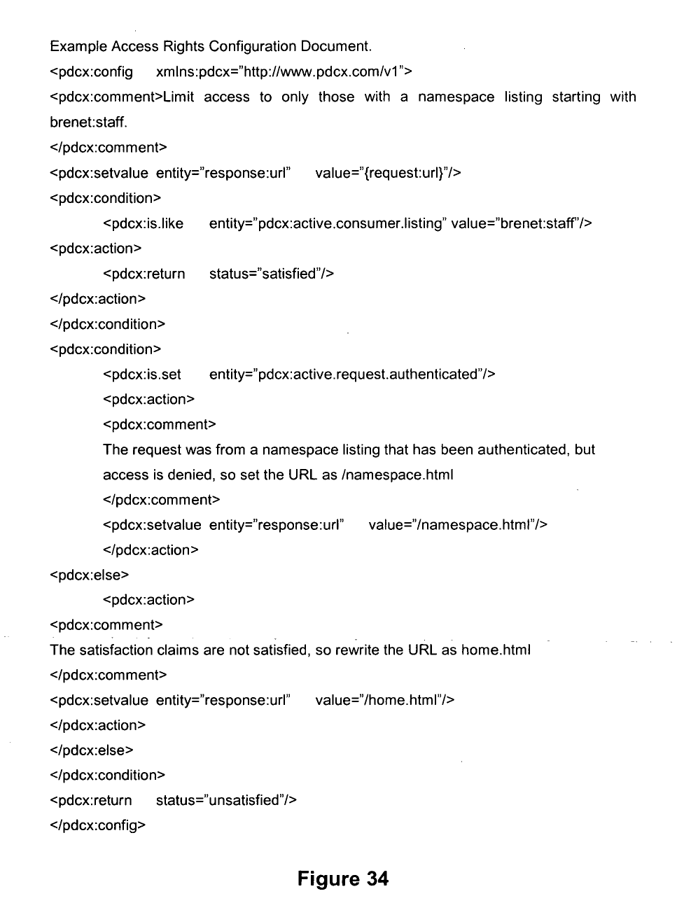

In creating or editing a pdcxaccess.xml configuration document, the user can set one or more namespace entity satisfaction claims. The return status is “satisfied” if the claims can be satisfied; otherwise, it is “unsatisfied”. The response:url is the path that the Namespace Management System is to use following the evaluation of the pdcxaccess.xml configuration document, which defaults to the existing path (see FIG. 34).

This is similar to Apache http:access rules, but allows one to set satisfaction claims based on the requesting process namespace listing, current date, current time, whether or not the request was authenticated, the remote host, remote IP address, DNN, and other namespace entity state information. Apache allows per user and group password authorization, but not namespace listings, current date, current time, nor distinguishing between authenticated and non-authenticated request. Unlike DNN listings, Apache user names and passwords are per web site. Access to content relative to the pdcxaccess.xml document is provided only if the satisfaction claims can be satisfied. When used with a hierarchical file system, each pdcxaccess.xml configuration document in the hierarchical path must be satisfied.

For Namespace Management System systems supporting the n-DFS (also known as 3dfs, source code freely available from http://www.research.att.com/sw/tools/ast), the open system call can be augmented to search for and import pdcxacccess.xml configuration documents. Alternatively, or in conjunction therewith, a Namespace Management System service can search for and import the pdcxaccess.xml configuration documents.

Hyper Text Transfer Protocol Services

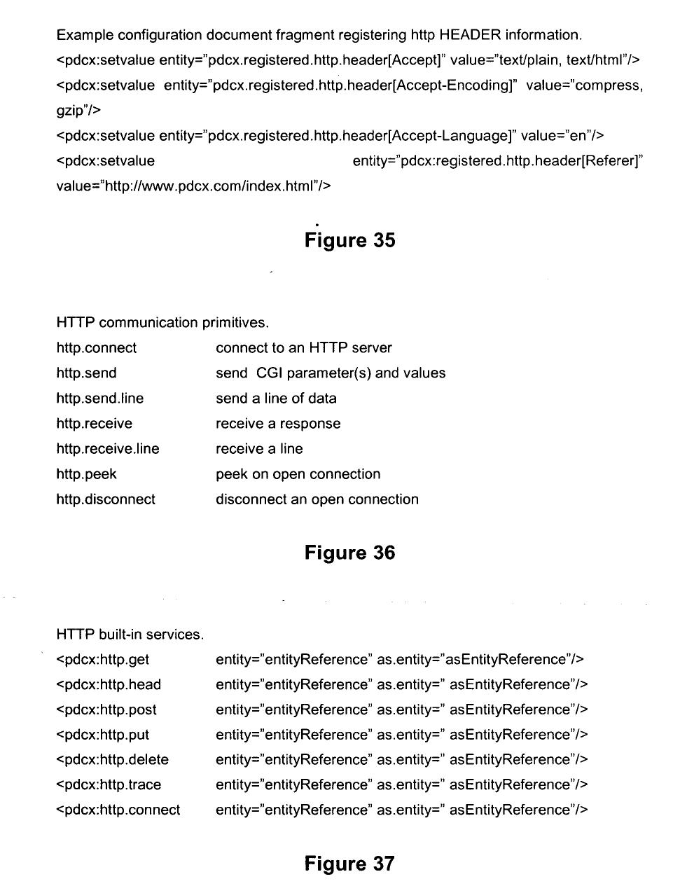

Listings within the http: active namespace represent resources accessed through the Hyper Text Transfer Protocol. A pdcx:entity.getvalue will use pdcx:http.get to request a resource, and a pdcx:entity.setvalue will use pdcx:http.post to post form data. The response from the POST command is saved as the current value, which can be retrieved using pdcx:entity.getvalue. The pdcx:entity.unset clears the current value. The pdcx:registered.http.header entity is used for the HTTP header (see FIG. 35). See FIG. 36 for a listing of http:communication primitives.

The http.connect service resolves the host reference and port reference and initializes the communication link. No data is sent or received. The registered connection is saved as the specified compoint.

### EXAMPLE

The following establishes a connection to the Google HTTP Server

<pdcx:comprim.http.connect
connectivity=”http://www.google.com” as.compoint=”google”/>

The http.send Service

The first call to http:send must send the HTTP command as the value of the send.value parameter. After the command is sent, the registered HTTP header information is sent. Cookie information, if any, is then sent, followed by a blank line. A second call to http:send can be used to send CGI named variable values if the HTTP command is POST. Otherwise, subsequent calls to hftp:send return status as unsatisfied.

### EXAMPLE

<pdcx:comprim.http.send compoint=”google”
value=”GET /search?q={local:keywords} HTTP/1.1”/>

The http.disconnect.send Service

The service is called to disconnect the send side of the communication link.

### EXAMPLE

<pdcx:comprim.http.disconnect.send compoint=”google” />

The http.receive Service

The service is called to receive the results of the HTTP command.

### EXAMPLE

<pdcx:comprim.http.receive compoint=”google”
as.entity=”response:http”/>

The http.disconnect Service

The service is called to disconnect the communication link.

### EXAMPLE

<pdcx:comprim.http.disconnect compoint=”google”/>

See FIG. 37 for the Hyper Text Transfer Protocol built-in services.
The pdcx:http.qet Service

The service generates the GET command string that is to be sent to the listing. The http.connect service is used to establish the connection. The http.send service is called to send the command string as the first line. The pdcx:http.get service then disconnects the send portion of the communication link using http.disconnect.send. The http.receive service is called to receive the response, and finally, the http.disconnect is called to disconnect the communication link.

### EXAMPLE

<pdcx:http.get listing=”google.com/search?q={local:keyword}” />

The pdcx:http.post Service

The service generates the POST command string that is to be sent to the listing. The http.connect service is used to establish the connection. The http.send service is called to send the command string as the first line. The http.send service is called to send the composite members of send.entity as CGI variable values. The http.send service is called to send a second blank line. The http.disconnect.send service is called to disconnect the send portion of the communication link. The http.receive service is called to receive the response, and finally, the http.disconnect is called to disconnect the communication link.

### EXAMPLE

In the following example, the HTTP POST command is sent to the Inet Address port 80 corresponding to www.pdcx.com for the /s resource. The send.entity identifies CGI variables to send as part of the POST. The from.listing and from.credential are not sent unless explicitly registered as composites of the send.entity.

<pdcx:http.post
listing=”http://www.pdcx.com/s” send.entity=”local:cgi.parameters”/>

### EXAMPLE

In the following example, the HTTP POST command is sent to the Namespace Management System corresponding to brenet:staff.member.john for the /s resource. The send.entity identifies CGI variables to send as part of the POST. The from.listing and from.credential are not sent unless explicitly registered as composites of the send.entity.

<pdcx:http.post
listing=”brenet:staff.member.john/s” send.entity=”local:cgi.parameters”/>

### EXAMPLE

In the following example, the resource is specified as a pdcx:request. The pdcx:http.post distinguishes a pdcx:request from a URI resource request and includes the from.listing and from.credential in the CGI variable values to be sent. The Namespace Management System receiving the request will register the CGI named variable values in the request: namespace prior to calling the service to satisfy the request.

<pdcx:http.post
listing=”brenet:staff.member.john/pdcx:request
service=’getNews’” send.entity=”local:cgi.parameters”/>

Cookie Information

An http response header can include cookie information. The pdcx:http.response.header service registers the http response information as pdcx:registered.http.response and sets cookie information in the cookie namespace corresponding to the relative listing called. Thus, cookie information in a response to http://www.pdcx.com/index.html is registered relative to cookie:www.pdcx.com/index.html.

HTTP Response

The registered response to the HTTP request can be sent as a response to a requesting process or further evaluated by the pdcx:http.response service. The service will register the header as the header.as entity and the body as the value of the body.as entity.

Using the Namespace Management System with Intelligent Edge Devices

The Namespace Management System can be used to implement many forms of discovery and interaction with intelligent edge devices such as PDAs, cell phones, and hand-held personal computers.

Emplovee Personal Identification Service

Many companies today use security badges or identification cards as means of personal identification for security purposes. These badges or cards may contain bar coding, magnetic stripes, RFID tags, and smart card coding as a means of distinguishing and identifying employees at secure checkpoints in order to grant access to physical facilities. The Namespace Management System, coupled with an intelligent edge device, can be used as a supplemental or alternative means of employee identification.

### Exemplary Implementation

The following provides an exemplary implementation of the Employee Personal Identification Service. XYZ Corporation implements an employee identification system using a multiplicity of Namespace Management Systems, an employee identification software program, and configuration documents. The system is comprised of a DNN Namespace Management System, a second Namespace Management System to process updates from the corporate human resources database, and a multiplicity of Namespace Management System enabled computing device security kiosks located at strategic access points throughout the headquarters' campus buildings and Bluetooth enabled cell phones. Each kiosk computing device is networked to the XYZ Corporation internal network and also supports Bluetooth communication. Each security kiosk runs the employee identification software program that is used to discover employee cell phones and communicate with the embedded cell phone program to obtain the employee unique identifier (EUI). Each employee is issued a company cell phone that is Bluetooth enabled. Alternatively, or in conjunction therewith, an employee may provide their own Bluetooth enabled cell phone.

XYZ Corporation uses a Namespace Management System to administer the xyzcorp: namespace with a first Namespace Management System. XYZ Corporation uses a second Namespace Management System to process employee identification requests against the corporate human resources database. The second Namespace Management System subscribes as xyzcorp:employee.central. As new employees are added to the corporate human resources database, a software program is used to register the employee with the xyzcorp:employee.central Namespace Management System. The software program connects to the xyzcorp:employee.central Namespace Management System and sends a pdcx:request for a service to register employee information adhering to a type definition for employee_id_t using the pdcx:entity.typedef built-in service where the type definition includes an employee name, employee number, date of hire, security level, a facial photo, and the Employee Unique Identifier (EUI). At the same time, the EUI is downloaded to the employee's cell phone, along with a cell phone identifier software program used to communicate with the kiosk cell phone discovery program.

XYZ Corporation uses an additional Namespace Management System in each security kiosk. In addition to the Namespace Management System, each security kiosk runs a cell phone discovery program that enables discovery of Bluetooth enabled cell phones as they are presented at the kiosk and to retrieve the EUI from the phone. As employees approach a security kiosk, the cell phone discovery program uses standard Bluetooth networking methods to establish a session with the cell phone carried by the employee. The cell phone discovery program establishes communication with the embedded cell phone identifier program and transfers the EUI. Once the EUI is received, the cell phone discovery program connects to the xyzcorp:employee.central Namespace Management System and sends the EUI and the kiosk identifier as a pdcx:request for service:request.employeeaccess to authenticate the employee and validate access level for the kiosk. When the xyzcorp:employee.central Namespace Management System receives the request, the provided EUI and security kiosk identifier are validated. If the EUI is found, and the security kiosk identifier is valid for the registered security level for the employee, the xyzcorp:employee.central Namespace Management System sends a response back to the security kiosk Namespace Management System that includes information from the registered employee information. The Namespace Management System on the security kiosk sends the contents to the cell phone discovery program, which displays the employee name and photo on the kiosk display device to indicate access is allowed. If the EUI is not found, or if the employee does not have sufficient access granted for the kiosk, the xyzcorp:employee.central Namespace Management System sends a response back to the security kiosk Namespace Management System indicating access is denied.

In some implementations, a log of employee access is created to track employee movements within the facility. In other implementations, the cell phone may be used to require the employee to enter a challenge/response code using the keypad of the phone to complete authentication. In other implementations, the security kiosk may be capable of controlling automatic access gates or doors, granting or denying access without the need for a human security guard. In other implementations, a PDA or hand-held computing device may be used to store the EUI. In other implementations, a smart card may be used to store the EUI and a smart card reader used instead of Bluetooth communications.

Paperless Airline Travel Service

When traveling by air, paper documents such as tickets, boarding passes, and baggage claim checks are used as a means of identification of the traveler and also to document pertinent travel data such as airport gate, seat number, and departure and arrival time. The Namespace Management System may be used to implement a paperless system that provides all of the capability of the current method.

### Exemplary Implementation

The following provides an exemplary implementation of the Paperless Airline Travel Service for travelers who have Bluetooth enabled cell phones. Keen Air implements a paperless travel service using -a multiplicity of Namespace Management Systems, software programs, and configuration documents. The system is comprised of a DNN Namespace Management System administering the keenair: namespace, a second Namespace Management System to process updates from the corporate reservation data base with subscription keenair:central, and a multiplicity of Namespace Management System enabled computing device kiosks located at strategic points throughout the Keen Air airport locations and Bluetooth enabled cell phones. Each kiosk computing device is networked to the Keen Air internal network and also supports Bluetooth communication. Each kiosk runs the traveler identification software program that is used to discover traveler cell phones and communicate with the embedded cell phone program to obtain the customer unique identifier (CUI) and download flight data. Keen Air customers who use the service have Bluetooth enabled cell phones.

Keen Air uses a Namespace Management System to administer the keenair: namespace with a first Namespace Management System. A second Namespace Management System (keenair:central) is used to process customer identification requests against the corporate reservations database and to provide flight itinerary data. Before Keen Air customers can use the service, they must first register using the Keen Air corporate web site, providing their name and a facial photo for identification. As new customers are added to the corporate reservations database from the web site, a software program is used to register the customer with the keenair:central Namespace Management System. Registration includes a CUI that is assigned to each customer. The software program connects to the keenair:central Namespace Management System and sends a pdcx:request for a service to register customer information adhering to a type definition for customer_id_t using the pdcx:entity.typedef built-in service, where the type definition includes the customer name, a facial photo, and the unique CUI. At the same time, the CUI is made available to be downloaded to the customer's cell phone, along with a cell phone identifier software program used to communicate with the kiosk cell phone discovery program. When a Keen Air customer books an air travel reservation, the reservation is linked to the customer's CUI in the Keen Air reservation database, the program communicates with the keenair:central Namespace Management System, and sends a pdcx:request to register a reservation adhering to the reservation_id_t type definition for reservation_id_t where the type contains a flight number, seat assignment, and CUI.

Keen Air uses an additional Namespace Management System in each airport kiosk. In addition to the Namespace Management System, each airport kiosk runs a cell phone discovery program that enables discovery of Bluetooth enabled cell phones as they are presented at the kiosk and to retrieve the CUI from the phone. As customers approach the airport baggage check-in kiosk located at the airport departure entrance, the cell phone discovery program uses standard Bluetooth networking methods to establish a session with the cell phone carried by the customer. The cell phone discovery program establishes communication with the embedded cell phone identifier program and transfers the CUI. Once the CUI is received, the cell phone discovery program connects to the local Namespace Management System and sends the CUI and the kiosk identifier as a pdcx:request for service:request.checkbaggage. The local airport baggage check-in kiosk Namespace Management System sends a request to the keenair:central Namespace Management System in order to authenticate the customer, determine flight status, and obtain flight data. When the keenair:central Namespace Management System receives the request, the provided CUI and kiosk identifier are validated against the registered information for customer_id_t and reservation_id_t. If the CUI is found, and a reservation is found for today, the keenair:central Namespace Management System sends a response back to the airport baggage check-in kiosk Namespace Management System that includes the information registered for the corresponding CUI. The Namespace Management System on the airport baggage check-in kiosk sends the information to the cell phone discovery program, which displays the customer name and photo on the kiosk display device for the baggage clerk manning the station to visually identify the customer. Bar-coded baggage claim tickets are printed for each piece of luggage to be checked by the kiosk and attached to each piece of luggage. The flight information is also downloaded to the customer's cell phone at this time, including flight number, gate, seat assignment, and travel times. If the CUI is not found, or if no flight reservation can be found, the keenair:central Namespace Management System sends a response back to the airport baggage check-in kiosk Namespace Management System, and a message is displayed on the kiosk display device for alerting the baggage clerk to deny access.

As customers approach the airport security kiosk located at the airport concourse entrance, the cell phone discovery program uses standard Bluetooth networking methods to establish a session with the cell phone carried by the customer. The cell phone discovery program establishes communication with the embedded cell phone identifier program and transfers the CUI. Once the CUI is received, the cell phone discovery program connects to the local Namespace Management System and sends the CUI and the kiosk identifier as a pdcx:request for service:request.authenticatetravel. The local airport security kiosk Namespace Management System sends a request to the keenair:central Namespace Management System in order to authenticate the customer and determine flight status and obtain flight data. When the keenair:central Namespace Management System receives the request, the provided CUI and kiosk identifier are validated against the registered customer_id_t and reservation_id_t information corresponding to the CUI. If the CUI is found, and a reservation is found for today, the keenair:central Namespace Management System sends a response back to the airport security kiosk Namespace Management System that includes the content of the registered type definitions. The Namespace Management System on the airport security kiosk sends the contents to the cell phone discovery program, which displays the customer name and photo on the kiosk display device for the airport security guard manning the station to visually identify the customer. If the CUI is not found, or if no flight reservation can be found, or if the customer is not at the correct airport concourse location for his gate, the second Namespace Management System sends a response back to the airport security kiosk Namespace Management System, and a message is displayed on the kiosk display device for alerting the security guard to deny access.

As customers approach the airport boarding gate kiosk located at the airport boarding gate, the cell phone discovery program uses standard Bluetooth networking methods to establish a session with the cell phone carried by the customer. The cell phone discovery program establishes communication with the embedded cell phone identifier program and transfers the CUI. Once the CUI is received, the cell phone discovery program connects to the local Namespace Management System and sends the CUI and the kiosk identifier as a pdcx:request for service:request.authenticatetravel. The local airport boarding gate kiosk Namespace Management System sends a request to the keenair:central Namespace Management System in order to authenticate the customer, determine flight status, and obtain flight data. When the second Namespace Management System receives the request, the provided CUI and kiosk identifier are validated. If the CUI is found, and a reservation for the corresponding CUI is found for today, the keenair:central Namespace Management System sends a response back to the airport boarding gate kiosk Namespace Management System that includes the information corresponding to the registered type definitions related to CUI. The Namespace Management System on the airport boarding gate kiosk sends the contents to the cell phone discovery program, which displays the customer name and photo on the kiosk display device for the Keen Air boarding agent manning the station to visually identify the customer. The Namespace Management System at the airport boarding gate sends a pdcx:request of type service:request.enplane to the keenair:central Namespace Management System to update the boarding status of the customer. If the CUI is not found, or if no flight reservation can be found, or if the customer is not at the correct gate for his flight, the keenair:central Namespace Management System sends a response back to the airport boarding gate kiosk Namespace Management System, and a message is displayed on the kiosk display device for alerting the Keen Air boarding agent to deny access.

At any time after checking luggage at the first kiosk, the customer may review flight itinerary via the embedded flight information program on the cell phone. If the customer's flight is delayed, the customer can be alerted on their cell phone while they are in communication with any Keen Air kiosk located throughout the airport.

After the flight has completed, as customers approach the airport baggage claim kiosk located at the baggage claim area, the cell phone discovery program uses standard Bluetooth networking methods to establish a session with the cell phone carried by the customer. The cell phone discovery program establishes communication with the embedded cell phone identifier program and transfers the CUI. Once the CUI is received, the cell phone discovery program connects to the local Namespace Management System and sends the CUI and the kiosk identifier as a pdcx:request for service:request.authenticatebaggage. The local airport baggage claim kiosk Namespace Management System sends a request to the keenair:central Namespace Management System in order to authenticate the customer, determine flight status, and obtain flight data. When the keenair:central Namespace Management System receives the request, the provided CUI and kiosk identifier are validated. If the CUI is found, and a reservation is found for today, the keenair:central Namespace Management System sends a response back to the airport baggage claim kiosk Namespace Management System that includes the information corresponding to the CUI. The Namespace Management System on the airport gate kiosk sends the contents to the cell phone discovery program, which displays the customer name and photo on the kiosk display device for the baggage claim agent manning the station to visually identify the customer. A bar code scanner on the kiosk is used to verify the luggage being checked out as belonging to the customer. The Namespace Management System at the airport baggage claim kiosk sends a pdcx:request of type service:request.deplane to the keenair:central Namespace Management System to update the boarding status of the customer. If the CUI is not found, or if no flight reservation can be found, or if the customer did not check baggage, the keenair:central Namespace Management System sends a response back to the airport baggage claim kiosk Namespace Management System, and a message is displayed on the kiosk display device for alerting the baggage claim agent to deny access.

In some implementations, a log of customer access is created to track movements within the airport. In other implementations, the cell phone may be used to require the customer to enter a challenge/response code using the keypad of the phone to complete authentication. In other implementations, a PDA or hand-held computing device may be used to store the CUI. In other implementations, a smart card may be used to store the CUI and a smart card reader used instead of Bluetooth communications.

In another implementation, the Paperless Airline Travel Service can be extended to facilitate auto rentals for the Keen Air customer. Cooperating with Acme Auto Rental, Keen Air provides Namespace Management Systems and software to extend their service. Acme Auto Rental subscribes to the keenair: namespace as keenair:acmeauto with a Namespace Management System used for reservations and kiosk Namespace Management Systems deployed at strategic airport locations. Customers book auto rental reservations via the Acme Auto Rental web site, at which time a software program is used to register the customer with the Acme Auto Namespace Management System. Registration includes the Keen Air CUI that is assigned to each customer. When a Keen Air customer books an auto rental reservation, the reservation is linked to the customer's CUI in the Keen Air reservation database, and the program communicates with the Acme Auto Namespace Management System using the pdcx:request service to register auto type, rental dates, and CUI.

As customers approach the Acme Auto Rental check-in kiosk located at the airport arrival entrance, the cell phone discovery program uses standard Bluetooth networking methods to establish a session with the cell phone carried by the customer. The cell phone discovery program establishes communication with the embedded cell phone identifier program and transfers the CUI. Once the CUI is received, the cell phone discovery program connects to the local Namespace Management System and sends the CUI and the kiosk identifier as a pdcx:request for service:request.checkreservation to the keenair:central Namespace Management System to authenticate the customer.

When the keenair:central Namespace Management System receives the request, the provided CUI and kiosk identifier are validated. If the CUI is found, the Namespace Management System on the check-in kiosk sends another request to the keenair:acmeauto Namespace Management System to obtain reservation data. In response thereto, the Namespace Management System on the check-in kiosk sends the contents to the cell phone discovery program, which displays the customer name and photo on the kiosk display device for the auto rental clerk manning the station to visually identify the customer. The reservation information is also downloaded to the customer's cell phone at this time, including parking lot lane number, auto make, model, and color, license plate number, and rental times. If the CUI is not found, or if no rental reservation can be found, the Keen Air Namespace Management System sends a response back to the check-in kiosk Namespace Management System, and a message is displayed on the kiosk display device for alerting the auto rental clerk to deny access.

When returning the rental car, as customers approach the Acme Auto return kiosk located at the rental return area, the cell phone discovery program uses standard Bluetooth networking methods to establish a session with the cell phone carried by the customer. The cell phone discovery program establishes communication with the embedded cell phone identifier program and transfers the CUI. Once the CUI is received, the cell phone discovery program connects to the local Namespace Management System and sends the CUI and the kiosk identifier as a pdcx:request for service:request.returnauto to the keenair:acmeauto Namespace Management System. The local kiosk Namespace Management System sends the request to the Keen Air Namespace Management System in order to authenticate the customer. When the Keen Air Namespace Management System receives the request, the provided CUI is validated. If the CUI is found, a request is sent to the Acme Auto Namespace Management System for service:request.checkreservation and, if an active reservation is found, the Acme Auto Namespace Management System sends a response back to the kiosk Namespace Management System that includes the content of the registered type definitions. The Namespace Management System on the kiosk sends the contents to the cell phone discovery program, which displays the customer name and photo on the kiosk display device for the rental agent manning the station to visually identify the customer. If the CUI is not found, or if no reservation can be found, the Namespace Management System sends a response back to the kiosk Namespace Management System, and a message is displayed on the kiosk display device for alerting the rental agent to deny access.

In another implementation, Acme Auto Rental may use their own unique CUI and use their own network of Namespace Management Systems instead of Keen Air Namespace Management Systems to authenticate customers. In another implementation, the Paperless Airline Travel Service can be extended to facilitate other travel related services, such as hotel, dining, or entertainment services.

Personalized Shopping Service

Although every household performs grocery shopping on an average of one or more times per week, this activity remains almost devoid of technology from the customer's perspective. Communication of grocery sale items and specials is generally accomplished via printed flyers either sent via the US Postal Service or made available at the store. Although the exemplary implementation is described in terms of Grocery Shopping, one skilled in the art can apply the methods and systems to other shopping experiences, including retail and real estate.

### Exemplary Implementation

The following provides an exemplary implementation of the Personalized Grocery Shopping Service. Snapping Fresh Markets implements a personalized grocery shopping service using a multiplicity of Namespace Management Systems, software programs, and configuration documents. The system is comprised of a DNN Namespace Management System, a second Namespace Management System to process updates from the corporate product inventory and customer databases, a multiplicity of Namespace Management System enabled computing device kiosks located at strategic points throughout the Snapping Fresh Markets grocery stores, and Bluetooth enabled cell phones. Each kiosk computing device is networked to the Snapping Fresh Markets internal network and also supports Bluetooth communication. Each kiosk runs the customer identification software program that is used to discover customer cell phones and communicate with the embedded cell phone program to obtain the customer unique identifier (CUI) and download shopping list data. Snapping Fresh customers who use the service have Bluetooth enabled cell phones.

Snapping Fresh uses a Namespace Management System to administer the snappingfresh: namespace with a first Namespace Management System. A second Namespace Management System subscribed as snappingfresh:central is used to process customer identification requests against the corporate customer database. Before Snapping Fresh customers can use the service, they must first register using the Snapping Fresh corporate web site, providing their name and a facial photo for identification. As new customers are added to the corporate database from the web site, a software program is used to register the customer with the snappingfresh:central Namespace Management System. Registration includes a CUI that is assigned to each customer. The software program connects to the snappingfresh:central Namespace Management System and registers the customer name, a facial photo, and the unique CUI. At the same time, the CUI is made available to be downloaded to the customer's cell phone, along with a cell phone identifier software program used to communicate with the kiosk cell phone discovery program.

Each time the customer makes a purchase from Snapping Fresh, their customer CUI can be used to track purchasing information. The CUI may be obtained from the customer's cell phone or via a standard magnetic card reader to read an issued customer identification card. The tracked purchasing information can be used to determine the frequency of visits and/or the dollar amount spent by the customer over a period of time (customer purchase history). The current customer purchase information is be sent to the snappingfresh:central Namespace Management System.

On subsequent visits to Snapping Fresh, the cell phone identifier software program executing as a process at the Namespace Management System kiosk located near the entrance of the store can obtain the customer CUI. The Namespace Management System sends a pdcx:request including the CUI to the snappingfresh:central Namespace Management System to request the customer.in.store service. The customer.in.store validates the CUI and interacts with the customer purchase history to select in-store special discounts for the customer. The in-store special discounts are sent as a pdcx:response to the requesting kiosk Namespace Management System and, in response thereto, communicated to the customer cell phone. The customer can view the information on their cell phone display to determine the in-store discounts applicable to the customer and make purchasing decisions accordingly.

Alternatively, or in conjunction with, the Snapping Fresh implementation uses a customer purchase history to selectively advertise services to said customer. The advertisement may be sent electronically to the customer's registered namespace listing, their cell phone, or to their electronic mail address.

Controlled Service Portals

Access to web sites providing subscription based services is often controlled via a user login and password, and the use of cookies. This requires the user to remember the login and password in order to gain access to the service offerings. There is also the risk that the subscriber will share his login and password with others, thus diminishing the monetization value of the service offering. With the Namespace Management System, access to service offerings can be controlled via the user's namespace listing.

In an implementation, Breanna is provisioned the brenet: namespace and her cousin is provisioned the nicolenet: namespace. Breanna can configure her Namespace Management System so that service offerings are available only to authorized members of nicolenet:, and Nicole can configure her Namespace Management System so that service offerings are available only to authorized members of the brenet: namespace. Using her web browser, Breanna can enter the URL address as a URR, such as nicolenet://service:news.from.school. The scheme handler redirects the request to her Namespace Management System local compoint, which then sends a request to the registered point of presence for the nicolenet: namespace. In response thereto, Nicole's Namespace Management System verifies the request is from a brenet: namespace member and provides the requested service. With the Namespace Management System, both Nicole and Breanna can easily establish rules governing the access to services without the burden of login/password and cookie administration. Both Nicole and Breanna can optionally narrow or expand the namespace listings from which they will accept requests. Further, either or both can offer public services, such as general information, information indicating that access is denied, or limited to particular namespace listings.

Market Makers

In the financial circles, the primary mechanisms supporting hedging against exposure to uncertain events and/or speculative trading on uncertain events include a continuous double auction, continuous double auction with market maker, and dynamic pari-mutuel market. The primary mechanism used for sports wagering is a bookie or bookmaker. Financial trading and wagering are logically the same with the bookie (bookmaker) acting as a market maker. Various market service offerings exist today. For sports betting, the service provider (the market maker) often takes a set transaction fee per wager or a fee calculated proportional to a wager such as $1 for each $10 wagered.

To provide an online market service offering, a market maker registers a domain name and establishes a web presence describing the offering and the rules and provides sign-in services for clients. To attract participants, the market maker must advertise their market service offering, wait for potential participants to discover and visit their web site, and to subscribe. After subscribing, the participant can discover more detailed information on current market service offerings.

The current implementations require the user to initiate the action of seeking out the current market service offerings. Although a market maker could provide an email notification service to alert the participant of current market offerings, it still requires the user to initiate an action such as checking for new email. If the user is traveling, this may not be possible, even though other forms of communication with the user would be possible, such as through their cell phone.

Breaking news related to the offering can impact a market offering or generate a new opportunity for an offering. Breaking news that OPEC has cut production rates, for example, can impact an offering for the oil futures market offering. The market maker ideally would want to contact a subscriber with the offering, and the subscriber ideally would want to learn of the offering as soon as possible, but in today's environment the subscriber must initiate the action.

The Namespace Management System overcomes these limitations by allowing a subscriber to receive a request or advertisement, in near real-time, describing the offering. The market maker can describe the opportunity through a form which is sent as a request to the subscriber, and in response thereto, the form is rendered in a browser for the subscriber to either accept or reject the offering. In this context, the browser will be started automatically and display the form. By selecting the accept button, the subscriber's browser will send the request to the Namespace Management System, which can encrypt all or part of the response back to the market maker sponsoring the market offering.

In an implementation, a market maker named Dallet is a stock broker who sponsors an opportunity and broadcasts the opportunity as a pdcx:request to her clients. One of her clients has the namespace listing chase:client.pete, and his Namespace Management System receives the request, generates an HTML form, and launches (starts the execution of) his web browser to render the HTML form. The form is displayed, and in response thereto, Pete selects the accept button to accept the market offering. Alternatively, Pete can enter information into the form prior to selecting the accept button. The scheme handler is used to send the response to his Namespace Management System, which in turn accepts the response to be sent to his broker, encrypts the content using the Public Key Infrastructure credential, and sends the response to his broker's namespace listing. Alternatively, Pete could configure his Namespace Management System to accept the initial request and communicate it using a session initiation protocol to his cell phone. Alternatively, he could configure his Namespace Management System to forward the request using a different protocol accessible to his Namespace Management System.

Any user with an active namespace listing can sponsor a market offering service through the Namespace Management System. A user with an active namespace listing can offer a facilitation service to facilitate a market offering and charge a fee, such as a transaction fee, for the use of the service. This enables a sponsor of a market offering to advertise the offering and have the facilitator provide information regarding the offering to its subscribers.

Horserace Namespace

A first user subscribes to the Root Namespace Management System to obtain the horserace: namespace and is provided a configured Namespace Management System along with a subscription document that, when imported into the Namespace Management System, registers the current point of presence for the horserace: namespace. In addition, the user has the horserace.com domain name and has a web site offering detailed information about the horserace: namespace.

An authorized Freehold Racetrack employee using their Microsoft IE web browser enters the horserace.com web site URL, and the resource response is rendered in their browser and displayed on their screen. The employee completes a form displayed in their browser, submits the form, and the browser receives a respond page that is rendered in the browser window, the rendered page including a hyperlink to a subscription configuration document and a second hyperlink to a configured Namespace Management System that can be downloaded and installed.

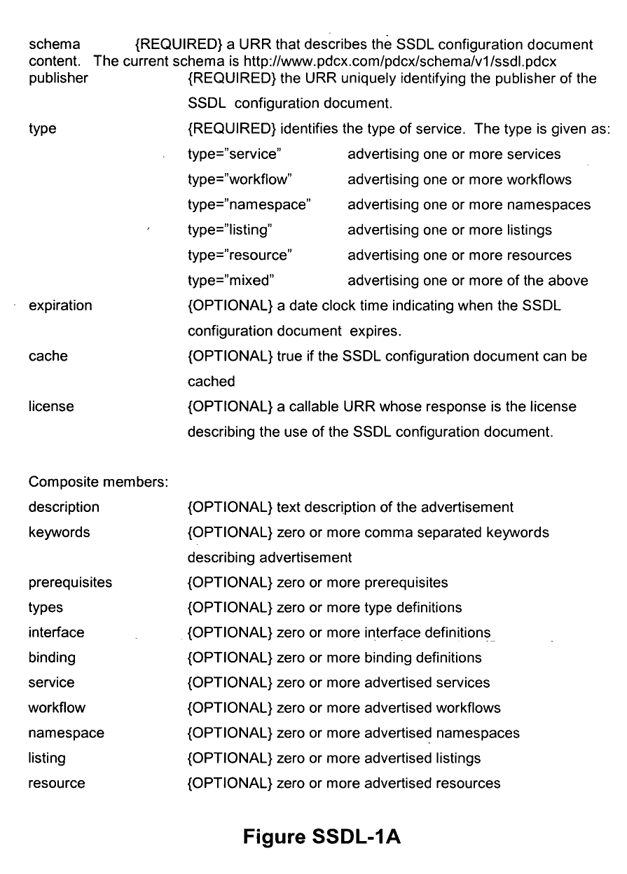

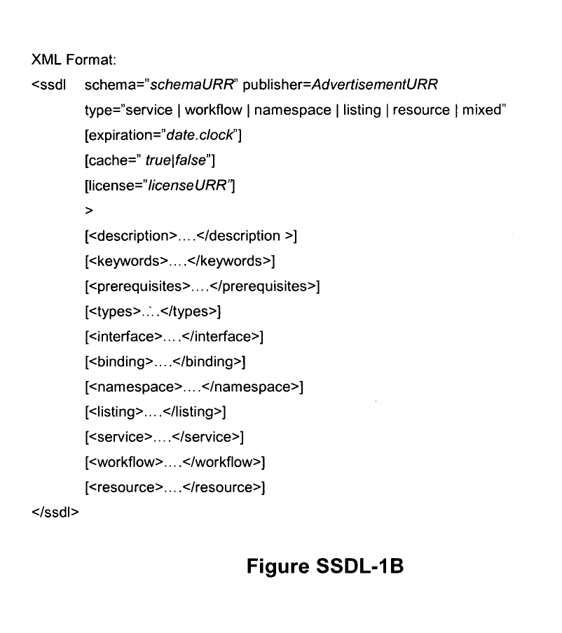

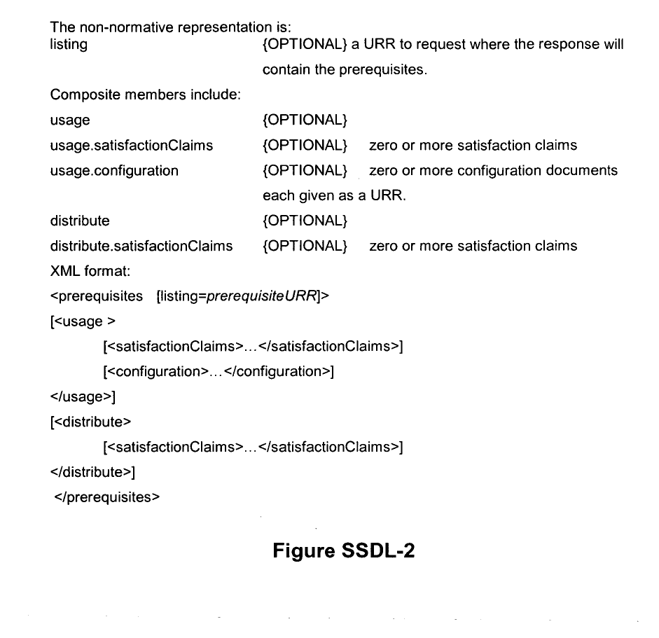

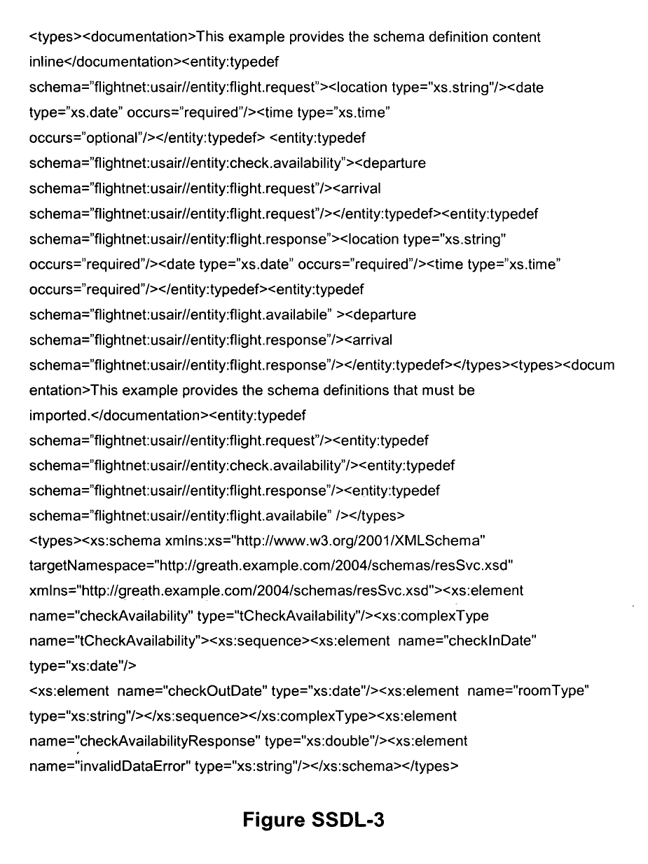

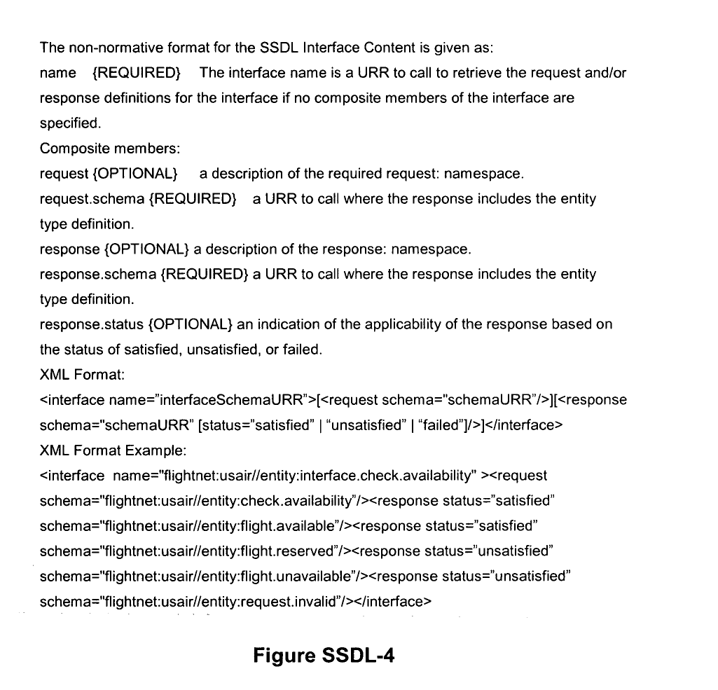

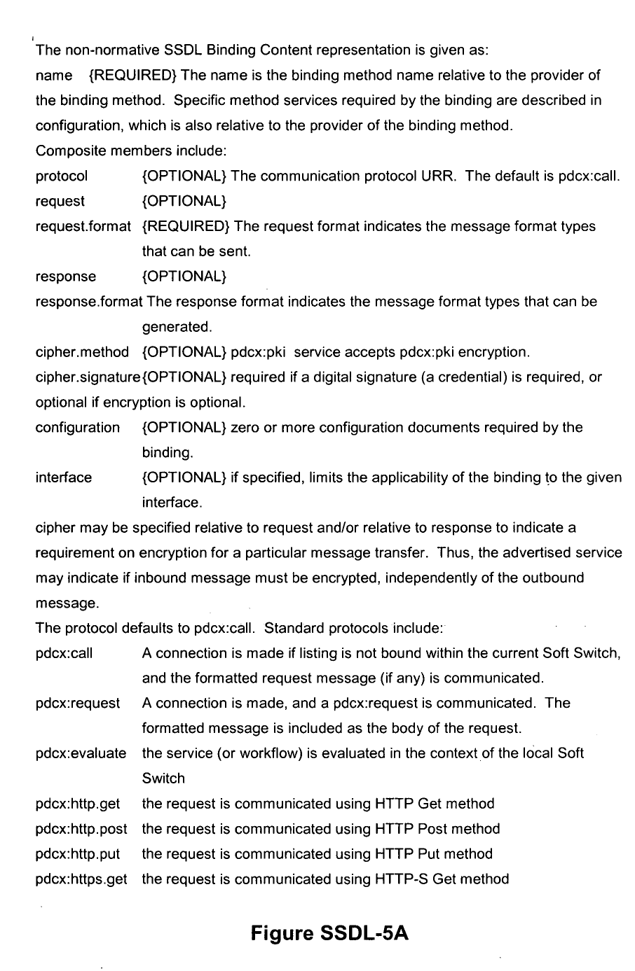

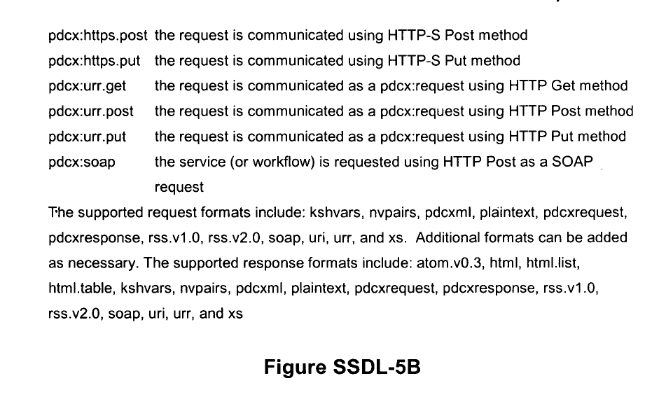

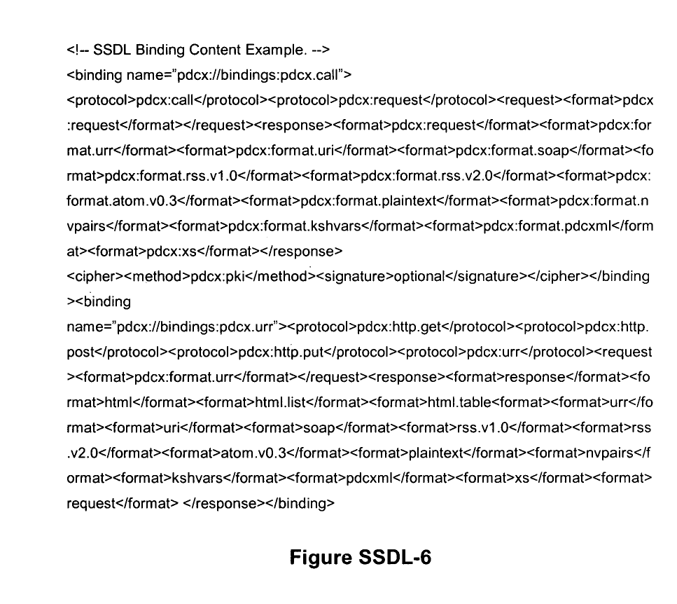

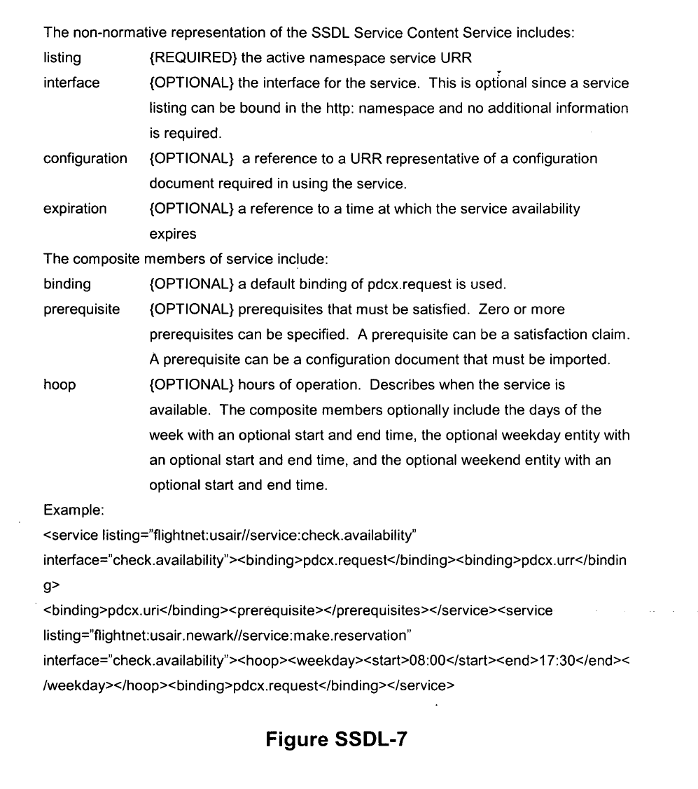

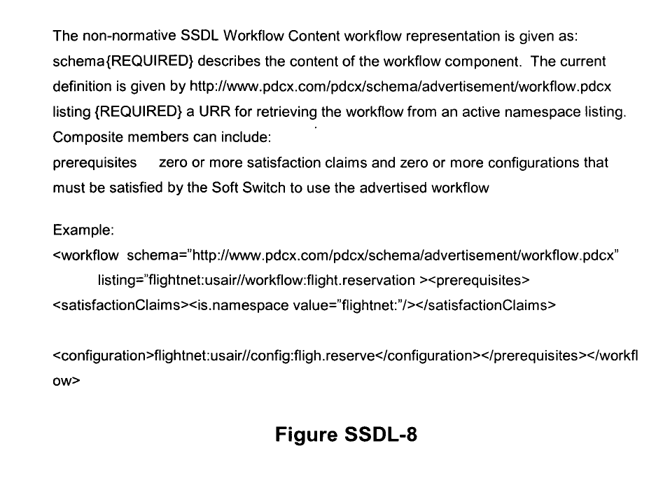

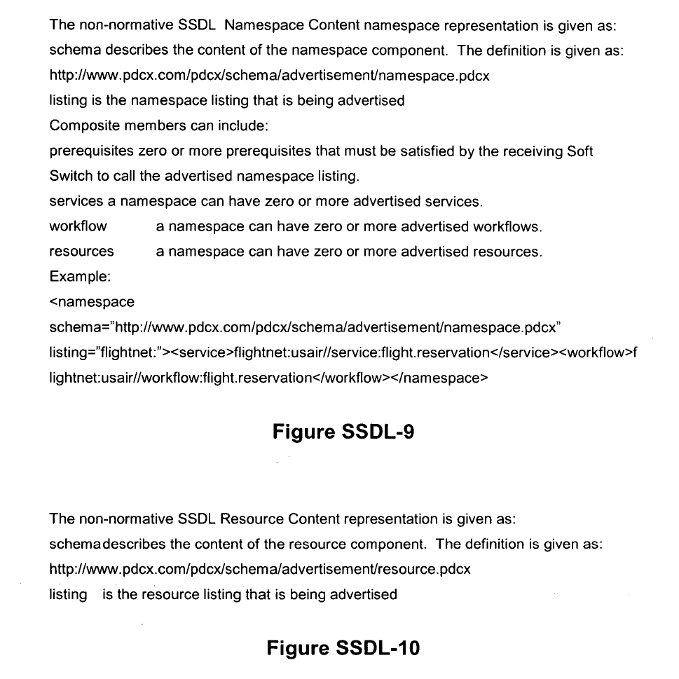

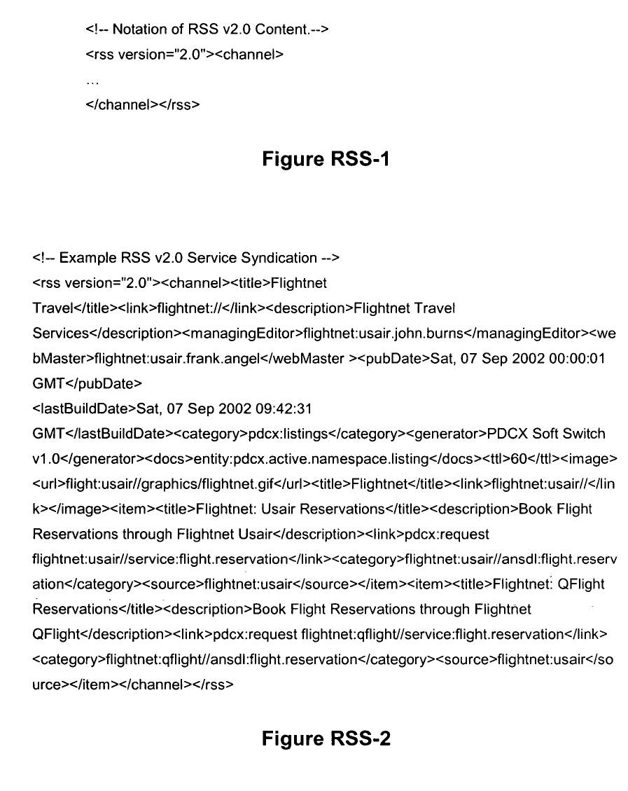

Upon installing the configured Namespace Management System and subscription configuration document, the employee starts the Namespace Management System which imports the subscription configuration document and registers the point of presence for horserace:track.freehold. The employee registers current race information into the Namespace Management System by importing the document shown in FIG. 41 using the pdcx:import service with as.entity=“horserace:track.freehold. Thus, horserace:track.freehold.race.horse[1].name would have the value “Trottin’” Tarzan.”

A customer using their Microsoft IE web browser enters the freeholdracetrack.com URL, and the resource response is rendered in their browser and displayed on their screen. The customer completes a form displayed in their browser, submits the form, and the browser receives a respond page that is rendered in the browser window, the rendered page including a hyperlink to a subscription configuration document and a second hyperlink to a configured Namespace Management System that can be downloaded and installed. Upon installing the configured Namespace Management System and subscription configuration document, the customer starts the Namespace Management System which imports the subscription configuration document and registers the point of presence for the customer listing given as horserace:track.freehold.customer.chris. A second customer follows a similar procedure for the namespace listing horserace:track.freehold .customer.art.

The first customer, upon reviewing the current race information, advertises a service that he will provide $10 to a first subscriber if horse 2 loses the race, on the condition that the subscriber will provide $10 to the first customer if horse 2 wins the race. The second customer, upon receiving the service advertisement, accepts the advertisement and subscribes to the service under the conditions specified. If horse 2 loses the race, the first customer provides the $10 in compensation to the second customer. Alternatively, if horse 2 wins the race, the second customer provides the $10 in compensation to the first customer. The administrator of the horserace:track.freehold namespace listing may, at its option, impose a transaction fee on the service provided by the first customer.

The horserace: namespace provider offers subscriptions to various racetracks, such as horserace:track.Freehold, horserace:track.Meadowlands, and horserace:track.MonmouthPark. Each track provides listings for their customers, such as horserace:track.Freehold.customer.bob and horserace:track.MonmouthPark.customer.art. A first subscriber can advertise a service to a second subscriber through the horserace: namespace independent of the track to which the subscriber has subscribed. In this context, each track may impose a transaction fee for providing (facilitating) communication content between subscribers.

SIP Namespace

The session initiation protocol (SIP) is widely used in Internet Telephony. The Internet Engineering Task Force RFC3268 states: “Spam, defined as the transmission of bulk unsolicited messages, has plagued Internet email. Unfortunately, spam is not limited to email. It can affect any system that enables user-to-user communications. The Session Initiation Protocol (SIP) defines a system for user-to-user multimedia communications. Therefore, it is susceptible to spam, just as email is.”

The Namespace Management System overcomes this limitation by using active namespace listings to locate and identify participants. Thus, a Namespace Management System can be configured to accept or reject session invitations based on the namespace listing of the session initiator, their credential information, and/or other criteria.

The sip: namespace includes composite entities representative of session initiation protocol services. The sip:invite service, for example, is used to request a session to be established with the identified namespace listing. The sip:cancel service is used to cancel a pending transaction, and the sip:bye service is used to terminate a current session. Through the Session Initiation Protocol, the Namespace Management System can be configured to be responsive to SIP sessions, thus enabling inbound and outbound session origination.

Additional namespaces can be added for other protocols, such as the gcp: namespace for the Gateway Control Protocol; the sdp: namespace for the Session Description. Protocol; the rtp: namespace for the Real-Time Transport Protocol; and the rtsp: namespace for the Real-Time Streaming Protocol. Additional namespaces can be added for other services, such as the vpim: namespace for the Voice Profile for Internet Mail; the imf: namespace for the Internet Message Format service; the vmrs: namespace for the Voice Message Routing Service; and the vmds: namespace for the Voice Messaging Directory Service.

Electronic Edge Devices

An electronic edge device can communicate with a Namespace Management System service to request a service, such as registering entity information in a Namespace Management System namespace. The GPS chip in an electronic device such as a user's cell phone can provide the current location information for the cell phone. Although a user can subscribe to the www.accutracking.com free tracking service, which installs software on the cell phone, the subscriber cannot configure new or extended services beyond the limited accutracking tracking services available from their server.

The accutracking information is not currently used in conjunction with Google's Short Message Service or Location service, nor can text driving instructions or graphic maps from a service such as www.mapsonus.com be sent back to the cell phone. Topographical image maps from NASA Worldwind cannot be easily integrated. Even if, or when, these services become available, the user will be confronted with a multiplicity of services from a multiplicity of service providers each focused on particular market niches, and will not have the necessary mechanisms to custom configure, integrate, or extend these disjointed service offerings.

The Namespace Management System is used to overcome these limitations by obtaining the GPS coordinates from a GPS enabled electronic device and communicating this information so that it can be registered as a namespace listing in a Namespace Management System namespace. The application can communicate the GPS location information to a Namespace Management System service that registers the location in a namespace listing. Additional identifying information can be communicated, such as the user's namespace listing or cell phone number. To minimize transmissions, rules, such as minimum location tolerance change, elapsed time, or frequency of reporting, can be set. GPS location information may be used in a geospatial namespace. One or more configuration documents can be stored in an electronic device and communicated to a Namespace Management System service. In one implementation, a user's cell phone is programmed and a configuration document is uploaded to the cell phone. Using a configured Namespace Management System executing on an edge device, the user's configuration document is provided to a Namespace Management System service. In response to receiving a subscription configuration document, the Namespace Management System registers a current point of presence to associate with the user's namespace listing. This allows a configured Namespace Management System kiosk to be provided in public venues, such as an airport terminal.

The user can start a brew application to post said configuration document with or without the GPS coordinates to a service available over the Internet, such as http://www.pdcx.com/mobile, which registers the information as an entity in a namespace and responds with a unique communication identifier, such as a listing. The cell phone user can subsequently key-in the unique communication identifier into a configured Namespace Management System, which sends this information in a query request to a service to retrieve said configuration document and any available GPS information. The Namespace Management System can use a decrypt service, such as pdcx:pgp.decrypt, to decrypt the configuration document, and the user can be prompted for a pass phrase, if necessary. The Namespace Management System imports the unencrypted subscription configuration document to register the point of presence to associate with the subscription. The web service can remove the entry from the namespace after the query.

A Namespace Management System can be installed on an electronic device offering interfaces for such installation and configuration documents made available to the Namespace Management System. This enables one skilled in the art to describe a service in a configuration document that can be responsive to Session Initiated Protocol (SIP), Voice over IP (VoIP) Protocol, Wireless Access Protocol (WAP), ITU-T H.323 protocol, and other industry standard protocols.

Correlating a provisioned namespace listing, such as a subscriber listing, with GPS location information enables location-based services, tracking services, and navigation services to be administered by the Namespace Management System. Depending on the GPS location information format, a conversion service may be called to convert Degrees/Minutes/Seconds to/from Decimal Latitude/Longitude. A reverse geocoding service is called to translate the GPS location information into street address information that is registered as a composite entity of the namespace listing. Having the location information registered in the namespace allows a Namespace Management System to be dynamically configured, by importing one or more configuration documents, to coordinate service interactions. A first user, for example, imports a configuration document providing a service to communicate GPS location information to obtain flood information from FEMA, while a second user imports a configuration document providing a service to obtain earthquake information from the US Geological Service using the current GPS location, and a third user imports a configuration document providing a service to obtain driving instructions to the nearest gas station. Another user imports a configuration document providing a tracking service. Thus, a multiplicity of configuration documents describing services using location can be provided. A user of a Namespace Management System can import one or more of these configuration documents, thus providing centralized access to only those services of interest.

Enabling an electronic device to communicate a configuration document allows a user to carry one or more configuration documents with them. A Namespace Management System kiosk in a designated public area, such as an airport terminal, can securely obtain the user's configuration document. Similarly, a corporation with virtual desks can deploy common Namespace Management System's to desk computers, and an employee arriving at the desk can have the Namespace Management System configured according to the employee's needs. Alternatively, a subscription configuration document could be stored on a computer readable media, such as a business card CD that can be inserted into a CD reader device accessible to the computer that is running the Namespace Management System. The subscription configuration document can be recorded on a magnetic strip that can be read by a magstripe reader accessible to a computer that is running the Namespace Management System.

The Namespace Management System as a Windows Network Provider

The Namespace Management System can be used to implement a Windows network provider that enables discovery of active namespace listings, as well as discovery and connection to services within the active namespace using the Windows user interface in a similar manner as other network providers such as Microsoft Networking, Novell Netware, and UNIX networks. A network provider implements network-specific actions, such as making a connection, and exposes a common interface to Windows. This interface is called the Network Provider API and consists of functions implemented by the network provider. A user can create a network provider DLL to support new network protocols. Because each network exposes a common interface through its provider, Windows can interact with several types of networks without knowing their network-specific implementation details. The Multiple Provider Router (MPR) handles communication with all of the various network providers on the system and presents an integrated network to the user.

Using the Namespace Management System and a network provider DLL configured to communicate with the Namespace Management System, Windows users can browse the active namespace for listings, including edge computing devices, and identify services offered using a Windows Shell extension handler, which implements a “My Active Namespace Places” folder according to rules established by the active namespace administrator. Such active namespace services may include access to shared folders on remote computers, printing to a remote printer connected to another computer within the active namespace, network FAX delivery to other computers within the active namespace, and other common networking tasks. The Windows Shell extension handler can provide the capability to subscribe and unsubscribe to active namespace services, and can also serve as the administrative interface to the Namespace Management System and to active namespace services. With the Windows Shell extension, users can publish services to other namespace listings. Authentication and security for accessing shared active namespace services via the Shell extension . is administered by the Namespace Management System and is not necessarily restricted by the security scheme of the native network, such as Windows NT, Windows 2000 or Windows 2003 domains, etc.

### Exemplary Embodiment

The following provides an exemplary embodiment for a private network, named The MyNet Namespace, operated by the Internet Service Provider MyNet Internet. The MyNet Namespace allows MyNet subscribers to share files with other MyNet subscribers, and also to print to printers connected to remote edge computing devices operated by other MyNet subscribers. The embodiment is implemented with a Namespace Management System administering the mynet: namespace, entries in the Windows registry, and a multiplicity of Namespace Management Systems, each configured with a network provider DLL and a Windows Shell extension handler DLL, and configuration documents all located on edge computing devices within the mynet: namespace.

MyNet uses a Namespace Management System to administer the mynet: namespace with a first Namespace Management System. A second Namespace Management System (mynet:central) is used to process subscriber identification requests against the corporate subscriber database. Before MyNet subscribers can use The MyNet Namespace service, they must first register using the MyNet corporate web site, providing their name and other subscription data, including the level of service desired. Two levels of service are provided by MyNet. Level one service includes a file sharing service, and level two service includes a file sharing service coupled with a printing service. As new customers are added to the corporate subscription database from the web site, a software program is used to register the customer with the mynet:central Namespace Management System. Registration includes a subscriber unique identifier (SUI) that is assigned to each subscriber and the subscription level. The software program connects to the mynet:central Namespace Management System and sends a pdcx:request for a service to register subscriber information adhering to a type definition for subscriber_id_t using the pdcx:entity.typedef built-in service where the type definition includes the subscriber name, the unique SUI, and the subscription level. Once the subscriber is registered, the Namespace Management System, configuration documents, and The MyNet Namespace software programs can be downloaded to the subscriber's computing device and installed and configured.

When The MyNet Namespace software is installed on the subscriber's Windows XP computing device, the Windows Registry is updated to configure the Windows Shell extension handler as an approved shell extension, and installs a “My Active Namespace Places” shortcut to the active namespace places system folder on the Windows XP desktop. The “My Computer” system folder is also updated to include a “My Active Namespaces Places” icon, which is also a shortcut to the active namespace places system folder. The MyNet Namespace software installation also registers a context menu handler for inserting MyNet sharing menu items for files and file objects located on the local computing device, and another context menu handler for inserting MyNet mapping menu items for files and file objects located on other edge computing devices within the active namespace.

After installation is complete, subscribers to The MyNet Namespace can explore the active namespace using the Windows Explorer. While exploring, subscribers are able to view the listings of other MyNet subscribers and, if permission is granted by another subscriber, connect to a shared file object or a shared printer on their remote computing device. Subscribers can also share file objects and printer objects on their own computing device and make them available to other MyNet subscribers, either individually or by group, or to all members.

A MyNet subscriber controls sharing of file objects with other MyNet subscribers on the MyNet: namespace also using the Windows Explorer. To modify the shared status of the file folder named My Documents, a subscriber opens the My Computer folder on their desktop by double-clicking the My Computer icon with the left button of the mouse pointing device or, alternatively, right-clicking the icon with the right button of the mouse pointing device and selecting the Open or Explore menu item, or, alternatively, selecting My Computer from the Windows Start menu using either the mouse pointing device or by appropriate keyboard device sequences. The local file system on the local computer device is further explored by opening the C: drive icon in the My Computer system folder using any appropriate Windows navigation technique with a valid combination of mouse pointing device actions and/or keyboard device actions. Exploration continues opening each file folder object in the hierarchy necessary to reach the My Documents folder. Once the My Documents folder object is displayed in the My Computer system folder, the subscriber modifies the sharing status and permissions by right-clicking the icon with the right button of the mouse pointing device and selecting the MyNet Share menu item, or, alternatively, selecting the icon using either the mouse pointing device or appropriate keyboard device sequences, and then selecting File, MyNet Share menu sequence from the My Computer system folder menu using either the mouse pointing device or by appropriate keyboard device sequences. To share the folder object with all MyNet subscribers such that anyone can read files from the folder object, but cannot write to them or delete them, the Share This Folder option is selected in the MyNet File Object Sharing dialog box, the Permissions command button is selected, resulting in another dialog box that presents a list of MyNet Namespace active namespace listings along with share level permissions including, read, write, and full control. The “Everyone” listing entry is selected using either the mouse pointing device or by appropriate keyboard device sequences, and read share level permission is selected using either the mouse pointing device or by appropriate keyboard device sequences. When these actions are completed, the subscriber saves the changes by selecting the Apply command button using either the mouse pointing device or by appropriate keyboard device sequences, or other means provided through underlying operating system interfaces. The specified options, to share the My Documents folder object for all MyNet subscribers for read only access, are then stored in the MyNet registry.

In another example, the My Documents file folder object is to be shared with MyNet subscriber a.j.jones for write access. To accomplish this, the subscriber follows the same sequence of steps as with the previous example; however, instead of selecting the “Everyone” listing entry, the listings list is searched for the entry associated with a.j.jones. When found, the list entry item is selected using either the mouse pointing device or by appropriate keyboard device sequences, and the write share level permission is selected using either the mouse pointing device or by appropriate keyboard device sequences. The settings are saved using the same procedure as in the previous example.

Opening My Active Namespace Places displays the My Active Namespace Places system folder, which includes an icon for The MyNet Namespace. The subscriber continues exploring The MyNet Namespace by double-clicking the The MyNet Namespace icon with the left button of the mouse pointing device or, alternatively, right-clicking the icon with the right button of the mouse pointing device and selects the Open or Explore menu item, or, alternatively, selecting the icon using either the mouse pointing device or appropriate keyboard device sequences, and then selecting File, Open or File, Explore menu sequence from the My Active Namespaces Places system folder menu using either the mouse pointing device or by appropriate keyboard device sequences. The My Active Namespace Places system folder displays a list containing the listing associated with each edge computing device in the mynet: namespace registry, with the list organized and formatted according to standard Windows Explorer settings, such as thumbnail view, tile view, icon view, list view, and details view. Depending on the view chosen, the subscriber may be able to sort the list by a certain attribute of the list, such as listing name. To further explore a particular listing, the subscriber double-clicks the list entry corresponding to the desired listing with the left button of the mouse pointing device, or, alternatively, right-clicks the list entry with the right button of the mouse pointing device and then selects the Open or Explore menu item, or, alternatively, selecting the desired list entry using either the mouse pointing device or appropriate keyboard device sequences, and then selecting the File, Open or File, Explore menu sequence from the My Active Namespaces Places system folder menu using either the mouse pointing device or by appropriate keyboard device sequences. If the selected listing edge computing device has file objects that have been shared by that subscriber, and the permissions established by that subscriber permit access by the inquiring subscriber, a list of file objects is displayed in the My Active Namespaces Places system folder. If the file object is a container object, such as a folder, the object may be further explored by the subscriber by double-clicking the list entry corresponding to the desired file folder object with the left button of the mouse pointing device, or, alternatively, right-clicking the file folder object with the right button of the mouse pointing device and selecting the Open or Explore menu item. If the file object is a file, the file may be copied from the remote edge computing device by dragging and dropping the object to any appropriate Windows Explorer object representing a file store on the local computing device, or, alternatively, right-clicking the file object with the right button of the mouse pointing device and selecting the Copy menu item and then pasting the copied file object to any appropriate Windows Explorer object representing a file store on the local computing device, or, alternatively, selecting the File, Copy menu sequence from the My Active Namespaces Places system folder menu using either the mouse pointing device or by appropriate keyboard device sequences.

Subscriber Listings and Cert Namespace

An active namespace listing subscription service can verify the credential of a subscriber and issue the subscriber a credential relative to the active namespace listing. On subsequent requests to the active namespace listing, the subscriber can use the newly issued credential.

In an implementation, brenet:staff.member.john subscribes to flightnet:usair, providing his Namespace Management System credential, which is verified by the implementation. In response thereto, brenet:staff.member.john receives a certificate with the distinguished name flightnet:usair.cust.jkb. The certificate is registered with brenet:staff.member.john's Namespace Management System as cert:flightnet.usair. In the implementation, the flightnet:usair.cust.jkb certificate expiration is bounded by the brenet:staff.member.john certificate expiration (if any). When brenet:staff.member.john sends a subsequent pdcx:request to flightnet:usair, the pdcx:request locates and uses the cert:flightnet.usair certificate for authentication and sets the from.listing to flightnet:usair.cust.jkb. Similarly, the public and private keys are used for encryption and decryption. When calling a listing relative to flightnet:usair, and there is not a corresponding certificate, then the cert:flightnet.usair certificate can be used. The flightnet:usair service can subsequently verify the flightnet:usair.cust.jkb credential without the need for verifying the credential assigned by brenet:staff.member to brenet:staff.member.john.

The implementation can be used in a liquidity: namespace where anonymous but credentialized participants who have a listing in the namespace can indicate interest in participating as a buyer and/or seller of a good or a service, transact that purchase and/or sale, manage and audit the transaction through parts of or all of its life cycle, and be made aware of the opportunity to participate in other such transactions regardless of messaging modality. A subscriber to the liquidity: namespace can be representative of a group of active namespace listings that subscribed to and are known to the group, enabling the subscriber to the liquidity: namespace to act on behalf of the group without identifying each participant in the group. Thus, the invention allows for anonymous but credentialized participants to take part in the market opportunity while ensuring the integrity of the transaction.

### SUMMARY

The Namespace Management System comprises a run-time configurable state information management system that evaluates a request within a semantic domain defined by the state information at a given moment in time. The Namespace Management System comprises a Namespace Management application executing on a computer system that is connected to the Internet or other Autonomous System. The Namespace Management System is programmatically and dynamically configurable to take part in and administer a multiplicity of namespaces, each of which contains listings, data, and services or other state information required to satisfy a request and/or interact with callable services.

What is claimed:

1. A namespace management system, executing on a computing device which is connected to a communication medium, comprising:
communication means for sending and receiving communications over said communication medium; and
namespace management means operational in said computing device, comprising:
bootstrap means for initializing a namespace administered by the namespace management means,
service registration means for registering services into said namespace administered by the namespace management means,
parser means, responsive to a configuration document received by said communication means, including data that describes a request to be interpreted by the namespace management means, for parsing and evaluating said received configuration document, and
service means, responsive to said parser means outputting a service request received in said configuration document, for calling a service identified in said service request and registered in said namespace by said service registration means.

2. The namespace management system of claim 1 wherein said communication means comprises:
protocol means for implementing at least one communication protocol for sending and receiving communications over said communication medium.

3. The namespace management system of claim 1 further comprising:
a dynamically loadable library containing at least one initialization function that is callable; and
wherein said namespace management means further comprises:
link means, responsive to said service request received in said configuration document calling said initialization function identified in said service request, where the called initialization function is absent from said namespace and loaded in said dynamically loadable library, for loading said initialization function from said at least one dynamically loadable library into said namespace.

4. The namespace management system of claim 1 further comprising:
at least one dynamically loadable library which contains at least one executable module that implements a service; and
wherein said namespace management means further comprises:
link means, responsive to said service request received in said configuration document calling a service identified in said service request, where the called service is absent from said namespace and loaded in said at least one dynamically loadable library, for loading said at least one module from said at least one dynamically loadable library into said namespace.

5. The namespace management system of claim 1 wherein said namespace management means further comprises:
subscription means, responsive to receiving a subscription request communicated by a first process executing on a first computing device, for validating the received subscription request and in response thereto registering a subscriber listing in said namespace; and
configuration means, responsive to validation of said subscription request, for transmitting a configuration document containing a registration request as the response to the subscription request wherein the configuration document includes a representation of the registered subscriber listing.

6. The namespace management system of claim 5 wherein said namespace management means further comprises:
registration means, responsive to receiving a registration request including a representation of a subscriber listing, for registering the current point of presence to associate with the subscriber listing.

7. The namespace management system of claim 6 wherein said namespace management means further comprises:
scheme handler means for resolving a namespace listing reference, which is given as a Uniform Resource Identifier, to the present point of presence for the namespace listing.

8. A method of operating a namespace management system, executing on a computing device which is connected to a communication medium, comprising:
sending and receiving communications over said communication medium; and
managing a namespace which is operational in said computing device, comprising:
initializing a namespace administered by the namespace management means;
registering services into said namespace administered by the namespace management means;
parsing, in response to a configuration document received by said communication means, including data that describes a request to be interpreted by the namespace management means, and evaluating said received configuration document; and
calling, in response to said parser means outputting a service request received in said configuration document, a service identified in said service request and registered in said namespace by said service registration step.

9. The method of operating a namespace management system of claim 8 wherein said step of sending and receiving comprises:
implementing at least one communication protocol for sending and receiving communications over said communication medium.

10. The method of operating a namespace management system of claim 8 further comprising:
dynamically loading a library containing at least one initialization function that is callable; and
wherein said step of managing a namespace further comprises:
loading, in response to said service request received in said configuration document calling said initialization function identified in said service request, where the called initialization function is absent from said namespace and loaded in said dynamically loadable library, said initialization function from said at least one dynamically loadable library into said namespace.

11. The method of operating a namespace management system of claim 8 further comprising:
loading at least one dynamically loadable library which contains at least one executable module that implements a service; and
wherein said step of managing a namespace further comprises:
loading, in response to said service request received in said configuration document calling a service identified in said service request, where the called service is absent from said namespace and loaded in said at least one dynamically loadable library, said at least one module from said at least one-dynamically loadable library into said namespace.

12. The method of operating a namespace management system of claim 8 wherein said step of managing a namespace further comprises:
validating, in response to receiving a subscription request communicated by a first process executing on a first computing device, the received subscription request and in response thereto registering a subscriber listing in said namespace; and
transmitting, in response to validation of said subscription request, a configuration document containing a registration request as the response to the subscription request wherein the configuration document includes a representation of the registered subscriber listing.

13. The method of operating a namespace management system of claim 12 wherein said step of managing a namespace further comprises:
registering, in response to receiving a registration request including a representation of a subscriber listing, the current point of presence to associate with the subscriber listing.

14. The method of operating a namespace management system of claim 12 wherein said step of managing a namespace further comprises:
resolving a namespace listing reference, which is given as a Uniform Resource Identifier, to the present point of presence for the namespace listing.

15. A method of operating a namespace management system comprising:
executing a first process with protocol services for sending and receiving communications;
allocating in said first process and initializing memory for a service directory;
registering a service registration listing in said service directory, said listing containing information representative of a registration service for registering additional services;
parsing in said first process a configuration document containing service request statements expressed in a language format that can be interpreted by said first process, wherein a service request statement is bound to said listing and said service registration service is called to evaluate the request;
wherein said request includes information representative of a dynamic load library module that was not linked with the executable code corresponding to the first process and in response thereto the first process loads the dynamic load library into the address space of the first process; and
resolving a reference to an initialization function in said address space;
calling the initialization function and in response thereto registering a multiplicity of listings in the service directory representative of additional protocol services that can subsequently be called.

16. A method of operating a namespace management system comprising:
executing a first process with protocol services for sending and receiving communications;
allocating in said first process and initializing memory for a service directory;
registering a service registration listing in said service directory, said listing containing information representative of a registration service for registering additional services;
parsing in said first process a configuration document containing service request statements expressed in a language format that can be interpreted by said first process, wherein a service request statement is bound to said listing and said service registration service is called to evaluate the request;
wherein said request includes information representative of a dynamic load library module that was not linked with the executable code corresponding to the first process and in response thereto the first process loads the dynamic load library into the address space of the first process; and
resolving a reference to an initialization function in said address space;
calling the initialization function and in response thereto registering a multiplicity of listings in the service directory representative of additional protocol services that subsequently can be called.
